(19) United States
(12) Patent Application Publication
(10) Pub. No.: US 2013/0268417 A1
(43) Pub. Date: Oct. 10, 2013

(54) METHOD AND APPARATUS FOR PROVIDING SERVICES AND REPORTING OF SALES

(71) Applicant: MY CLEAR REPORTS, LLC, Westbury, NY (US)

(72) Inventor: Amedeo Dino Sgueglia, Glen Cove, NY (US)

(73) Assignee: My Clear Reports, LLC, Westbury, NY (US)

(21) Appl. No.: 13/857,681

(22) Filed: Apr. 5, 2013

Related U.S. Application Data
(60) Provisional application No. 61/620,672, filed on Apr. 5, 2012.

(51) Int. Cl. G06Q 40/00

(52) U.S. Cl. CPC G06Q 40/10
USPC 705/30; 705/317

(57) ABSTRACT

A request for custom credit card sales account information is received at a server from a merchant employing a mobile device. The request includes an indication of a particular reporting type of the custom credit card sales account information. The server requests credit card sales account information from a financial service provider. The financial service provider is different than an entity hosting the server. The server receives the credit card sales account information from the financial service provider. The server filters the credit card sales account information based on the particular reporting type. The server generates a filtered custom credit card sales account based on the filtering. The server provides the filtered custom credit card sales account information to the mobile device.

### CROSS REFERENCE TO RELATED APPLICATIONS

This application claims benefit of U.S. Provisional Application Ser. No. 61/620,672 filed Apr. 5, 2012, the disclosure of which is hereby incorporated herein by reference in its entirety.

### TECHNICAL FIELD

This specification is generally directed to methods, systems and apparatus for providing services and reporting of sales and more particularly to methods, systems and apparatus for providing services and reporting of sales to merchants.

### BACKGROUND

Financial service providers provide economic services. Financial service providers include credit unions, banks, credit card companies, independent sales organizations (ISOs), insurance companies, consumer finance companies, stock brokerages, investment funds and some government sponsored enterprises.

A financial service provider may provide merchant reporting to its own individual merchants. For example, when a merchant wishes to view a list of credit card sales for a particular period (e.g., a month), the merchant can request a monthly report of credit card sales from the financial service provider. The financial service provider may also provide the merchant with account or reporting information related to the credit card sales. For example, the financial service provider may supply the merchant with a summary of available funds. The financial service provider may be limited in the information that it can supply to the merchant. That is, the financial service provider may be limited in the types of reports that can be supplied to the merchant.

### SUMMARY

This invention is generally directed to methods, systems, apparatus, and a computer readable medium for providing information relating to credit card accounts. In an embodiment, a request for custom credit card sales account information is received at a server from a merchant employing a mobile device. The request includes an indication of a particular reporting type of the custom credit card sales account information. The server requests credit card sales account information from a financial service provider. The financial service provider is different than an entity hosting the server. The server receives the credit card sales account information from the financial service provider. The server filters the credit card sales account information based on the particular reporting type. The server generates a filtered custom credit card sales account based on the filtering. The server provides the filtered custom credit card sales account information to the mobile device.

In an embodiment, the server receives a search request from the mobile device to search for a particular credit card sale. The server performs a search of the filtered custom credit card sales account information to identify the particular credit card sale. The server provides the particular credit card sale to the mobile device in a format that can be properly displayed by the mobile device.

In an embodiment, the reports server receives a request for cash advance from the mobile device. The request for cash advance is based on a total number of sales indicated by the credit card sales account information. The server requests the cash advance from at least one of the financial service provider or another financial service provider. The server receives payment based on the cash advance from at least one of the financial service provider, or another financial service provider. The server provides an indication of the funds based on the cash advance to the mobile device.

In an embodiment, the server receives a request for providing branded information on reports provided to the mobile device from the financial service provider. The server inputs the branded information on the reports, generates the branded reports, and provides the branded reports to the mobile device. The branded reports include at least the branded information and the filtered custom credit card sales account information.

In an embodiment, a server receives a request for a processing card industry compliance certificate from a merchant employing a device. The server authenticates the device. The server transmits a processing card industry compliance questionnaire, including a plurality of questions, to the device. The server receives one or more responses to the plurality of questions and verifies the one or more responses. The server processes the one or more responses in order to determine whether or not the merchant complies with a processing card industry compliance requirement. The server provides a processing card industry compliance certificate to the device in response to determining that the merchant complies with the processing card industry compliance requirement.

In an embodiment, the verifying further includes performing a network security scan by the server. The network security scan may be performed periodically to ensure that the merchant complies with the processing card industry compliance requirement.

In an embodiment, the server determines that the merchant does not comply with the processing card industry compliance requirement. The server alerts the merchant in response to the determining.

In an embodiment, a server receives a first request for credit card sales account information from a merchant employing a mobile device. The server requests from a financial service provider, credit card sales account information. The financial service provider is different than an entity hosting the server. The server receives the credit card sales account information from the financial service provider. The server provides the credit card sales account information to the mobile device. The server receives a second request to provide a prepaid card account loaded with available funds based on the credit card sales account information from the merchant. The server creates the prepaid card account by loading the prepaid card account with an amount of funds in an amount of the available funds. The server maintains transactional information associated with the prepaid card account. The server detects a transaction that is processed on the prepaid card account. The server provides an alert to the mobile device in response to the detecting.

These and other advantages of the present disclosure will be apparent to those of ordinary skill in the art by reference to the following Detailed Description and the accompanying drawings.

### BRIEF DESCRIPTION OF THE DRAWINGS

FIG. 1 depicts a communication system that may be used to provide services and reporting of sales, in accordance with an embodiment;

FIG. 2 depicts functional components of a device, in accordance with an embodiment;

FIG. 3 depicts functional components of a server, in accordance with an embodiment;

FIG. 4 depicts an application executing on a browser, in accordance with an embodiment;

FIG. 5 depicts functional components of a database, in accordance with an embodiment;

FIG. 6A is a flowchart depicting a method of providing custom credit card sales account information, in accordance with an embodiment;

FIG. 6B is a flowchart depicting a method of determining processing card industry compliance, in accordance with an embodiment;

FIG. 6C is a flowchart depicting a method of creating a prepaid card account, in accordance with an embodiment;

FIG. 7 depicts a mobile application's splash screen, in accordance with an embodiment;

FIG. 8 depicts a mobile application's navigator screen, in accordance with an embodiment;

FIG. 9A depicts a mobile application's top portion of the contact us screen, in accordance with an embodiment;

FIG. 9B depicts a mobile application's bottom portion of the contact us screen, in accordance with an embodiment;

FIG. 10A depicts a mobile application's ATM locator screen, in accordance with an embodiment;

FIG. 10B depicts another mobile application's ATM locator screen, in accordance with an embodiment;

FIG. 11 depicts a mobile application's FAQ screen, in accordance with an embodiment;

FIG. 11A depicts a mobile application's FAQ screen for merchant accounts, in accordance with an embodiment;

FIG. 11B depicts a mobile application's FAQ screen for Advanced funding accounts, in accordance with an embodiment;

FIG. 11C depicts a mobile application's FAQ screen for Prepaid debit card accounts, in accordance with an embodiment;

FIGS. 12A and 12B depicts a mobile application's Savings screen, in accordance with an embodiment;

FIG. 13 depicts a mobile applications privacy and security screen, in accordance with an embodiment;

FIG. 14 depicts a mobile application's login screen, in accordance with an embodiment;

FIG. 14A depicts another mobile application's login screen, in accordance with an embodiment;

FIG. 15 depicts a mobile application's about us screen, in accordance with an embodiment;

FIG. 16 depicts a mobile application's terms screen, in accordance with an embodiment;

FIG. 17 depicts a mobile application's main menu screen, in accordance with an embodiment;

FIG. 17A depicts a mobile application's merchant account screen, in accordance with an embodiment;

FIG. 17B depicts another mobile application's merchant account screen, in accordance with an embodiment;

FIG. 17C depicts a mobile application's funds screen, in accordance with an embodiment;

FIG. 18A depicts a mobile application's top portion of the alerts screen, in accordance with an embodiment;

FIG. 18B depicts a mobile application's bottom portion of the alerts screen, in accordance with an embodiment;

FIG. 19A depicts a mobile application's top portion of the merchant account filtering screen, in accordance with an embodiment;

FIG. 19B depicts a mobile application's middle portion of the merchant account filtering screen, in accordance with an embodiment;

FIG. 19C depicts a mobile application's bottom portion of the merchant account filtering screen, in accordance with an embodiment;

FIG. 20A depicts a mobile application's merchant account detail reporting screen, in accordance with an embodiment;

FIG. 20B depicts a mobile application's merchant account sales screen, in accordance with an embodiment;

FIG. 20C depicts a mobile application's top portion of the merchant account card type screen, in accordance with an embodiment;

FIG. 20D depicts a mobile application's bottom portion of the merchant account card type screen, in accordance with an embodiment;

FIG. 20E depicts a mobile application's top portion of the merchant account deposits screen, in accordance with an embodiment;

FIG. 20F depicts a mobile application's bottom portion of the merchant account deposits screen, in accordance with an embodiment;

FIG. 20G depicts a mobile application's top portion of the merchant account batches screen, in accordance with an embodiment;

FIG. 20H depicts a mobile application's bottom portion of the merchant account batches screen, in accordance with an embodiment;

FIG. 20I depicts a mobile application's merchant account transactions screen, in accordance with an embodiment;

FIG. 20J depicts a mobile application's merchant account chargebacks screen, in accordance with an embodiment;

FIGS. 20K and 20L depict a mobile application's merchant account fees screen, in accordance with an embodiment;

FIG. 21 depicts a mobile application's advanced funding account screen, in accordance with an embodiment;

FIG. 22A depicts a mobile application's top portion of the advanced funding account alerts screen, in accordance with an embodiment;

FIG. 22B depicts a mobile application's bottom portion of the advanced funding account alerts screen, in accordance with an embodiment;

FIG. 23A depicts a mobile application's top portion of the advanced funding account funds screen, in accordance with an embodiment;

FIG. 23B depicts a mobile application's bottom portion of the advanced funding account funds screen, in accordance with an embodiment;

FIG. 24 depicts a mobile application's advanced funding account paid back screen, in accordance with an embodiment;

FIG. 25 depicts a mobile application's advanced funding account hold back percentage screen, in accordance with an embodiment;

FIG. 26 depicts a mobile application's advanced funding account funds advanced screen, in accordance with an embodiment;

FIG. 27 depicts another mobile application's advanced funding account screen, in accordance with an embodiment;

FIG. 28 depicts a mobile application's advanced funding account learn more screen, in accordance with an embodiment;

FIG. 29A depicts a mobile application's top portion of the prepaid debit card account screen, in accordance with an embodiment;

FIG. 29B depicts a mobile application's bottom portion of the prepaid debit card account screen, in accordance with an embodiment;

FIG. 30A depicts a mobile application's top portion of the prepaid debit card account alerts screen, in accordance with an embodiment;

FIG. 30B depicts a mobile application's bottom portion of the prepaid debit card account alerts screen, in accordance with an embodiment;

FIG. 31A depicts a mobile application's prepaid debit card account block card screen, in accordance with an embodiment;

FIG. 31B depicts another mobile application's prepaid debit card account block card screen, in accordance with an embodiment;

FIG. 31C depicts another mobile application's prepaid debit card account block card screen, in accordance with an embodiment;

FIG. 32A depicts a mobile application's prepaid debit card account screen with financial information, in accordance with an embodiment;

FIG. 32B depicts another mobile application's prepaid debit card account screen with financial information, in accordance with an embodiment;

FIG. 33A depicts a mobile application's top portion of the prepaid debit card account card activity screen, in accordance with an embodiment;

FIG. 33B depicts a mobile application's bottom portion of the prepaid debit card account card activity screen, in accordance with an embodiment;

FIG. 34 depicts a mobile application's prepaid debit card account learn more, in accordance with an embodiment;

FIG. 35 depicts a mobile application's prepaid debit card account get card screen, in accordance with an embodiment;

FIG. 36 depicts a mobile application's time out screen, in accordance with an embodiment;

FIG. 37 depicts a web application's home screen, in accordance with an embodiment;

FIG. 38 depicts a web application's products, services and tools screen, in accordance with an embodiment;

FIG. 38A depicts a web application's reporting tool mobile learn more screen, in accordance with an embodiment;

FIG. 38B depicts a web application's sales tax reporting learn more screen, in accordance with an embodiment;

FIG. 38C depicts a web application's advanced funding learn more screen, in accordance with an embodiment;

FIG. 38D depicts a web application's prepaid debit card learn more screen, in accordance with an embodiment;

FIG. 38E depicts a web application's gift card learn more screen, in accordance with an embodiment;

FIG. 38F depicts a web application's check processing learn more screen, in accordance with an embodiment;

FIG. 38G depicts a web application's processing card industry (PCI) learn more screen, in accordance with an embodiment;

FIG. 38H depicts a web application's graphic designer learn more screen, in accordance with an embodiment;

FIG. 38I depicts a web application's savings learn more screen, in accordance with an embodiment;

FIG. 38J depicts a web application's terminal supplies learn more screen, in accordance with an embodiment;

FIG. 39 depicts a web application's home screen statement message, in accordance with an embodiment;

FIG. 40 depicts a web application's merchant account screen, in accordance with an embodiment;

FIG. 41A depicts a web application's merchant account sales by month screen, in accordance with an embodiment;

FIG. 41B depicts a web application's merchant account sales by month screen with timeframe option, in accordance with an embodiment;

FIG. 41C depicts a web application's merchant account sales by month screen with grid selection option, in accordance with an embodiment;

FIG. 41D depicts a web application's merchant account sales by month screen with chart selection option, in accordance with an embodiment;

FIG. 41E depicts a web application's merchant account sales by month screen with calendar selection option, in accordance with an embodiment;

FIG. 41F depicts a web application's merchant account sales by month screen with filter option, in accordance with an embodiment;

FIG. 42A depicts a web application's merchant account card type by month screen, in accordance with an embodiment;

FIG. 42B depicts a web application's merchant account card type by month screen with timeframe option, in accordance with an embodiment;

FIG. 42C depicts a web application's merchant account card type by month screen with grid selection option, in accordance with an embodiment;

FIG. 42D depicts a web application's merchant account card type by month screen with chart selection option, in accordance with an embodiment;

FIG. 42E depicts a web application's merchant account card type by month screen with calendar selection option, in accordance with an embodiment;

FIG. 42F depicts a web application's merchant account card type by month screen with filter option, in accordance with an embodiment;

FIG. 43A depicts a web application's merchant account deposits by day screen, in accordance with an embodiment;

FIG. 43B depicts a web application's merchant account deposits by day screen with timeframe option, in accordance with an embodiment;

FIG. 43C depicts a web application's merchant account deposits by day screen with grid selection option, in accordance with an embodiment;

FIG. 43D depicts a web application's merchant account deposits by day screen with expanded grid selection option, in accordance with an embodiment;

FIG. 43E depicts a web application's merchant account deposits by day screen with chart selection option, in accordance with an embodiment;

FIG. 43F depicts a web application's merchant account deposits by day screen with calendar selection option, in accordance with an embodiment;

FIG. 43G depicts a web application's merchant account deposits by day screen with filter option, in accordance with an embodiment;

FIG. 44A depicts a web application's merchant account batches by day screen, in accordance with an embodiment;

FIG. 44B depicts a web application's merchant account batches by day screen with timeframe option, in accordance with an embodiment;

FIG. 44C depicts a web application's merchant account batches by day screen with grid selection option, in accordance with an embodiment;

FIGS. 44D and 44E depict a web application's merchant account deposits by day screen with expanded grid selection option, in accordance with an embodiment;

FIG. 44F depicts a web application's merchant account batches by day screen with chart selection option, in accordance with an embodiment;

FIG. 44G depicts a web application's merchant account batches by day screen with calendar selection option, in accordance with an embodiment;

FIG. 44H depicts a web application's merchant account batches by day screen with filter option, in accordance with an embodiment;

FIG. 45A depicts a web application's merchant account transactions by day screen, in accordance with an embodiment;

FIG. 45B depicts a web application's merchant account transactions by day screen with timeframe option, in accordance with an embodiment;

FIG. 45C depicts a web application's merchant account transactions by day screen with grid selection option, in accordance with an embodiment;

FIG. 45D depicts a web application's merchant account deposits by day screen with expanded grid selection option, in accordance with an embodiment;

FIG. 45E depicts a web application's merchant account transactions by day screen with chart selection option, in accordance with an embodiment;

FIG. 45F depicts a web application's merchant account transactions by day screen with calendar selection option, in accordance with an embodiment;

FIG. 45G depicts a web application's merchant account transactions by day screen with filter option, in accordance with an embodiment;

FIG. 46A depicts a web application's merchant account transactions by day screen, in accordance with an embodiment;

FIG. 46B depicts a web application's merchant account chargebacks screen with timeframe option, in accordance with an embodiment;

FIG. 46C depicts a web application's merchant account chargebacks screen with grid selection option, in accordance with an embodiment;

FIG. 46D depicts a web application's merchant account chargebacks screen with chart selection option, in accordance with an embodiment;

FIG. 46E depicts a web application's merchant account screen with calendar selection option, in accordance with an embodiment;

FIG. 46F depicts a web application's merchant account chargebacks screen with filter option, in accordance with an embodiment;

FIG. 47A depicts a web application's merchant account fee descriptions screen, in accordance with an embodiment;

FIG. 47B depicts a web application's merchant account fee descriptions screen with timeframe option, in accordance with an embodiment;

FIG. 47C depicts a web application's merchant account fee descriptions screen with grid selection option, in accordance with an embodiment;

FIG. 47D depicts a web application's merchant account deposits by day screen with expanded grid selection option, in accordance with an embodiment;

FIG. 47E depicts a web application's merchant account fee descriptions screen with chart selection option, in accordance with an embodiment;

FIG. 47F depicts a web application's merchant account fee descriptions screen with calendar selection option, in accordance with an embodiment;

FIG. 47G depicts a web application's merchant account fee descriptions screen with filter option, in accordance with an embodiment;

FIG. 47H depicts a web application's merchant account manage alerts screen, in accordance with an embodiment;

FIG. 48 depicts a web application's advanced funding account screen, in accordance with an embodiment;

FIG. 48A depicts a web application's advanced funding account request funds screen, in accordance with an embodiment;

FIG. 48B depicts a web application's top portion of the advanced funding account request funds screen with the holdback percentage displaying, in accordance with an embodiment;

FIG. 48C depicts a web application's bottom portion of the advanced funding account request funds screen with the holdback percentage displaying, in accordance with an embodiment;

FIG. 49 depicts a web application's advanced funding account funds advanced screen, in accordance with an embodiment;

FIG. 49A depicts a web application's advanced funding account funds advanced screen for filtering on timeframe, in accordance with an embodiment;

FIG. 49B depicts a web application's advanced funding account funds advanced screen for viewing information in a grid view, in accordance with an embodiment;

FIG. 49C depicts a web application's advanced funding account funds advanced screen for viewing information in a chart view, in accordance with an embodiment;

FIG. 49D depicts a web application's advanced funding account funds advanced screen for viewing information in a calendar view, in accordance with an embodiment;

FIG. 49E depicts a web application's advanced funding account funds advanced screen for filtering information, in accordance with an embodiment;

FIG. 50 depicts another advanced funding account screen, in accordance with an embodiment;

FIG. 50A depicts a web application's advanced funding account amount paid back screen, in accordance with an embodiment;

FIG. 50B depicts a web application's advanced funding account amount paid back screen for filtering on timeframe, in accordance with an embodiment;

FIG. 50C depicts a web application's advanced funding account amount paid back screen for viewing information in a grid view, in accordance with an embodiment;

FIG. 50D depicts a web application's advanced funding account amount paid back screen for viewing information in a chart view, in accordance with an embodiment;

FIG. 50E depicts a web application's advanced funding account amount paid back screen for viewing information in a calendar view, in accordance with an embodiment;

FIG. 51 depicts a web application's advanced funding account holdback percentage screen, in accordance with an embodiment;

FIG. 52 depicts a web application's advanced funding account manage alerts screen, in accordance with an embodiment;

FIG. 53 depicts a web application's advanced funding account documents screen, in accordance with an embodiment;

FIG. 54 depicts a web application's prepaid debit card account screen, in accordance with an embodiment;

FIG. 54A depicts a web application's prepaid debit card account get a card screen, in accordance with an embodiment;

FIG. 54B depicts a web application's prepaid debit card account order supplemental card screen, in accordance with an embodiment;

FIG. 54C depicts a web application's prepaid debit card account activate card screen, in accordance with an embodiment;

FIG. 55A depicts a web application's prepaid debit card account card activity screen, in accordance with an embodiment;

FIG. 55B depicts a web application's advanced funding account card activity screen for filtering on timeframe, in accordance with an embodiment;

FIG. 55C depicts a web application's advanced funding account card activity screen for viewing information in a grid view, in accordance with an embodiment;

FIG. 55D depicts a web application's merchant account deposits by day screen with expanded grid selection option, in accordance with an embodiment;

FIG. 55E depicts a web application's advanced funding account card activity screen for viewing information in a chart view, in accordance with an embodiment;

FIG. 55F depicts a web application's advanced funding account card activity screen for viewing information in a calendar view, in accordance with an embodiment;

FIG. 55G depicts a web application's advanced funding account card activity screen for filtering information, in accordance with an embodiment;

FIG. 56 depicts a web application's prepaid debit card account use your card screen, in accordance with an embodiment;

FIG. 56A depicts a web application's prepaid debit card account use your card screen displaying use your card, in accordance with an embodiment;

FIG. 56B depicts a web application's prepaid debit card account use your card screen displaying card benefits, in accordance with an embodiment;

FIG. 56C depicts a web application's prepaid debit card account use your card screen displaying find load center locator, in accordance with an embodiment;

FIG. 56D depicts a web application's prepaid debit card account use your card screen displaying ATM locator, in accordance with an embodiment;

FIG. 56E depicts a web application's prepaid debit card account use your card screen displaying direct deposit, in accordance with an embodiment;

FIG. 56F depicts a web application's prepaid debit card account direct deposit form, in accordance with an embodiment;

FIG. 57 depicts a web application's prepaid debit card account transfer screen, in accordance with an embodiment;

FIG. 57A depicts a web application's prepaid debit card account transfer screen displaying card to bank transfers, in accordance with an embodiment;

FIG. 57B depicts a web application's prepaid debit card account transfer screen displaying card to card transfers, in accordance with an embodiment;

FIG. 57C depicts a web application's prepaid debit card account screen for creating a recipient for card to card transfers, in accordance with an embodiment;

FIG. 58 depicts a web application's prepaid debit card account manage cards, in accordance with an embodiment;

FIG. 58A depicts a web application's prepaid debit card account manage cards screen displaying manage alerts, in accordance with an embodiment;

FIG. 58B depicts a web application's prepaid debit card account manage cards screen displaying block card, in accordance with an embodiment;

FIG. 58C depicts a web application's prepaid debit card account manage cards screen displaying my debit card profile, in accordance with an embodiment;

FIG. 58D depicts a web application's prepaid debit card account manage cards screen displaying set pin, in accordance with an embodiment;

FIG. 58E depicts a web application's prepaid debit card account manage cards screen displaying dispute transaction, in accordance with an embodiment;

FIGS. 58F and 58G depict a web application's prepaid debit card account dispute transaction form, in accordance with an embodiment;

FIG. 59 depicts a web application's bill pay screen, in accordance with an embodiment;

FIG. 59A depicts a web application's bill pay make a payment screen, in accordance with an embodiment;

FIG. 59B depicts a web application's bill pay add a payee screen, in accordance with an embodiment;

FIG. 59C depicts a web application's bill pay payment history screen, in accordance with an embodiment;

FIG. 59D depicts a web application's bill pay payee list screen, in accordance with an embodiment;

FIG. 60 depicts a web application's gift card screen, in accordance with an embodiment;

FIGS. 60A and 60B depict a web application's bill pay order cards screen, in accordance with an embodiment;

FIG. 61 depicts a web application's check processing screen, in accordance with an embodiment;

FIG. 61A depicts a web application's check processing apply screen, in accordance with an embodiment;

FIG. 61B depicts a web application's check processing add ach screen, in accordance with an embodiment;

FIG. 61C depicts a web application's check processing add consumer screen, in accordance with an embodiment;

FIG. 62 depicts a web application's check processing view consumers screen, in accordance with an embodiment;

FIG. 63 depicts a web application's check processing view transactions screen, in accordance with an embodiment;

FIG. 64 depicts a web application's check processing view subscriptions screen, in accordance with an embodiment;

FIG. 65 depicts a web application's check processing view terms screen, in accordance with an embodiment;

FIG. 66 depicts a web application's PCI questionnaire screen, in accordance with an embodiment;

FIG. 66A depicts a web application's PCI questionnaire about our questionnaire screen, in accordance with an embodiment;

FIG. 67 depicts a web application's PCI merchant type screen, in accordance with an embodiment;

FIG. 67A depicts a web application's PCI merchant type screen displaying merchant type A—click here for more information, in accordance with an embodiment;

FIG. 67B depicts a web application's PCI merchant type screen displaying merchant type B—click here for more information, in accordance with an embodiment;

FIG. 67C depicts another web application's PCI merchant type screen displaying merchant type B—click here for more information, in accordance with an embodiment;

FIG. 67D depicts a web application's PCI merchant type screen displaying merchant type C—click here for more information, in accordance with an embodiment;

FIG. 67E depicts a web application's PCI merchant type screen displaying merchant type C-VT—click here for more information, in accordance with an embodiment;

FIG. 67F depicts a web application's PCI merchant type screen displaying merchant type D—click here for more information, in accordance with an embodiment;

FIG. 67G depicts a web application's PCI merchant type screen displaying merchant type not sure—click here for more information, in accordance with an embodiment;

FIG. 68A depicts a web application's PCI part I—Determine your merchant type screen displaying question 1, in accordance with an embodiment;

FIG. 68B depicts a web application's PCI part I—Determine your merchant type screen displaying question 1 help pop-up screen, in accordance with an embodiment;

FIG. 68C depicts a web application's PCI part I—Determine your merchant type screen displaying question 2, in accordance with an embodiment;

FIG. 68D depicts a web application's PCI part I—Determine your merchant type screen displaying question 2 help pop-up screen, in accordance with an embodiment;

FIG. 68E depicts a web application's PCI part I—Determine your merchant type screen displaying question 3, in accordance with an embodiment;

FIG. 68F depicts a web application's PCI part I—Determine your merchant type screen displaying question 3 help pop-up screen, in accordance with an embodiment;

FIG. 68G depicts a web application's PCI part I—Determine your merchant type screen displaying question 4, in accordance with an embodiment;

FIG. 68H depicts a web application's PCI part I—Determine your merchant type screen displaying question 4 help pop-up screen, in accordance with an embodiment;

FIG. 68I depicts a web application's PCI part I—Determine your merchant type screen displaying question 5, in accordance with an embodiment;

FIG. 68J depicts a web application's PCI part I—Determine your merchant type screen displaying question 5 help pop-up screen, in accordance with an embodiment;

FIG. 68K depicts a web application's PCI part I—Determine your merchant type screen displaying question 6, in accordance with an embodiment;

FIG. 68L depicts a web application's PCI part I—Determine your merchant type screen displaying question 6 help pop-up screen, in accordance with an embodiment;

FIG. 68M depicts a web application's PCI part I—Determine your merchant type screen displaying question 7, in accordance with an embodiment;

FIG. 68N depicts a web application's PCI part I—Determine your merchant type screen displaying question 7 help pop-up screen, in accordance with an embodiment;

FIG. 68O depicts a web application's PCI part I—Determine your merchant type screen displaying question 8, in accordance with an embodiment;

FIG. 68P depicts a web application's PCI part I—Determine your merchant type screen displaying question 8 help pop-up screen, in accordance with an embodiment;

FIG. 69A depicts a web application's PCI part 2—you are merchant type screen, in accordance with an embodiment;

FIG. 69B depicts a web application's PCI part 2—meeting your requirements screen displaying requirement 1, in accordance with an embodiment;

FIG. 69C depicts a web application's PCI part 2—meeting your requirements screen displaying requirement 2, in accordance with an embodiment;

FIG. 69D depicts a web application's PCI part 2—meeting your requirements screen displaying the top portion of requirement 3, in accordance with an embodiment;

FIG. 69E depicts a web application's PCI part 2—meeting your requirements screen displaying the bottom portion of requirement 3, in accordance with an embodiment;

FIG. 69F depicts a web application's PCI part 2—meeting your requirements screen displaying requirement 4, in accordance with an embodiment;

FIG. 69G depicts a web application's PCI part 2—meeting your requirements screen displaying requirement 5, in accordance with an embodiment;

FIG. 69H depicts a web application's PCI part 2—meeting your requirements screen displaying the top portion of requirement 6, in accordance with an embodiment;

FIG. 69I depicts a web application's PCI part 2—meeting your requirements screen displaying the bottom portion of requirement 6, in accordance with an embodiment;

FIG. 69J depicts a web application's PCI part 2—meeting your requirements screen displaying requirement 7, in accordance with an embodiment;

FIG. 69K depicts a web application's PCI part 2—meeting your requirements screen displaying the top portion of requirement 8, in accordance with an embodiment;

FIG. 69L depicts a web application's PCI part 2—meeting your requirements screen displaying the bottom portion of requirement 8, in accordance with an embodiment;

FIG. 69M depicts a web application's PCI part 2—meeting your requirements screen displaying the top portion of requirement 9, in accordance with an embodiment;

FIG. 69N depicts a web application's PCI part 2—meeting your requirements screen displaying the bottom portion of requirement 9, in accordance with an embodiment;

FIG. 69O depicts a web application's PCI part 2—meeting your requirements screen displaying the top portion of requirement 10, in accordance with an embodiment;

FIG. 69P depicts a web application's PCI part 2—meeting your requirements screen displaying the bottom portion of requirement 10, in accordance with an embodiment;

FIG. 69Q depicts a web application's PCI part 2—meeting your requirements screen displaying the top portion of requirement 11, in accordance with an embodiment;

FIG. 69R depicts a web application's PCI part 2—meeting your requirements screen displaying the bottom portion of requirement 11, in accordance with an embodiment;

FIG. 69S depicts a web application's PCI part 2—meeting your requirements screen displaying the top portion of requirement 12, in accordance with an embodiment;

FIG. 69T depicts a web application's PCI part 2—meeting your requirements screen displaying the bottom portion of requirement 12, in accordance with an embodiment;

FIG. 70 depicts a web application's PCI attestation screen, in accordance with an embodiment;

FIG. 71 depicts a web application's PCI results screen, in accordance with an embodiment;

FIG. 71A depicts a web application's PCI results screen displaying the PCI Certification report, in accordance with an embodiment;

FIG. 71B depicts a web application's PCI results screen displaying the Attestation report, in accordance with an embodiment;

FIG. 72 depicts a web application's IRS report screen, in accordance with an embodiment;

FIG. 72A depicts a web application's IRS 1099K report, in accordance with an embodiment;

FIG. 73 depicts a web application's sales tax reporting screen, in accordance with an embodiment;

FIG. 73A depicts a web application's sales tax reporting apply screen, in accordance with an embodiment;

FIG. 73B depicts a web application's sales tax reporting add cash receipts screen, in accordance with an embodiment;

FIG. 74 depicts a web application's graphic design screen, in accordance with an embodiment;

FIG. 74A depicts a web application's graphic design apply screen, in accordance with an embodiment;

FIG. 75 depicts a web application's savings system screen, in accordance with an embodiment;

FIG. 75A depicts a web application's savings system apply screen, in accordance with an embodiment;

FIG. 75B depicts a web application's graphic designer apply screen, in accordance with an embodiment;

FIG. 76 depicts a web application's customer relationship management tools (CRM) screen displaying the dashboard tab, in accordance with an embodiment;

FIG. 76A depicts a web application's customer relationship management create an email campaign step 1 screen, in accordance with an embodiment;

FIG. 76B depicts a web application's customer relationship management create an email campaign step 2 and step 3 screen, in accordance with an embodiment;

FIG. 76C depicts a web application's customer relationship management send a text message screen, in accordance with an embodiment;

FIG. 77A depicts a web application's customer relationship management accounts screen, in accordance with an embodiment;

FIG. 77B depicts a web application's customer relationship management accounts add an account screen, in accordance with an embodiment;

FIG. 78A depicts a web application's customer relationship management customers screen, in accordance with an embodiment;

FIG. 78B depicts a web application's customer relationship management customers add a customer screen, in accordance with an embodiment;

FIG. 79A depicts a web application's customer relationship management campaigns screen, in accordance with an embodiment;

FIG. 79B depicts a web application's customer relationship management campaigns email campaign step 1 screen, in accordance with an embodiment;

FIG. 79C depicts a web application's customer relationship management campaign's email campaign step 2 and step 3 screen, in accordance with an embodiment;

FIG. 79D depicts a web application's customer relationship management campaigns text messaging screen, in accordance with an embodiment;

FIG. 80 depicts a web application's calculator screen, in accordance with an embodiment;

FIG. 80A depicts a web application's calculator screen displaying current cash flow calculator, in accordance with an embodiment;

FIG. 80B depicts a web application's calculator screen displaying financial statement ratio analysis calculator, in accordance with an embodiment;

FIG. 80C depicts a web application's calculator screen displaying product pricing calculator, in accordance with an embodiment;

FIG. 81 depicts a web application's discounts screen, in accordance with an embodiment;

FIG. 82 depicts a web application's marketing tips screen, in accordance with an embodiment;

FIG. 83 depicts a web application's documents screen, in accordance with an embodiment;

FIG. 84 depicts a web application's change password screen, in accordance with an embodiment;

FIG. 85 depicts a web application's contact us screen, in accordance with an embodiment;

FIG. 86 depicts a web application's profile screen, in accordance with an embodiment;

FIG. 87A depicts a web administration report application's graph screen of total merchant accounts, in accordance with an embodiment;

FIG. 87B depicts a web administration report application's graph screen of PCI accounts and status, in accordance with an embodiment;

FIG. 87C depicts a web administration report application's graph screen of PCI portfolio status, in accordance with an embodiment;

FIG. 87D depicts a web administration report application's graph screen of PCI SAQ A accounts and status, in accordance with an embodiment;

FIG. 87E depicts a web administration report application's graph screen of merchant accounts and their IRS tax id match, in accordance with an embodiment;

FIG. 87F depicts a web administration report application's graph screen of merchant accounts and their IRS tax id match status, in accordance with an embodiment;

FIG. 87G depicts a web administration report application's graph screen of merchant inquiries, in accordance with an embodiment;

FIG. 88A depicts a web administration report application's dashboard screen, in accordance with an embodiment;

FIG. 88B depicts a web administration report application's dashboard editor screen, in accordance with an embodiment;

FIG. 89A depicts a web administration report application's products screen of number of advanced funding accounts, in accordance with an embodiment;

FIG. 89B depicts a web administration report application's products screen of number of prepaid debit card accounts, in accordance with an embodiment;

FIG. 89C depicts a web administration report application's products screen of number of gift card accounts, in accordance with an embodiment;

FIG. 89D depicts a web administration report application's products screen of number of check processing accounts, in accordance with an embodiment;

FIG. 89E depicts a web administration report application's products screen of number of sales tax accounts, in accordance with an embodiment;

FIG. 90 depicts a web administration report application's status screen, in accordance with an embodiment;

FIG. 91 depicts a web administration report application's web analytics screen, in accordance with an embodiment;

FIG. 92A depicts a web administration report application's system settings screen, in accordance with an embodiment;

FIG. 92B depicts a web administration report application's system settings screen displaying settings tool, in accordance with an embodiment;

FIG. 92C depicts a web administration report application's system settings screen displaying groups/users tool, in accordance with an embodiment;

FIG. 92D depicts a web administration report application's system settings screen displaying security tab, in accordance with an embodiment;

FIG. 92E depicts a web administration report application's system settings screen displaying database tool, in accordance with an embodiment;

FIG. 93A depicts a web administration report application's manage merchants screen displaying search tab, in accordance with an embodiment;

FIG. 93B depicts a web administration report application's manage merchants screen displaying view tab, in accordance with an embodiment;

FIG. 93C depicts a web administration report application's manage merchants screen displaying forms tab account summary, in accordance with an embodiment;

FIG. 93D depicts a web administration report application's manage merchants screen displaying forms tab ach transactions, in accordance with an embodiment;

FIG. 93E depicts a web administration report application's manage merchants screen displaying forms tab credit card transactions for authorizations, in accordance with an embodiment;

FIG. 93F depicts a web administration report application's manage merchants screen displaying forms tab credit card transactions for detail information for authorizations, in accordance with an embodiment;

FIG. 93G depicts a web administration report application's manage merchants screen displaying forms tab credit card transactions for batches, in accordance with an embodiment;

FIG. 93H depicts a web administration report application's manage merchants screen displaying forms tab credit card transactions for detail information for batches, in accordance with an embodiment;

FIG. 93I depicts a web administration report application's manage merchants screen displaying forms tab IRS 1099K information, in accordance with an embodiment;

FIG. 93J depicts a web administration report application's manage merchants screen displaying forms tab notes information, in accordance with an embodiment;

FIG. 93K depicts a web administration report application's manage merchants screen displaying forms tab messages information, in accordance with an embodiment;

FIG. 93L depicts a web administration report application's manage merchants screen displaying forms tab users account, in accordance with an embodiment;

FIG. 93M depicts a web administration report application's manage merchants screen displaying documents tab, in accordance with an embodiment;

FIG. 93N depicts a web administration report application's manage merchants screen displaying reports tab, in accordance with an embodiment;

FIG. 93O depicts a web administration report application's manage merchants screen displaying reports tab showing an IRS 1099K form, in accordance with an embodiment;

FIG. 93P depicts a web administration report application's manage merchants screen displaying reports tab showing PCI compliant certificate, in accordance with an embodiment;

FIG. 93Q depicts a web administration report application's manage merchants screen displaying reports tab showing PCI attestation report, in accordance with an embodiment;

FIG. 94A depicts a web administration report application's manage clients screen displaying the search tab, in accordance with an embodiment;

FIG. 94B depicts a web administration report application's manage clients screen displaying the forms tab displaying basic information, in accordance with an embodiment;

FIG. 94C depicts a web administration report application's manage clients screen displaying the forms tab displaying basic information with directory, in accordance with an embodiment;

FIG. 94D depicts a web administration report application's manage clients screen displaying the forms tab displaying accounts screen, in accordance with an embodiment;

FIG. 94E depicts a web administration report application's manage clients screen displaying the forms tab displaying buy rate screen, in accordance with an embodiment;

FIG. 94F depicts a web administration report application's manage clients screen displaying the forms tab displaying residual information, in accordance with an embodiment;

FIG. 94G depicts a web administration report application's manage clients screen displaying the forms tab displaying profitability information, in accordance with an embodiment;

FIG. 94H depicts a web administration report application's manage clients screen displaying the forms tab displaying notes information, in accordance with an embodiment;

FIG. 94I depicts a web administration report application's manage clients screen displaying the forms tab displaying messages information, in accordance with an embodiment;

FIG. 94J depicts a web administration report application's manage clients screen displaying the forms tab displaying user account information, in accordance with an embodiment;

FIG. 94K depicts a web administration report application's manage clients screen displaying the documents tab displaying user account information, in accordance with an embodiment;

FIG. 94L depicts a web administration report application's manage clients screen displaying the reports tab displaying user account information, in accordance with an embodiment;

FIG. 95A depicts a web administration report application's manage ISO and agents screen displaying search tab, in accordance with an embodiment;

FIG. 96 depicts a web administration report application's chat communicator screen, in accordance with an embodiment;

FIG. 97 depicts a web administration report application's notes screen, in accordance with an embodiment;

FIG. 98A depicts a web administration report application's statements and news screen, in accordance with an embodiment;

FIG. 98B depicts a web administration report application's statements and news screen displaying edit statement, in accordance with an embodiment;

FIG. 99 depicts a web administration report application's statements, in accordance with an embodiment;

FIG. 100 depicts a web administration report application's residuals reports, in accordance with an embodiment;

FIG. 101 depicts a web administration report application's reports, in accordance with an embodiment;

FIG. 102 depicts a web administration report application's Visa Fan report, in accordance with an embodiment;

FIG. 103A depicts a web administration report application's prepaid card reports, in accordance with an embodiment;

FIG. 103B depicts a web administration report application's prepaid card reports displaying card issuance report, in accordance with an embodiment;

FIG. 103C depicts a web administration report application's prepaid card reports displaying transaction detail report, in accordance with an embodiment;

FIG. 103D depicts a web administration report application's prepaid card reports displaying bank reconciliation report, in accordance with an embodiment;

FIG. 103E depicts a web administration report application's prepaid card reports displaying card activation detail report, in accordance with an embodiment;

FIG. 103F depicts a web administration report application's prepaid card reports displaying aged un-activated card report, in accordance with an embodiment;

FIG. 103G depicts a web administration report application's prepaid card reports displaying adjustment detail report, in accordance with an embodiment;

FIG. 104 depicts a web administration report application's profile screen, in accordance with an embodiment;

FIG. 105 depicts a web administration report application's change password screen, in accordance with an embodiment;

FIG. 105A depicts a web application's user guide report, in accordance with an embodiment;

FIG. 106 depicts a flow diagram of merchant account data flow, in accordance with an embodiment;

FIGS. 106A, 106B and 106C depict customization options, in accordance with an embodiment; and

FIG. 107 illustrates a computer adapted to implement the methods described herein.

### DETAILED DESCRIPTION

A system is provided that enables financial service providers and merchants to have the ability to provide reporting capabilities with additional value added products and services designed by merchants for merchants. The system provides a unique, powerful web tool that can both substantially reduce merchant attrition for financial service providers while increase significantly their gross margins and profitability.

The system provides a web portal and a mobile application for products designed for merchants of financial service providers that integrate such information, reporting, products and services, in one place.

The system provides a paradigm in merchant retention and monetization for financial service providers and other product and service providers of the system.

The system provides a web based reporting and sales software system developed for merchants, processors, banks and independent sales offices (ISO). The system integrates credit card processing reporting, merchant financing, prepaid card issuing, processing card industry (PCI) security, customer relationship management tools (CRM) and other ancillary products and services. The system provides the ability for financial service providers to update their merchant's credit card processing data, daily or in real time. The system enables this data and other sales products and services data and information to be instantly available upon any merchant's web request. The system directly integrates with the financial service provider and any product and or service providers made available to the merchant, per the financial service provider to monetize the relationship for the financial service provider. Either directly through the financial service provider's web site or directly through the system's web portal, merchants may gain access to the system and services, 24 hours a day, 7 days a week.

Merchants may benefit from the powerful reporting and analytics the system provides. With the ability to customize queries, details and account summaries, the system can be used to review batches and settlement, track business trends, confirm internal revenue service (IRS) reporting and reconciliation, and schedule employee shifts.

The system may anchor merchant relationships. In addition to being an incredibly strong retention tool, the system monetizes merchant relationships. The system also serves as a customer service portal, giving merchants, ISOs, banks and processors the ability to access account information anytime, anywhere.

The system may anchor each merchant relationship to any ISO or organization. In addition to being an incredibly strong retention tool, the system may provide ISOs, merchants, processors and banks with enhanced added value and resources.

The system may serve as a tool to directly reduce merchant attrition for a financial service provider. The system was also created to provide greater merchant loyalty to a financial service provider, while increasing revenue and margins for the financial service provider.

The system may also be used as a customer service portal and tool for financial service providers and merchants. The system gives merchants, ISOs, banks and processors the ability to access certain key account information anytime, anywhere.

The system provides a web portal where merchants can see all their valuable merchant services in one place. Along with reporting and analytics, customers are offered additional products and services to benefit and grow their business.

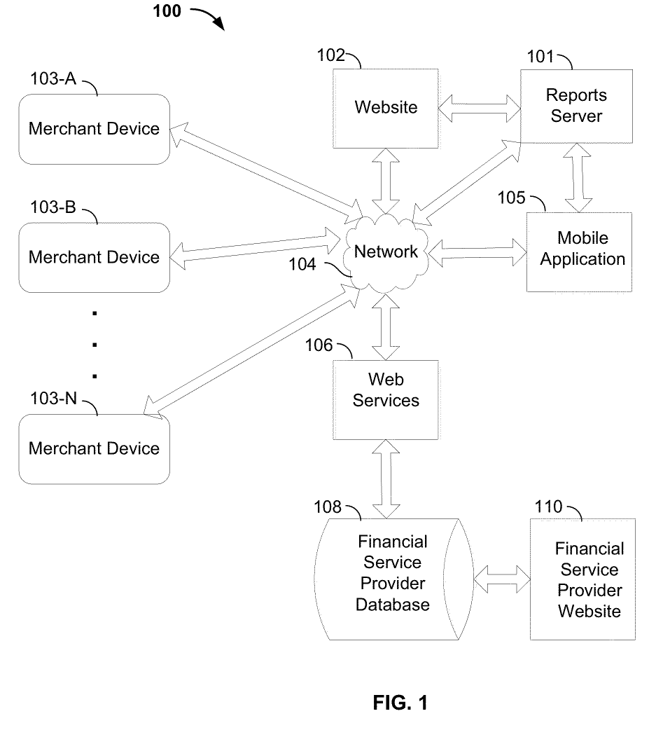

FIG. 1 depicts a communication system 100 that may be used to provide services and reporting of sales, in accordance with an embodiment. Communication system 100 includes a reports server 101, a website 102, a merchant device 103-A, a merchant device 103-B, a merchant device 103-N, a network 104, a mobile application 105, web services 106, a financial service provider database 108, and a financial service provider website 110. Communication system 100 may include more or fewer than “N” merchant devices. For convenience, the term “merchant device 103” is used herein to refer to any one of merchant devices 103-A, 103-B . . . 103-N. Accordingly, any discussion herein referring to “merchant device 103” is equally applicable to each of merchant devices 103-A, 103-B . . . 103-N.

In an embodiment, a financial service provider manages financial service provider database 108 and/or financial service provider website 110. In other embodiments, multiple financial service providers may manage one or more databases and websites.

In the illustrative embodiment depicted in FIG. 1, website 102 is hosted by reports server 101. Website 102 may be a reports website which resides on reports server 101. In other embodiments, website 102 may reside on and/or be hosted by one or more web servers.

In the exemplary embodiment of FIG. 1, network 104 is the Internet. In other embodiments, network 104 may include one or more of a number of different types of networks, such as, for example, an intranet, a local area network (LAN), a wide area network (WAN), a wireless network, a cellular network, a Fibre Channel-based storage area network (SAN), or Ethernet. Other networks may be used. Alternatively, network 104 may include a combination of different types of networks.

In an embodiment, reports server 101 may host a web application that can be accessed by merchant device 103. In an alternate embodiment, the web application may be hosted by any other server. In an embodiment, reports server 101 may provide access to one or more webpages hosted on website 102 providing access to the web application. Device 103 may access one or more World Wide Web pages on website 102 that may be viewed using a conventional web browser, for example.

In another embodiment, reports server 101 communicates with mobile application 105. Mobile application 105 may be utilized by any mobile device wishing to access system information. For example, when a mobile device wishes to retrieve credit card account information, the mobile device connects to mobile application 105, via network 104.

Device 103 may be any device that enables a merchant to access application 316. Device 103 may be connected to network 102 through a direct (wired) link, or wirelessly. Device 103 may have a display screen (not shown) for displaying information. For example, device 103 may be a personal computer, a laptop computer, a workstation, a mainframe computer, a mobile communication device such as a wireless phone, a personal digital assistant, cellular device, a laptop computer, a netbook, a tablet device, an electronic book reader etc. Other devices may be used.

Website 102 and web services 106 communicate via network 104.

The system website interfaces with the financial service provider website (i.e., website 110) via Web Service calls. Reports server 101 may provide software code for the Web Service. The Web Service code can run in several environments, (e.g., operating systems such as WINDOWS, LINUX, MAC OS).

Each financial service provider may maintain its own financial service provider database 108 as specified by a customizable database schema. All merchant information may remain with the financial service provider and is only shared with their merchants. Financial service provider database 108 can reside on one or more different database engines (e.g. Microsoft SQL Server, Oracle, Sybase, MySQL). Additionally, multiple financial service providers may access reports server 101.

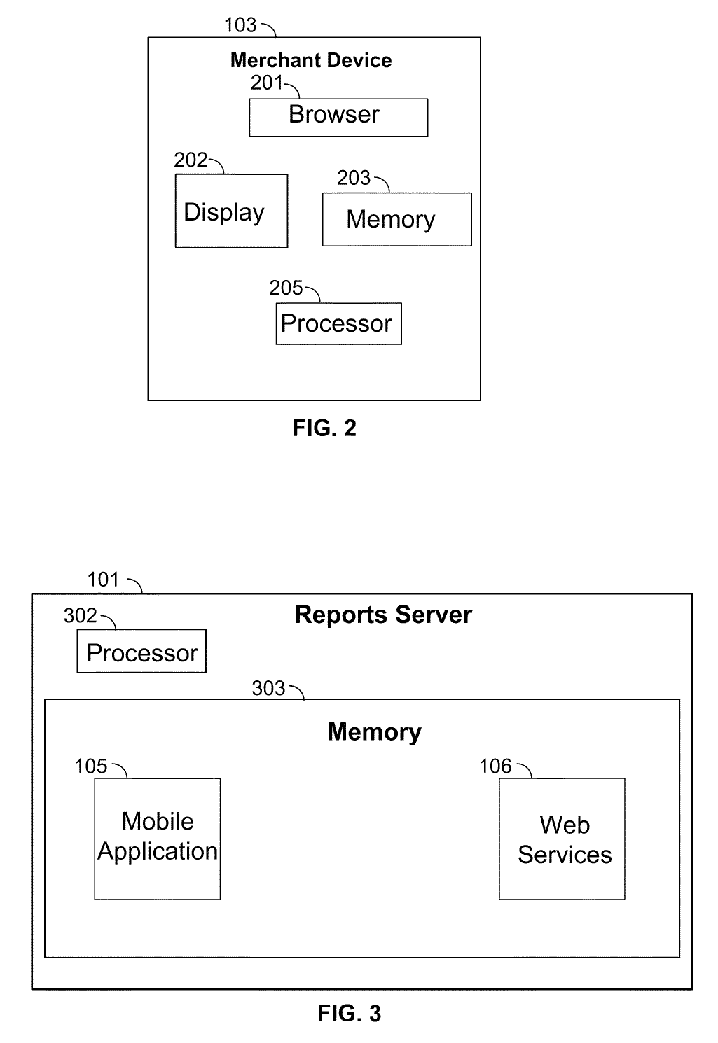

FIG. 2 depicts functional components of a device, in accordance with an embodiment. Merchant device 103 includes a browser 201 and a display 202, a memory 203, and a processor 205. Browser 201 may be a conventional web browser used to access World Wide Web sites via the Internet, for example. Display 202 may display software applications, webpages, documents, text, images, video, multimedia and other information.

FIG. 3 depicts functional components of a server, in accordance with an embodiment. Reports server 101 includes a processor 302 and a memory 303. Reports server 101 may include other components not shown in FIG. 3. Memory 303 stores mobile application 105. In an alternative embodiment, mobile application 105 may be stored external to memory 303 and reports server 101.

When a merchant employing merchant device 103 is using a mobile device, merchant device 103 may access mobile application 105. In another embodiment, a merchant may access web services 106.

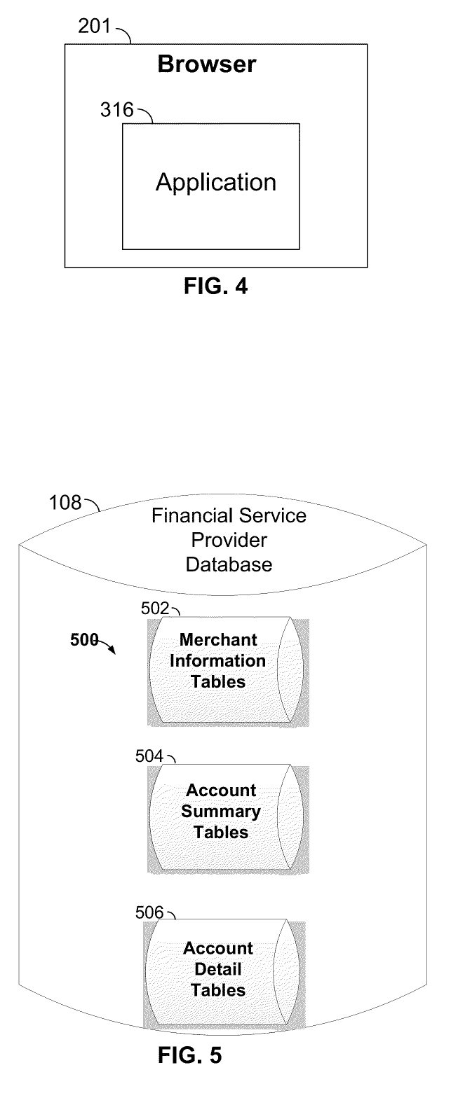

FIG. 4 depicts an application executing on a browser, in accordance with an embodiment. Browser 201 executes application 316. In an embodiment, application 316 may be the same application executing on reports server 101 (e.g., either mobile application 105 or web services 106). Alternatively, application 316 may be different than the application executing on reports server 101.

FIG. 5 depicts functional components of a database, in accordance with an embodiment. Several types of data 500 may be stored within a database, such as database 108 or elsewhere. Types of data 500 include merchant information tables 502, account summary tables 504, and account detail tables 506.

Merchant information tables 502 contain all the basic information about the merchant (e.g., name, address, phone, contact information, etc.).

Account summary tables 504 contain summary information about each merchant account on a monthly basis (e.g., sales, volume, chargebacks/retrievals, etc.).

Account detail tables 506 contain information about each merchant's transactions (e.g., card type, debits/credits, transaction dates, etc.).

In an embodiment, website 102 uses at least the merchant information tables 502 to function. By providing data in the account summary tables 504 and the account detail tables 506, more meaningful reports and statistics can be displayed for the merchant. The financial service provider controls what information they want to publish, by maintaining these tables. They can also set their own retention policy for each type of table. All information remains in the financial service providers' database and the information is only displayed to the financial service providers merchants based on their login credentials and security rights. No cardholder data is stored in any of the tables and the entire database schema complies with PCI regulations.

Suppose that a merchant named Tammy Johnson is accessing the mobile application. Upon successfully logging into mobile application 105, Tammy Johnson may view access to available cash advance, select a merchant account, select an advanced fund account, select a prepaid card account, etc. Tammy Johnson may also obtain cash.

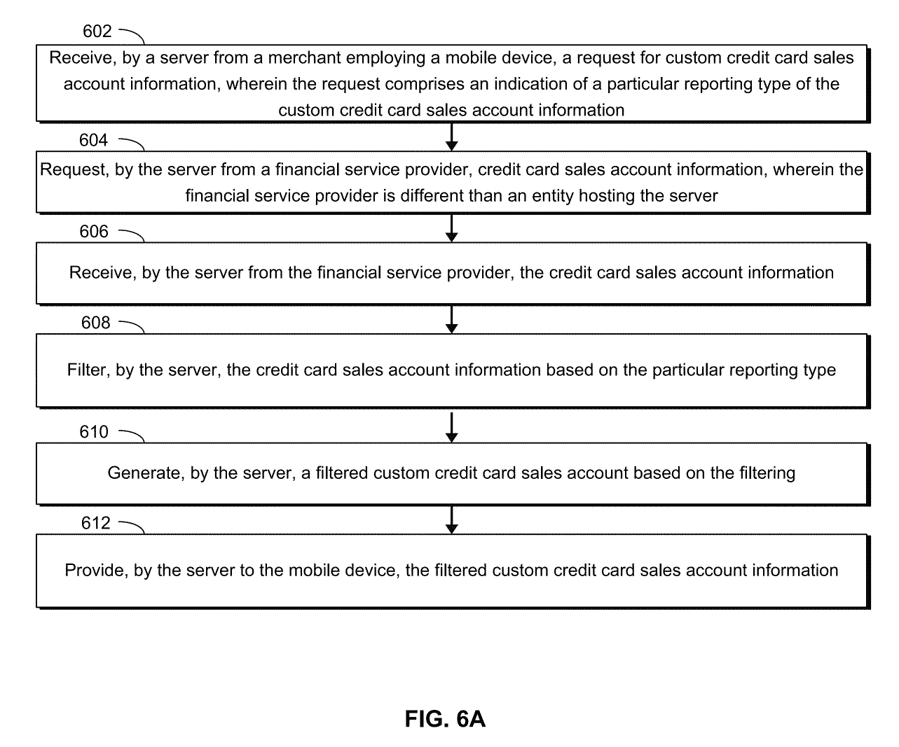

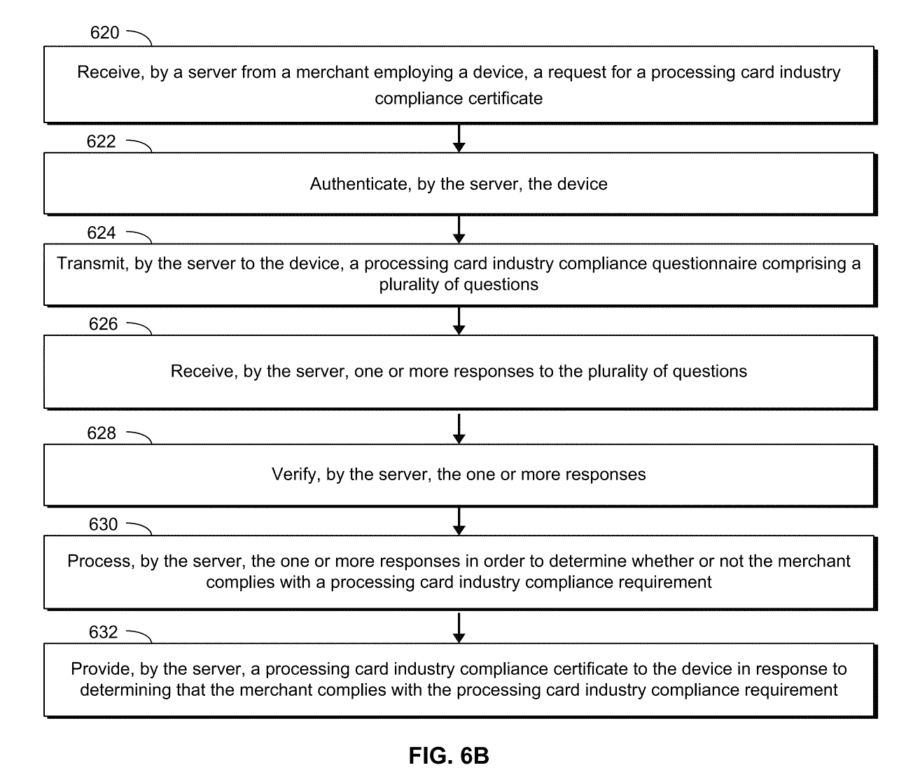

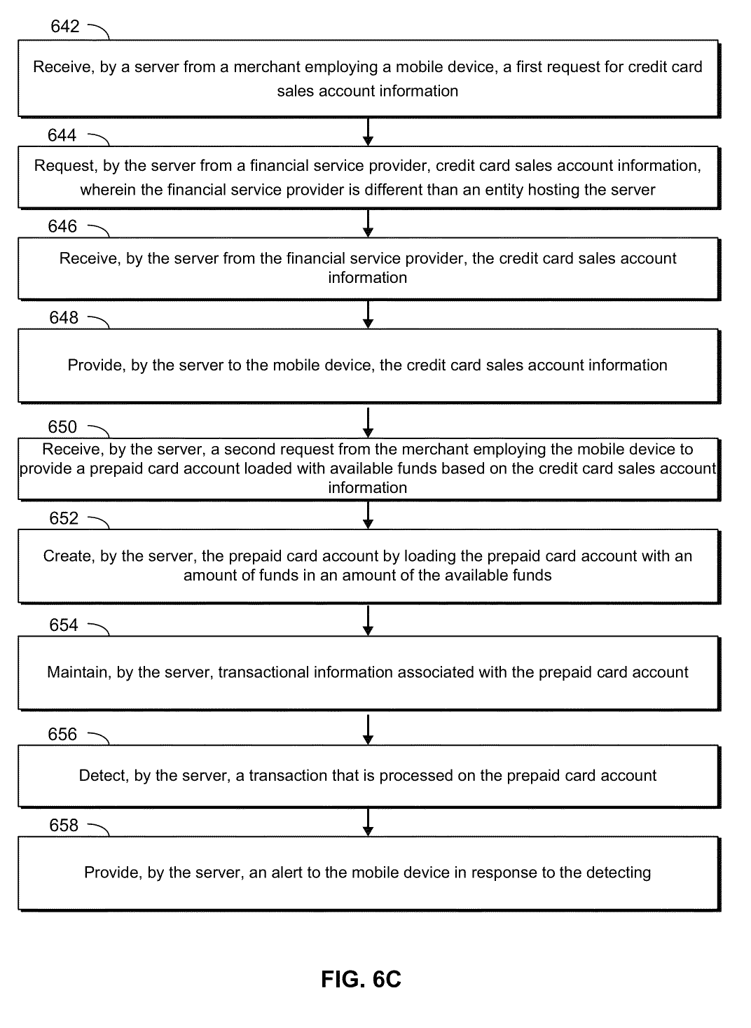

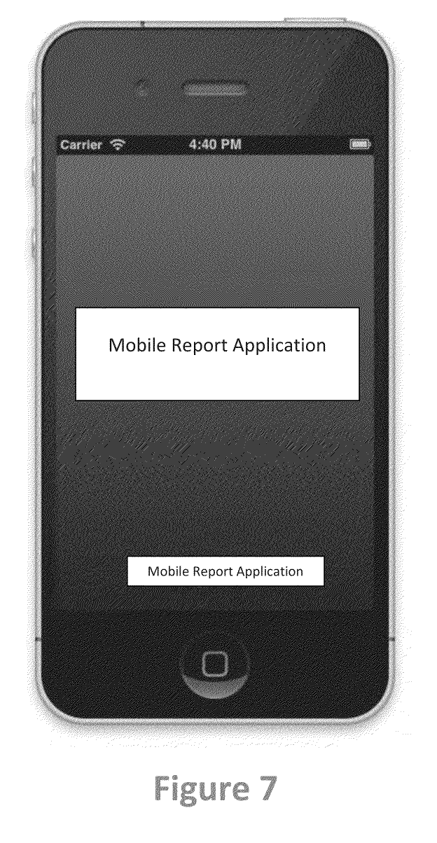

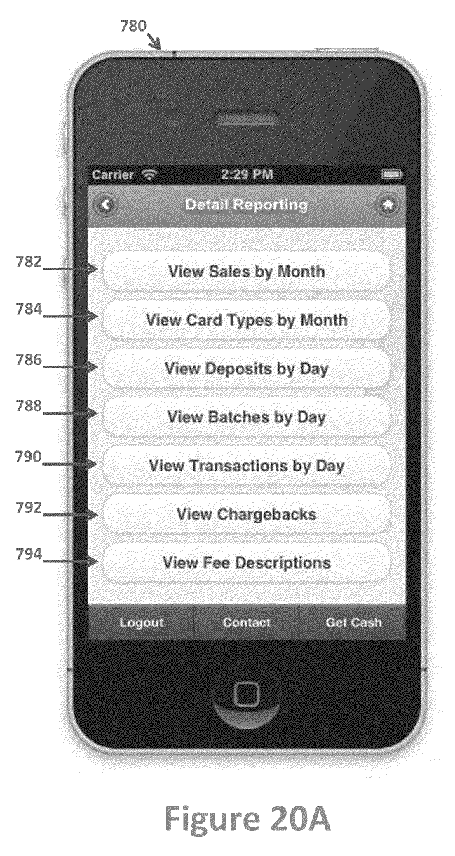

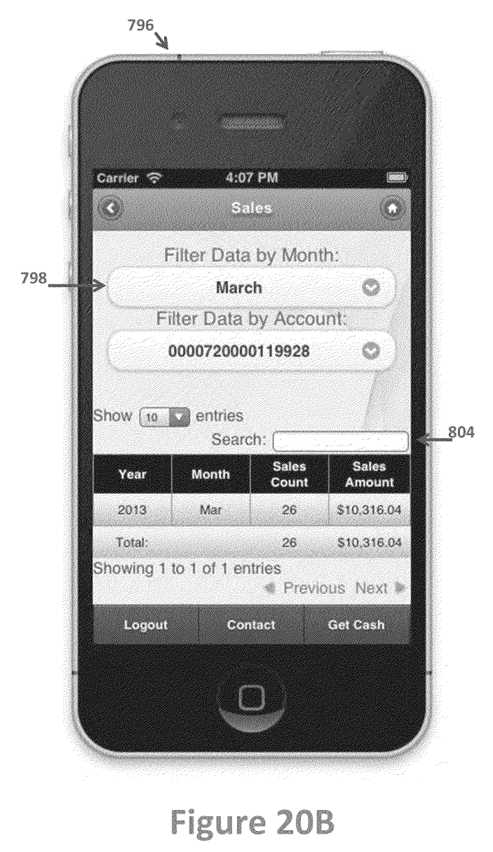

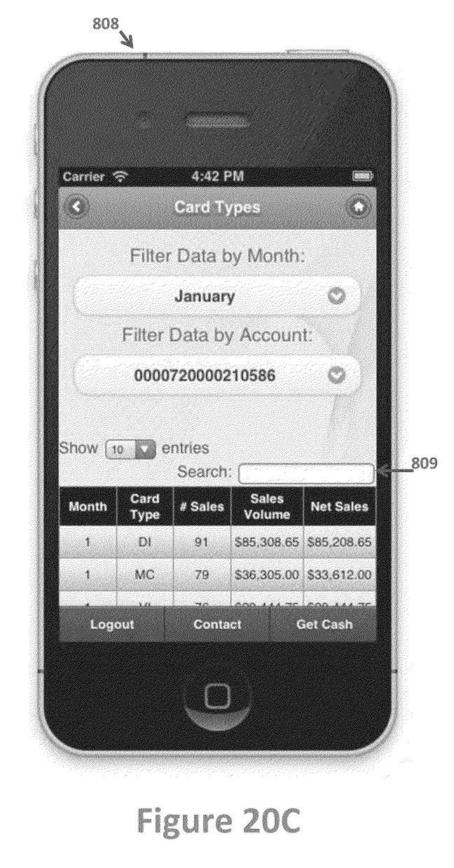

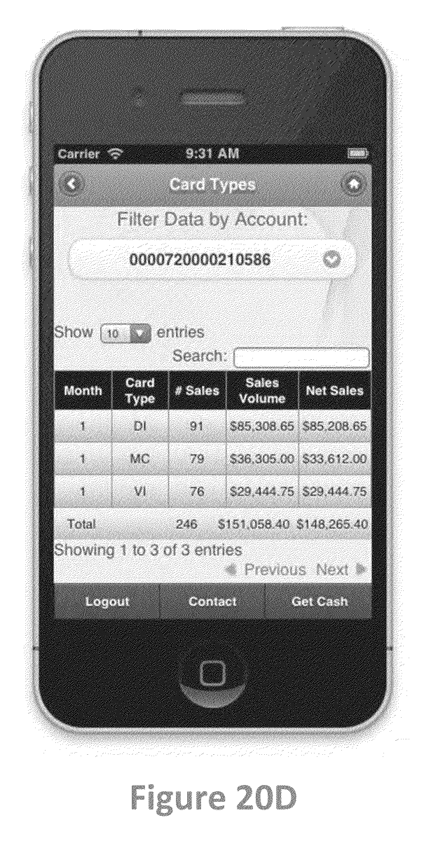

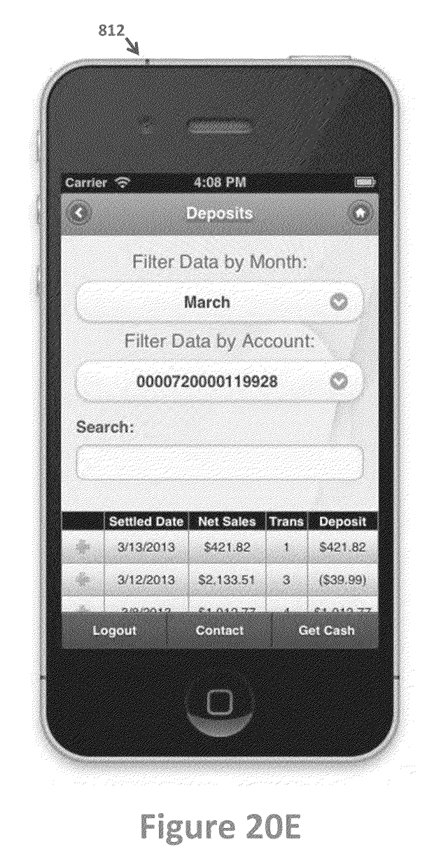

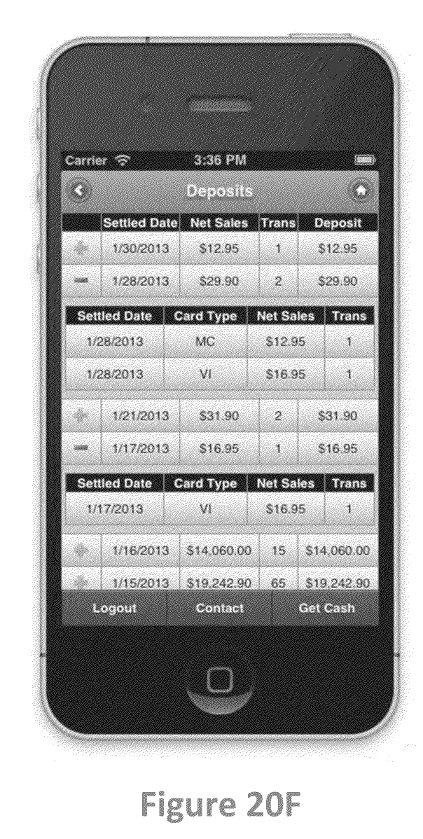

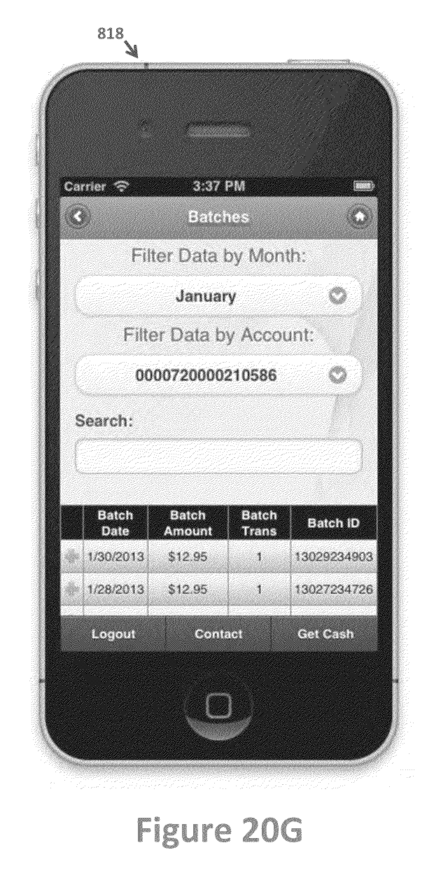

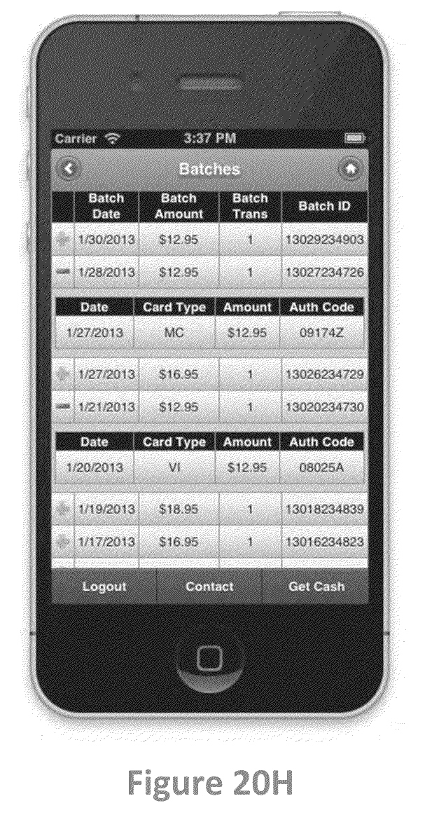

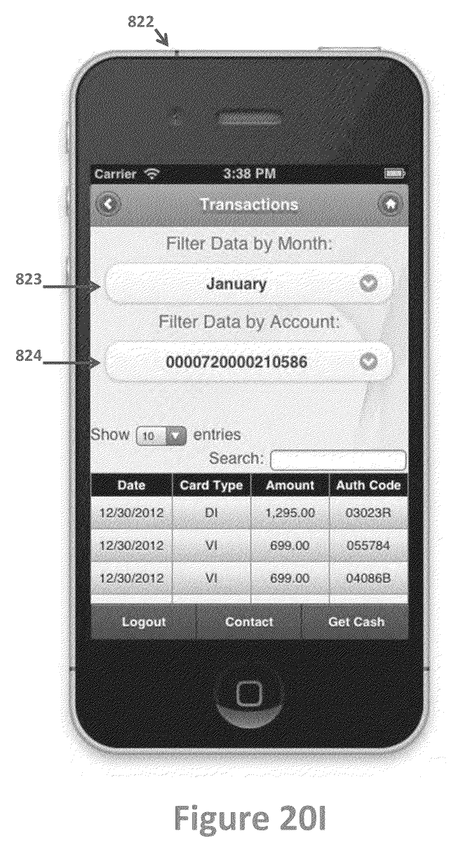

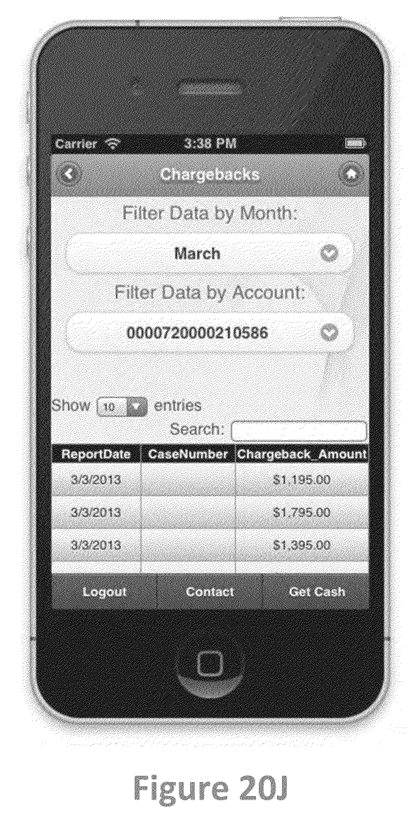

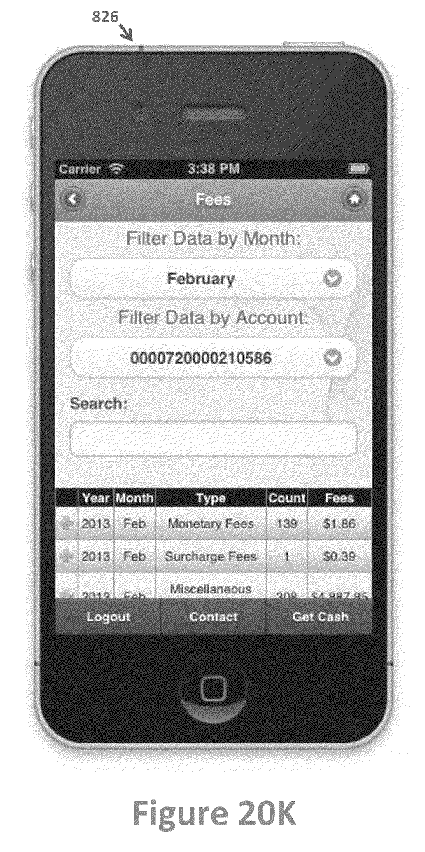

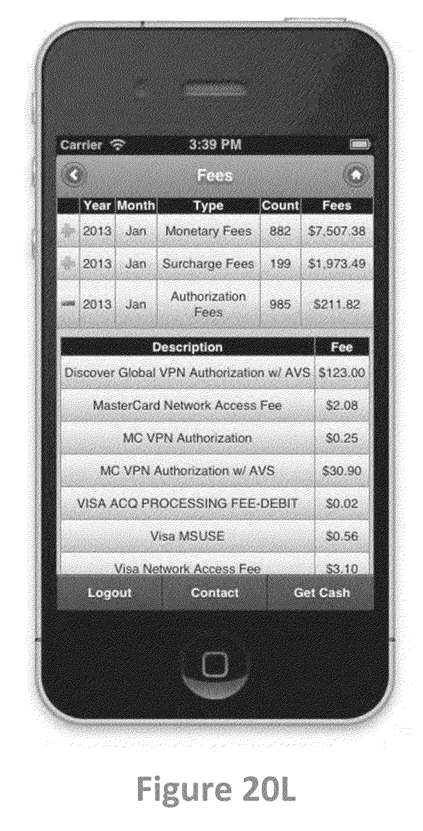

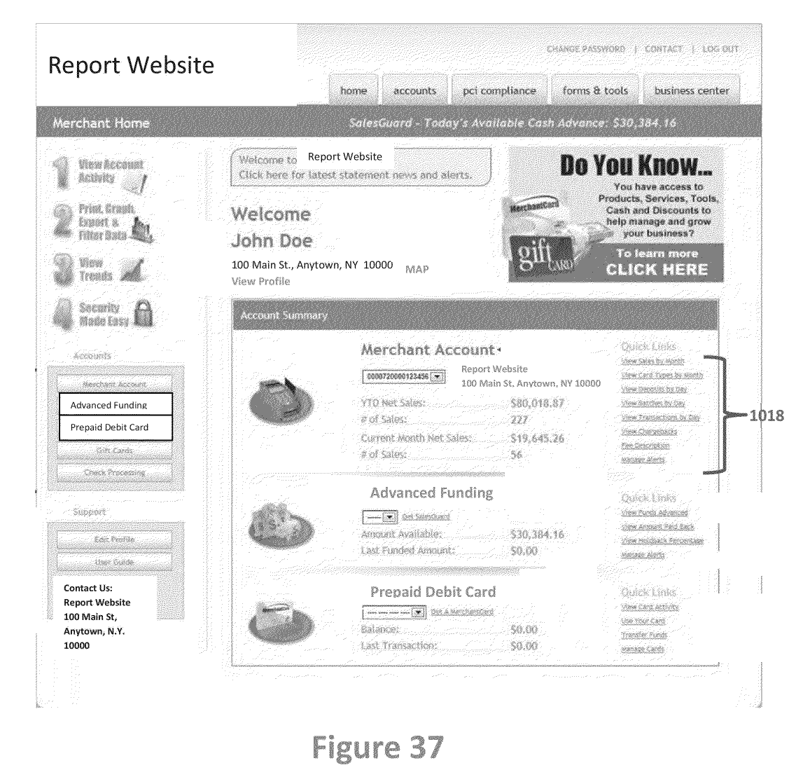

In the illustrative embodiment, merchant device 103 is a mobile device such as a cell phone. FIG. 6A is a flowchart depicting a method of providing custom credit card sales account information, in accordance with an embodiment. At step 602, a request for custom credit card sales account information is received by a server from a merchant employing a mobile device, wherein the request comprises an indication of a particular reporting type of the custom credit card sales account information. Reports server 101 receives a request for credit card sales account information from merchant device 103. The request may be sent by merchant device 103 from network 104. The request includes an indication of a particular reporting type of the custom credit card sales account information. For example, referring to FIG. 20 and/or FIG. 37, suppose that the merchant wishes to view detail reporting of sales by month. Thus, the particular reporting type is a monthly reporting type. The merchant can then select view box 782 of FIG. 20 and/or 1018 of FIG. 37 to view sales by month. The merchant may select one of many different reporting types shown in FIG. 20 and FIG. 37. Details regarding FIG. 20 and FIG. 37 are discussed in more detail below.

At step 604, the server requests credit card sales account information from a financial service provider, wherein the financial service provider is different than an entity hosting the server. Reports server 101 requests the credit card sales account information from financial service provider database 108, via network 104. In an embodiment, the credit card sales account information may include available funds, a batch of credit card sales, chargebacks, deposits, fees, or cash advance.

In response, financial service provider database 108 provides the requested credit card sales account information to reports server 101 in a raw data form.

At step 606, the server receives the credit card sales account information from the financial service provider. Reports server 101 receives the credit card sales account information from financial service provider database 108. In an embodiment, reports server 101 may receive the credit card sales account information from service provider database 108 in a raw data form. As such, service provider database 108 stores the credit card sales account information in a format compatible with reports server 101 and reports server 101 may receive the credit card sales account information in a raw data form so that reports server 101 may convert the credit card sales account information prior to providing it to the merchant employing the mobile device.

At step 608, the server filters the credit card sales account information based on the particular reporting type. Reports server 101 performs a filtering of the credit card sales account information. For example, suppose that the merchant wishes to view sales based on a particular reporting type (e.g., monthly). Reports server 101 filters the credit card sales account information in the raw data form such that the sales are grouped and sorted by months.

Raw data is extracted from a financial service provider's database 108 via web service calls 106. This information is processed by either the web site 102 or the mobile application 105 and transmitted to the merchant's device 103 via the network 104. The information received by the merchant, for example monthly sales data, is displayed on the merchant's screen in the monthly sales form.

At step 610, a filtered custom credit card sales account is generated by the server based on the filtering. Reports server 101 generates a filtered custom credit card sales account (e.g., sorted monthly) based on the filtering, as described in step 608.

At step 612, the server provides the filtered custom credit card sales account information to mobile device. Reports server 101 provides the filtered custom credit card sales account information to merchant device 103, via network 104. The filtered custom credit card sales account information is provided to merchant device 103 in a format that is displayable to merchant device 103. For example, referring to FIG. 20A, the merchant employing user device 103 is provided with sales data for the month of March after the credit card sales account information is filtered on a monthly basis and more particularly, filtered based on the month of March.

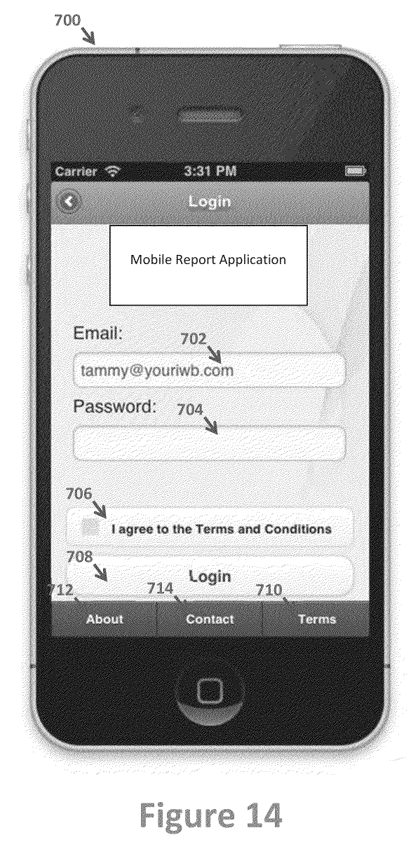

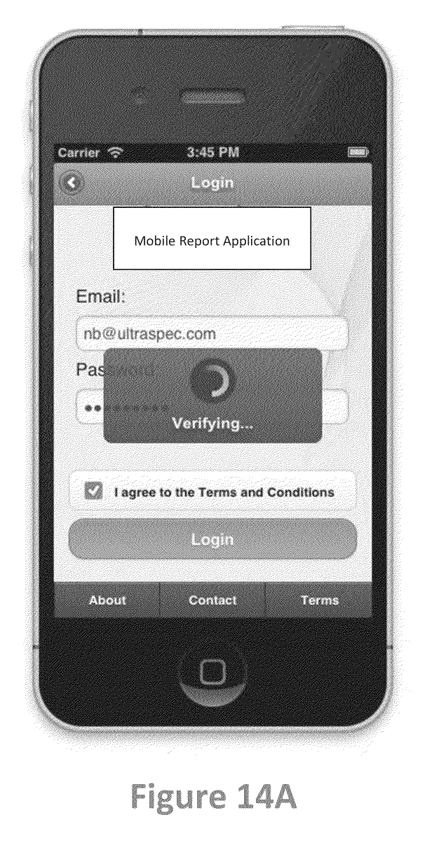

In an embodiment, the server authenticates the mobile device. In an embodiment, reports server 101 authenticates merchant device 103 prior to receiving the request. For example, merchant device 103 may access mobile application 105. A merchant employing merchant device 103 may attempt to log in to mobile application 105 (e.g., by entering a user name and password which is transmitted to reports server 101 via network 104 for authentication). For example, the merchant employing merchant device 103 may log in to his/her account by entering his/her log in identification or his/her merchant identification number (MID#) and his/her password using a graphical user interface, such as that shown in FIG. 14. FIG. 14 is discussed in more detail below. Reports server 101, in response to receiving the log in information, performs authentication of the merchant in a known manner.

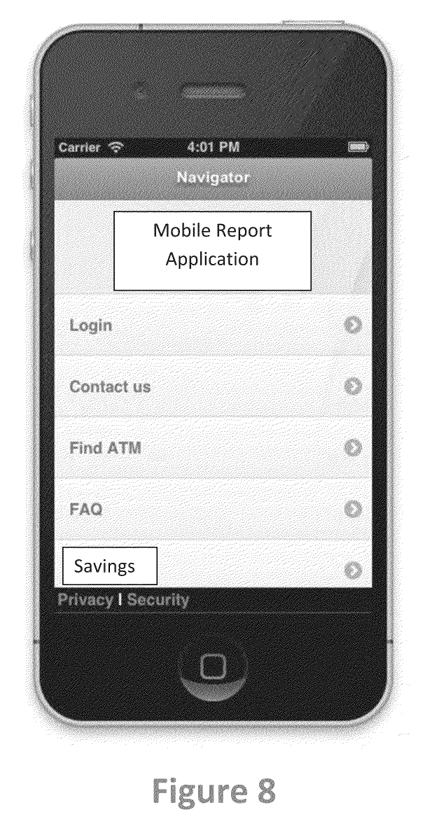

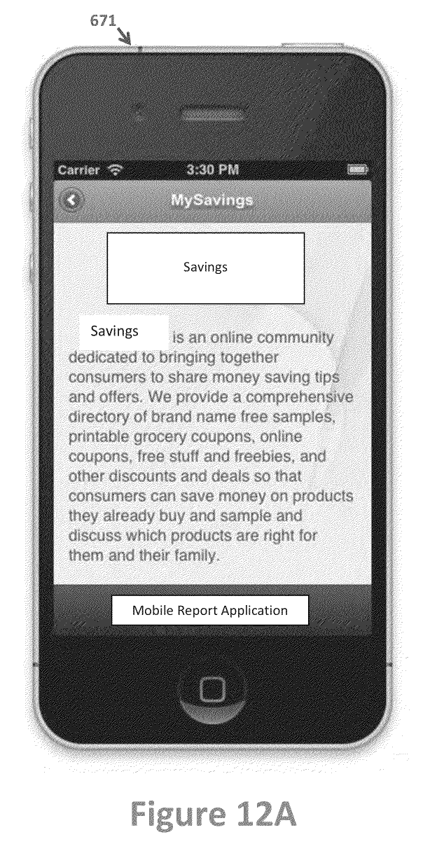

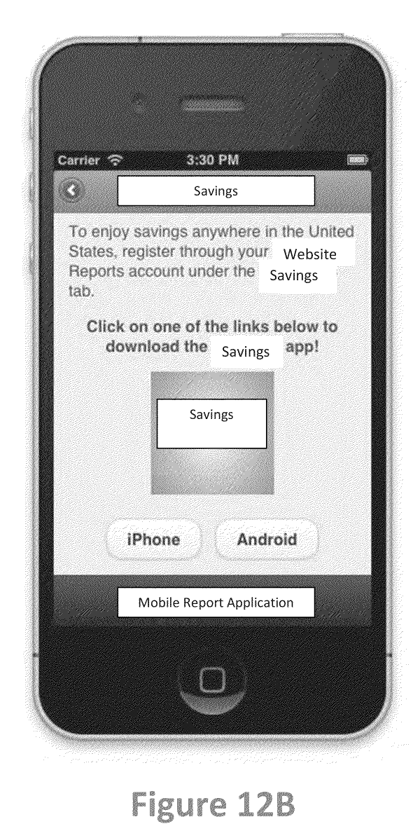

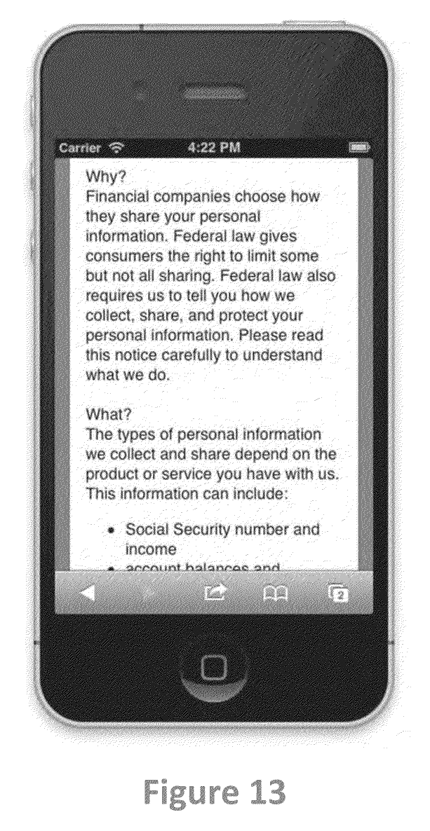

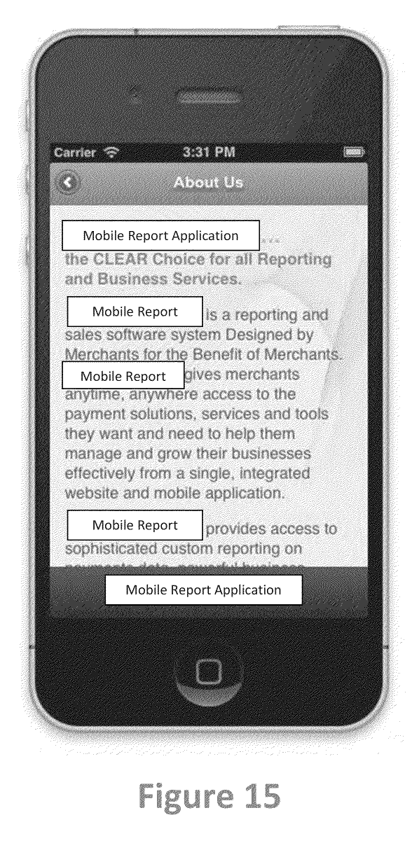

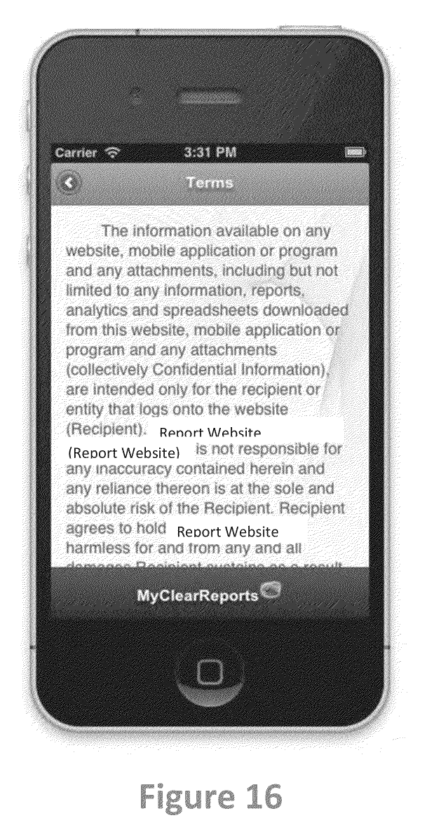

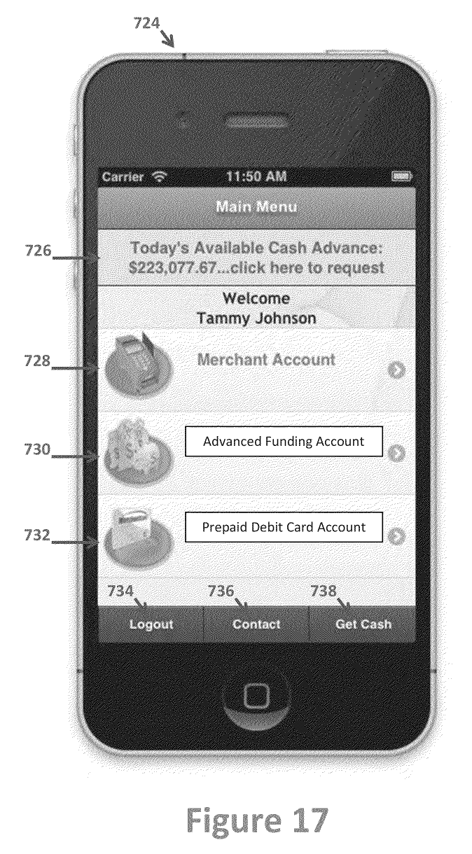

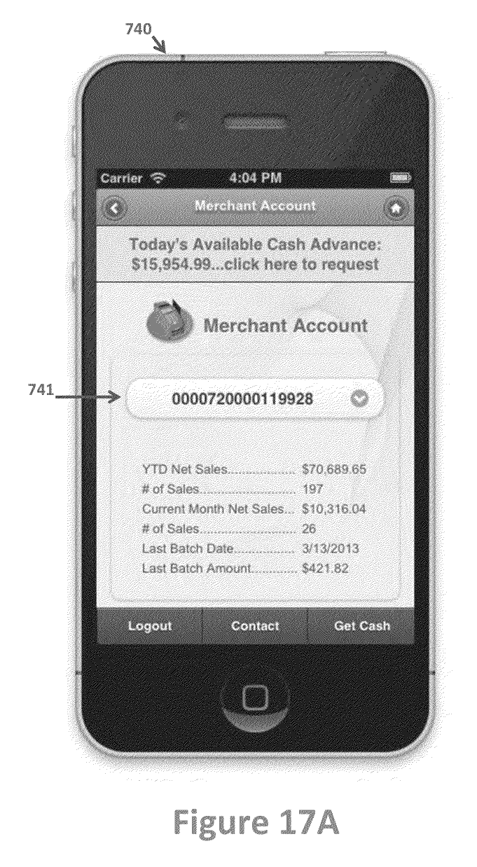

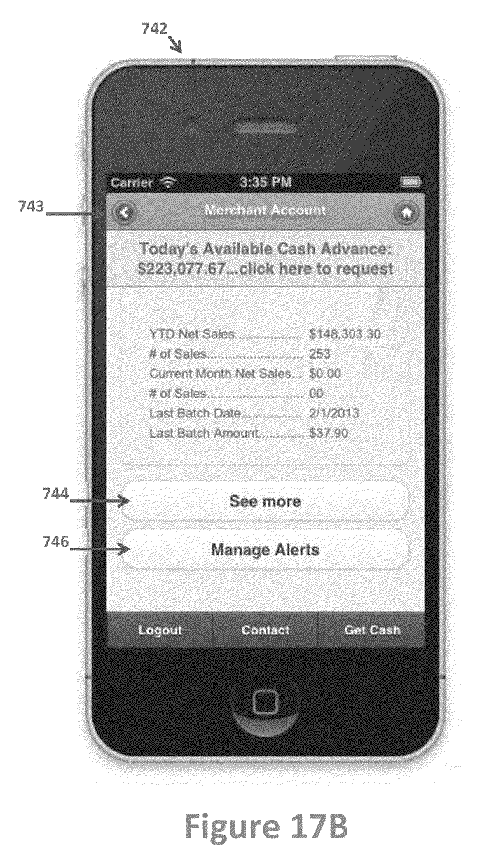

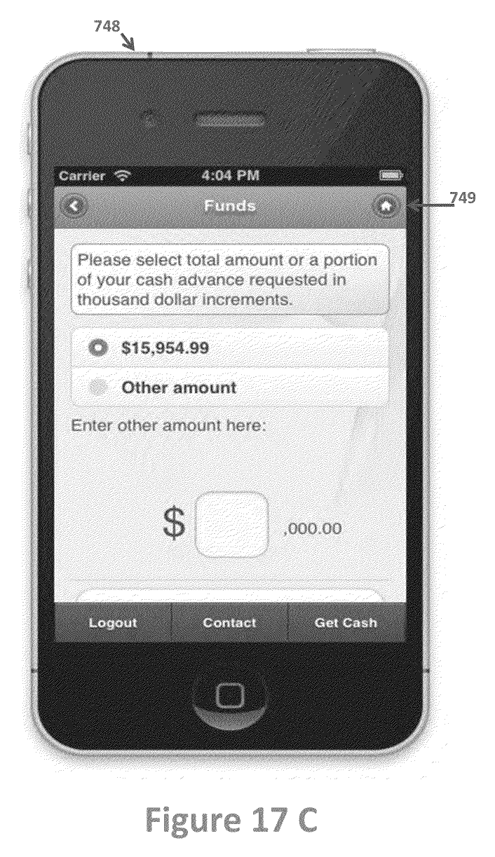

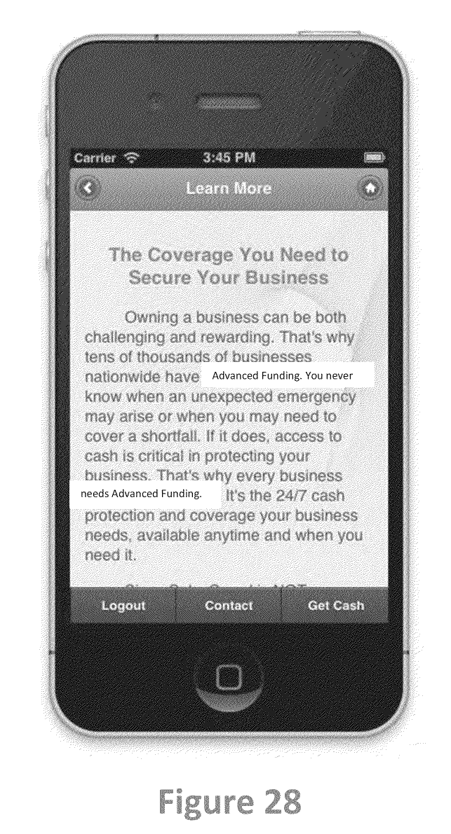

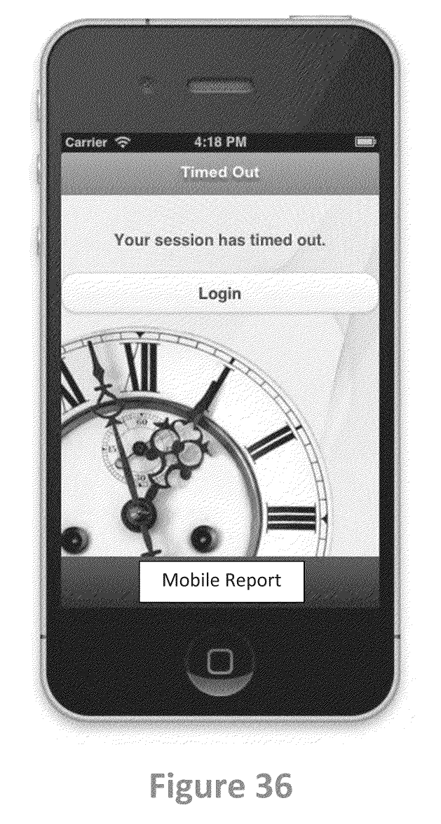

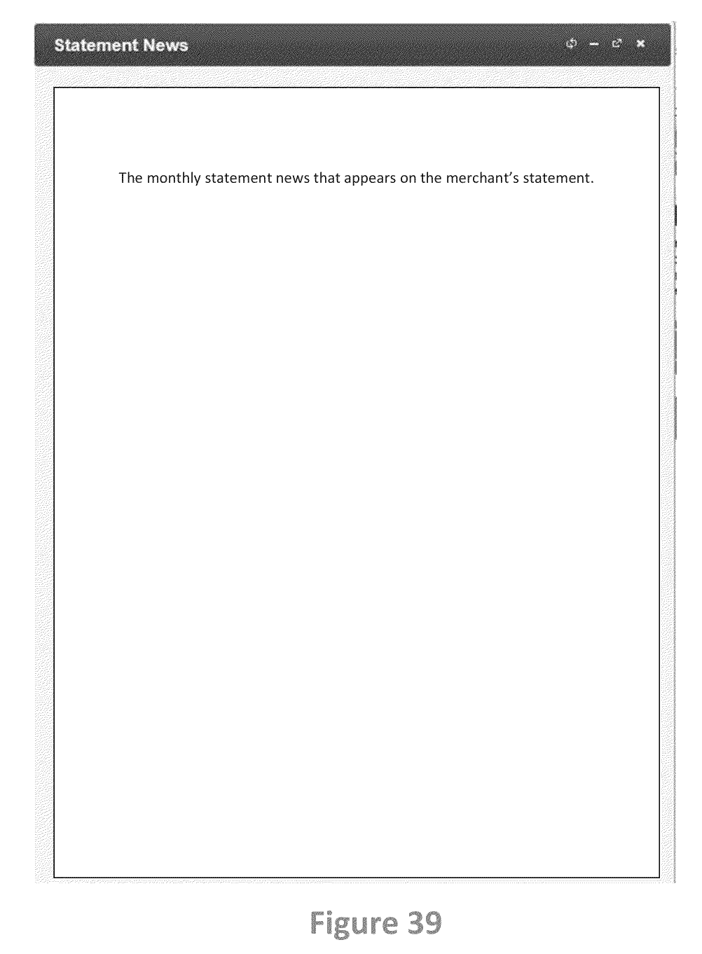

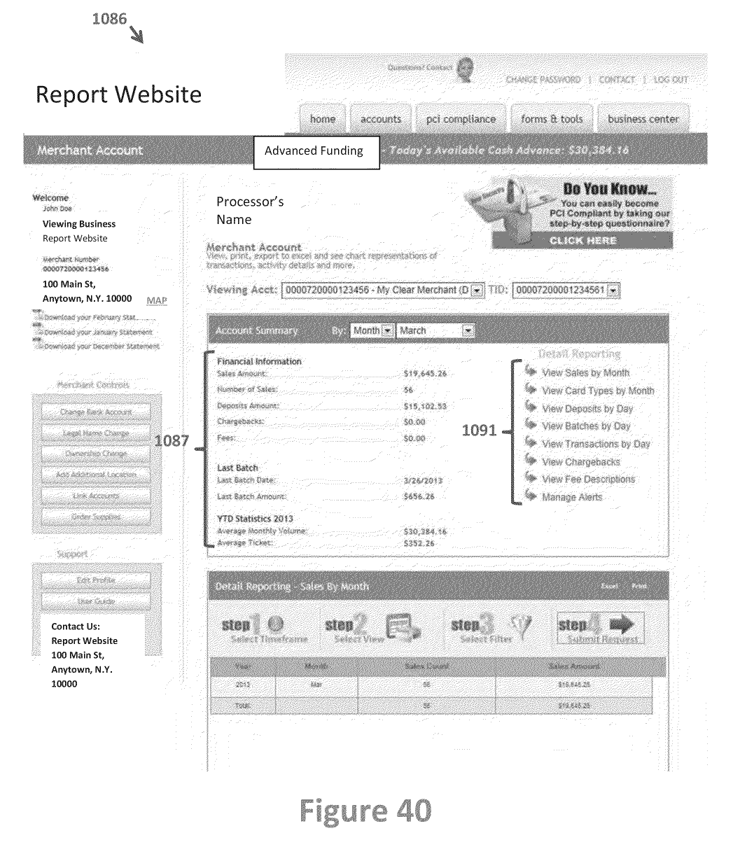

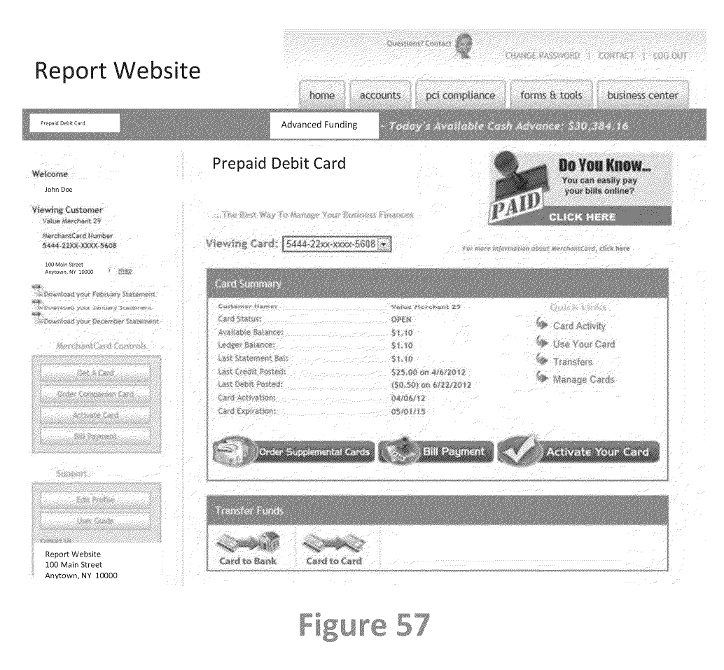

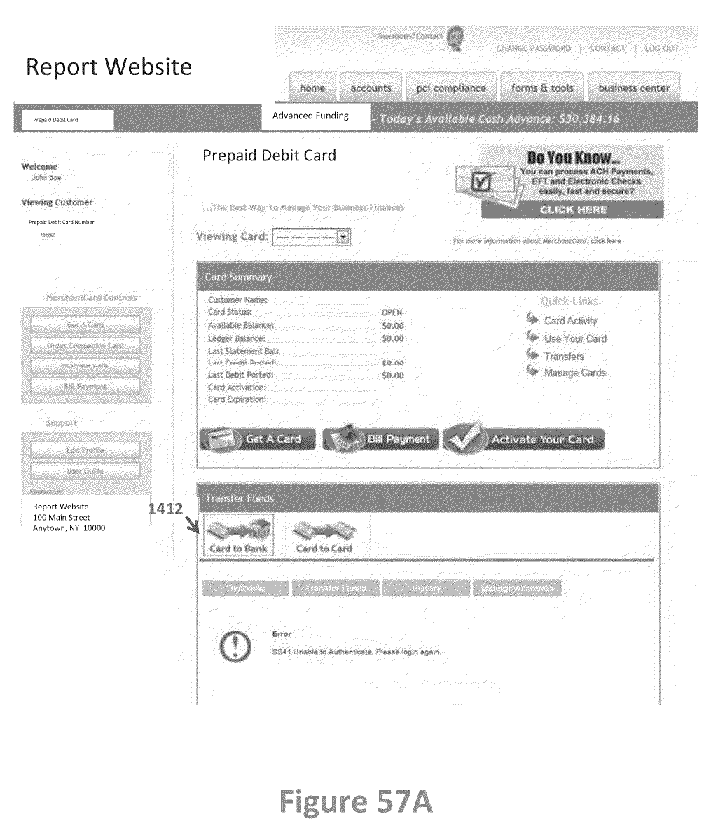

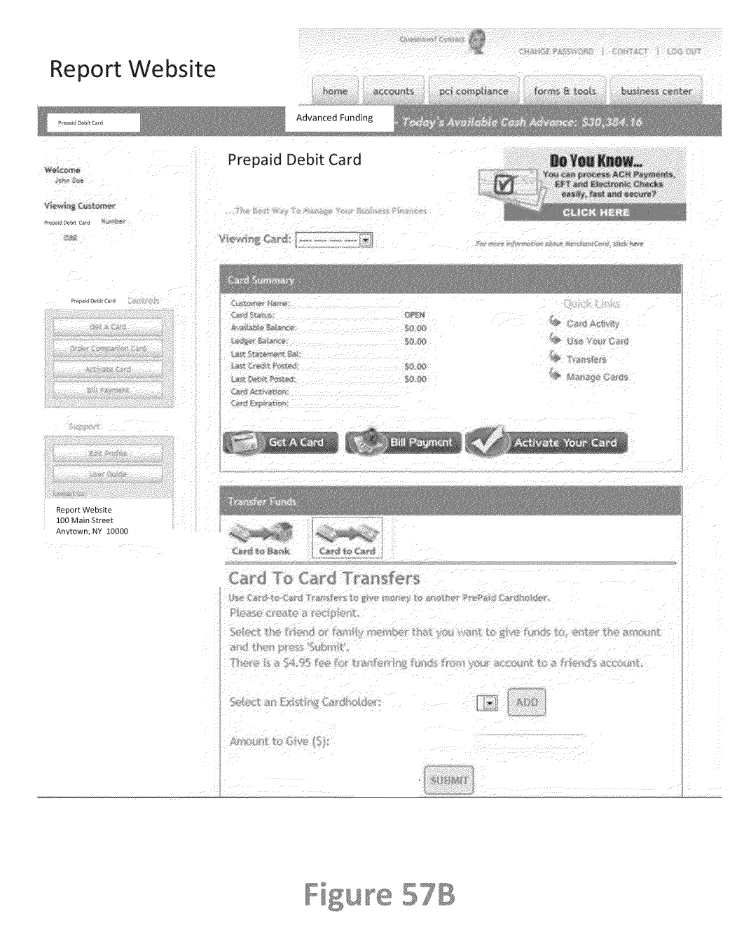

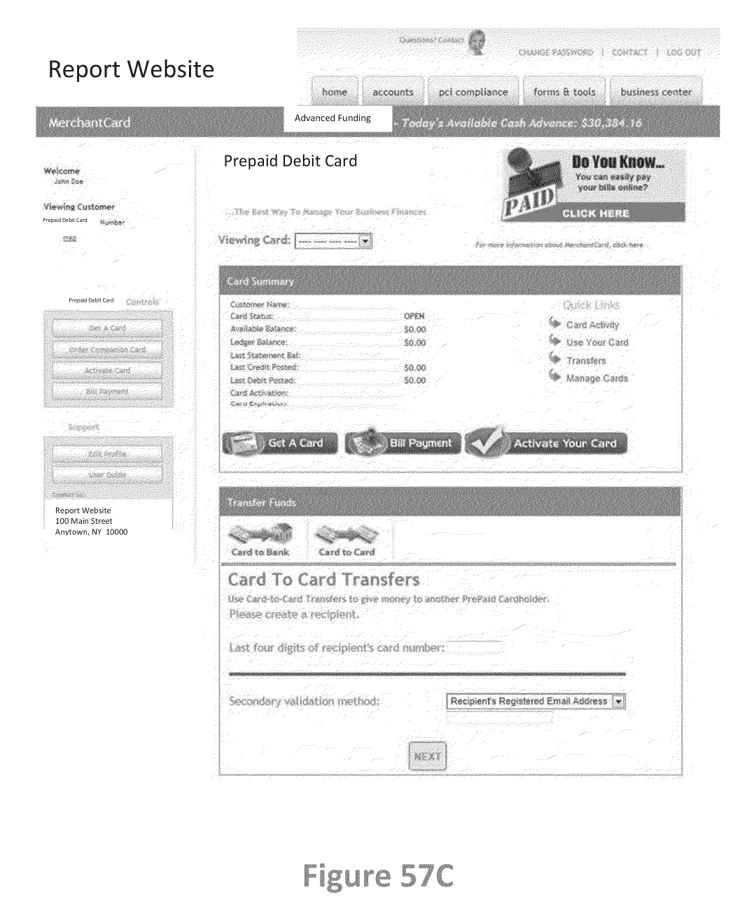

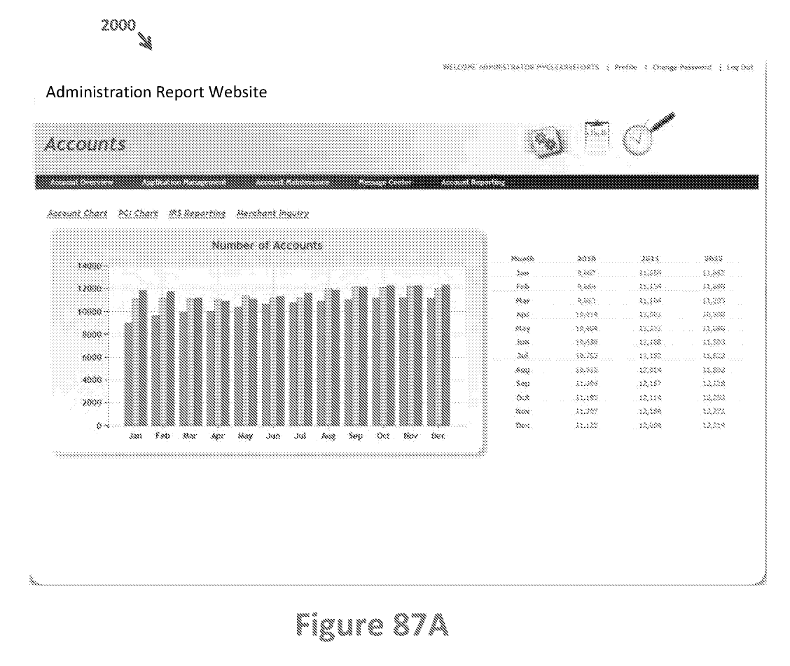

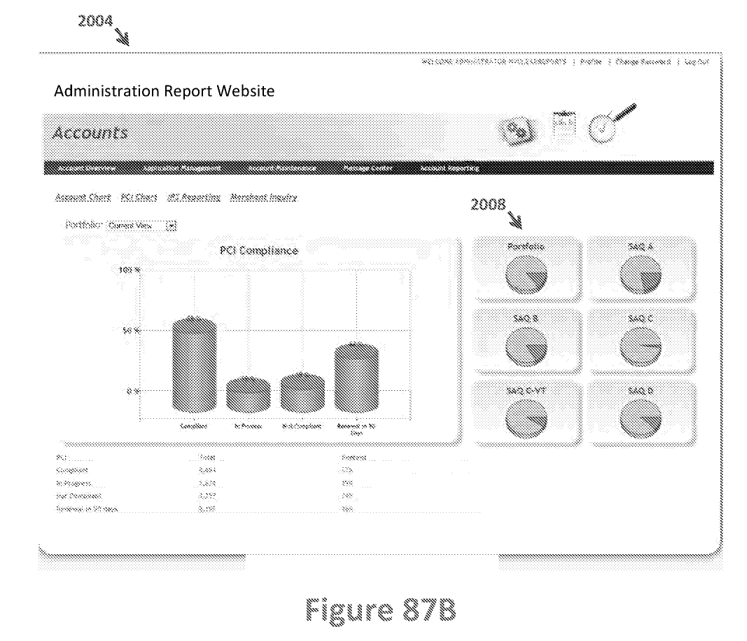

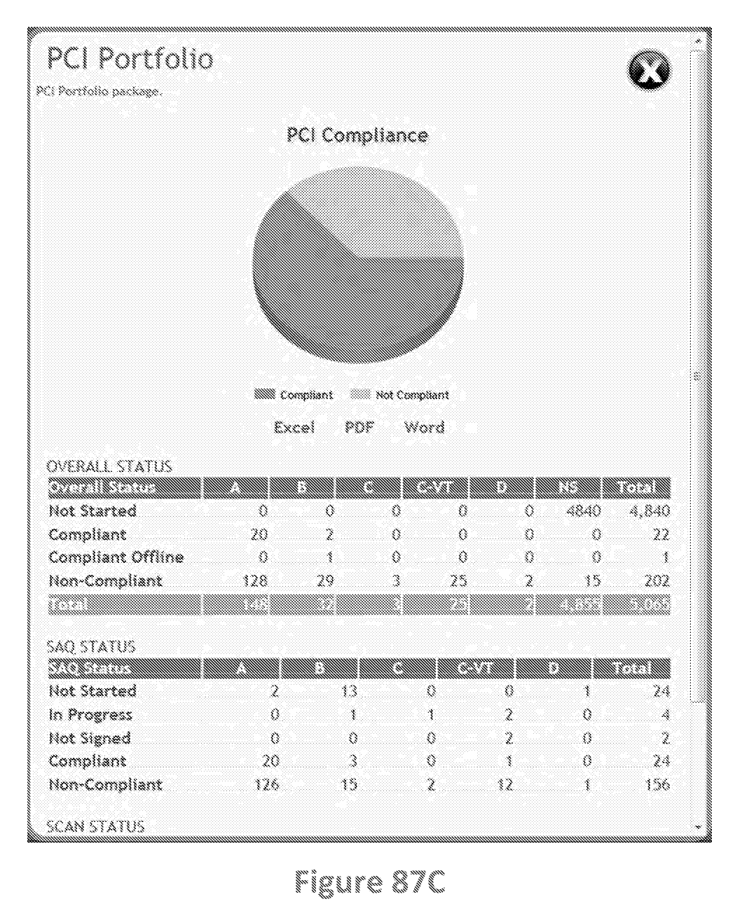

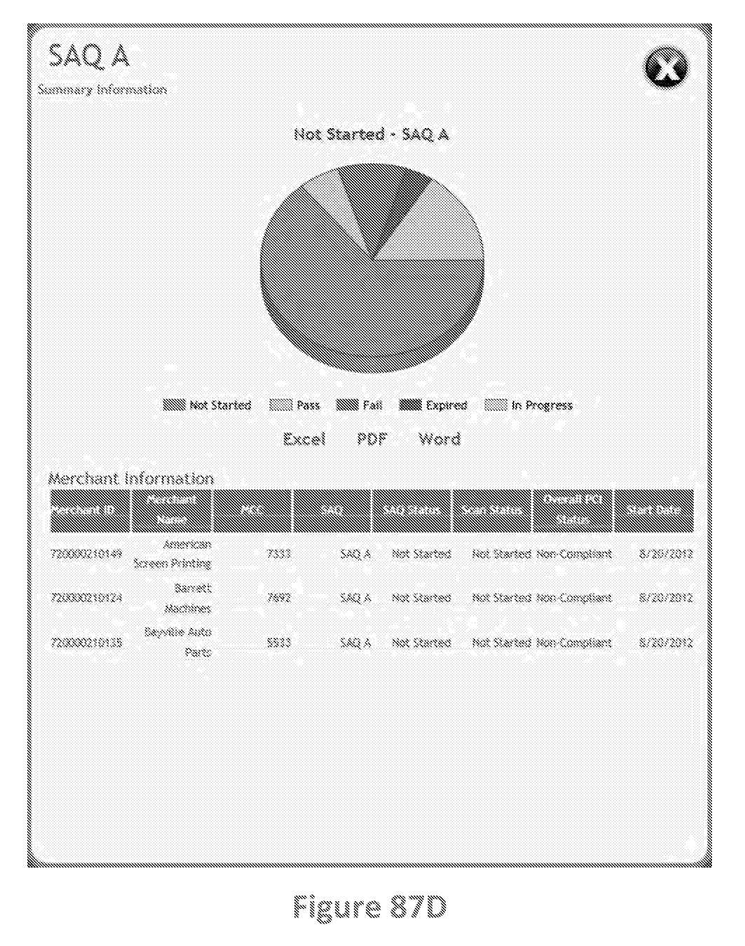

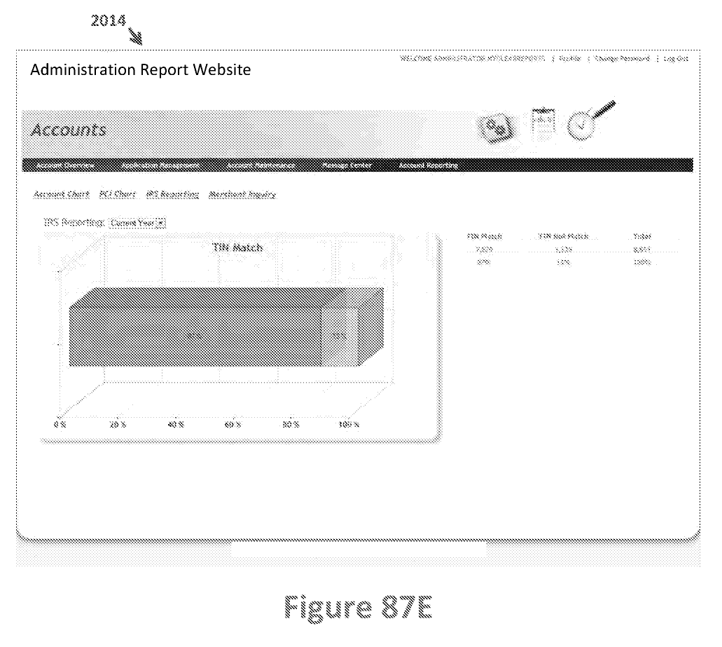

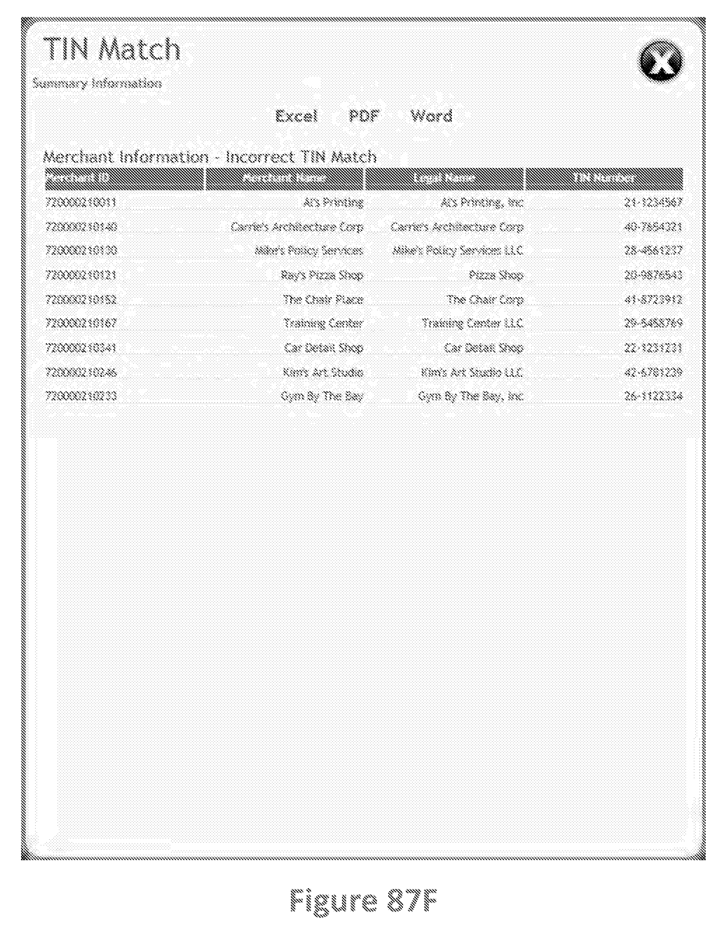

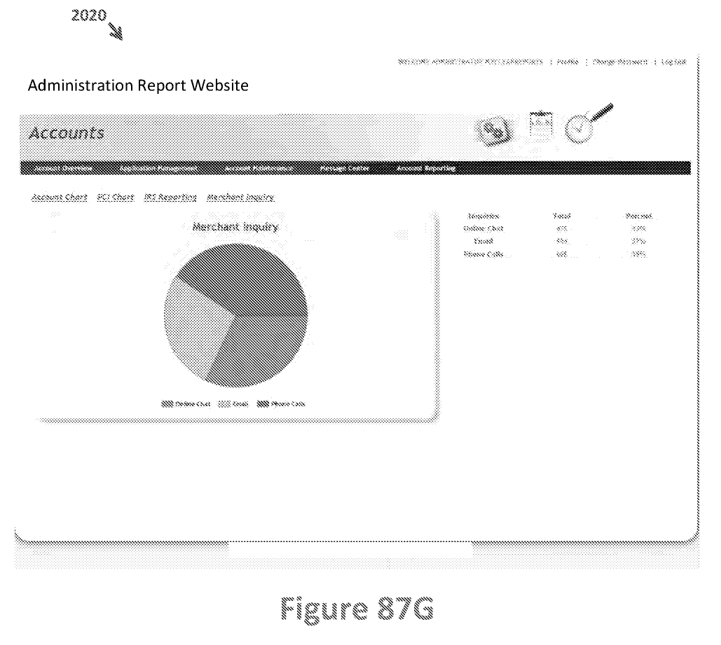

FIG. 7 through FIG. 36 depicts mobile reporting screens. FIG. 37 through FIG. 86 depicts website reporting screens. And FIG. 87 through FIG. 105 depicts administration reporting screens. The screens depicting merchant account information on the mobile device are shown in FIG. 17A through FIG. 26 and on the website are shown in FIG. 40 through FIG. 47G. The merchant account screens are discussed showing both the mobile figures and the website figures.

FIG. 14 depicts a login screen, in accordance with an embodiment. In an embodiment, every merchant may have his/her own login credentials to access the system. Suppose that merchant device 103 is a mobile device. A merchant employing merchant device 103 may access mobile application 105 via network 104. The merchant may be prompted to enter information into a login screen 700. In the illustrative embodiment, the merchant may be prompted to enter his/her email address in field 702; his/her password in field 704; and be asked to agree to the terms and conditions by selecting the checkbox in box 706. In the depicted embodiment, the merchant may view the terms by selecting box 710. In another embodiment, the merchant may view the terms and conditions by selecting on a hyperlinked word/phrase or box 706 may expand and collapse to display the terms and conditions. Upon entering the information, the merchant may select login 708 in order to access his/her account. The merchant may enter the information onto login screen 700 using any of a variety of methods. For example, the merchant may utilize an onscreen keyboard and/or a touch screen to enter the information. In another embodiment, the merchant may utilize speech-to-text features to enter the information. Other methods may be utilized to enter the information.

Login screen 700 also includes additional boxes such as box 712, which provides details about mobile reporting application (e.g., the application version number, etc.) and box 714, which provides contact information for contacting support staff associated with the mobile application. Logging into the website reporting system allows the user to log in to a website by supplying a user name, password and accepting the terms and conditions of the website.

Upon selection of login 708, the information entered by the merchant is transmitted by merchant device 103 to mobile application 105 via network 104. The information is then provided to reports server 101. Reports server 101 performs authentication of the merchant employing merchant device 103.

Once reports server 101 authenticates the merchant employing merchant device 103, the merchant is provided with a main menu screen 724, as depicted in FIG. 17. Main menu screen 724 may provide a variety of options to the merchant. For example, upon successfully logging into mobile application 105, Tammy Johnson may view access to available cash advance, select a merchant account by selecting box 728, select an advanced funding account by selecting box 730, select a prepaid card account by selecting box 732, etc. Tammy Johnson may obtain cash by selecting box 738.

In an embodiment the report website provides similar functionality to the mobile report device. As depicted in FIG. 37, the merchant is provided with a main menu screen. Main menu screen may provide a variety of options to the merchant. For example, upon successfully logging into web application 105, Tammy Johnson may access available cash advance, select a merchant account by selecting box 1030, select an advanced funding account by selecting box 1032, select a prepaid card account by selecting box 1034, etc.

Suppose that Tammy Johnson selects the merchant account by selecting box 728 shown in FIG. 17 or hyperlink 1030 as shown in FIG. 37. Upon making the selection, a merchant account screen 740, shown in FIG. 17A on the mobile device or merchant account screen 1086 as shown in FIG. 40, is displayed to Tammy.

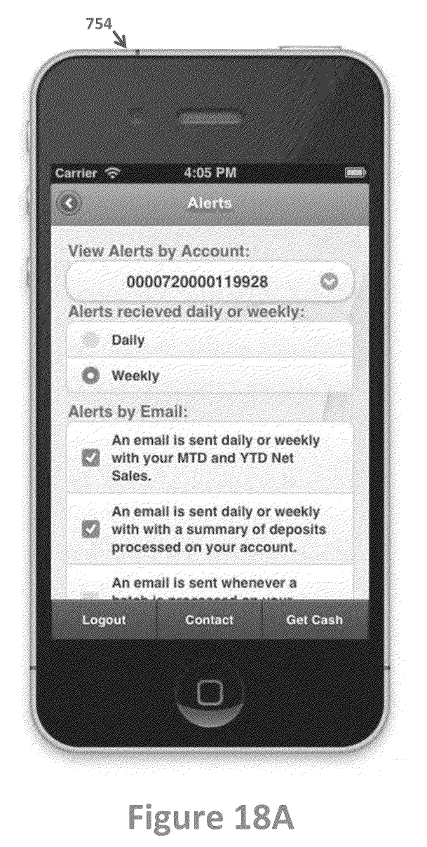

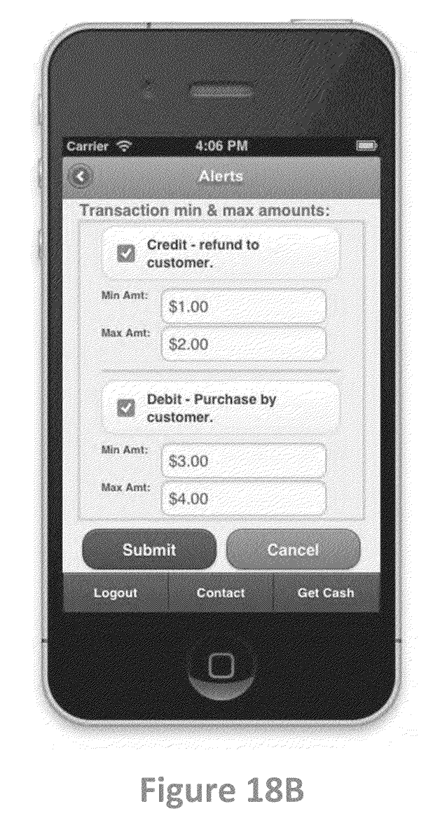

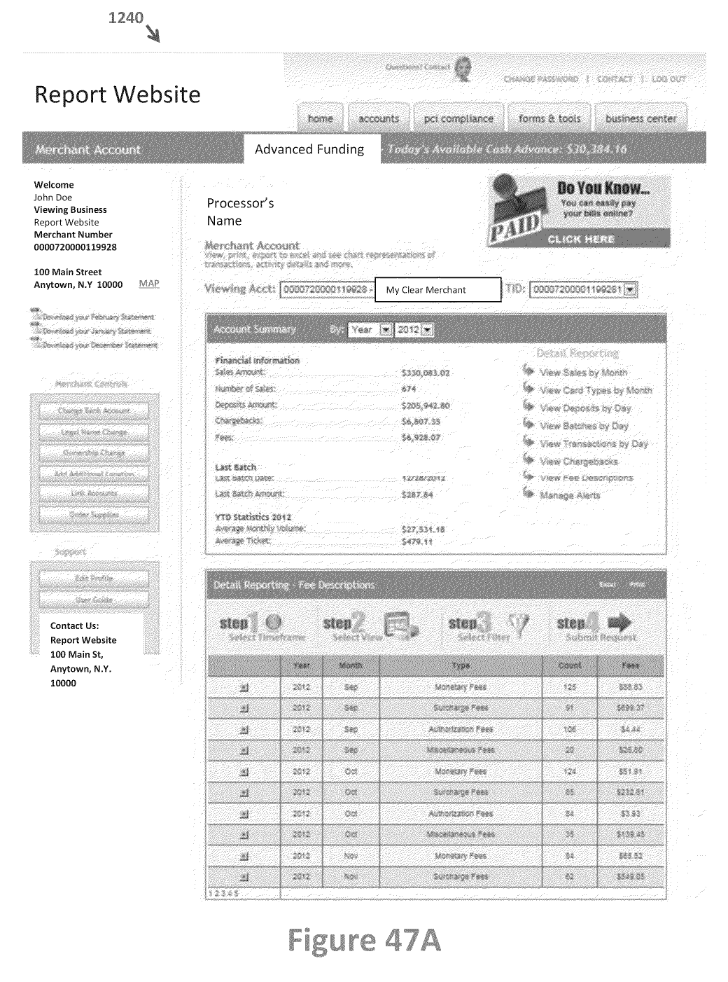

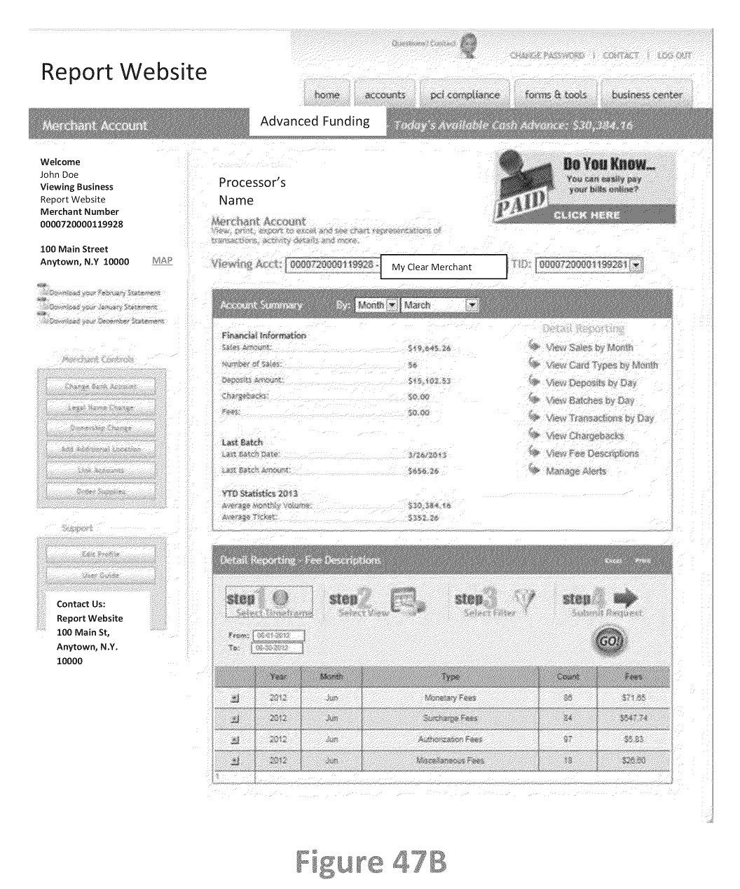

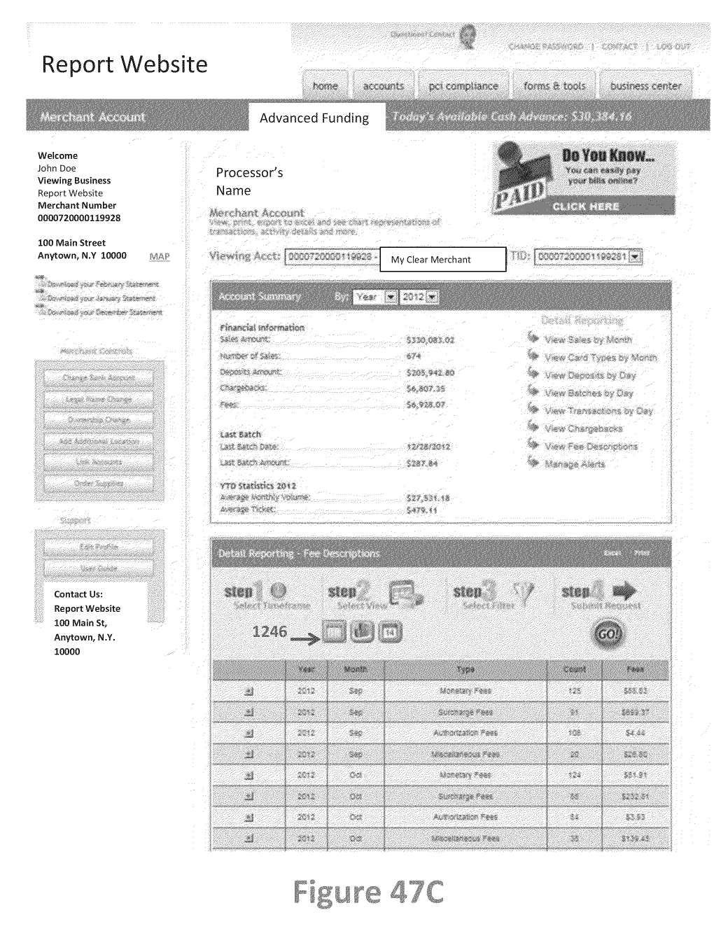

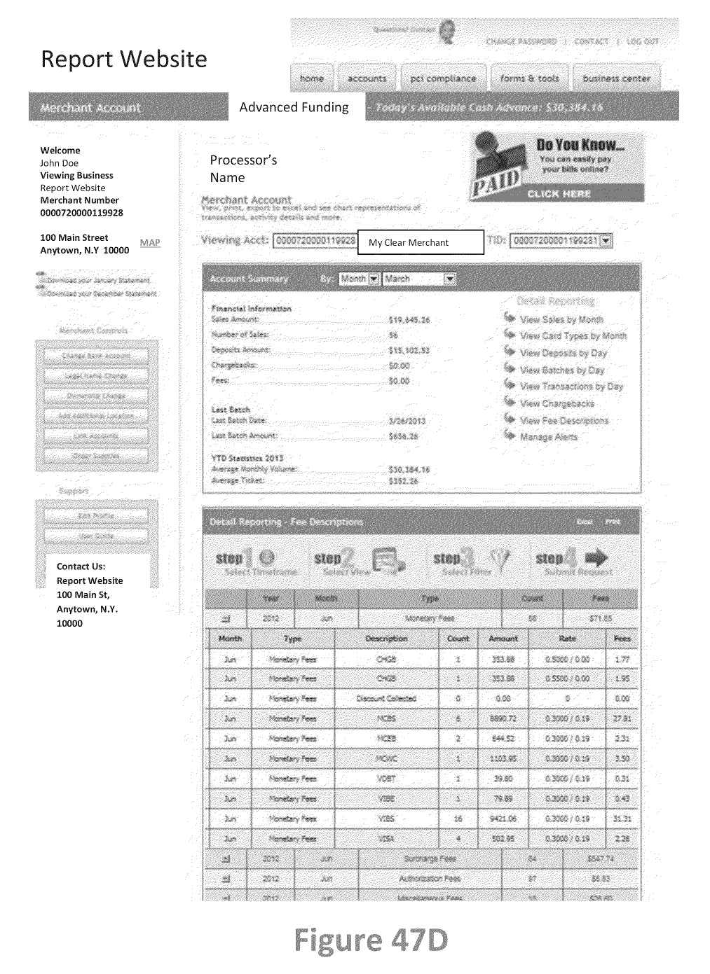

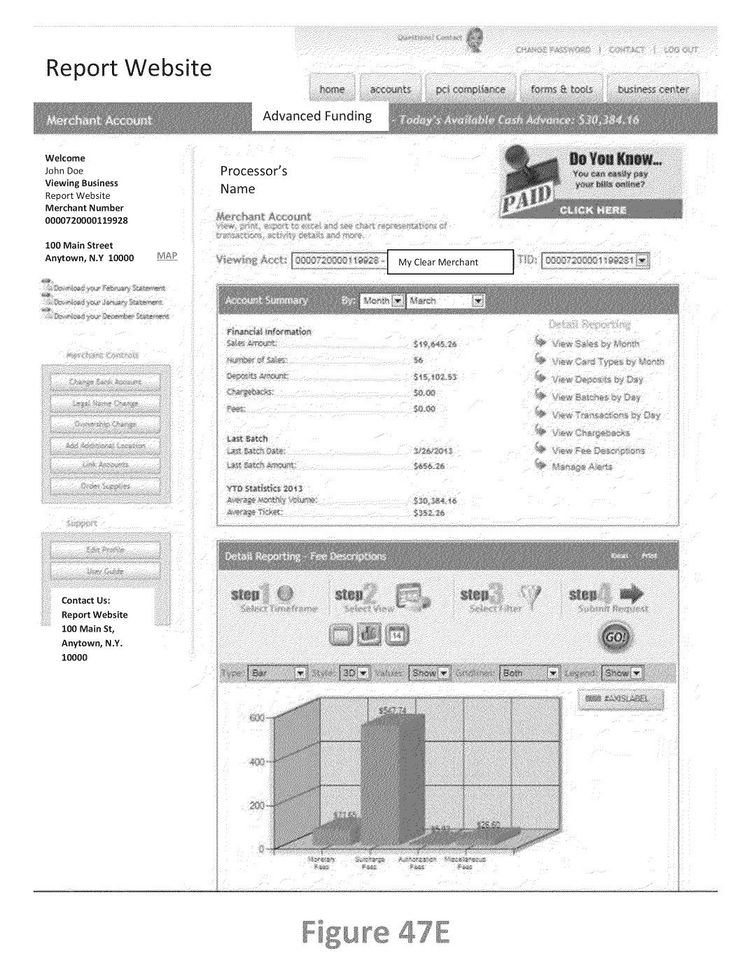

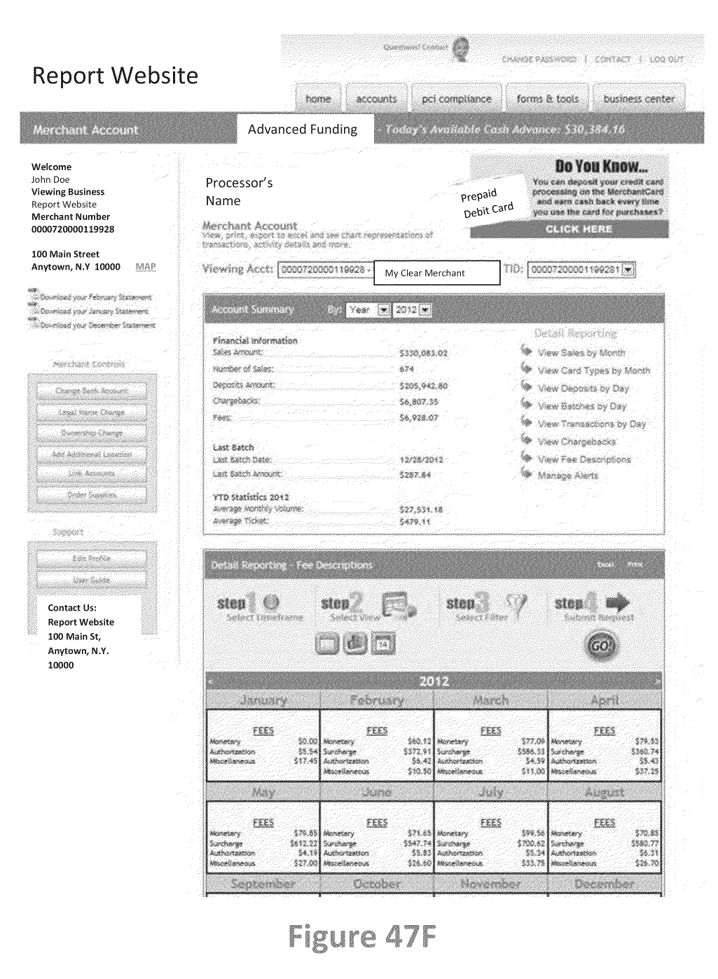

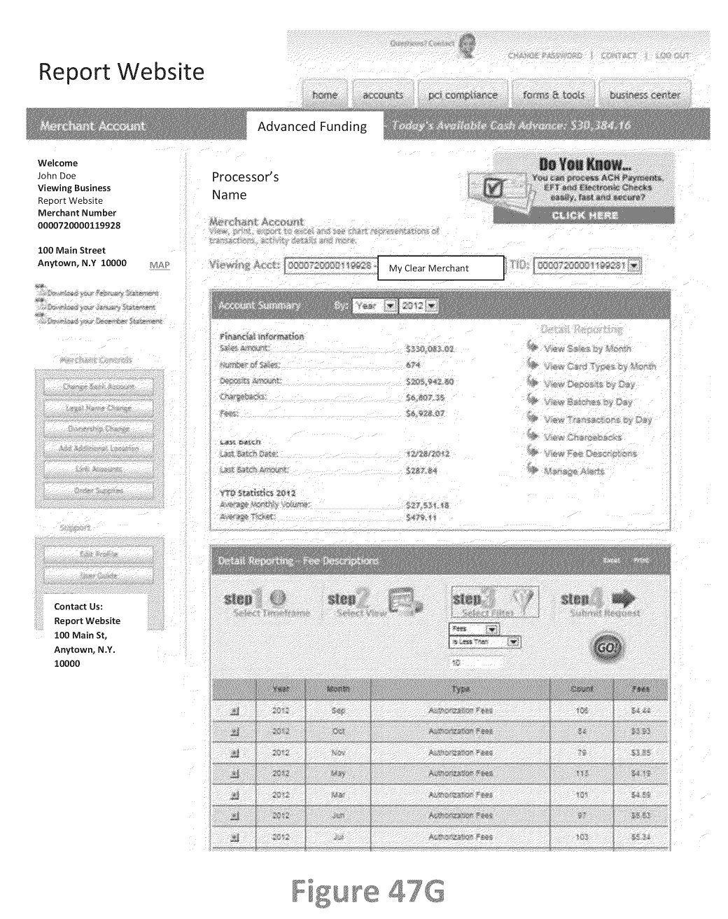

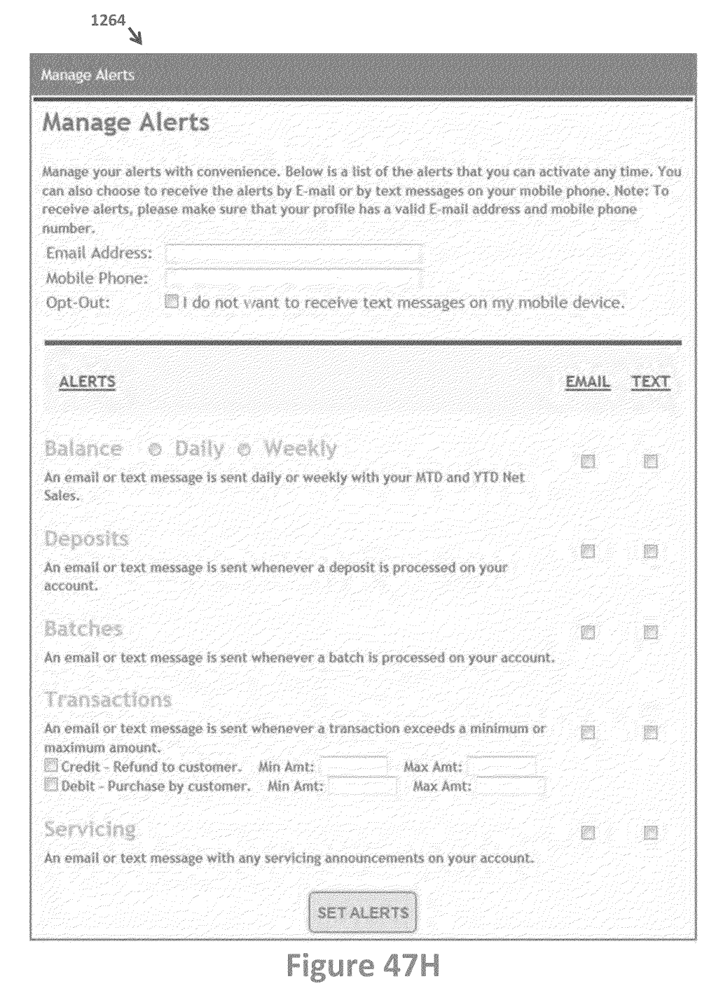

Merchant account screen 740 in FIGS. 17A and 1086 in FIG. 40 provides details related to a particular merchant account, shown in box 741 in FIG. 17A and box 1087 in FIG. 40. These details include year-to-date (YTD) net sales, the YTD number of sales, the current month's net sales, the current month's number of sales, the date of the last batch, and the amount of the last batch. Other details may also be provided. In an embodiment, the details of the merchant account provided on the screen may be selected by a merchant. The merchant may also be provided with an option to see more information and to manage alerts. Upon selection of box 744, the see more option, the merchant is provided with the screen depicted in FIG. 17B. Upon selection of box 746 or a manage alerts link in box 1091, the manage alerts option, the merchant is provided with the screen depicted in FIG. 18A or 47G. Upon selection of link 726, in FIG. 17, available cash advance is provided to the merchant. Specifically, upon selection of link 726, a funds screen 748 depicted in FIG. 17C is provided to the merchant. In merchant account screen 740, additional items may be selected. For example, back button 743 may be selected which would return to a previous screen. Home button 749 may be selected which would provide a home screen such as main menu screen 724.

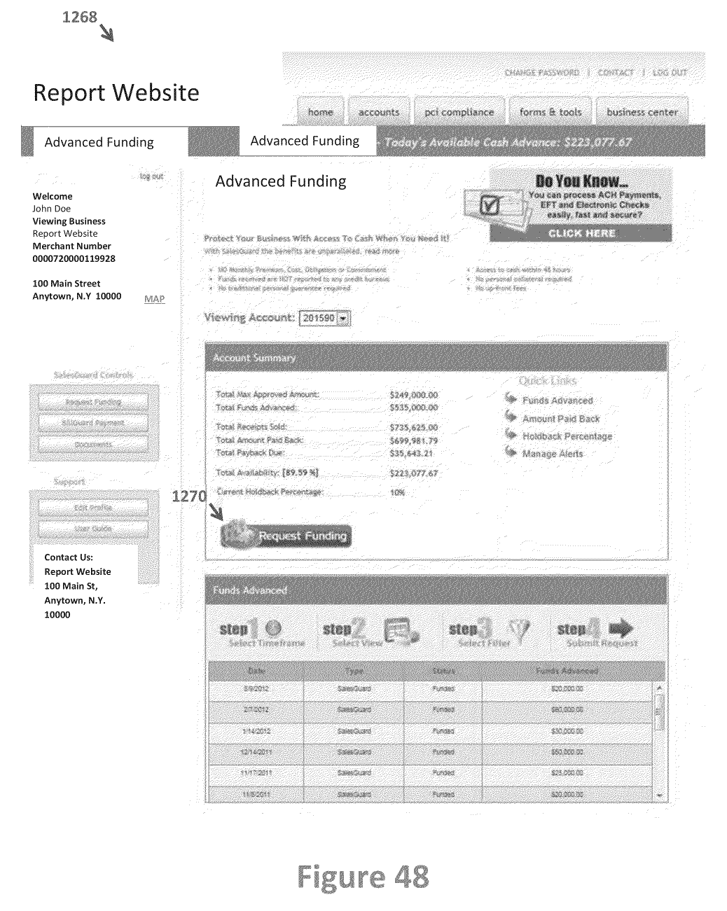

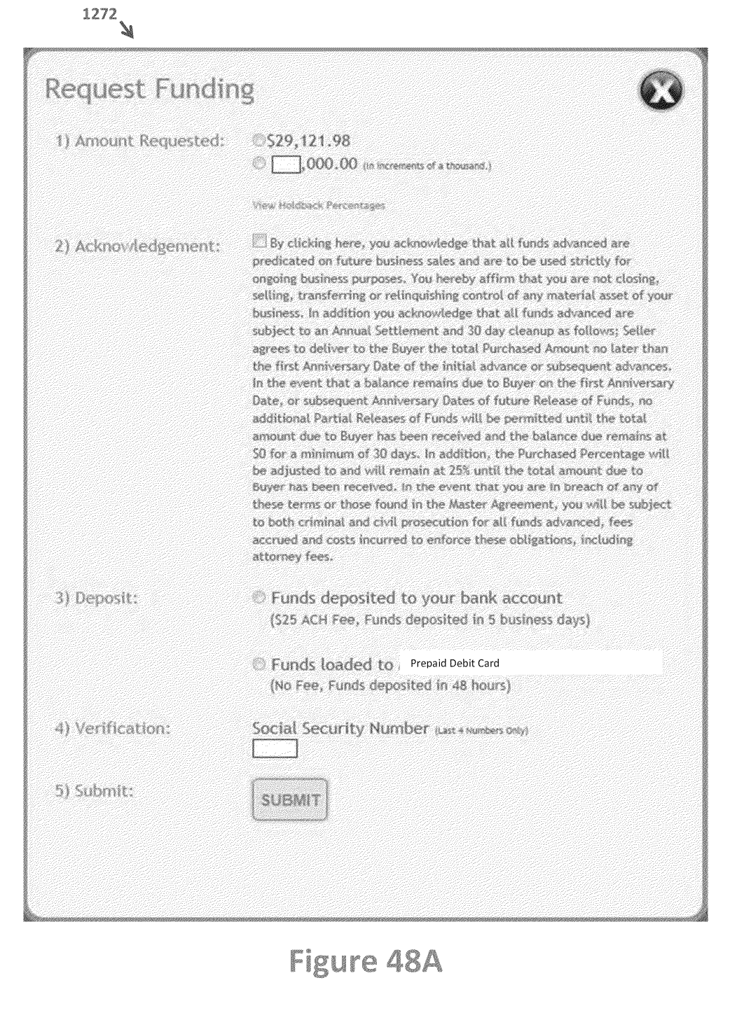

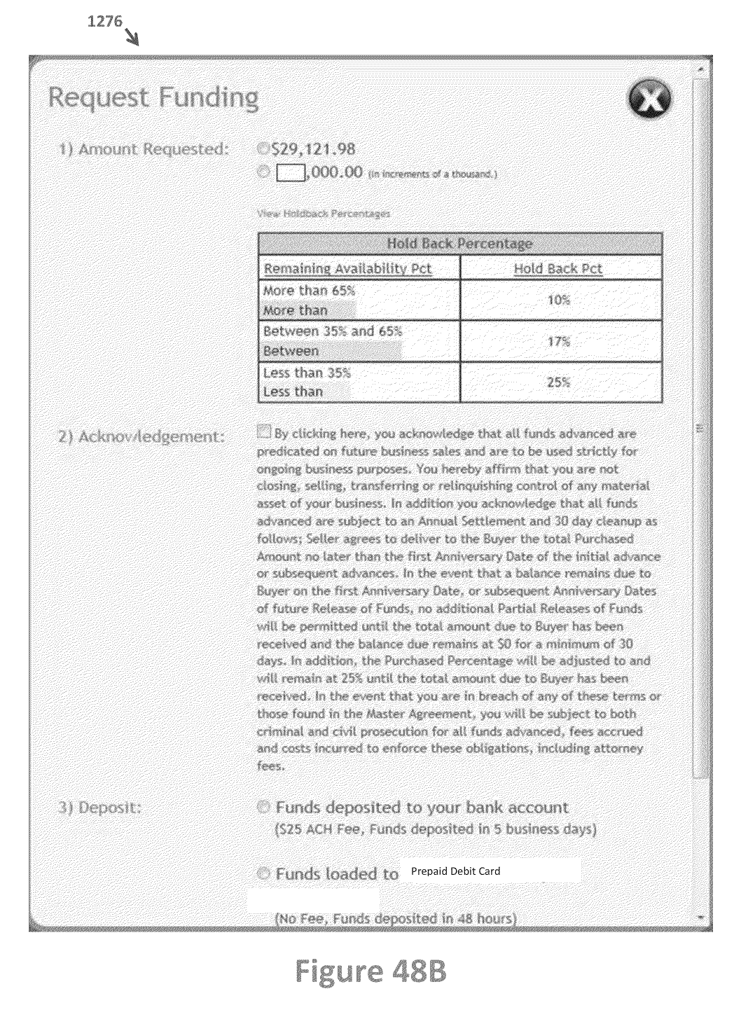

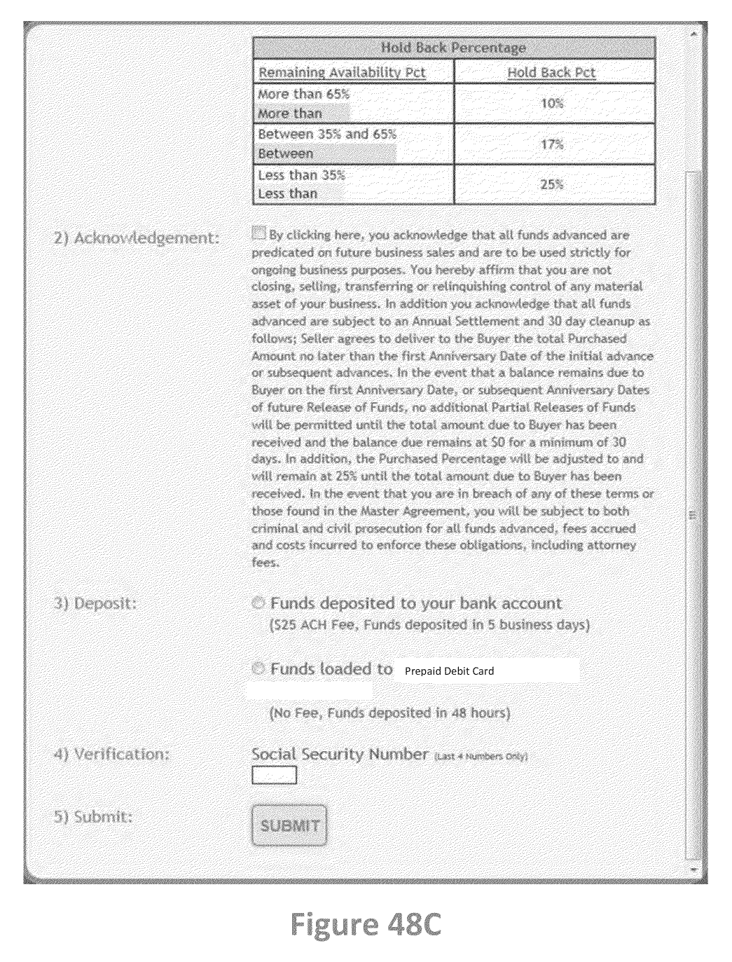

Suppose that a merchant employing merchant device 103 wishes to request a cash advance or available cash in the merchant account. The merchant may submit a request for cash advance to reports server 101 by entering the request into mobile application 105. For example, the merchant may select an amount of available cash advance, as shown in FIG. 17C or FIG. 48A. Reports server 101, in FIG. 1, may receive the request for the cash advance from merchant device 103, over network 104. In an embodiment, the request for the cash advance is based on a total number of sales indicated by the credit card sales account information. Reports server 101 then requests the cash advance from either the financial service provider (not shown in FIG. 1) associated with financial service provider database 108 or another financial service provider, or from both, over network 104. One of the financial service providers sends payment based on the cash advance to reports server 101, over network 104. The payment may be sent for example, from at least one of the financial service provider's or another financial service provider's bank account into an account managed by reports server 101. Reports server 101 may receive the payment based on the cash advance from at least one of the financial service providers, over network 104. Reports server 101 provides an indication of available funds based on the cash advance to merchant device 103 over network 104.

FIG. 25 and FIG. 48B depicts a holdback percentage screen 872 and a holdback percentage screen 1276, respectively, in accordance with an embodiment. The holdback percentage screen shows the percentage amount held back.

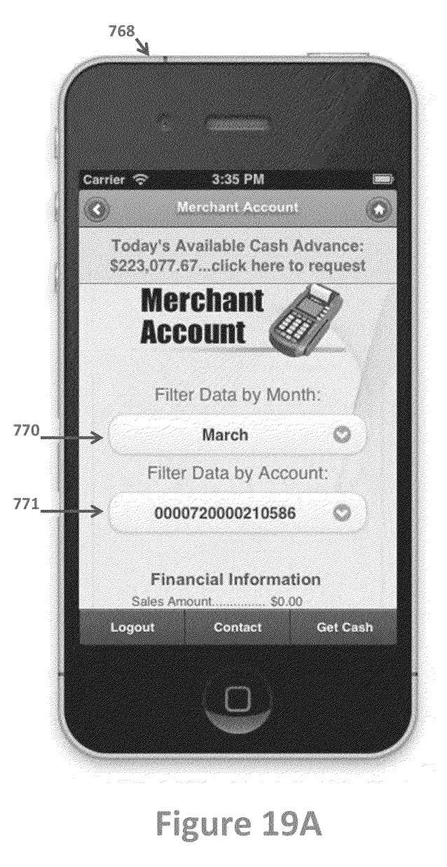

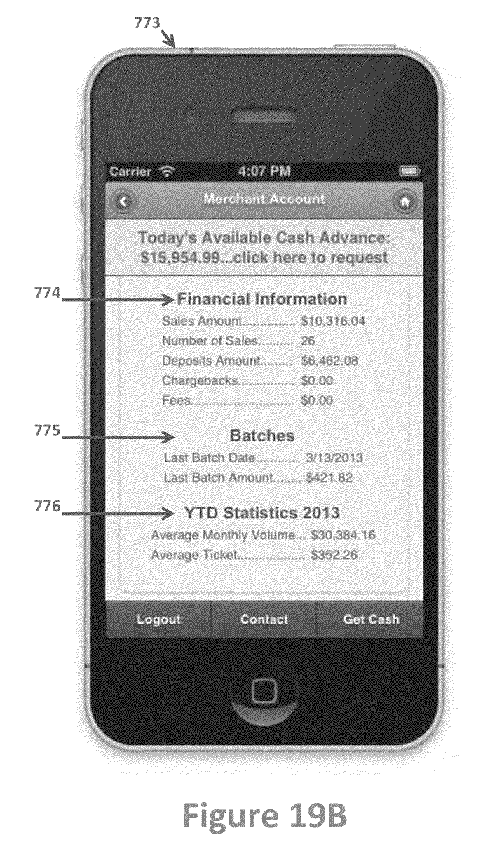

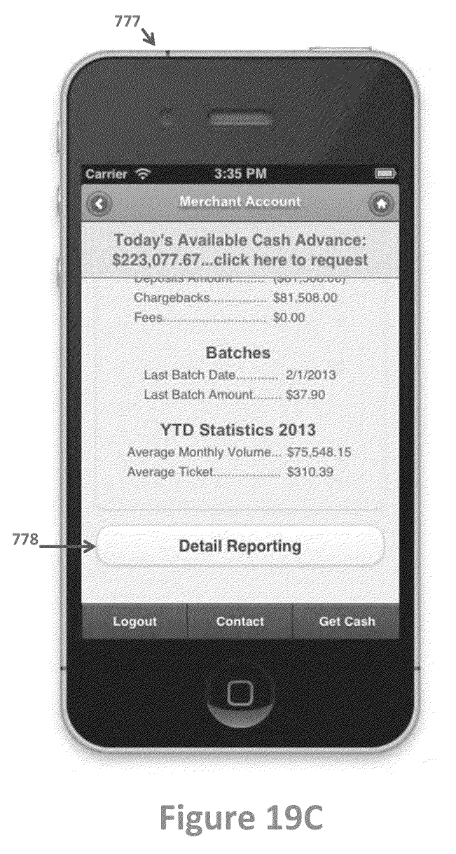

FIG. 19A depicts a merchant account filtering options screen, in accordance with an embodiment. In FIG. 19A, merchant account screen 768 provides various options for filtering. For example, a merchant employing merchant device 103 may select to filter his/her account data for a certain month (i.e., March), as shown in box 770. The merchant may also have multiple accounts and may choose to filter the data based on a particular account, as shown in box 771. Upon changing a selection of the month in box 770 or the account in box 771, the data shown under financial information 774, batches 775 and YTD statistics 776 for a particular year may be updated. Upon selection of box 778, detail reporting, a detail reporting screen in FIG. 20 is shown.

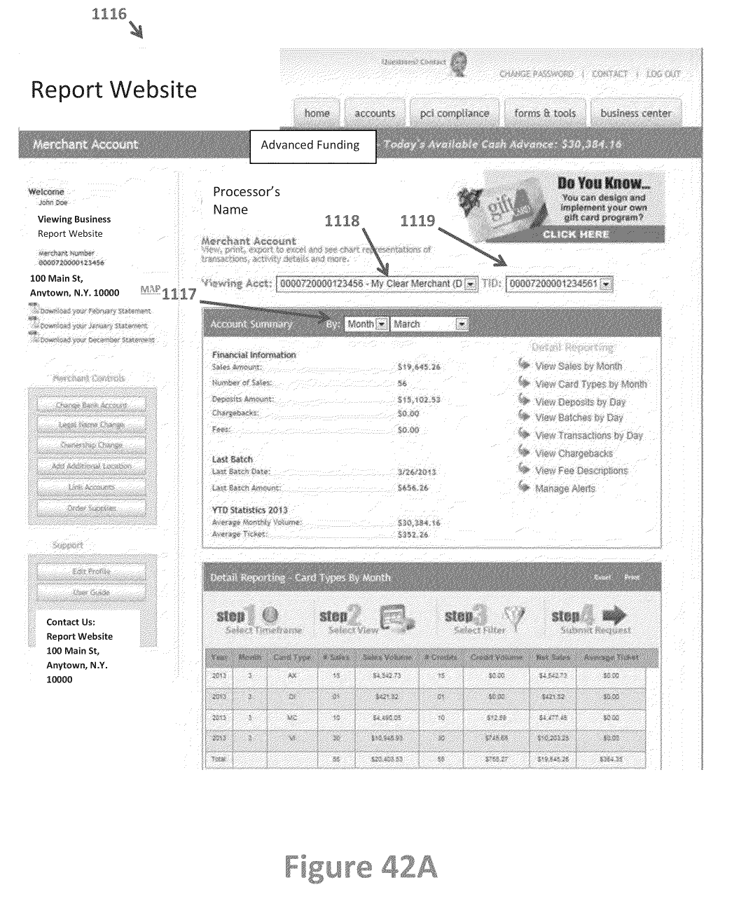

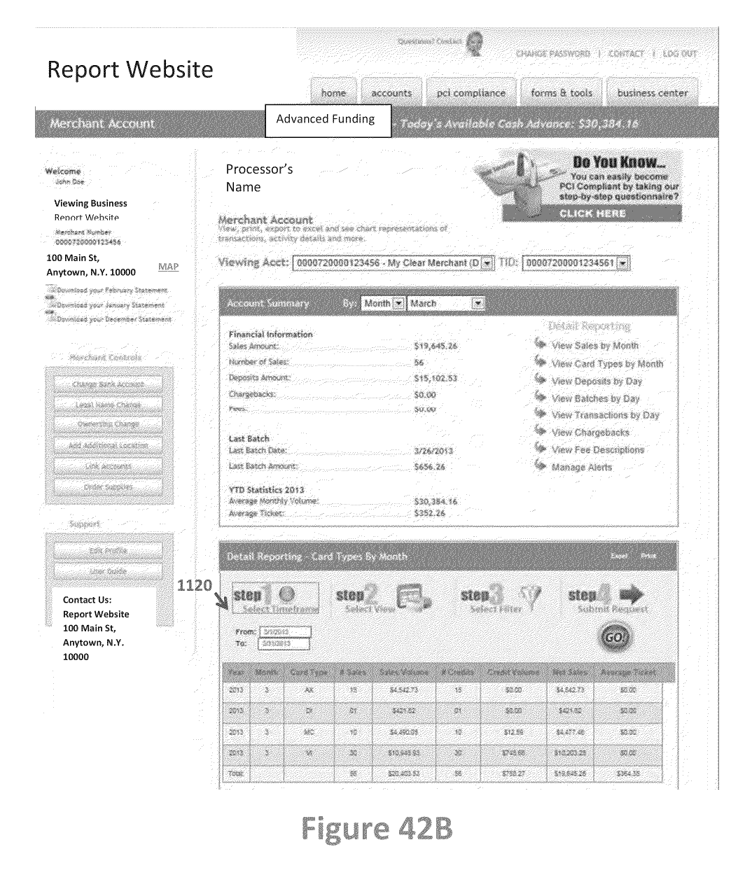

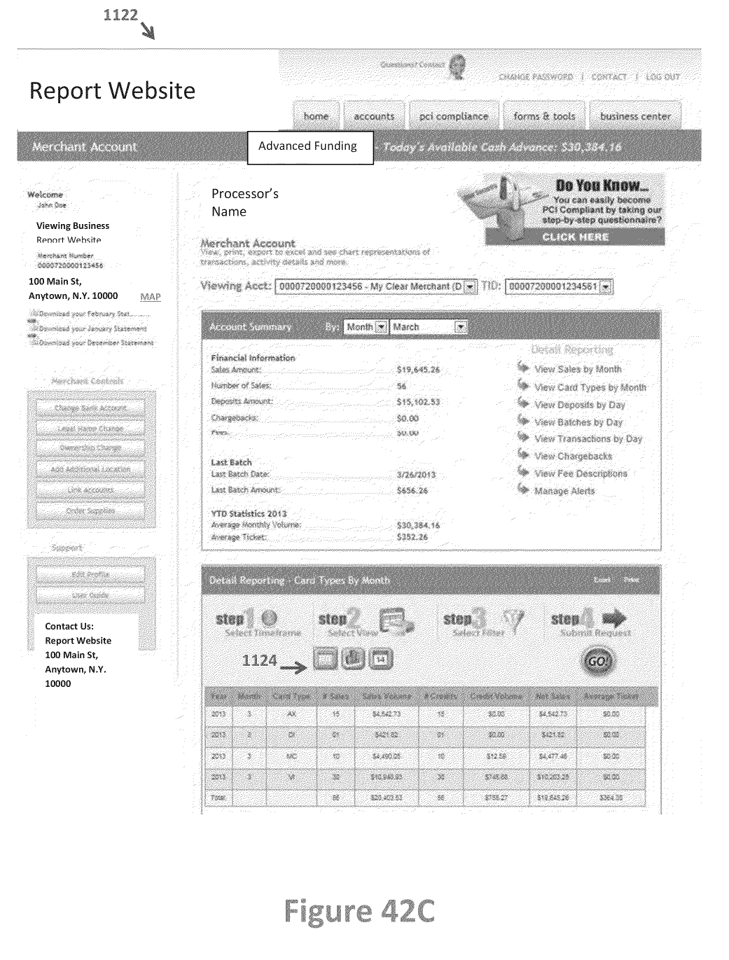

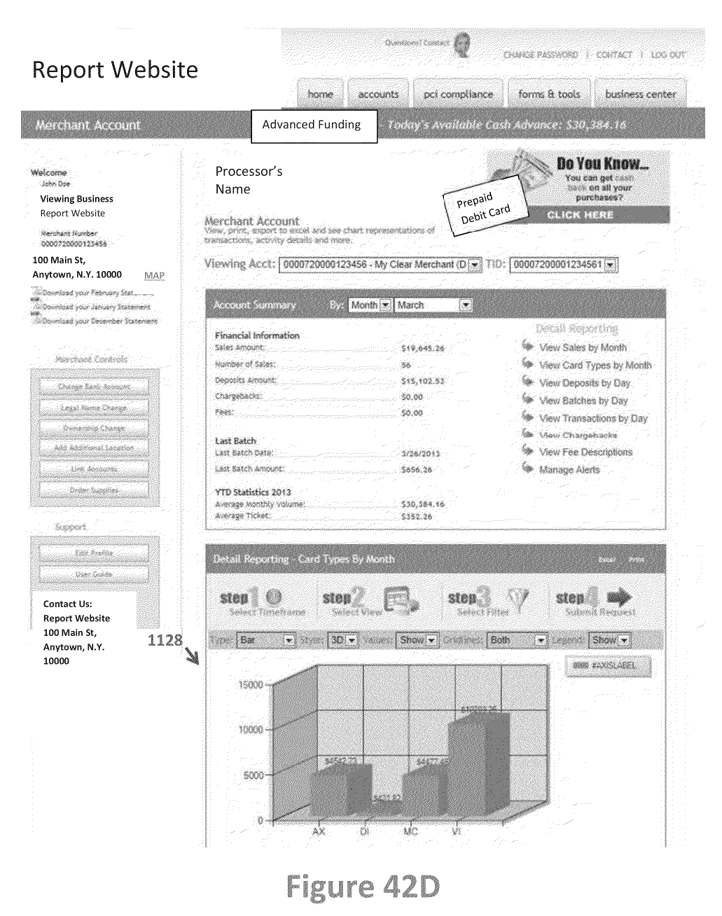

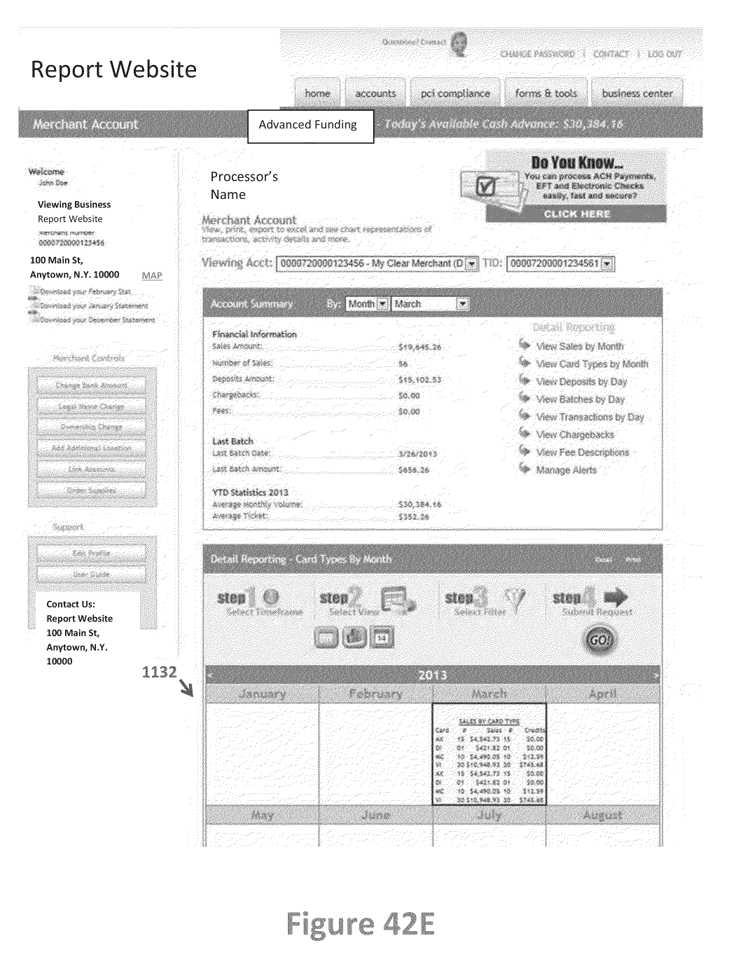

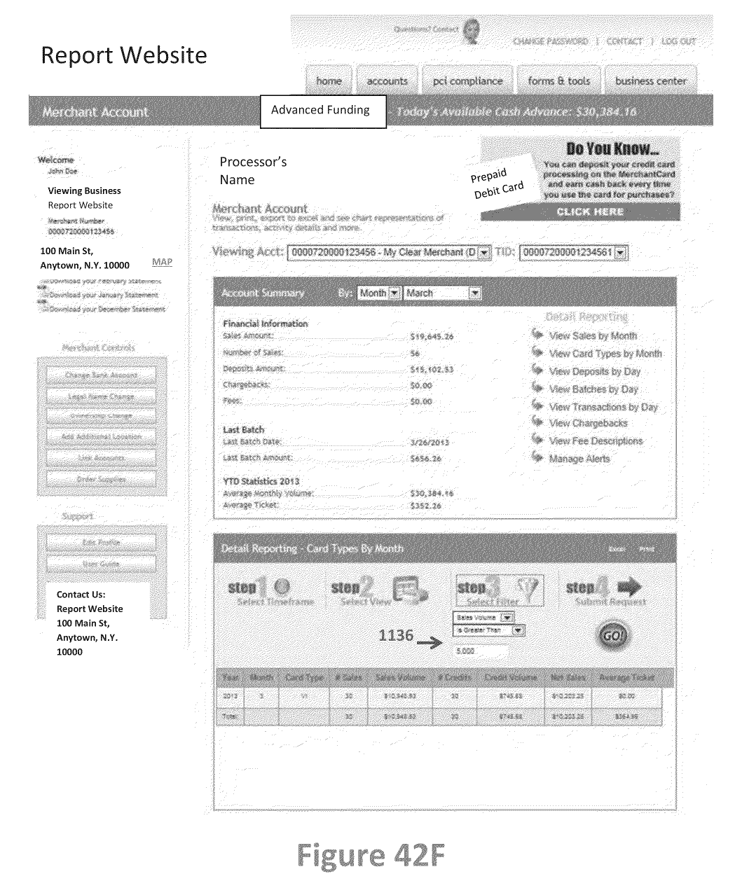

On the report website, the merchant may be provided with additional tools to filter and view the data. FIG. 42B depicts a merchant account filtering by timeframe screen, in accordance with an embodiment. In FIGS. 42C, 42D, and 42E, the merchant account screen can be displayed in a grid view 1122, chart view 1128 and calendar view 1132, respectively. The data can also be filtered by any field as shown in FIG. 42F item 1136. For example, a merchant employing merchant device 103 may select to filter his/her account data for a certain month (i.e., March), as shown in box 1117. The merchant may also have multiple accounts and may choose to filter the data based on a particular account, as shown in box 1118 or terminal, as shown in box 1119. Upon changing a selection of the month in box 1117 or the account in box 1118 or the terminal in box 1119, the data shown under financial information 1124, batches and YTD statistics for a particular year may be updated. Upon selection of any box described above, a detail reporting screen in FIG. 42A is shown.

FIG. 18A depicts an alerts screen, in accordance with an embodiment. The merchant may select one or more alerts from alerts screen 754. The merchant may wish to receive daily or weekly alerts associated with his/her merchant account by email and/or by text. Some exemplary alerting options are shown in alerts screen 754.

FIG. 47G depicts an alerts screen on the report website, in accordance with an embodiment. The merchant may select one or more alerts from alerts screen 1264. The merchant may wish to receive daily or weekly alerts associated with his/her merchant account by email and/or by text. Some exemplary alerting options are shown in alerts screen 1264.

FIG. 20 depicts a detailed reporting screen 780, in accordance with an embodiment. Detail reporting screen 780 provides an option to view sales by month upon selection of box 782; view card types by month upon selection of box 784; view deposits by day upon selection of box 786; view batches by day upon selection of box 788; view transactions by day upon selection of box 790; view chargebacks upon selection of box 792; and view fee descriptions upon selection of box 794.

Upon selection of box 782 (view sales by month) in FIG. 20, a sales screen 796 shown in FIG. 20A is provided. Sales screen 796 provides details regarding all sales for a selected month (e.g., March). For example, as shown in FIG. 20A, a total of 26 credit card sales occurred in the month of March 2013, totaling an amount of $10,316.04. A merchant can filter data by a particular month by selecting the proper month in the drop-down menu in box 798. Suppose that a merchant wishes to search for a particular credit card sale that occurred in the month of March. The merchant can input the search criteria (e.g., a sales amount, a sale transaction date, etc.) into box 804 and search for the particular credit card sale. When the merchant inputs a search request to search (e.g., the search criteria) for a particular credit card sale into box 804, reports server 101 receives the search request. Reports server 101 performs a search of the filtered custom credit card sales account information (as described above with respect to FIG. 6A) to identify the particular credit card sale that the merchant is searching for. Reports server 101 provides the particular credit card sale to merchant device 103 in a format that can be properly displayed by merchant device 103. For example, the particular credit card sale is provided in a format that is displayable within a display screen of merchant device 103.

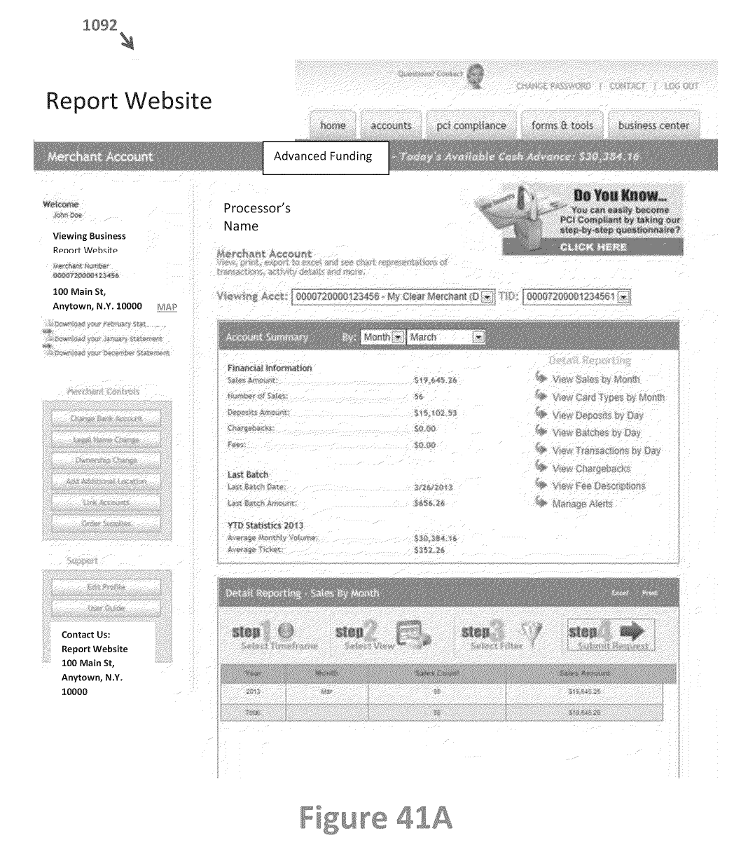

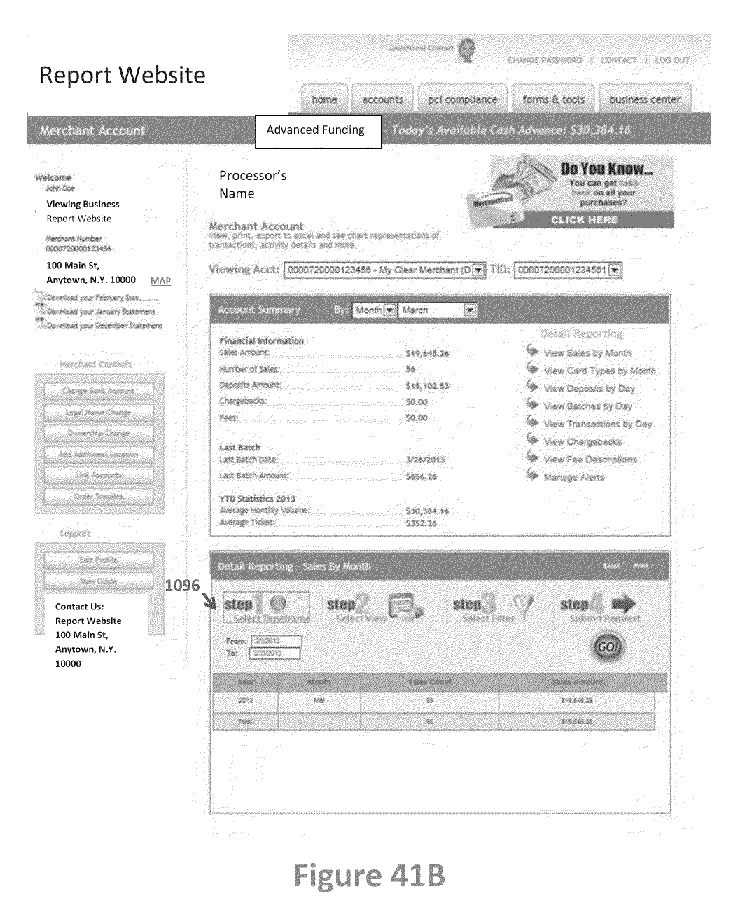

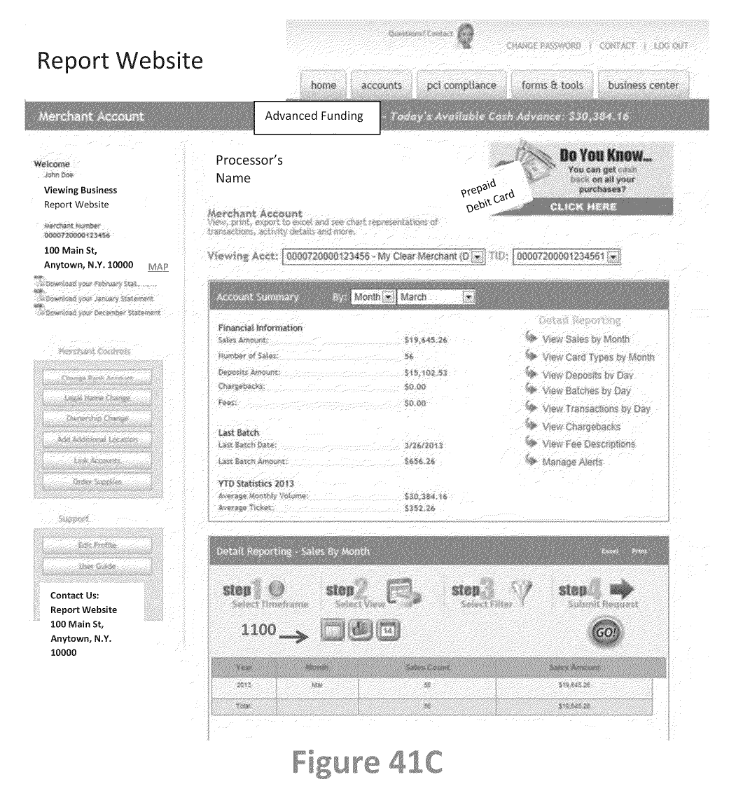

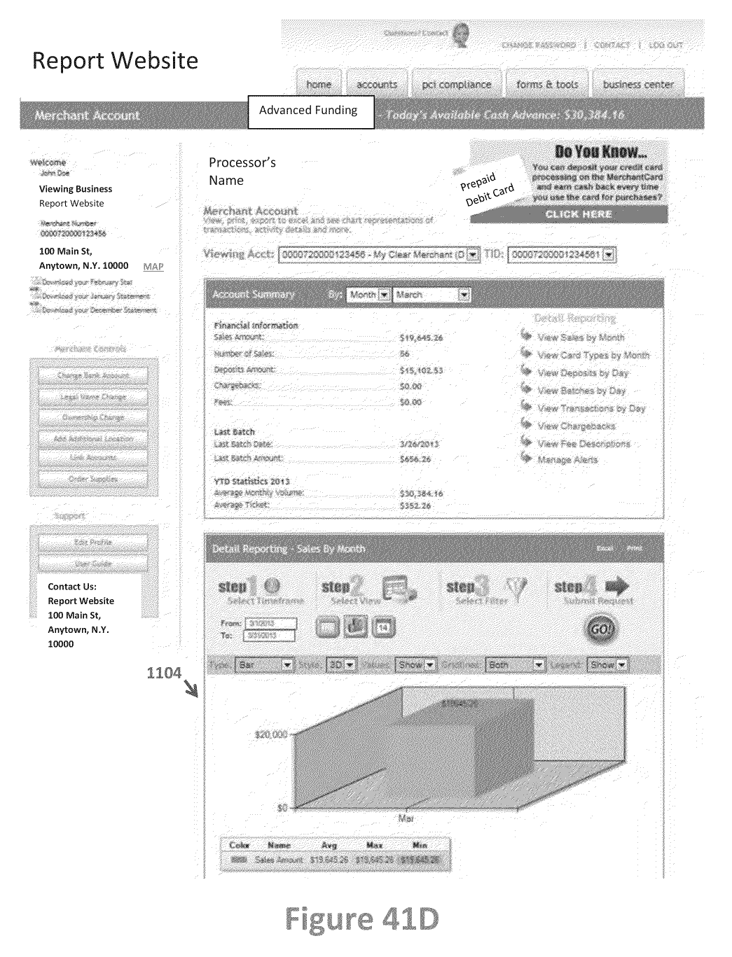

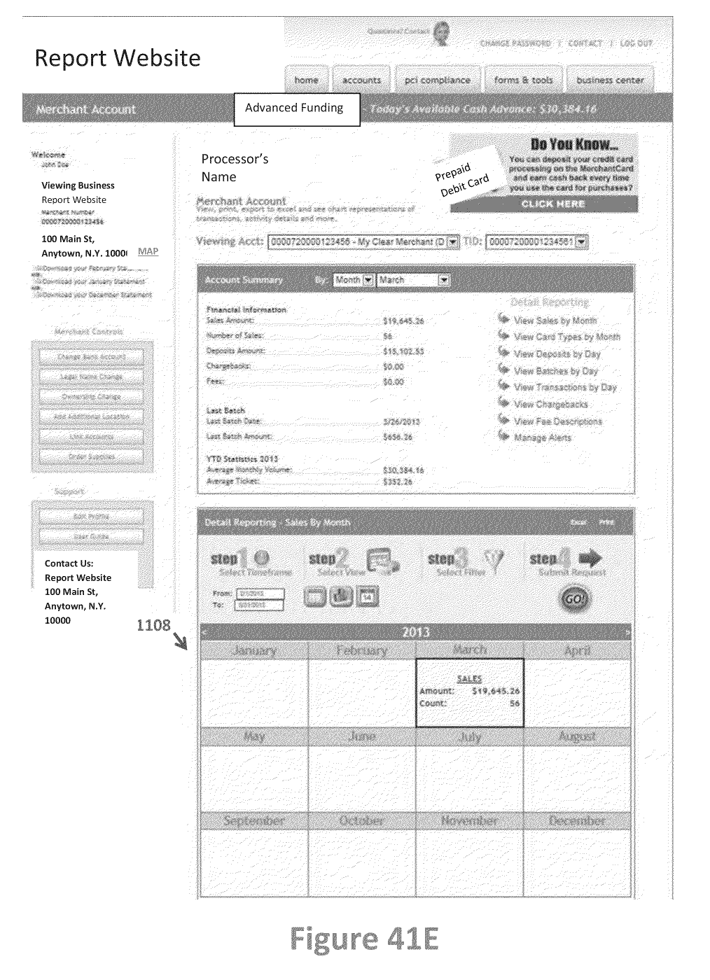

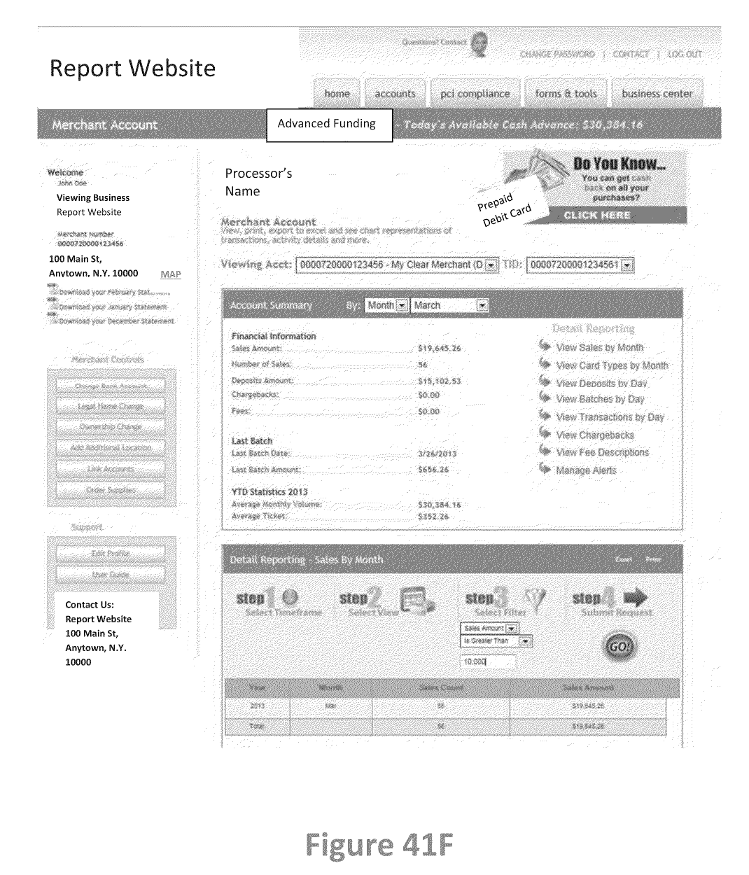

Upon selection of an item in box 1091 (to view sales by month) in FIG. 40, a card type screen 1092 shown in FIG. 41A is provided. In the card type screen 1092, sales are combined based on credit card types. FIG. 41A through 41F depict merchant account screens for view sales by month.

Upon selection of box 784 (to view card types by month) in FIG. 20, a card type screen 808 shown in FIG. 20B is provided. In the card type screen 808, sales are combined based on credit card types.

Upon selection of an item in box 1091 (to view card types by month) in FIG. 40, a card type screen 1116 shown in FIG. 42A is provided. In the card type screen 1116, sales are combined based on credit card types. FIG. 42A through 42F depict merchant account screens for view card types by month.

Upon selection of box 786 (to view deposits by day) in FIG. 20, a deposits screen 812 is provided as shown in FIG. 20D. Deposits screen 812 provides details regarding deposits. A search box 809, shown in FIG. 20B, may also be provided to enable searching of deposits.

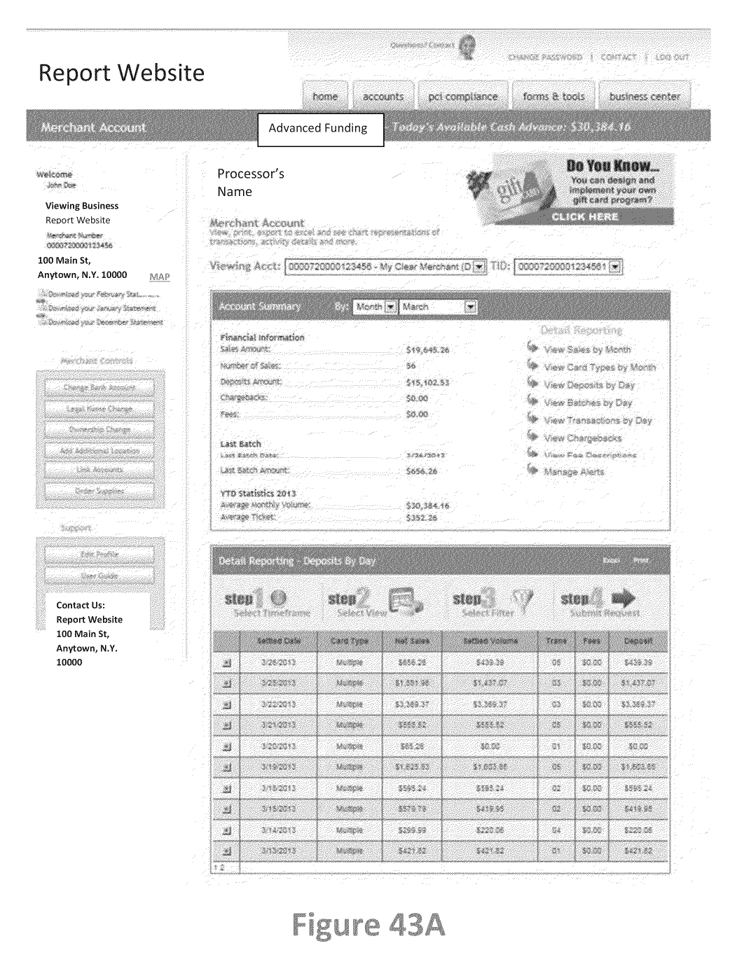

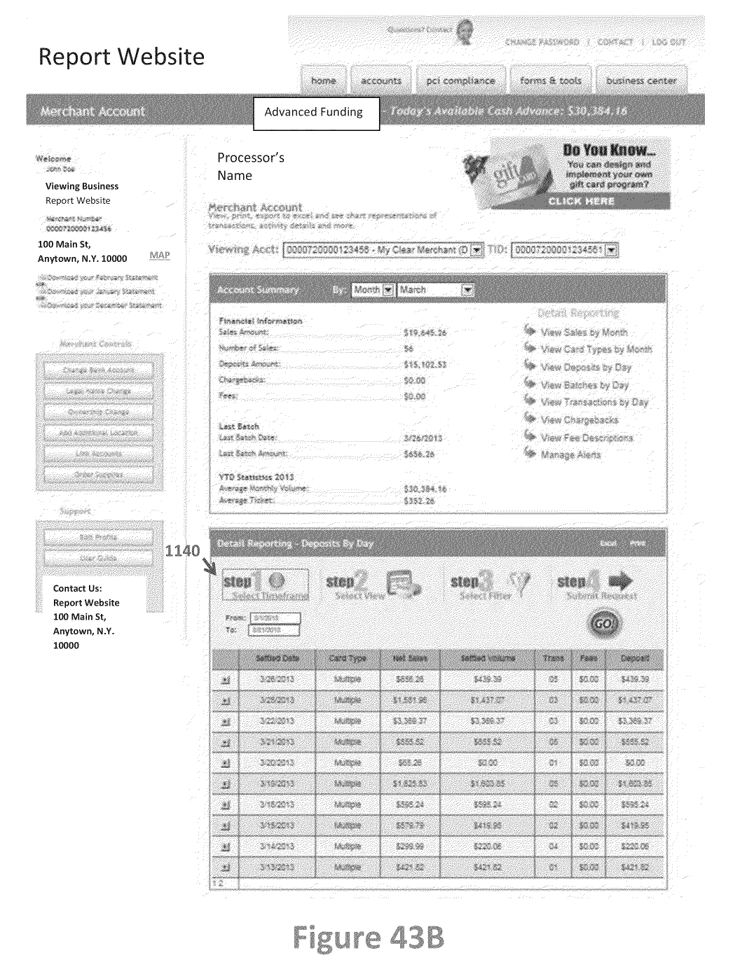

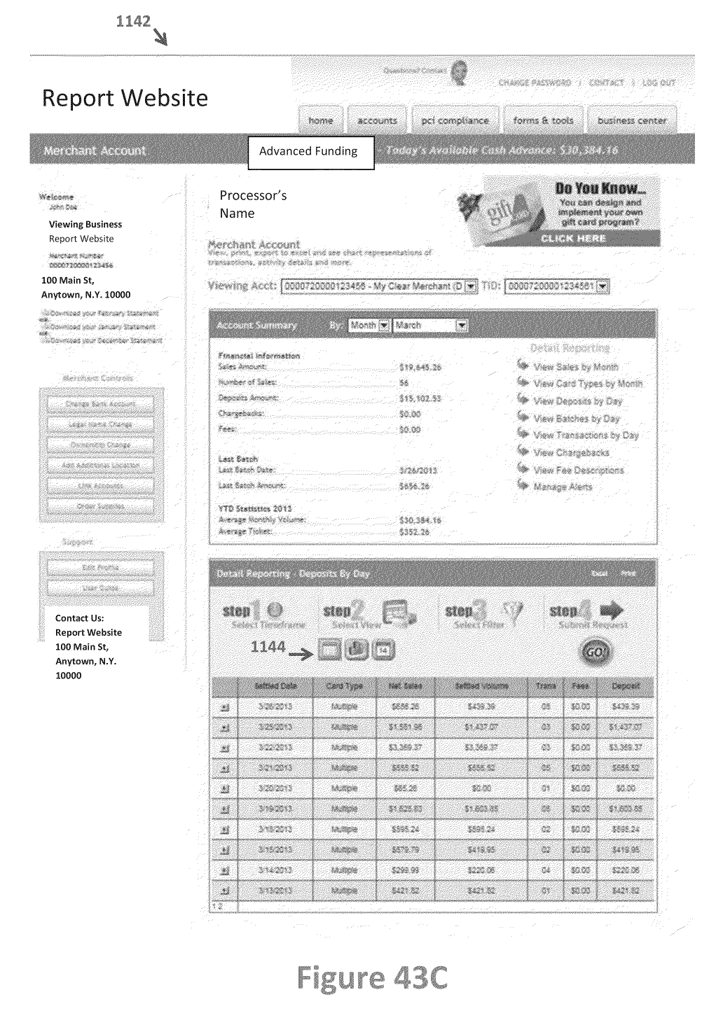

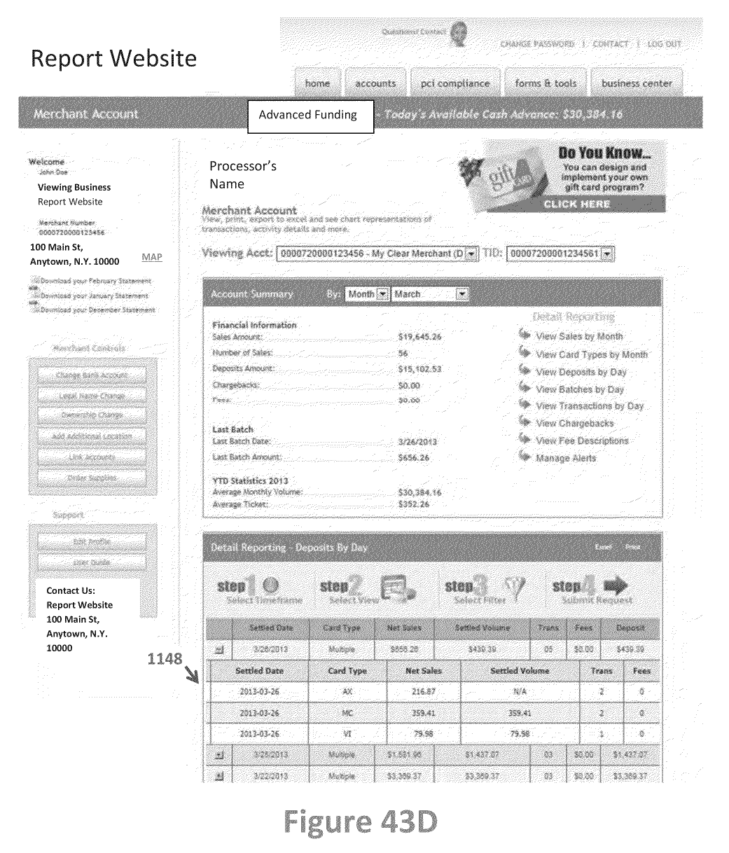

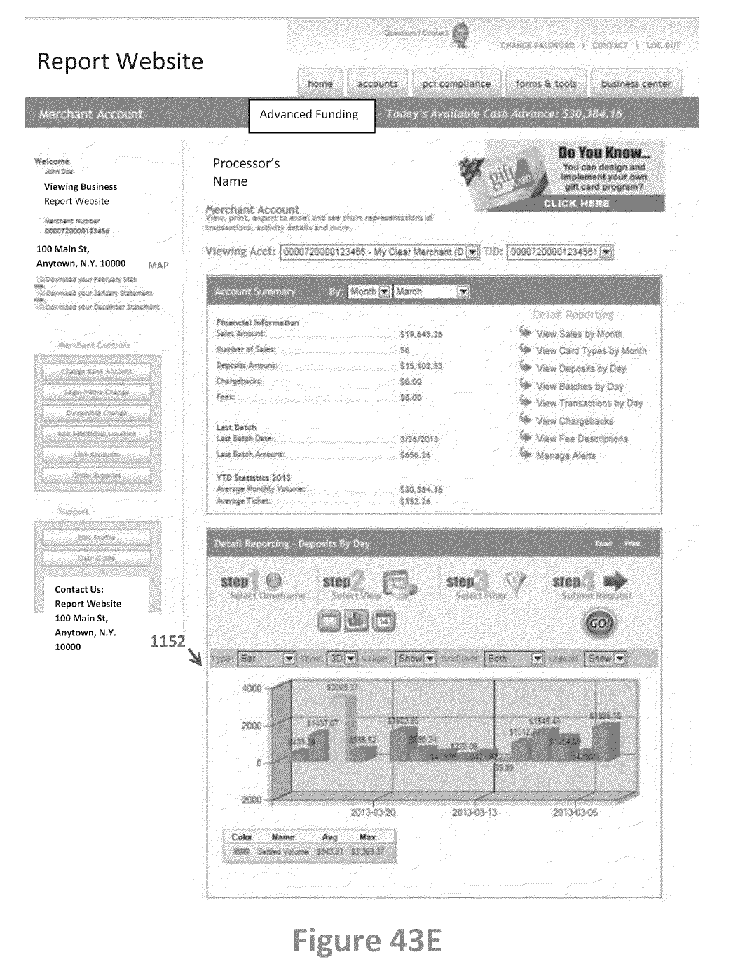

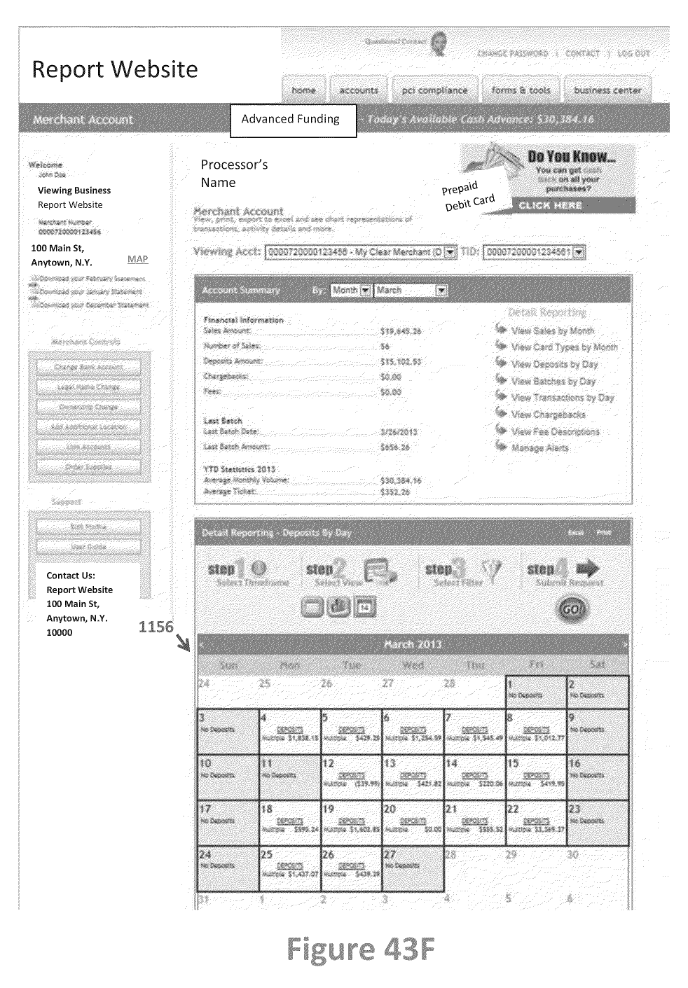

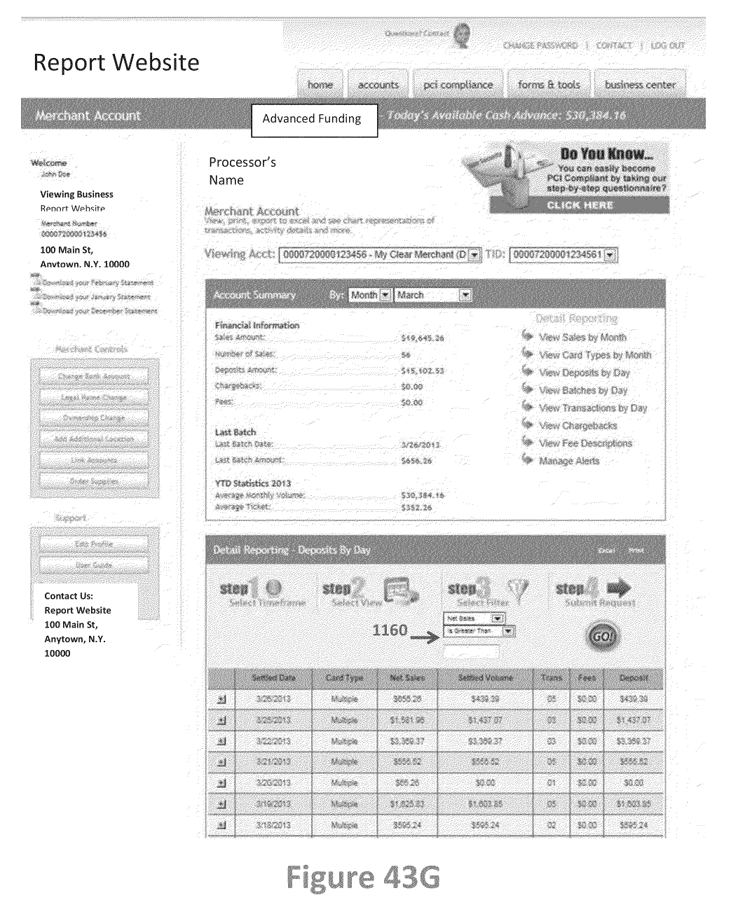

Upon selection of an item in box 1091 (to view deposits by day) in FIG. 40, a card type screen 1136 shown in FIG. 43 is provided. In the card type screen 1136, sales are combined based on credit card types. FIG. 43A through 43F depict merchant account screens for view deposits by day.

Upon selection of box 788 (to view batches by day) in FIG. 20, a batches screen 818 is provided as shown in FIG. 20F. The transactions may be batched together and the details regarding each of the batches may be provided by batches screen 818.

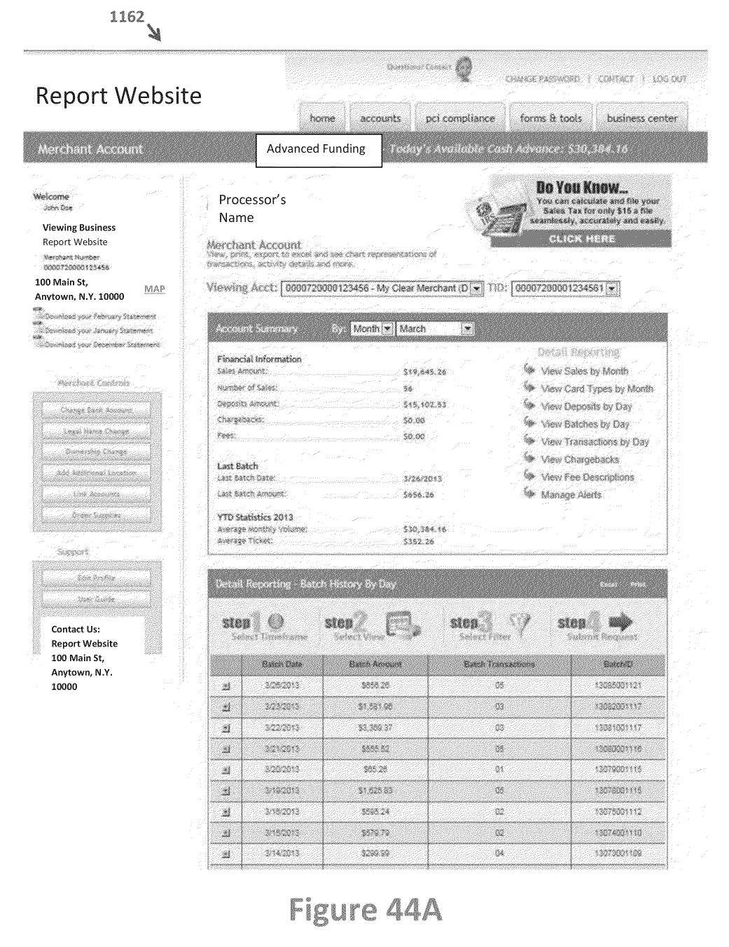

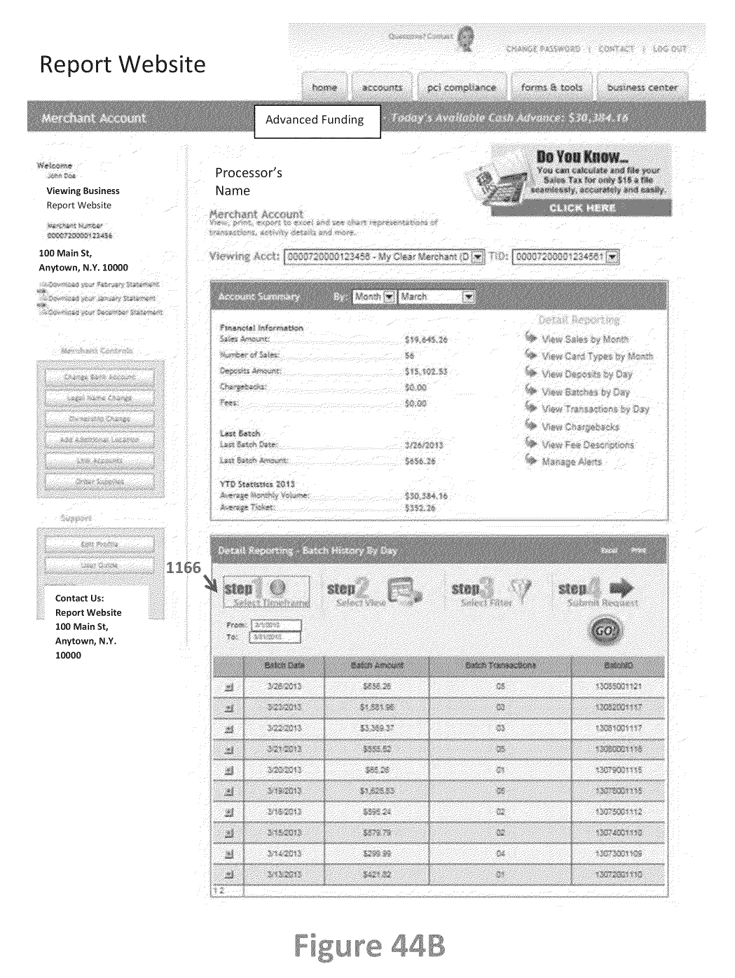

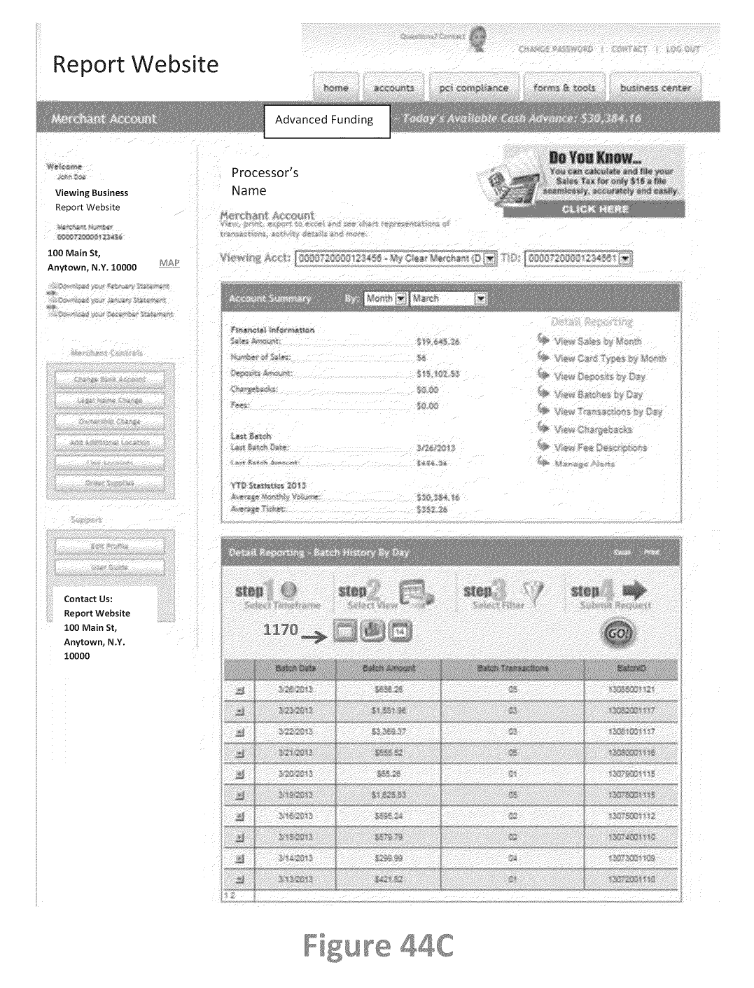

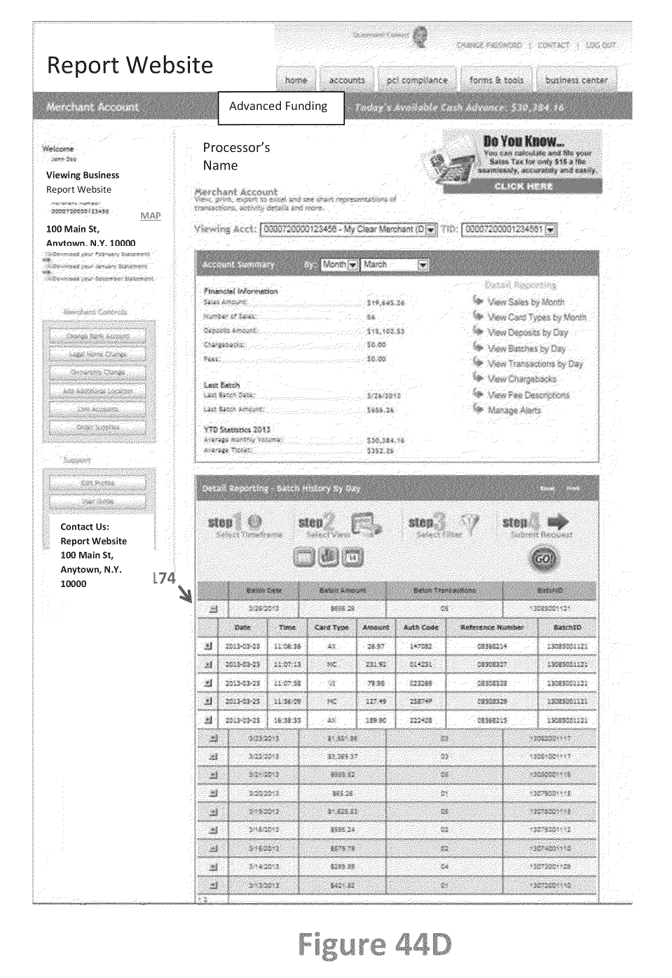

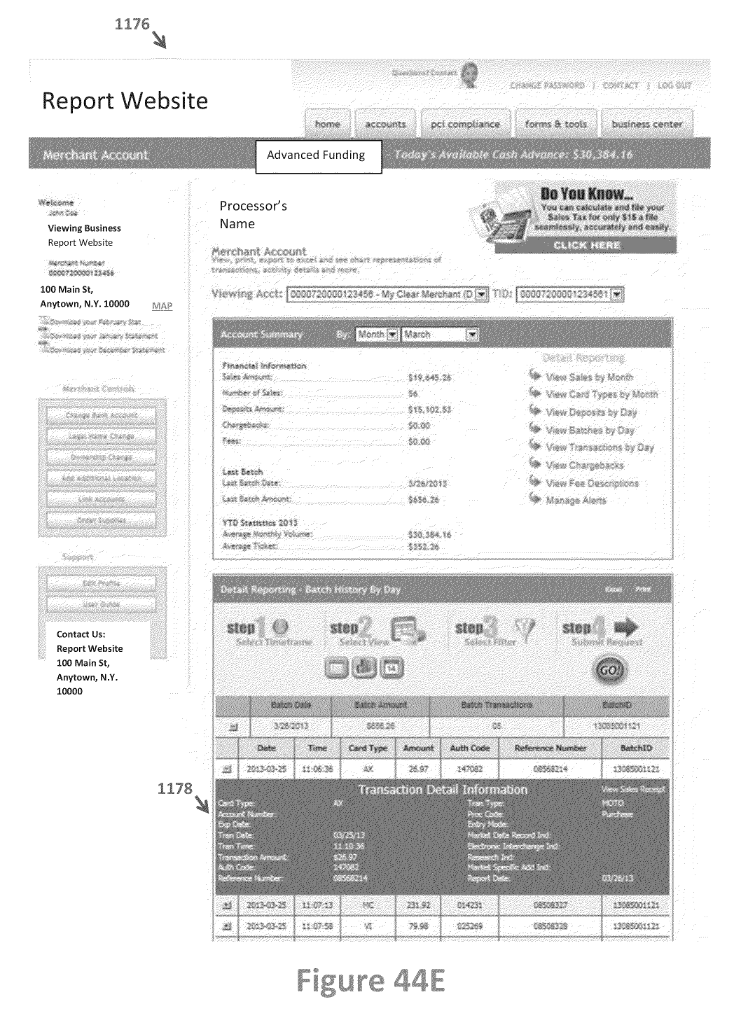

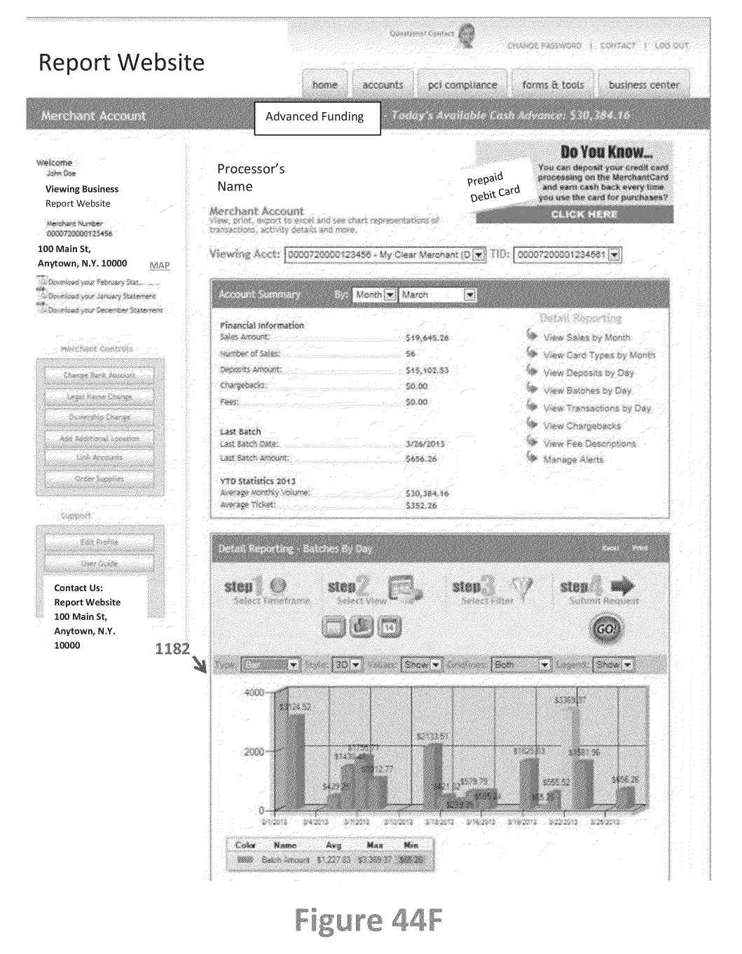

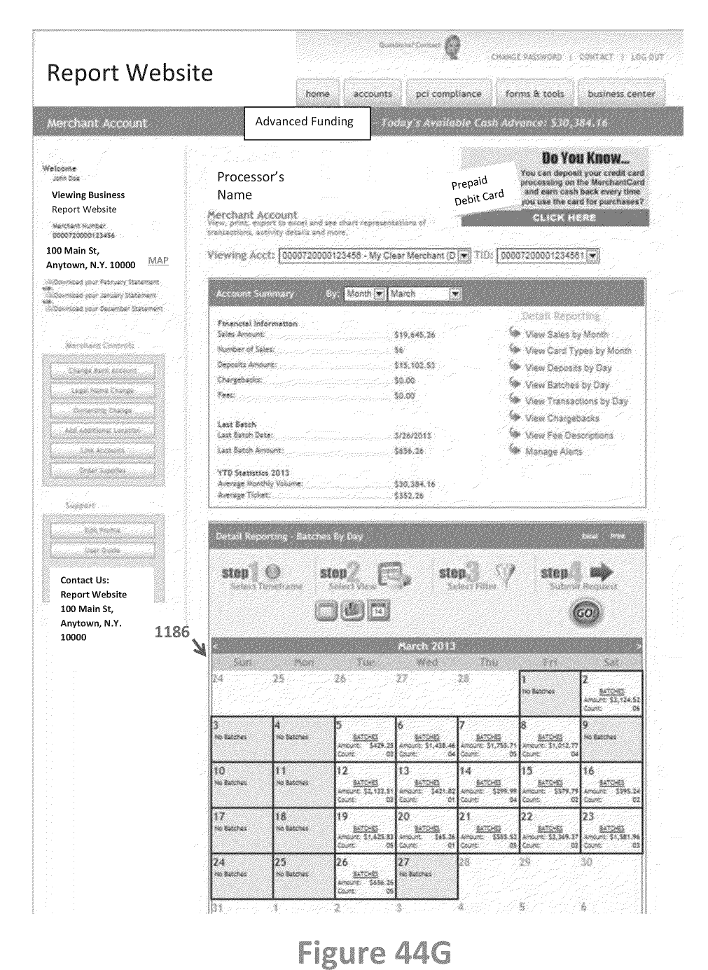

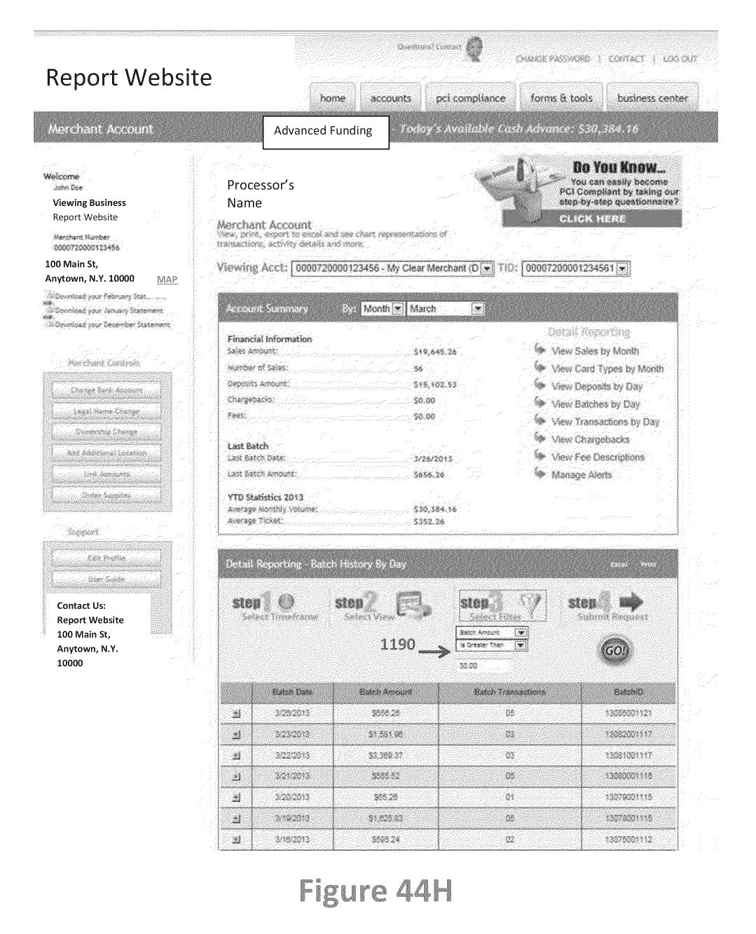

Upon selection of an item in box 1091 (to view batches by day) in FIG. 40, a card type screen 1162 shown in FIG. 44 is provided. In the card type screen 1162, sales are combined based on credit card types. FIG. 44A through 44F depict merchant account screens for view batches by day.

Upon selection of box 790 (to view transactions by day) in FIG. 20, a transactions screen 822 is provided as shown in FIG. 20H. In transactions screen 822, the transactions may be filtered by the month and/or by the account. For example, a merchant employing merchant device 103 may select to view transaction data for a certain month (i.e., January), as shown in box 823. The merchant may also have multiple accounts and may choose to filter the data based on a particular account, as shown in box 824. Upon changing a selection of the month in box 823 or the account in box 824, the transaction entries may be updated. In FIG. 20H, the transaction entries are sorted based on the date of the transaction. Additional information regarding the transaction entries is shown, including a card type (e.g., VISA (VI) or MASTERCARD (MC), DISCOVER (DI), credit card types, etc.), an amount, and an authorization code.

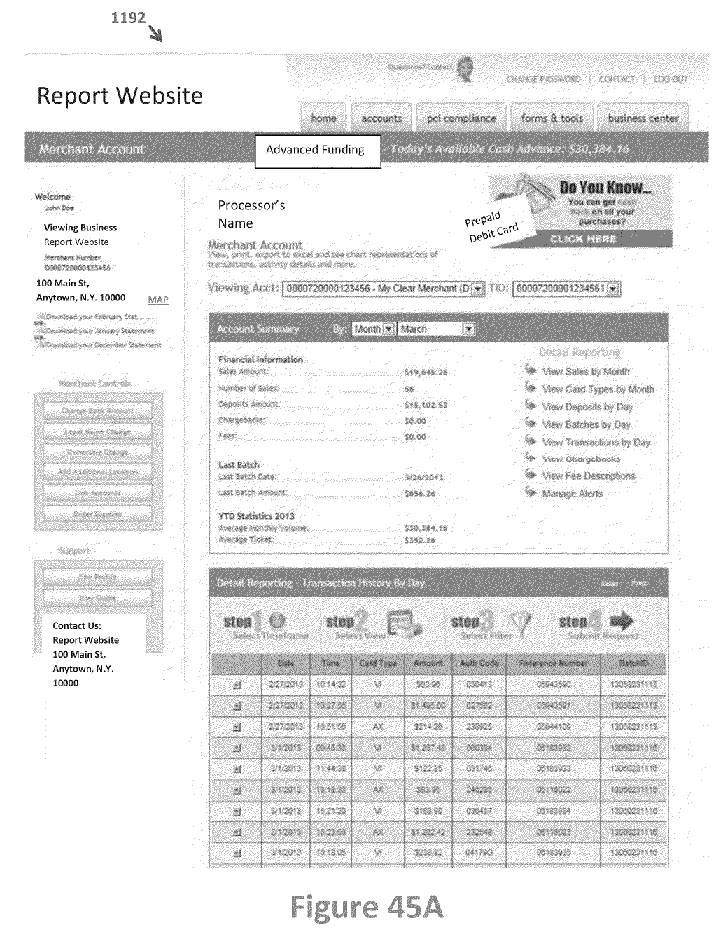

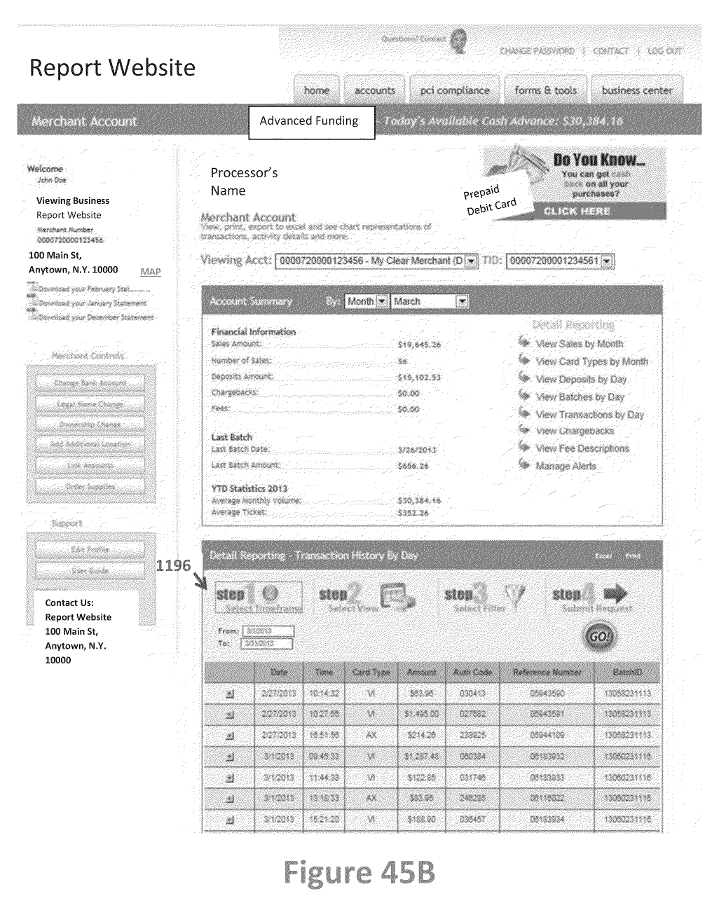

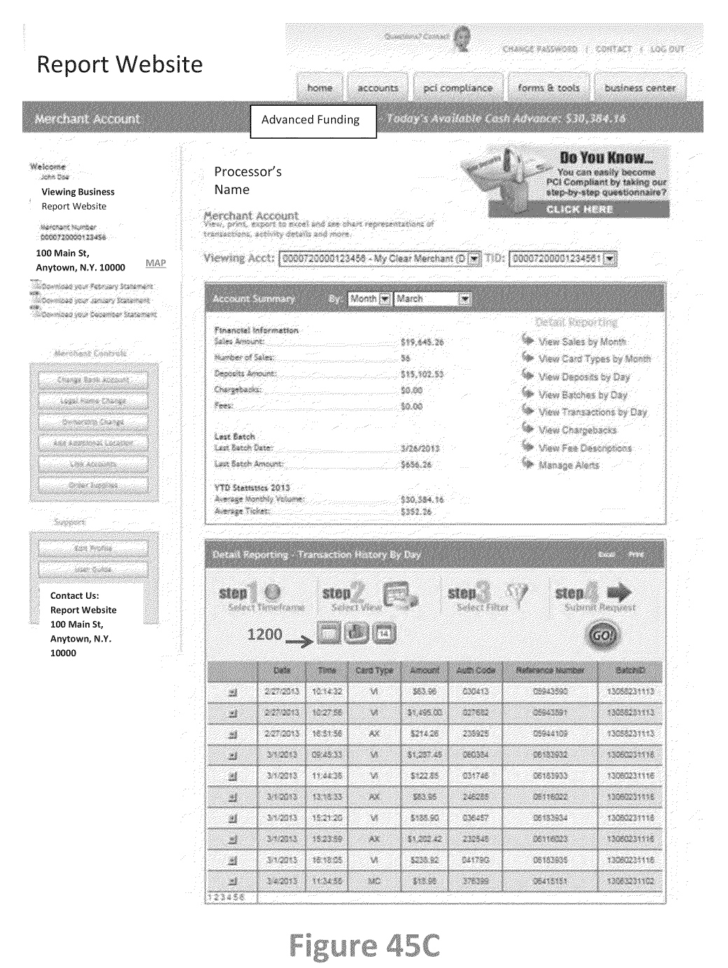

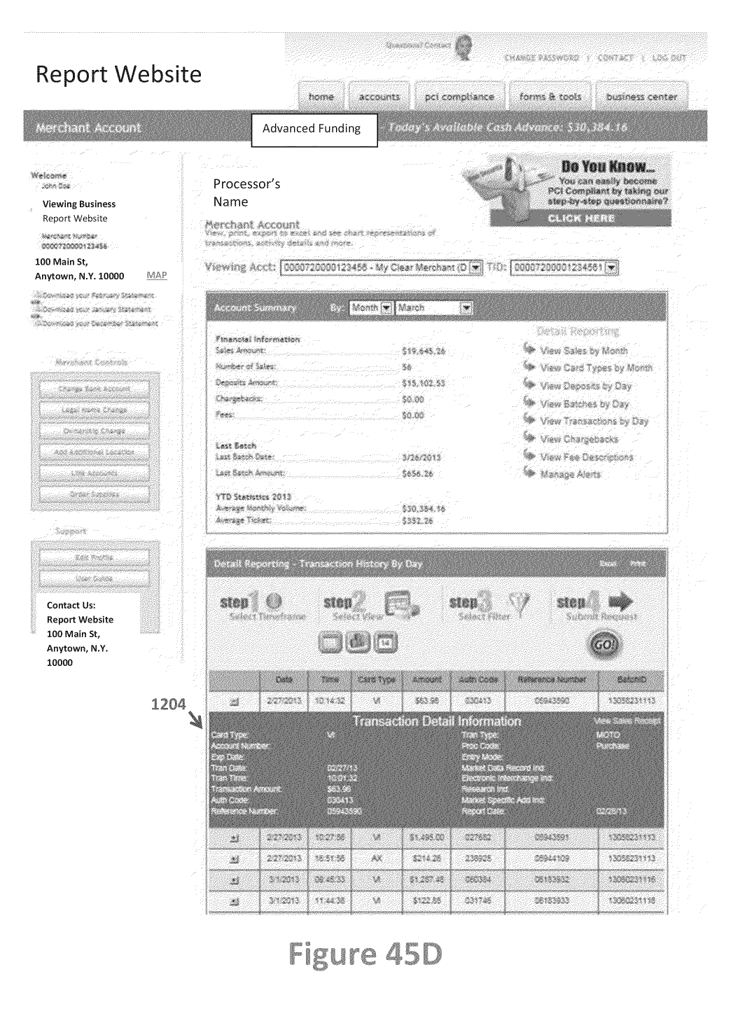

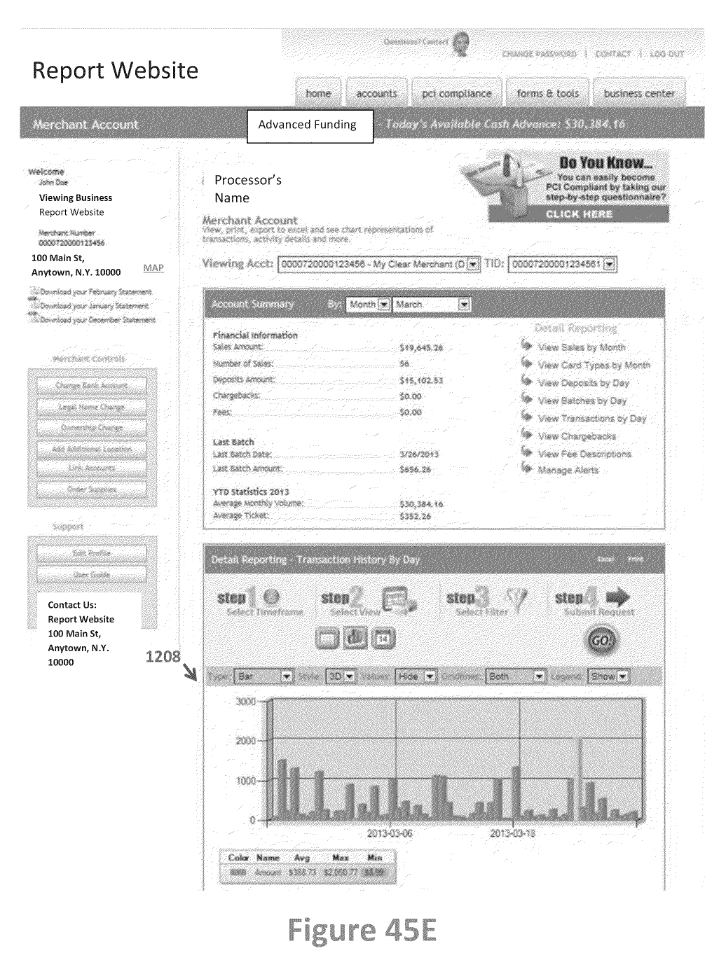

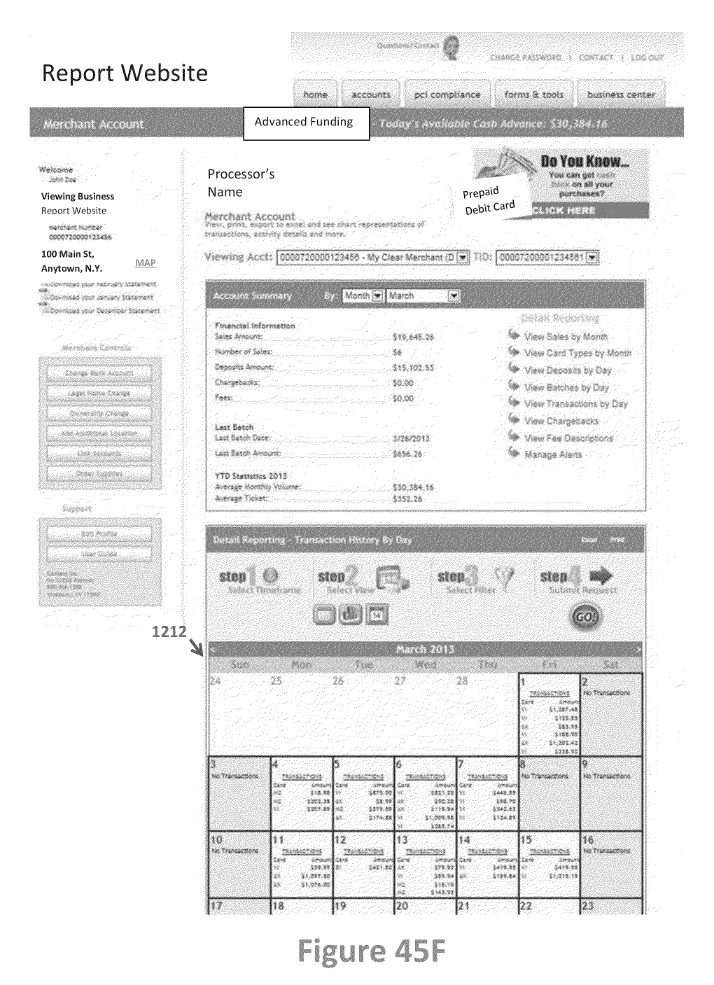

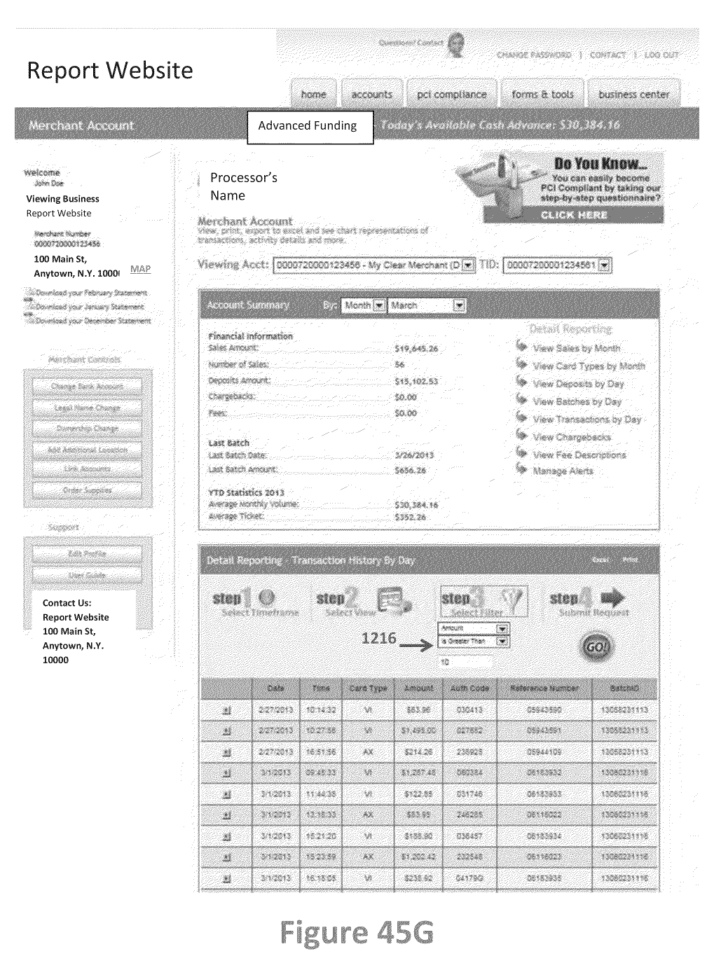

Upon selection of box an item in box 1091 (to view transactions by day) in FIG. 40, a card type screen 1192 shown in FIG. 45 is provided. In the card type screen 1192, sales are combined based on credit card types. FIG. 45A through 45F depict merchant account screens for view transactions by day.

Upon selection of box 792 (to view chargebacks) in FIG. 20, a paid back screen 864 is provided as shown in FIG. 24. Paid back screen 864 provides a date, a settlement amount, a holdback percentage and an amount paid back.

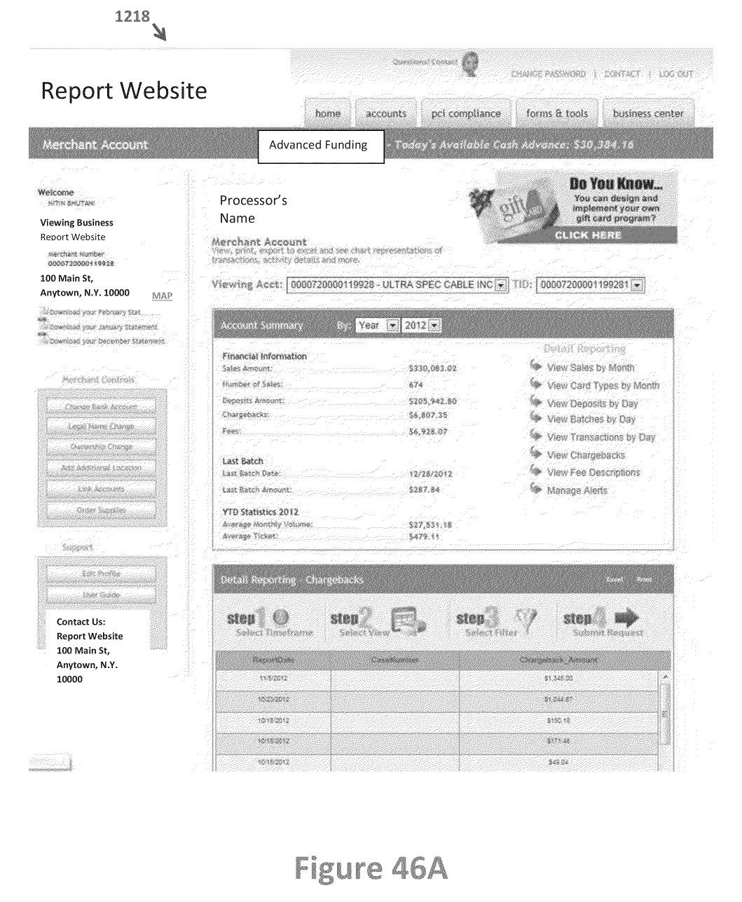

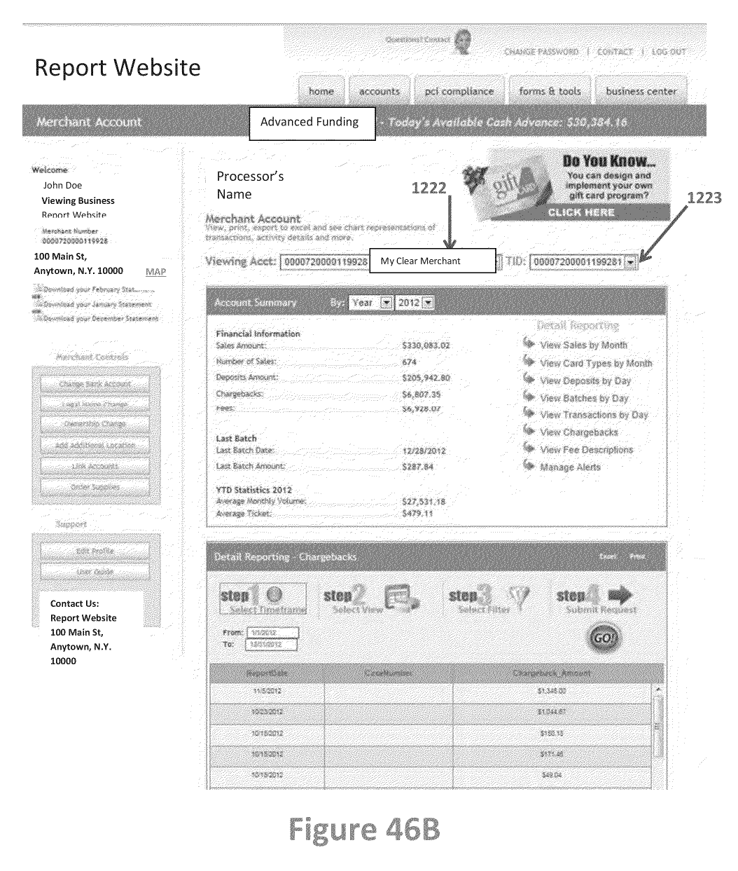

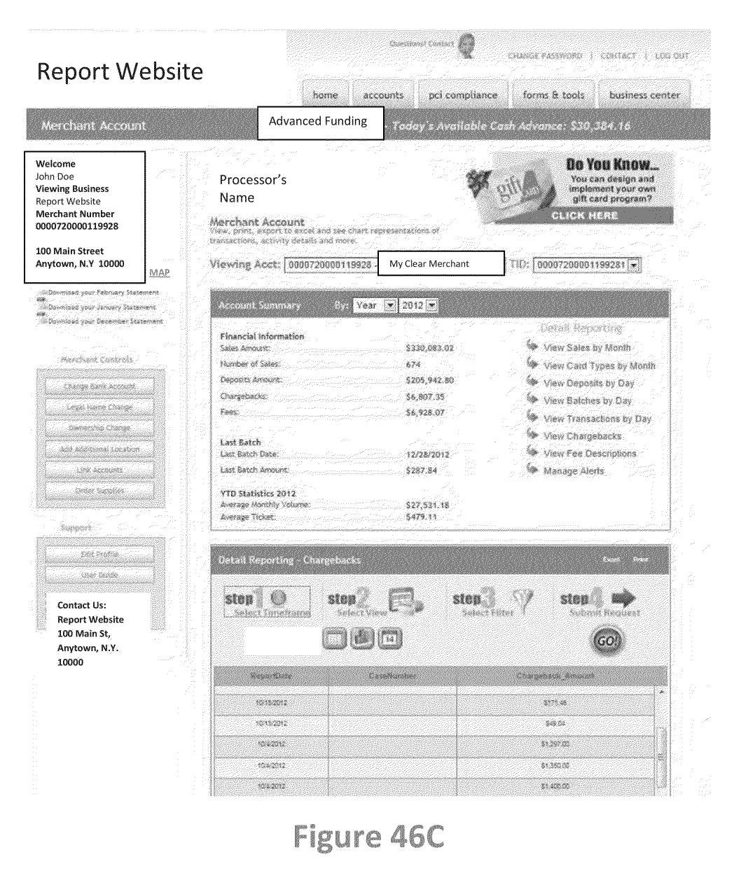

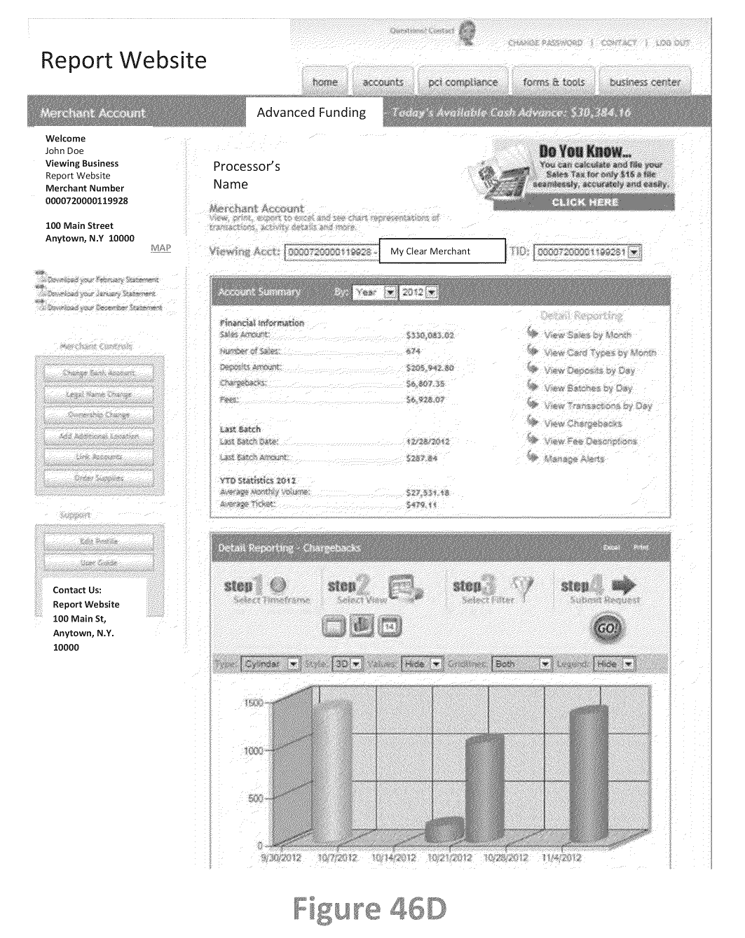

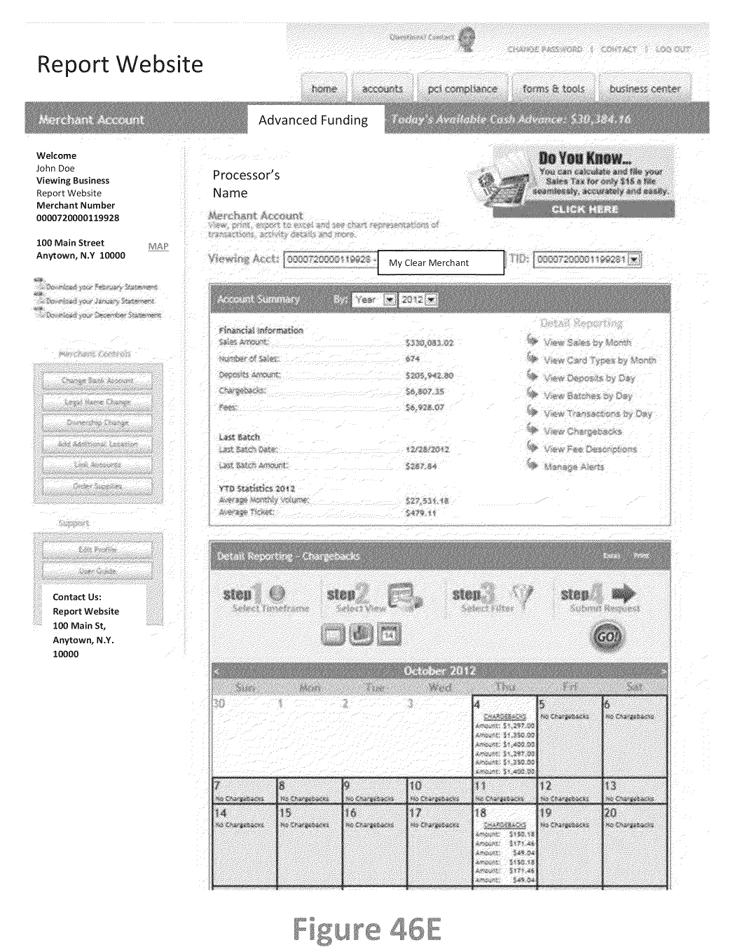

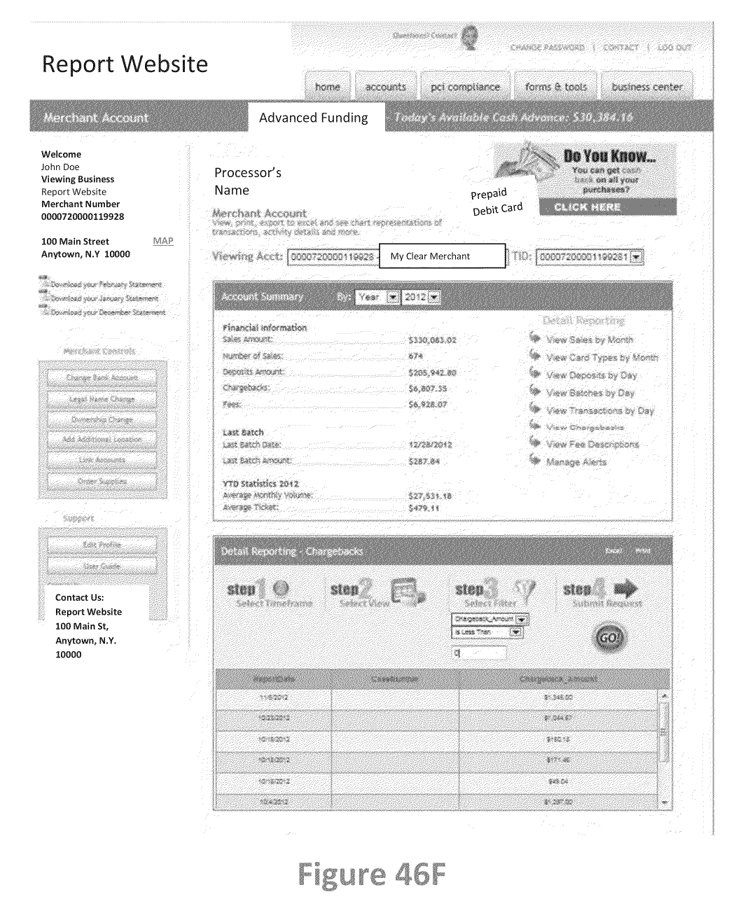

Upon selection of an item in box 1091 (to view chargebacks by month) in FIG. 40, a card type screen 1218 shown in FIG. 46 is provided. In the card type screen 1218, sales are combined based on credit card types. FIG. 46A through 46E depict merchant account screens for view chargebacks by month.

Upon selection of box 794 (to view fee descriptions) in FIG. 20, a fees screen 826 is provided as shown in FIG. 20J. Fees screen 826 provides fees sorted by month, types of fees, count and fees.

Upon selection of an item in box 1091 (to view fee descriptions) in FIG. 40, a card type screen 1240 shown in FIG. 47 is provided. In the card type screen 1240, sales are combined based on credit card types. FIG. 47A through 47F depict merchant account screens for viewing fee descriptions.

### Advanced Fund Merchant Financing

Merchants have the ability to request funds as an advance from their future credit card receivables.

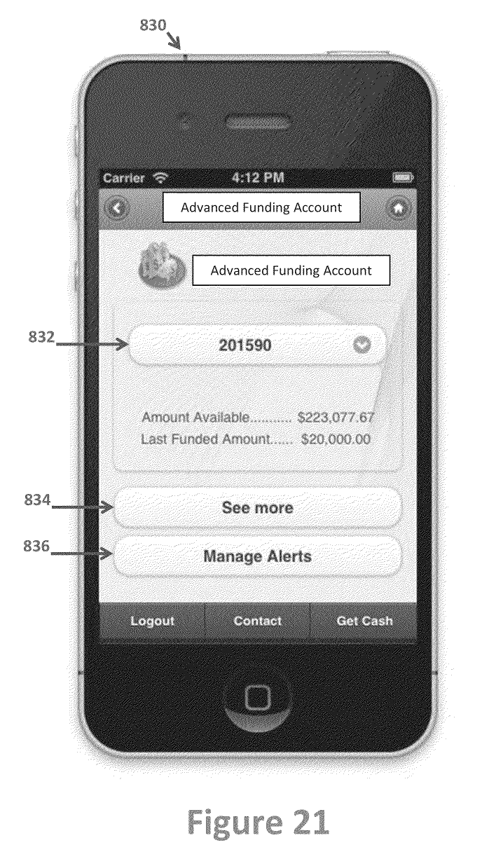

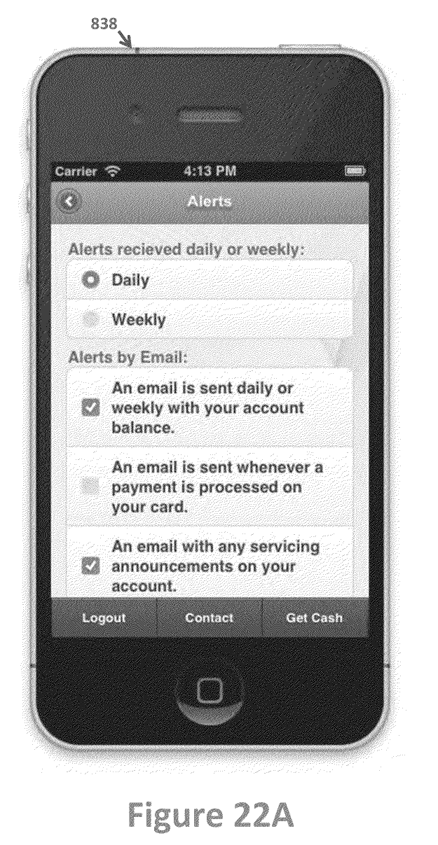

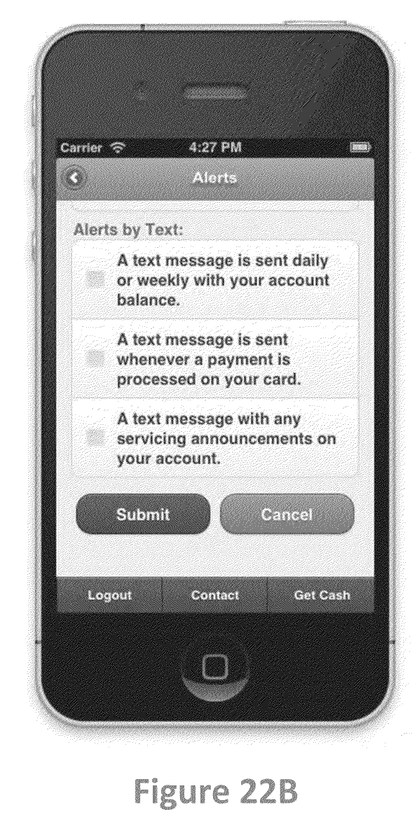

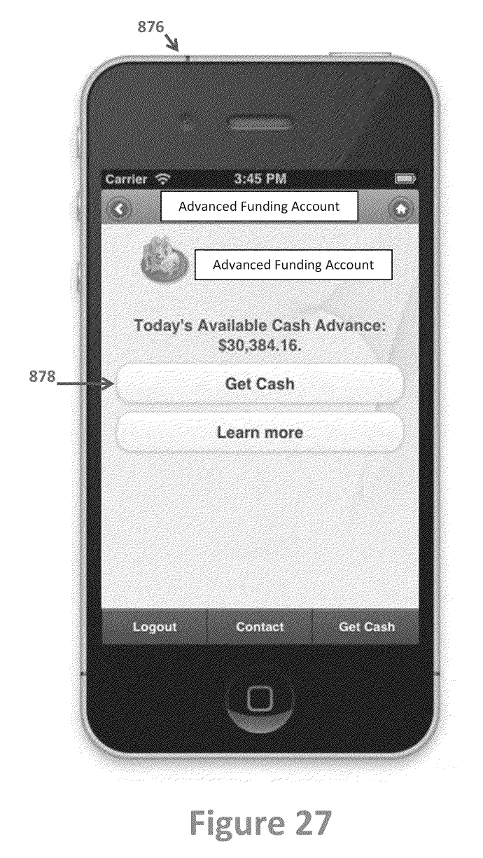

Returning to FIG. 17, upon selection of box 730, the advanced funding account is provided. FIG. 21 depicts an advanced funding account screen 830, in accordance with an embodiment. Box 832 provides a number of a particular advanced funding account. Upon selection of the particular advanced funding account (or by default) the amount available and the last funded amount is shown. Advanced funding information of another advanced funding account may be provided by selection of the advanced funding account. Additional options to see more information and to manage alerts may be provided. Upon selection of box 834, the see more option, the screen depicted in FIG. 27 is provided. Upon selection of box 836, the manage alerts option, the screen depicted in FIG. 22A is provided.

FIG. 27 depicts another advanced funding account screen, in accordance with an embodiment. Advanced funding account screen 876 provides available cash options. Upon selection of button 878, the get cash option, cash is transferred to the merchant's account. The cash may be transferred using any of a variety of methods including sending the cash directly to the merchant's bank account.

The report website FIG. 48 depicts another advanced funding account screen, in accordance with an embodiment. Advanced funding account screen 1268 provides available cash options. Upon selection of button 1270, the get cash option, cash is transferred to the merchant's account. The cash may be transferred using any of a variety of methods including sending the cash directly to the merchant's bank account.

FIG. 22A depicts an alerts screen associated with the advanced funding account, in accordance with an embodiment. The merchant may select one or more alerts from alerts screen 838. The merchant may wish to receive daily or weekly alerts associated with his/her merchant account by email and/or by text. Some exemplary alerting options are shown in alerts screen 838.

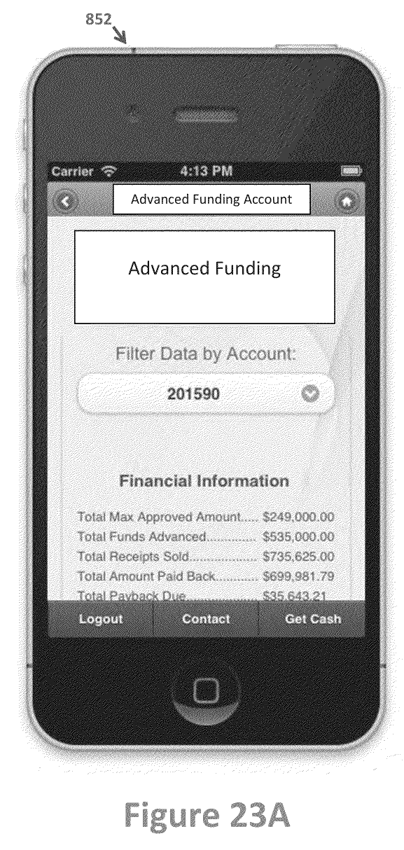

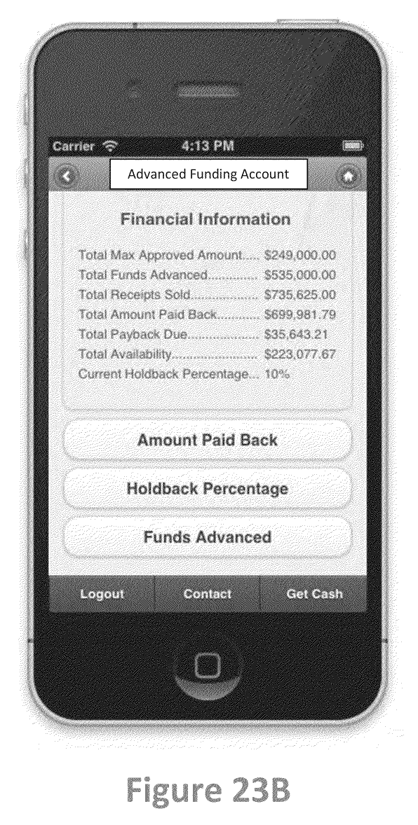

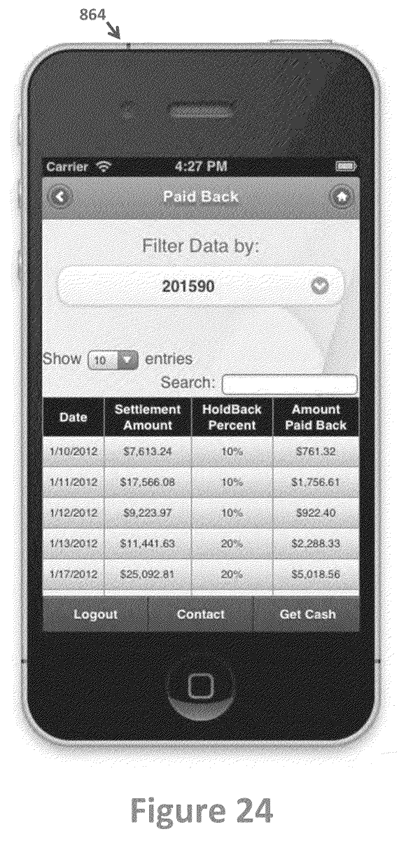

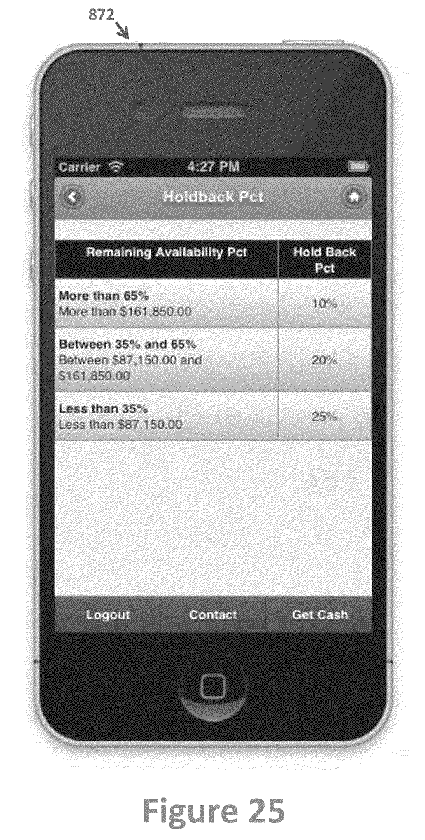

FIG. 23A depicts an additional advanced funding account screen 852, in accordance with an embodiment. Various information associated with a particular advanced funding account (i.e., account number 201590) is shown, including details regarding financial information, amount paid back, holdback percentage, and funds available. Additional information regarding the particular advanced fund account may also be provided.

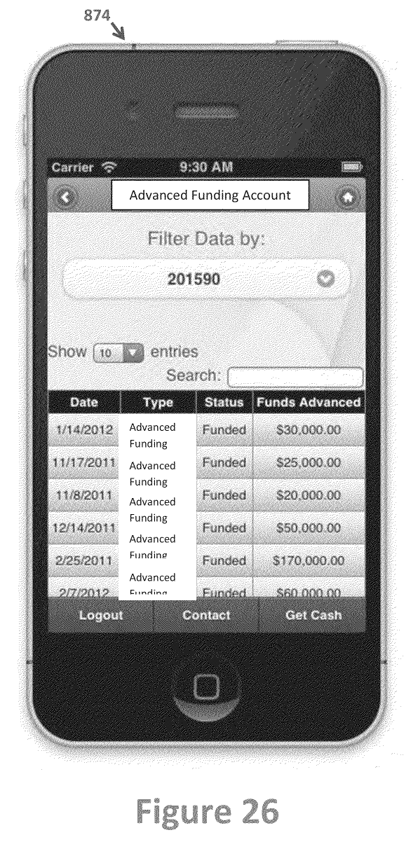

FIG. 26 depicts an advanced funding screen 874, in accordance with an embodiment. Advanced funding screen 874 sorts funds by date, and provides information regarding the type of fund, the status and funds advanced.

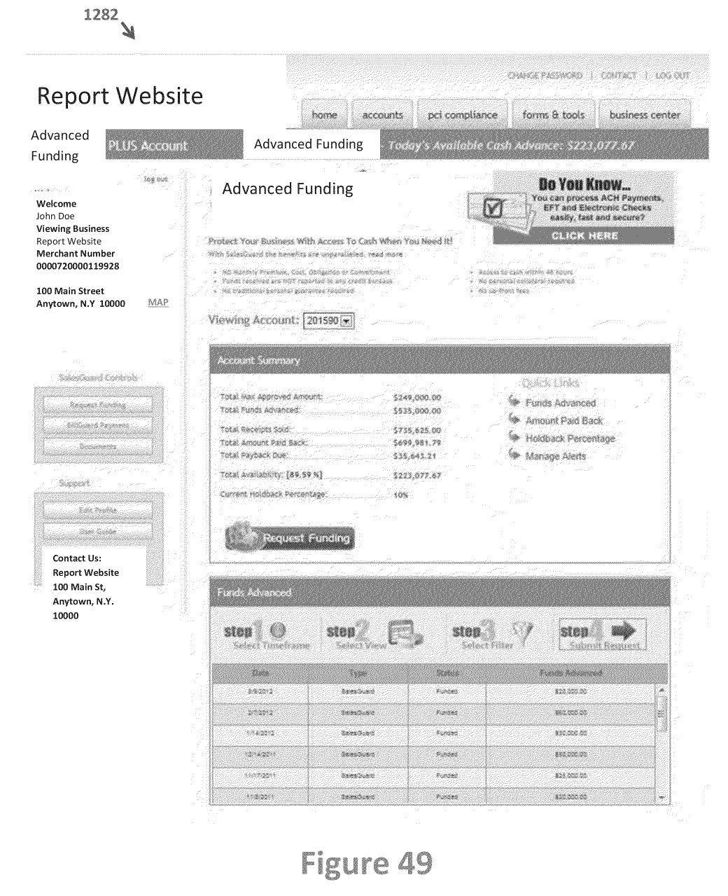

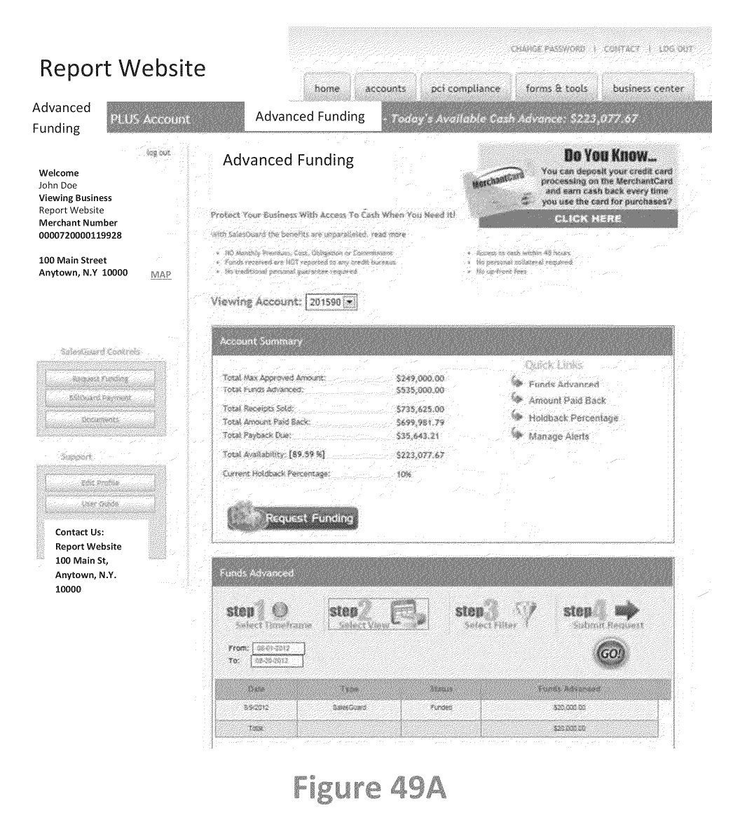

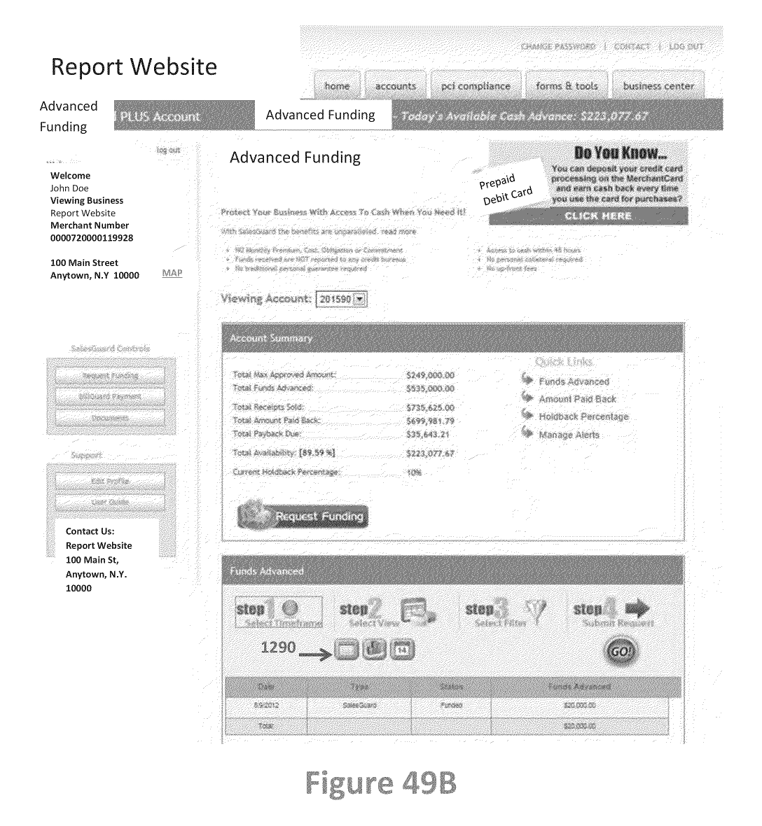

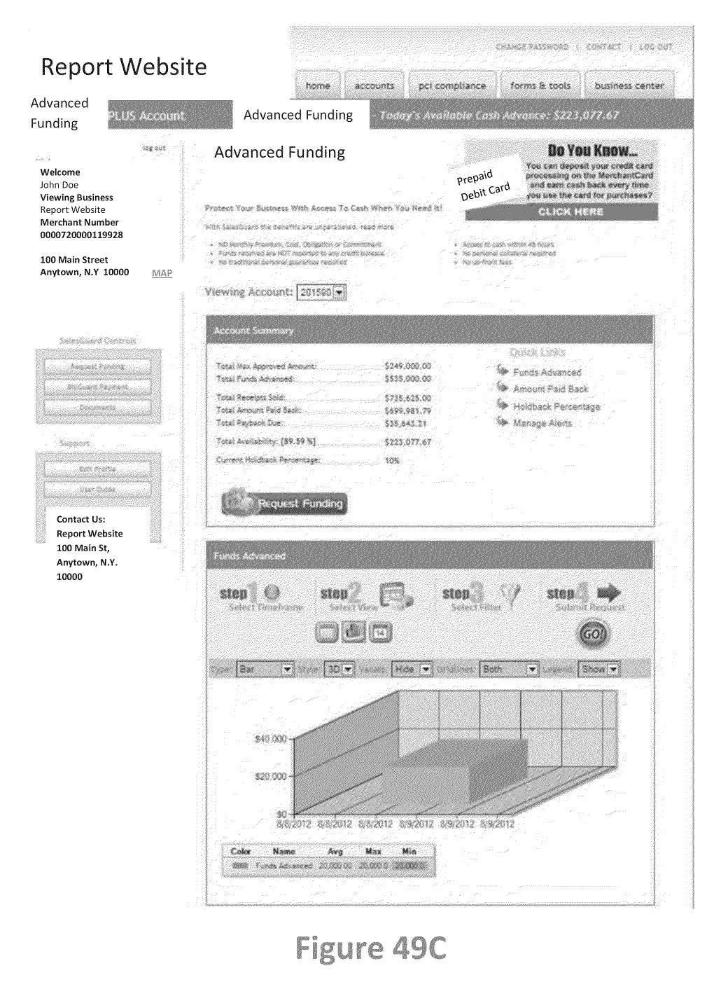

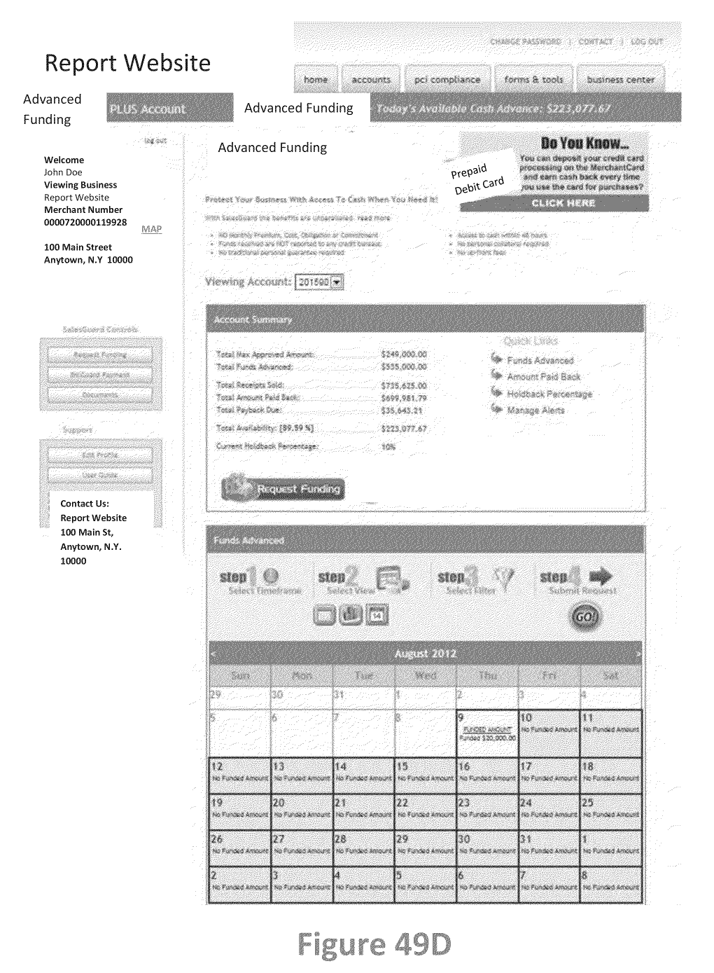

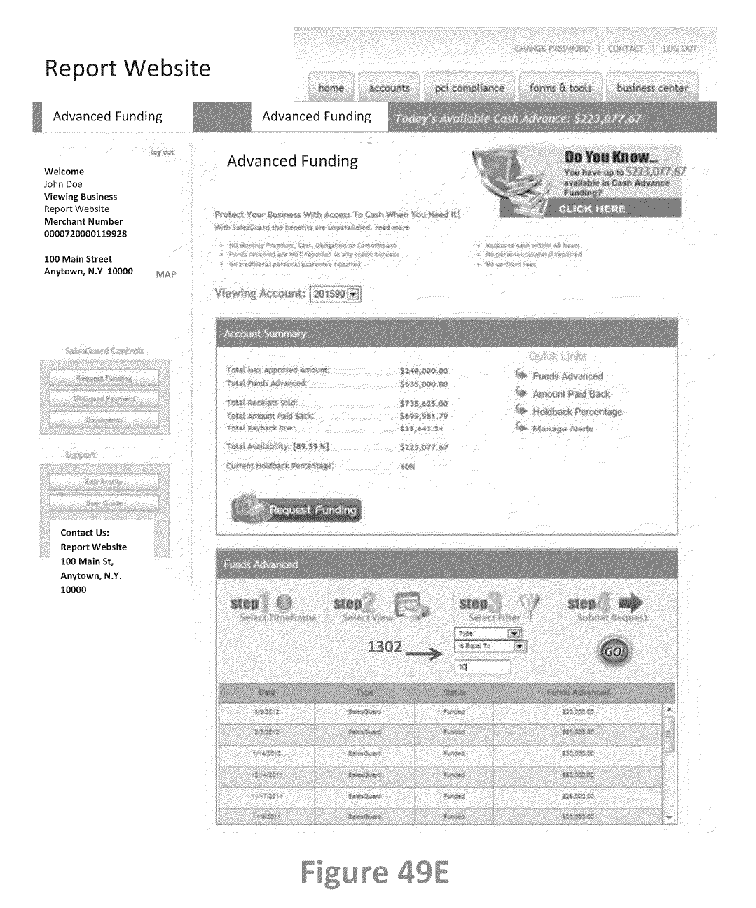

The report website FIG. 49 depicts another advanced funding account screen, in accordance with an embodiment. The funds advanced information is displayed in another advanced funding account screen 1282. FIG. 49A through 49E depict screens for funds advance.

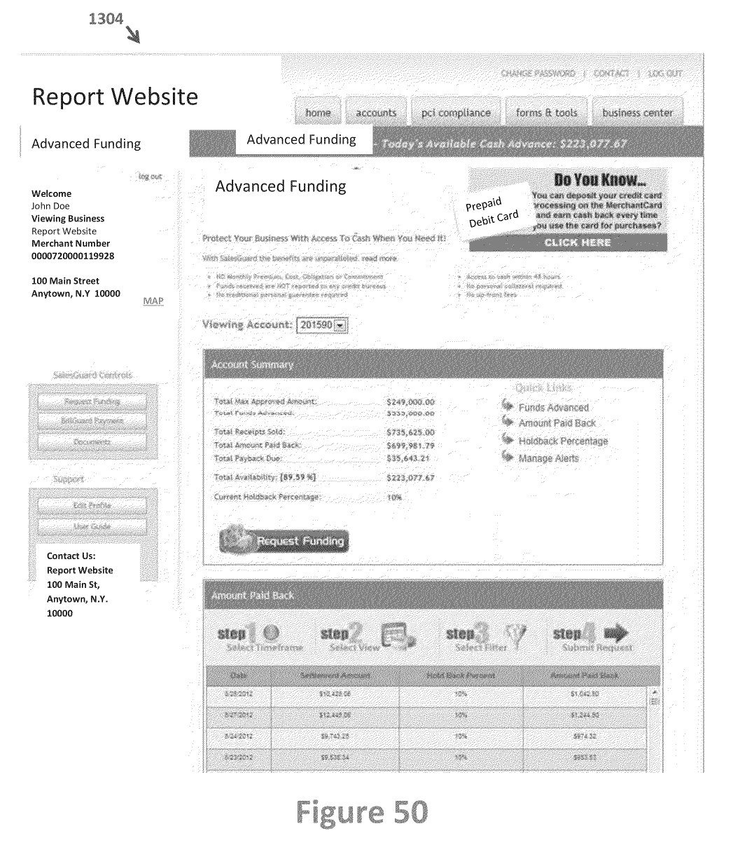

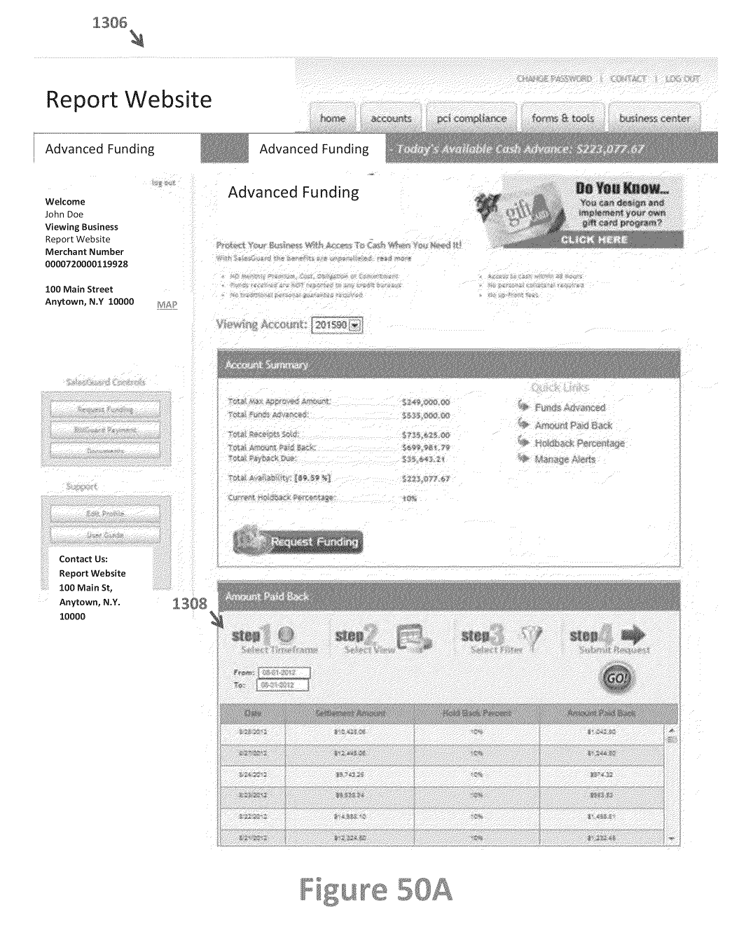

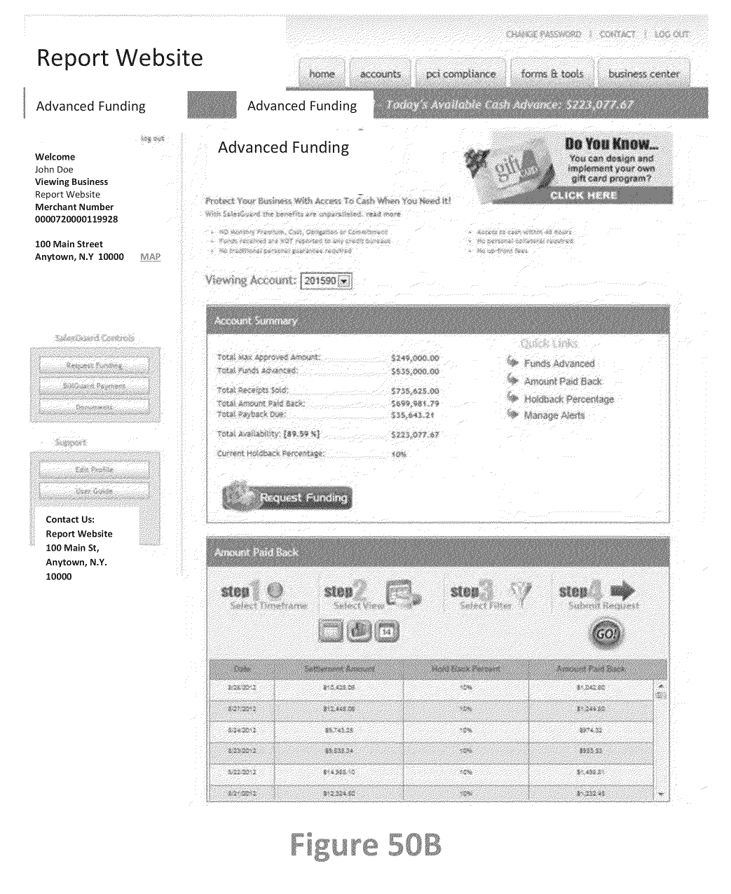

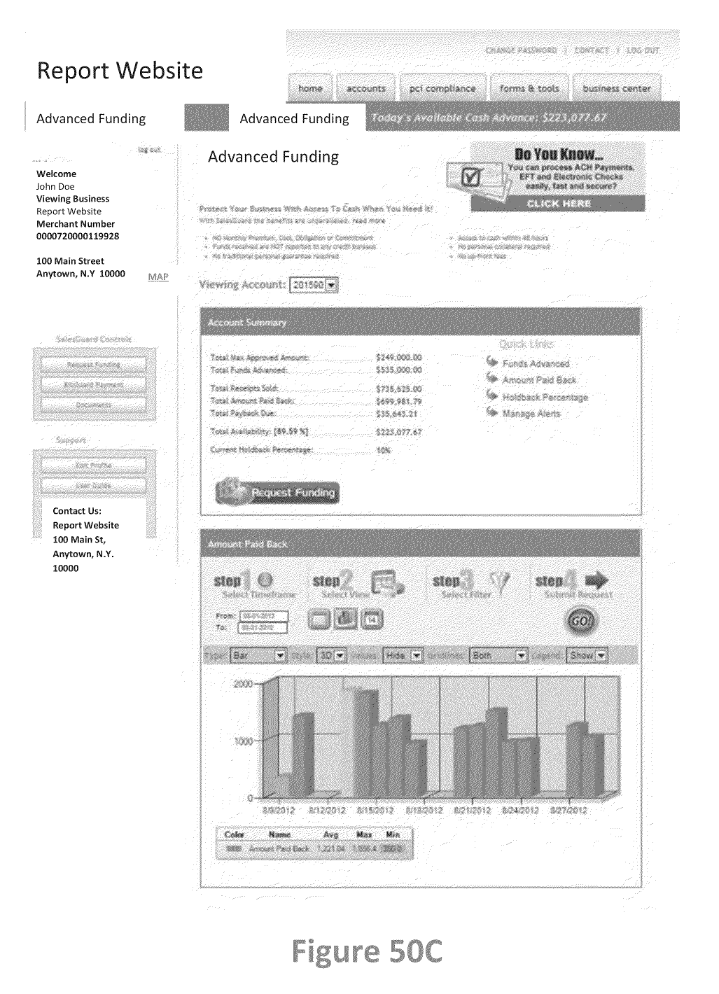

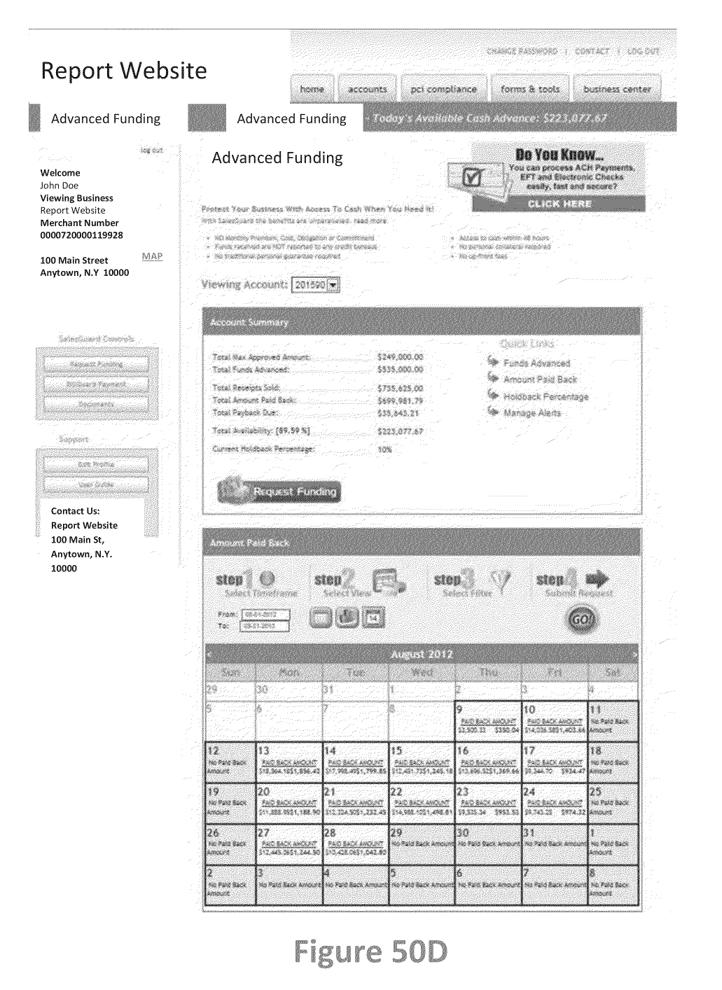

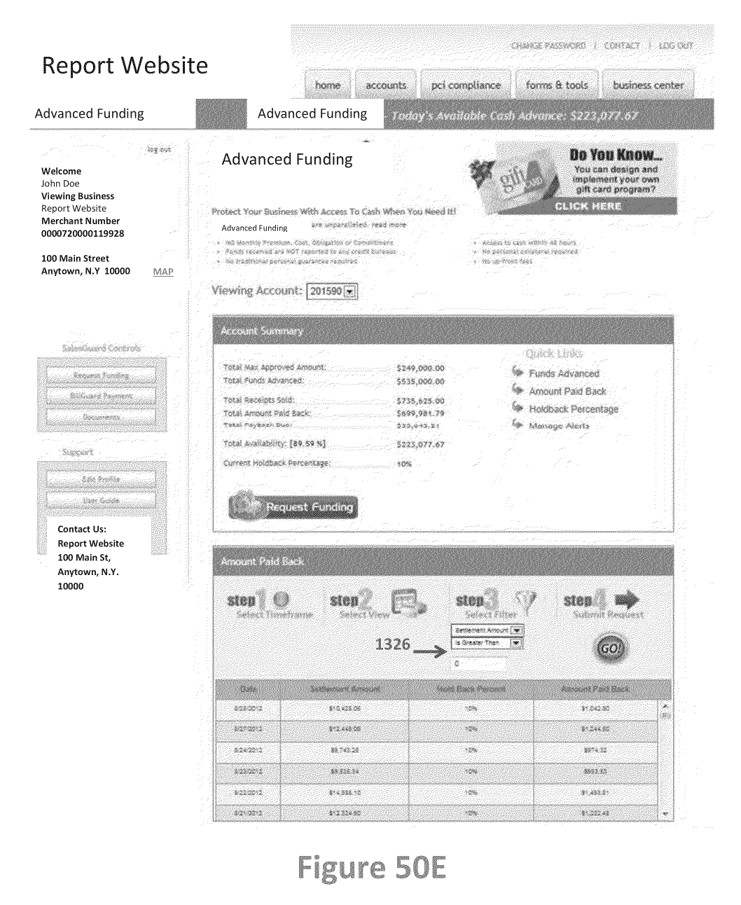

For the report website FIG. 50 depicts another advanced funding account screen, in accordance with an embodiment. The amount paid back information is displayed 1304. FIG. 50A through 50E depict universal screens for funds advance.

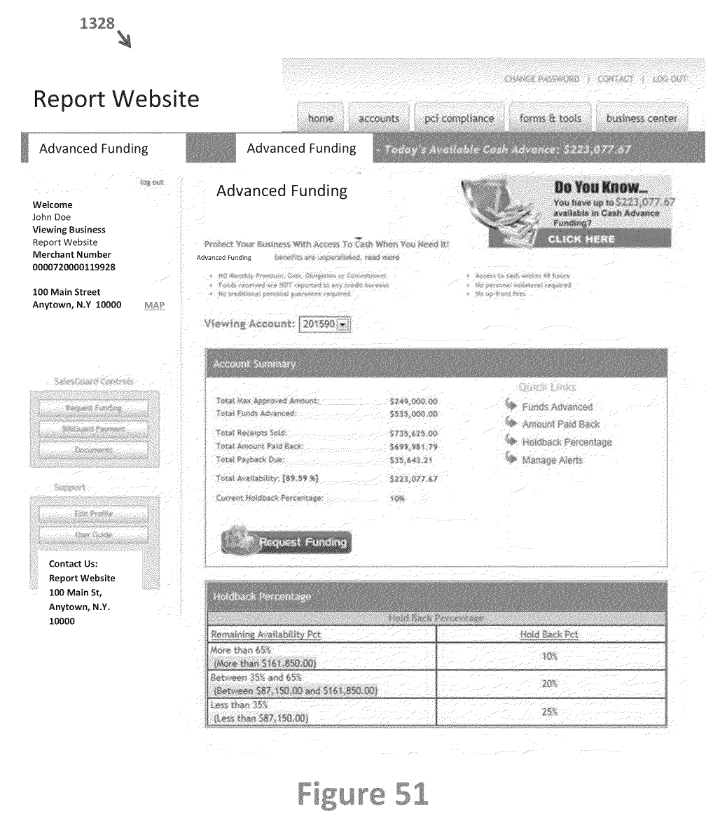

The report website FIG. 51 depicts another advanced funding account screen, in accordance with an embodiment. The hold back percentage information is displayed in another advanced funding account screen 1328.

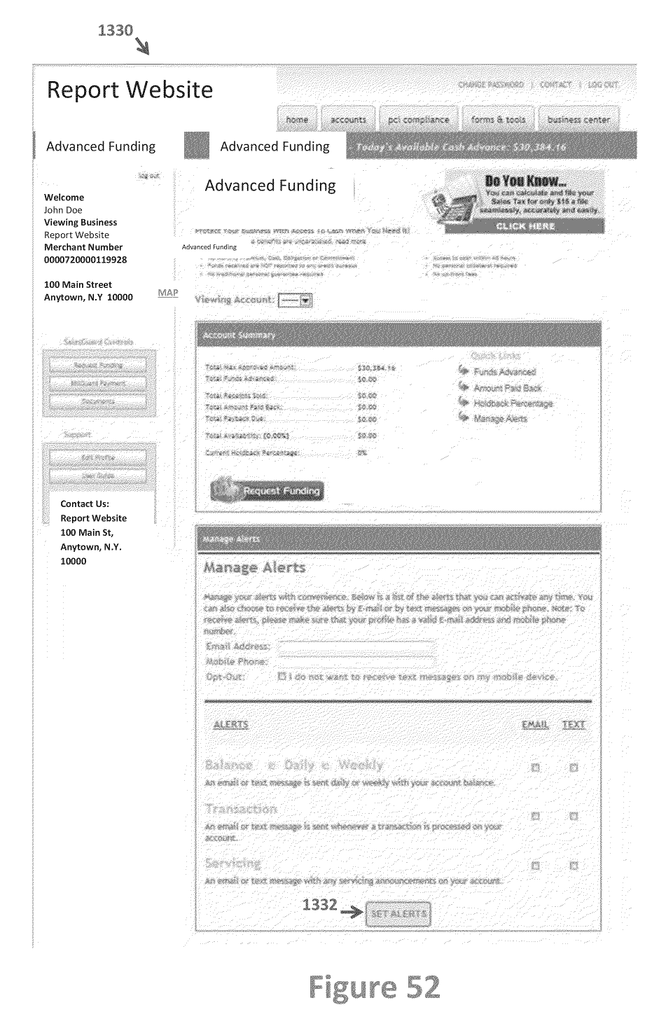

The report website FIG. 52 depicts another advanced funding account screen, in accordance with an embodiment. The manage alerts screen is displayed in another advanced funding account screen 1330.

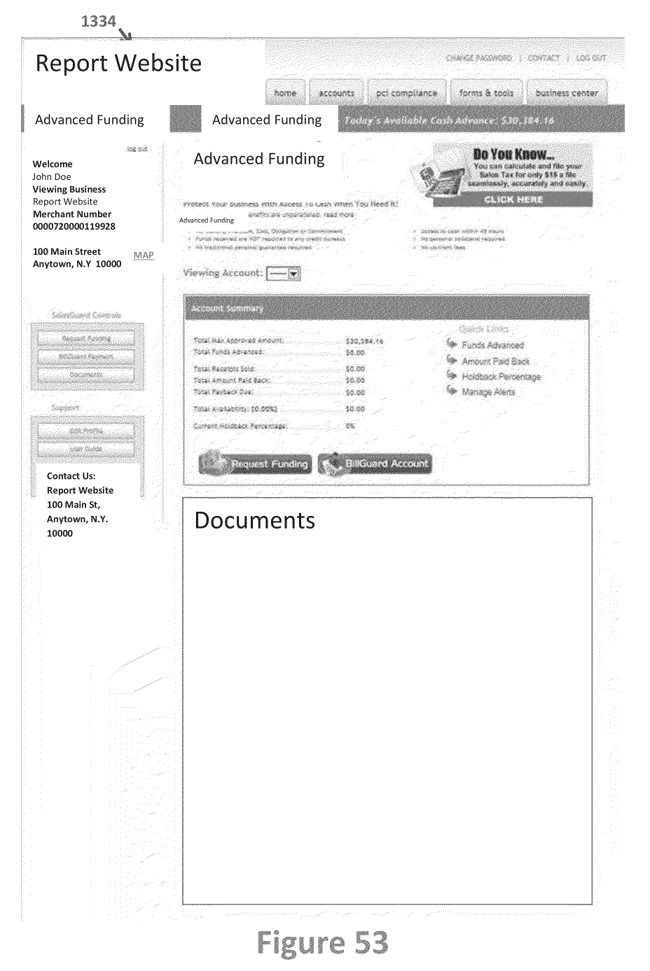

The report website FIG. 53 depicts another advanced funding account screen, in accordance with an embodiment. The advanced funding documents are displayed in another advanced funding account screen 1334.

### PCI

An easy, step-by-step self-assessment questionnaire for merchants of financial service providers to become PCI compliant is provided. The questionnaire is fully automated and can be integrated for any organization, including custom certifications.

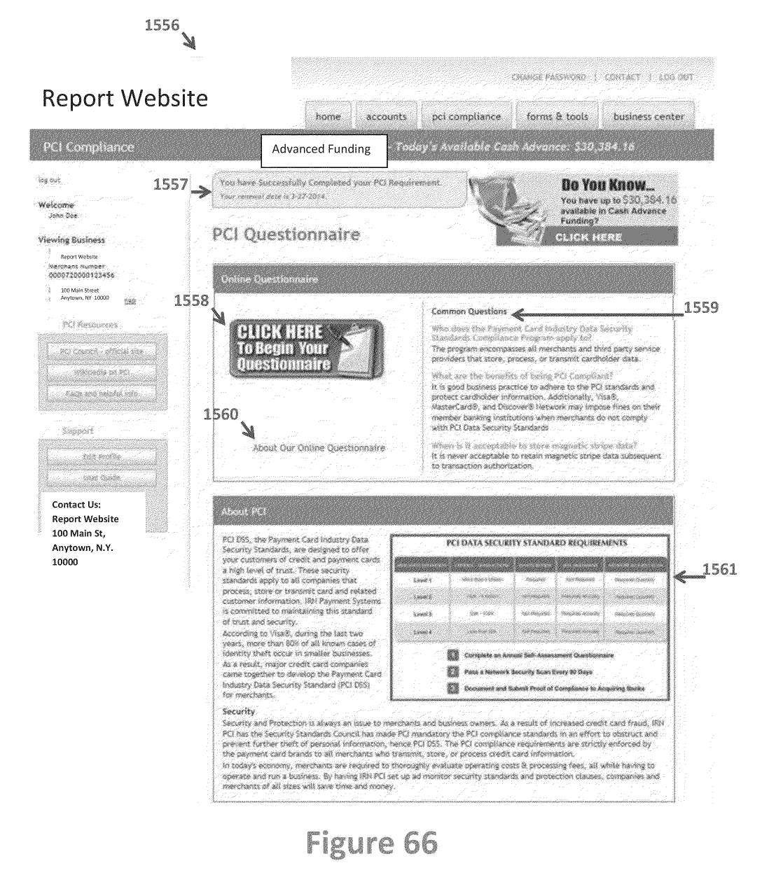

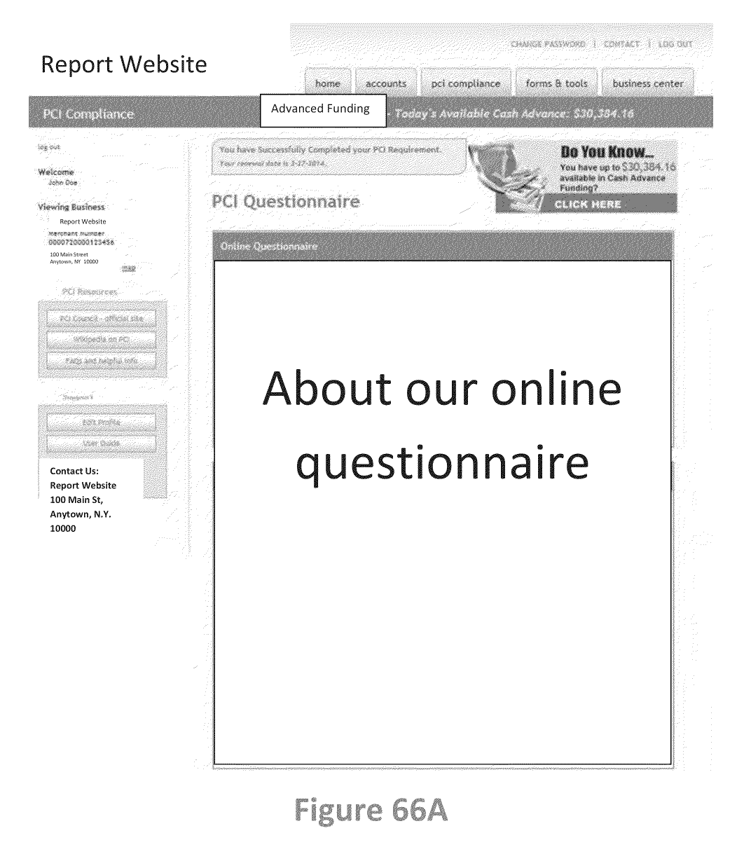

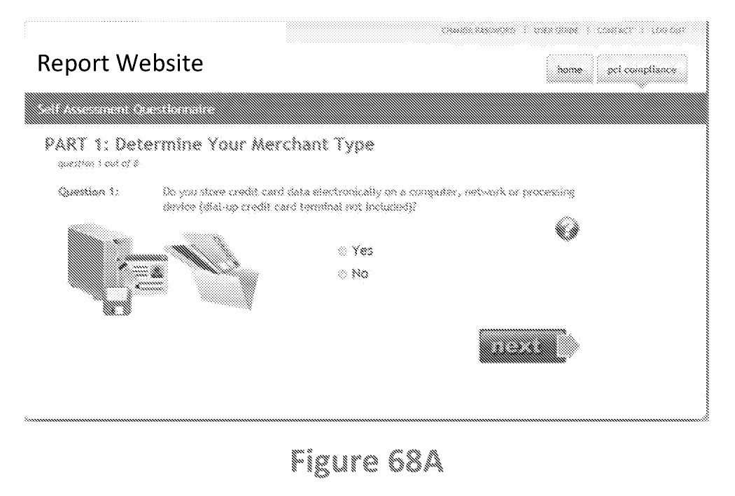

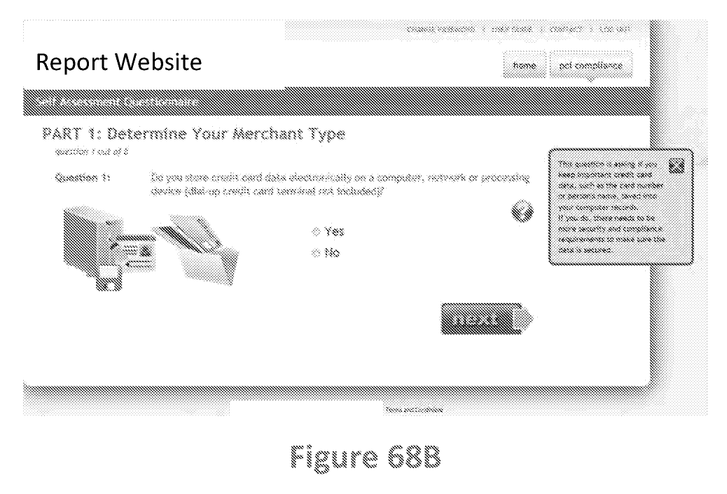

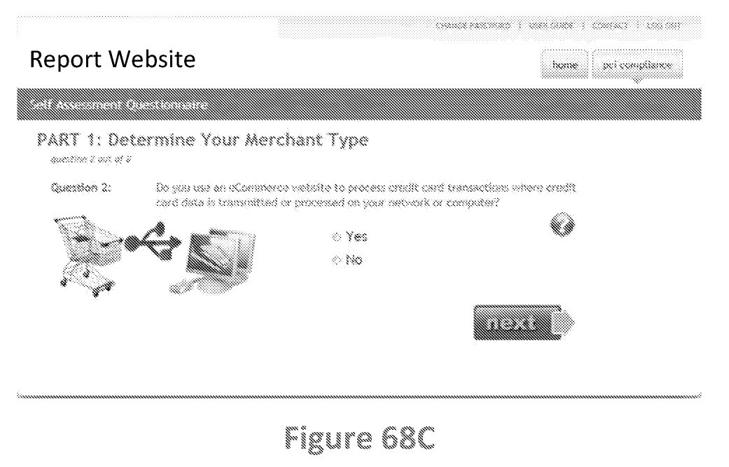

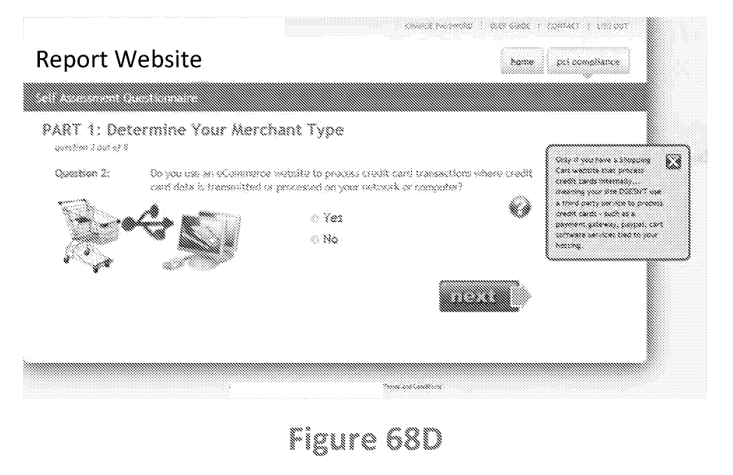

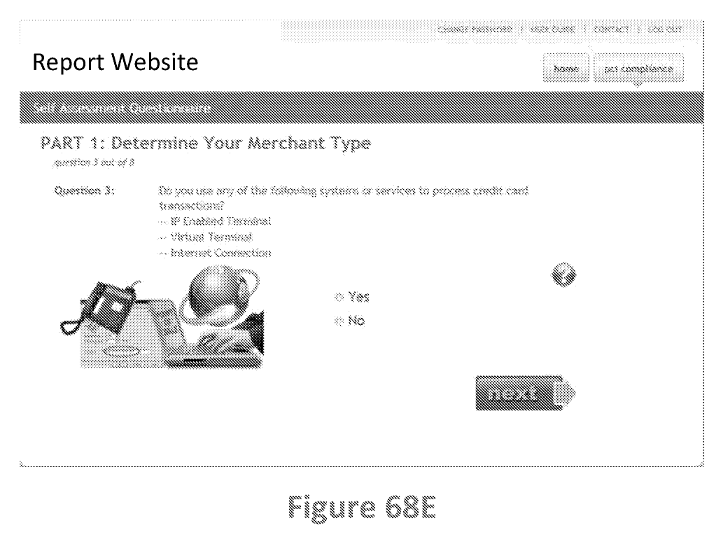

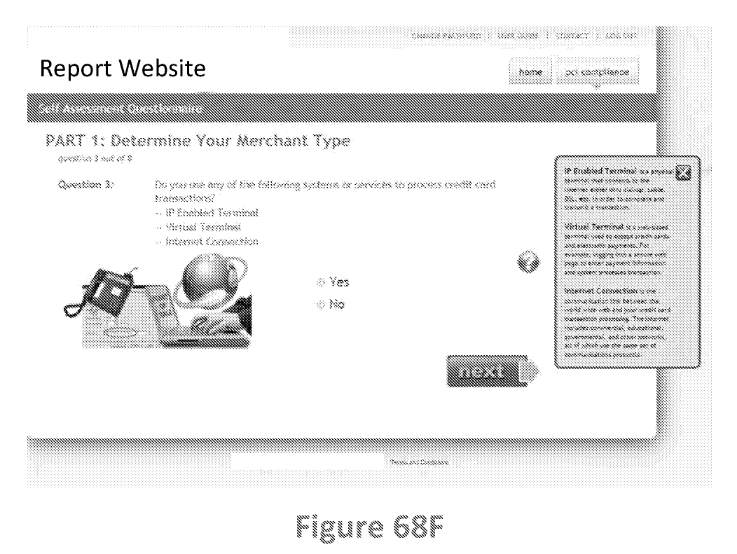

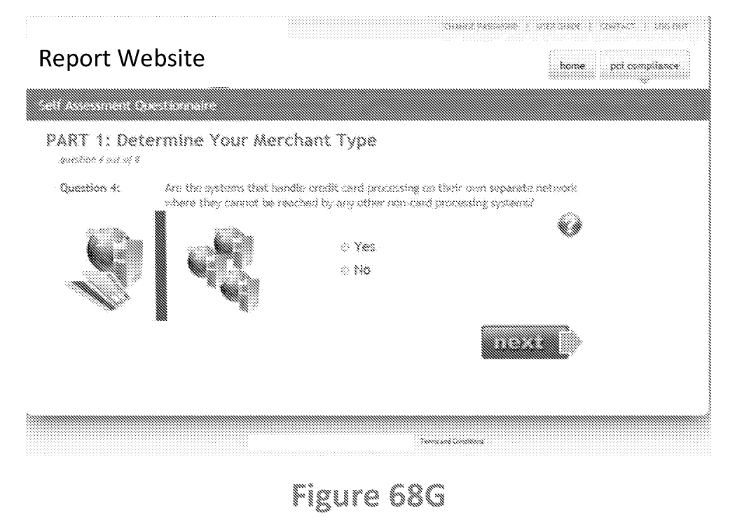

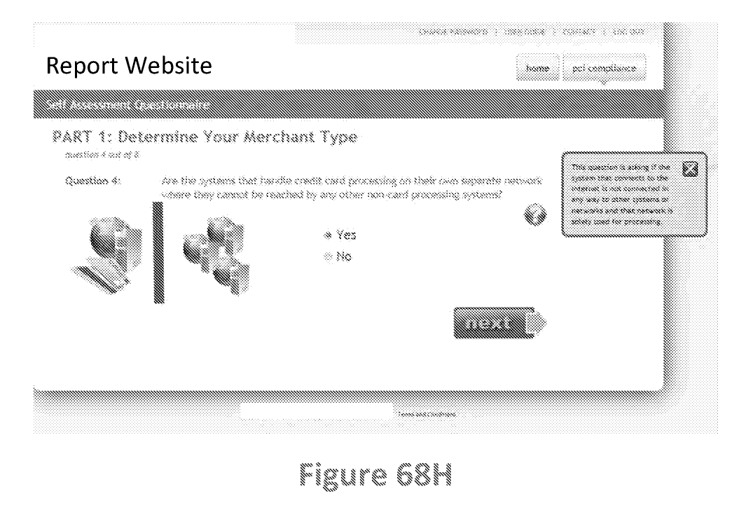

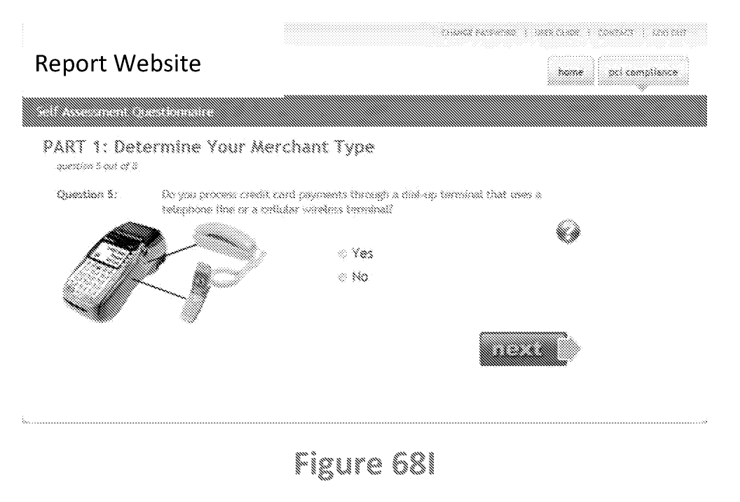

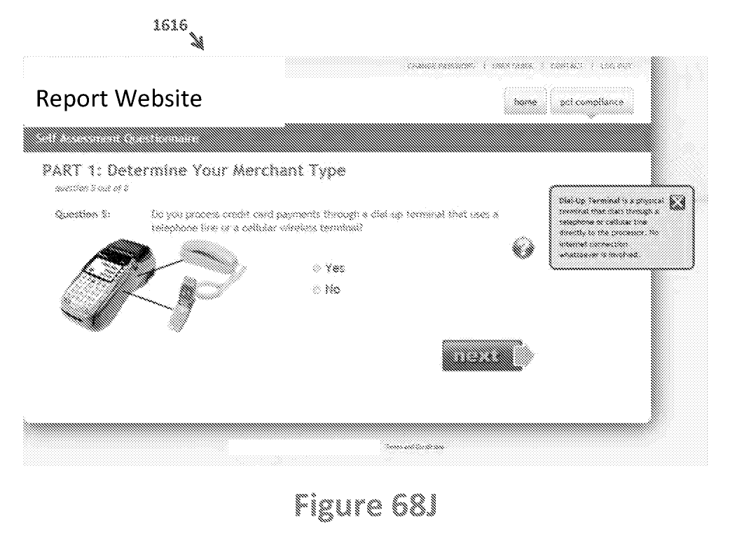

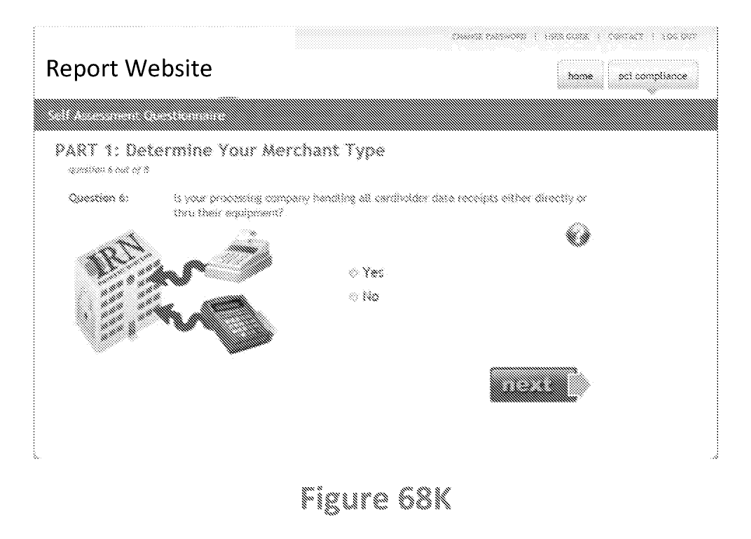

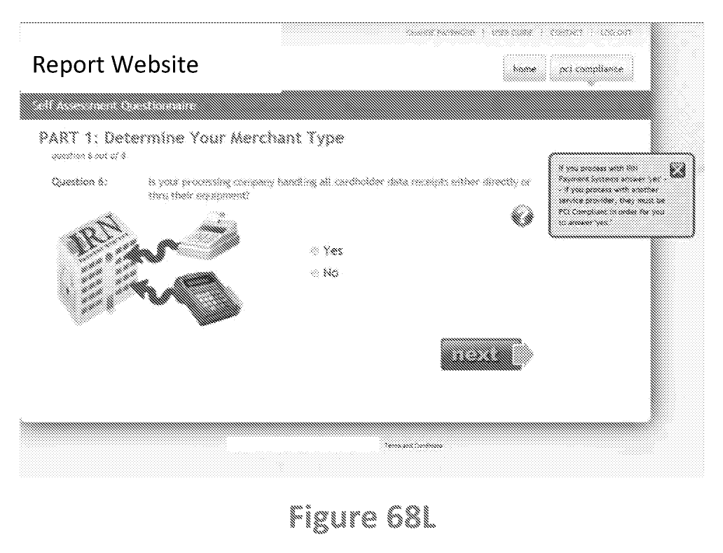

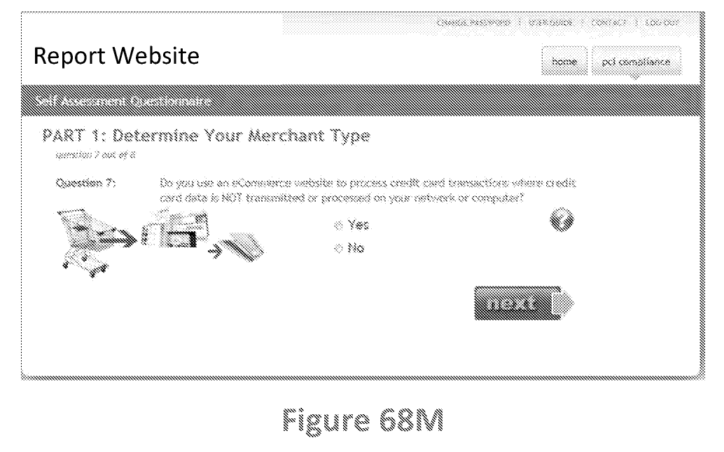

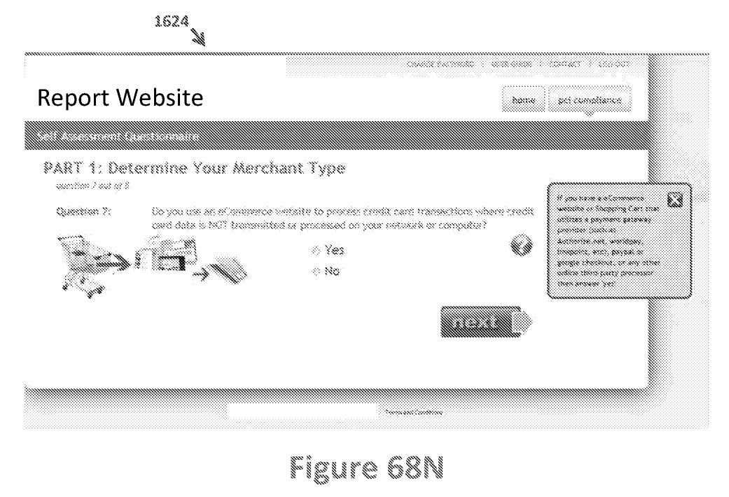

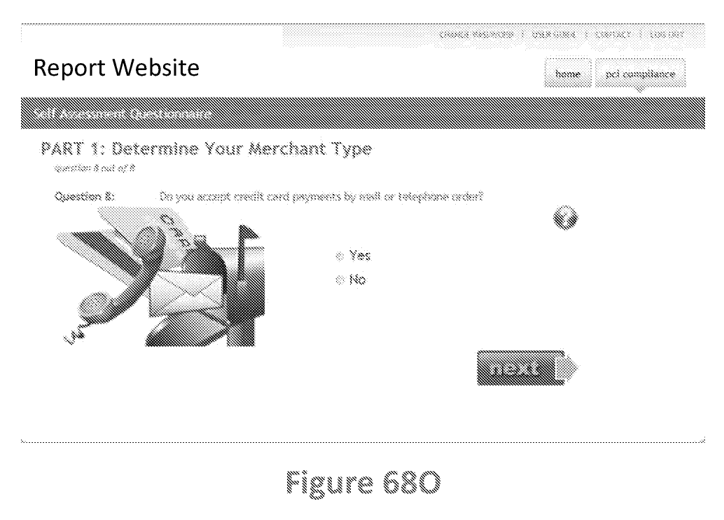

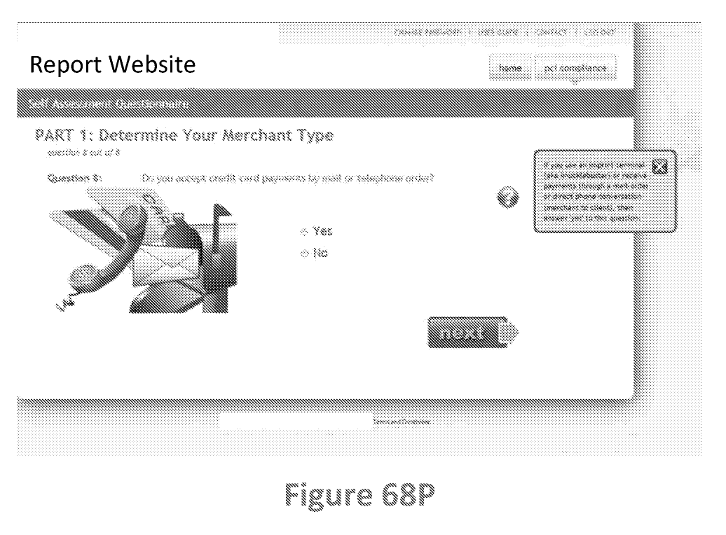

FIG. 66 depicts a PCI questionnaire screen 1556, according to an embodiment. In box 1557, a reminder message is provided for display. The reminder message states either “As of mm/dd/yyyy, you have NOT met our PCI security requirement. Please Complete our Online Questionnaire.” or “You have successfully completed your PCI requirement. Your renewal date is mm/dd/yyyy.” Box 1558 includes a clickable link to the questionnaire. Box 1559 displays some common questions. Link 1569 opens a new screen describing additional details regarding PCI. Box 1561 provides PCI data security standard requirements. The requirements may be provided for Level 1, Level 2, etc. By selecting box 1558 the merchant has the ability to complete an annual self-assessment questionnaire; run any necessary network security scans, which occur every 90 days; and document and submit proof of compliance to acquiring banks or processors. The questionnaire may include picture-guided options with additional help pop-ups for each question. Details regarding the questionnaire are described with respect to FIGS. 68 through 71. Once the questionnaire is successfully completed, the merchant can print out their PCI certificate 71A.

Referring now to FIG. 6B which is flowchart depicting a method of determining PCI, in accordance with an embodiment, the method of obtaining a PCI certificate is described.

Suppose that a merchant employing merchant device 103 wishes to become PCI compliant. The merchant sends a request to reports server 101, via network 104, to begin the PCI compliance questionnaire depicted in FIG. 66A. At step 620, the server receives a request for a processing card industry compliance certificate from a merchant employing a device. Reports server 101 receives a request from merchant device 103, shown in FIG. 1, for a PCI certificate, from network 104.

At step 622, the server authenticates the device. Reports server 101 authenticates merchant device 103 (e.g., by using a known authentication process).

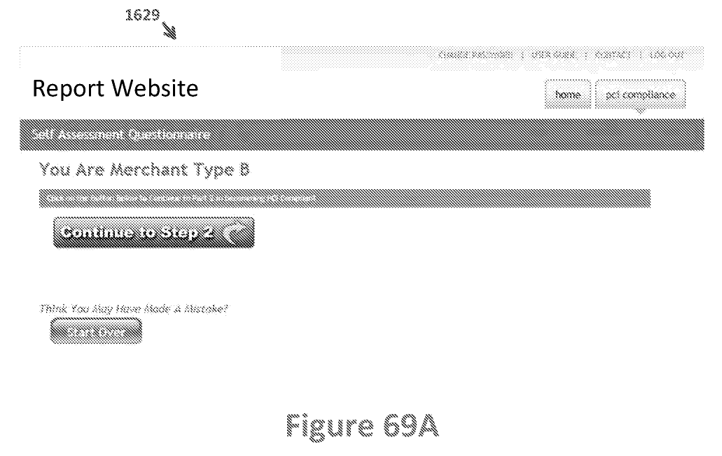

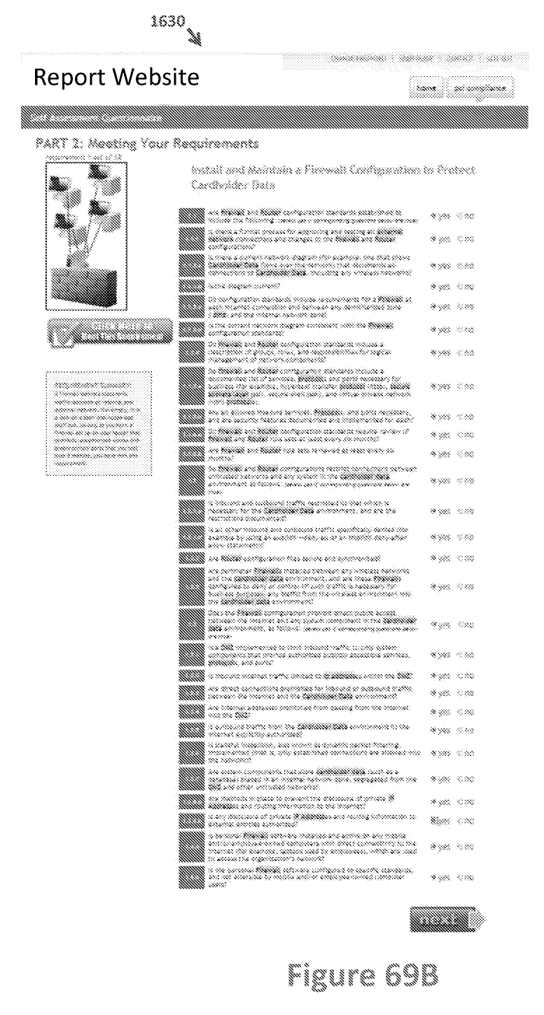

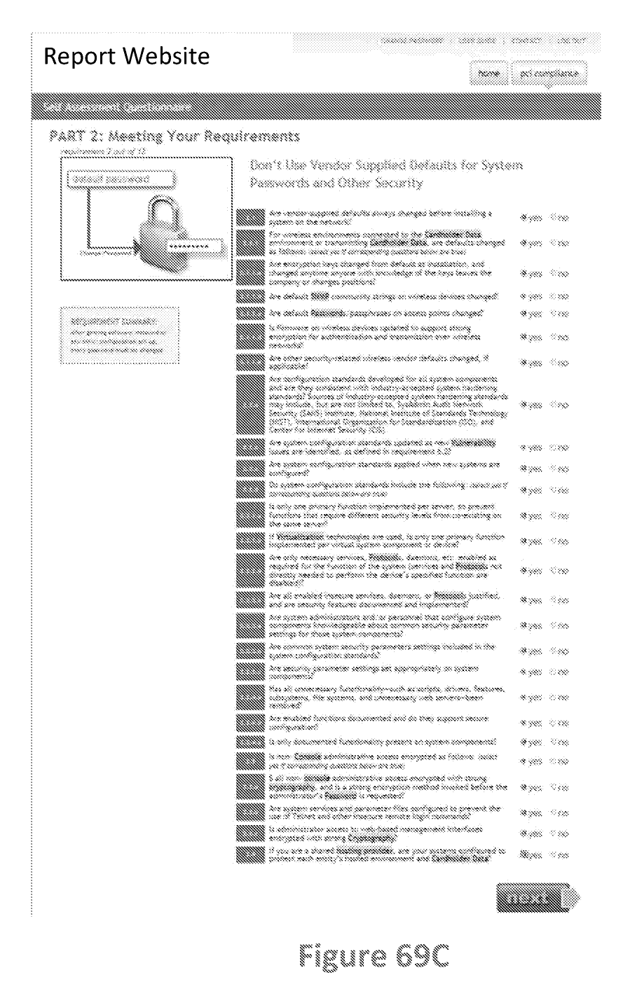

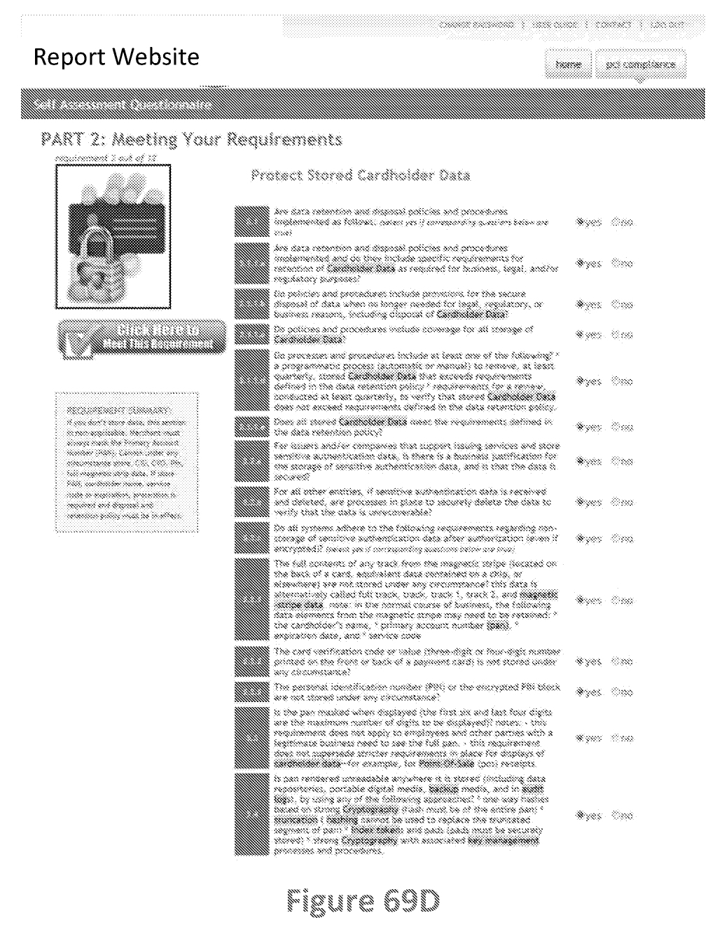

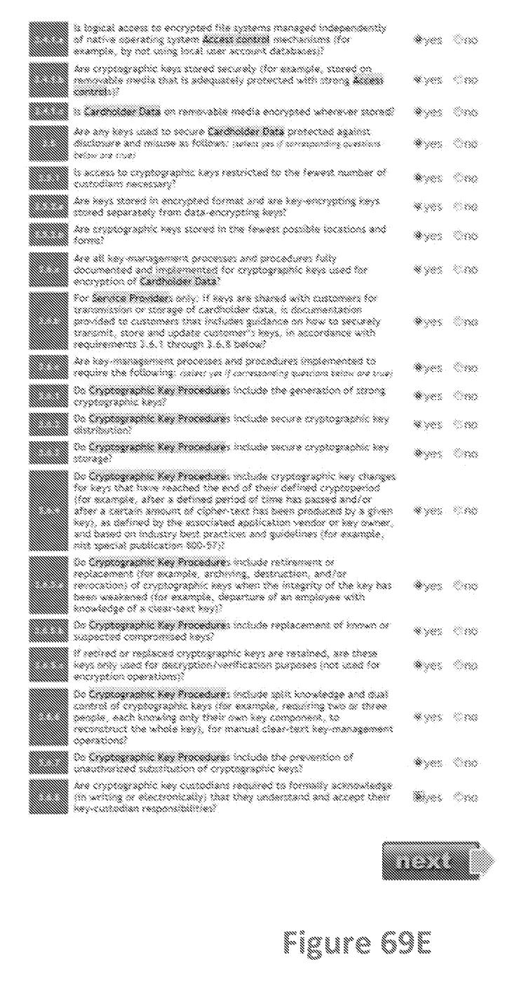

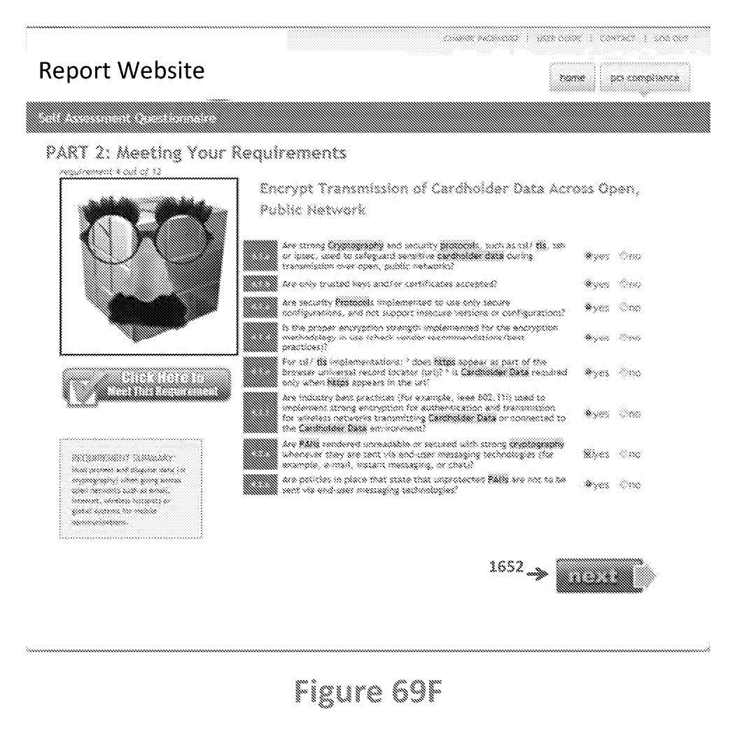

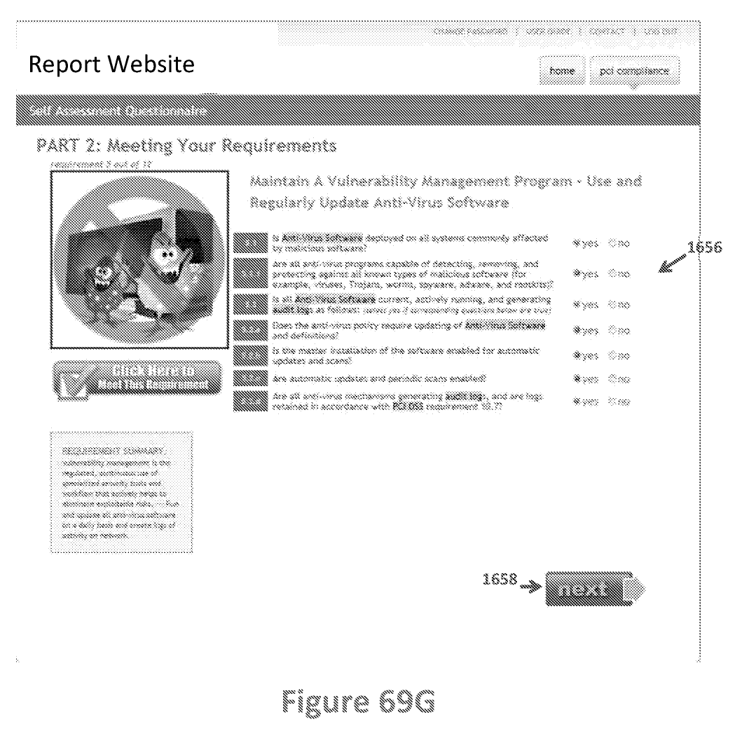

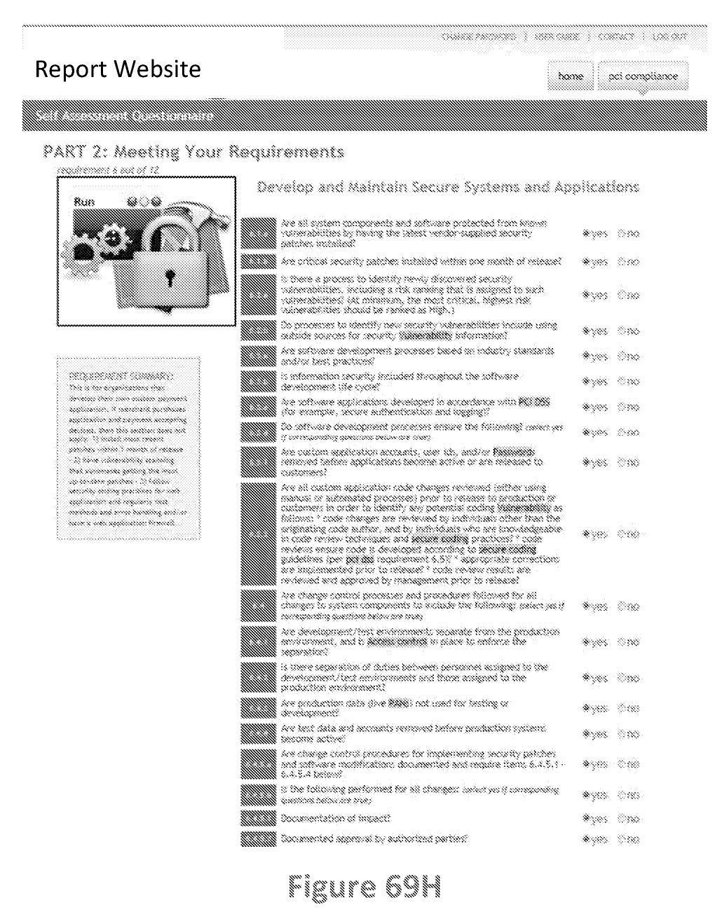

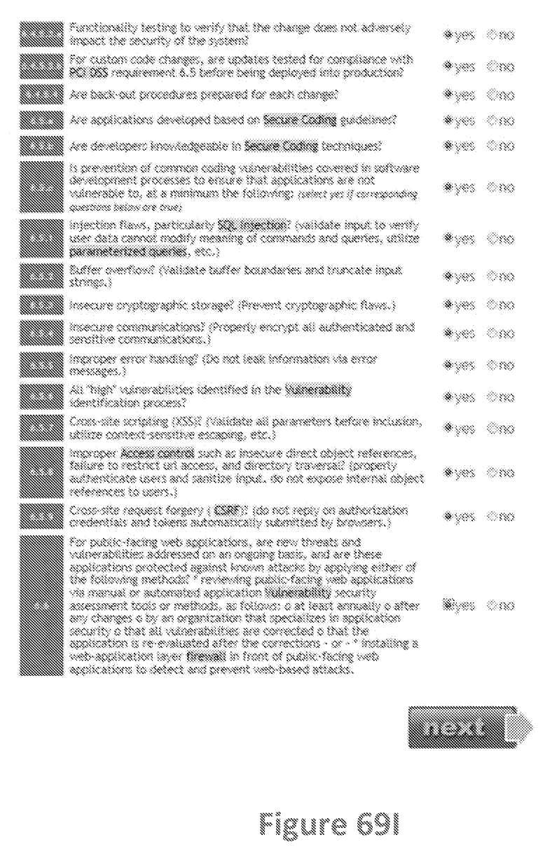

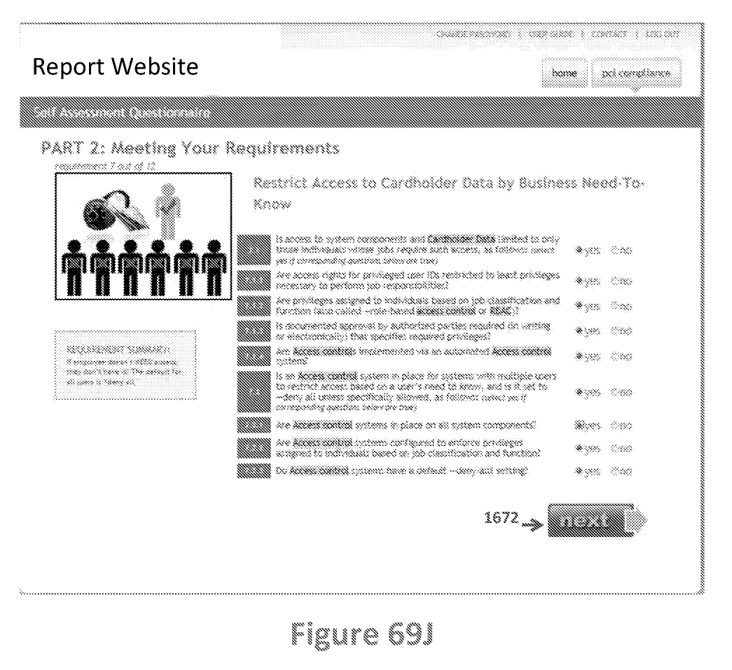

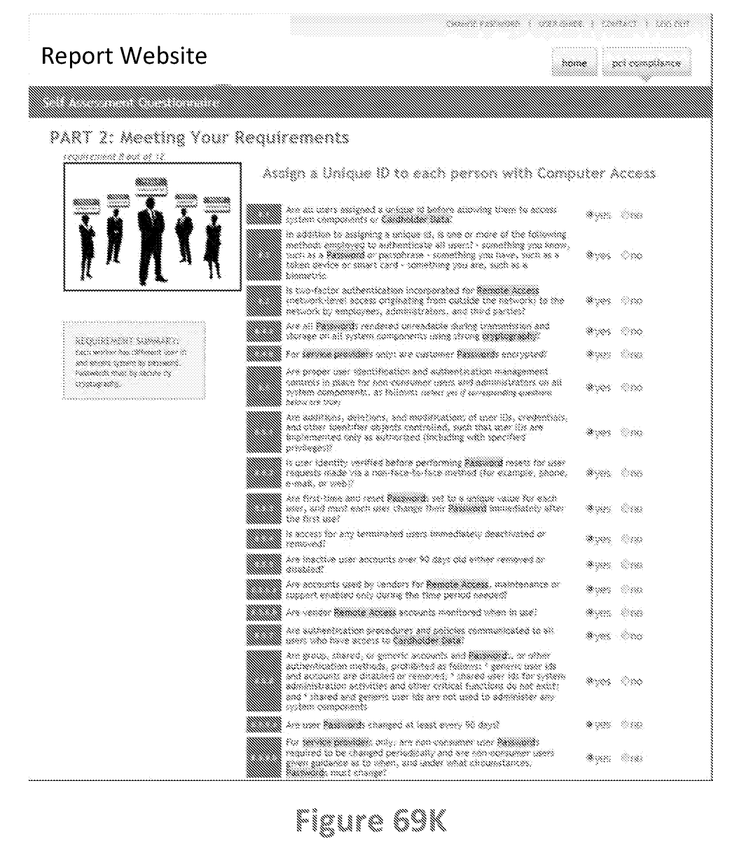

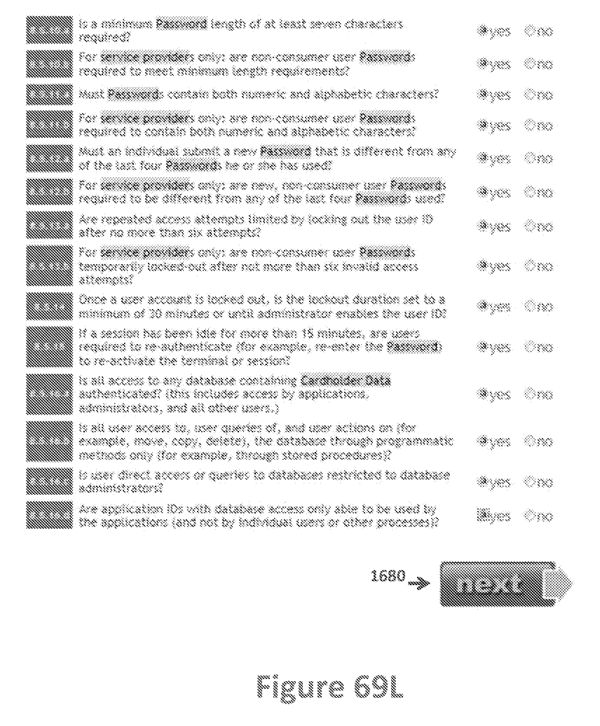

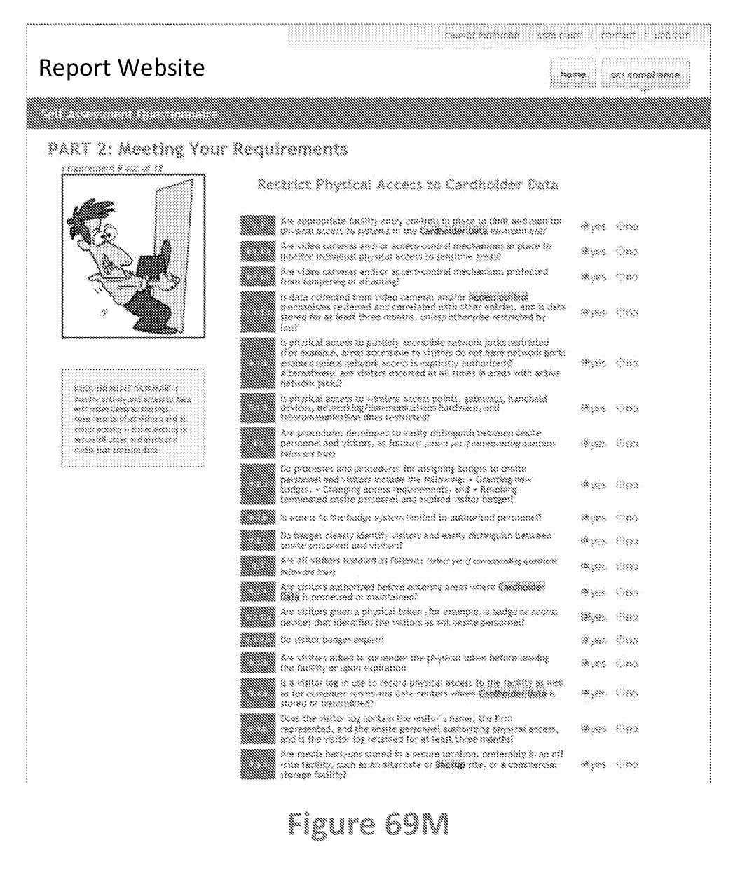

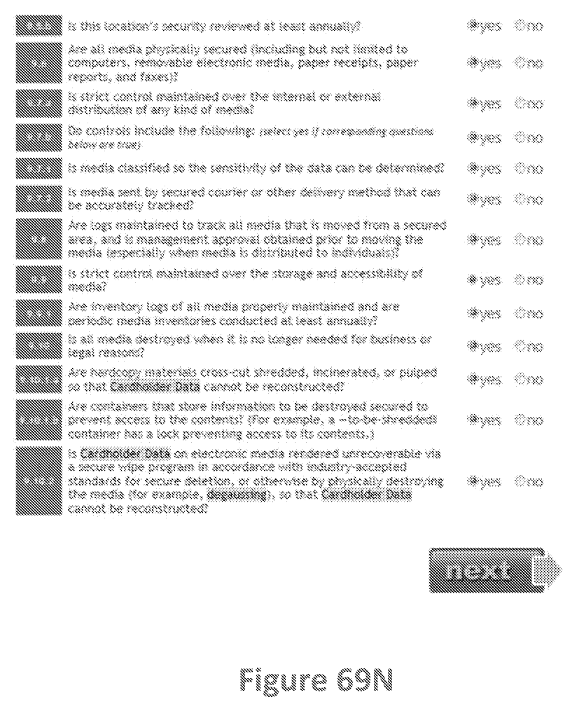

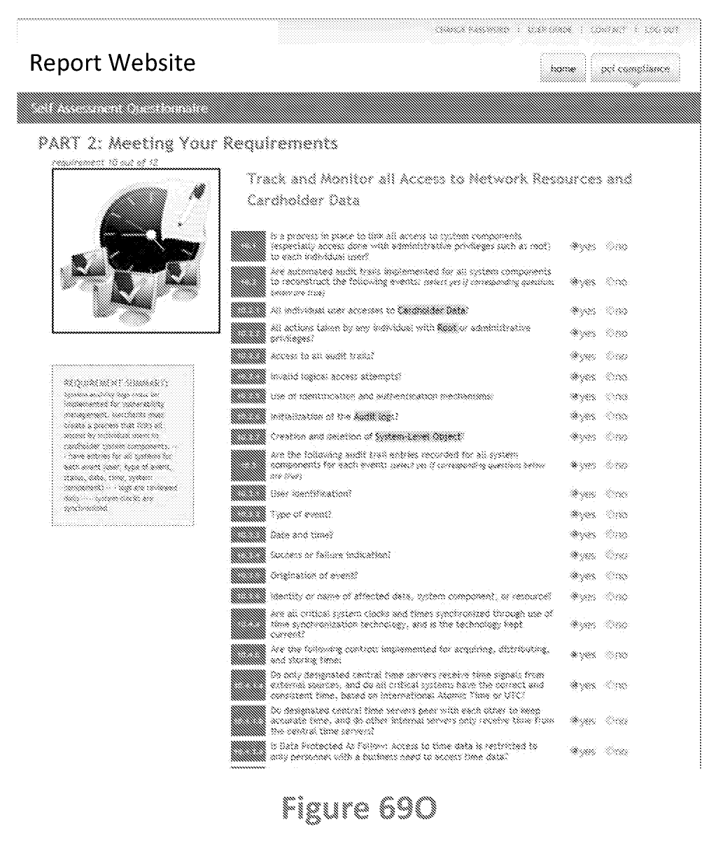

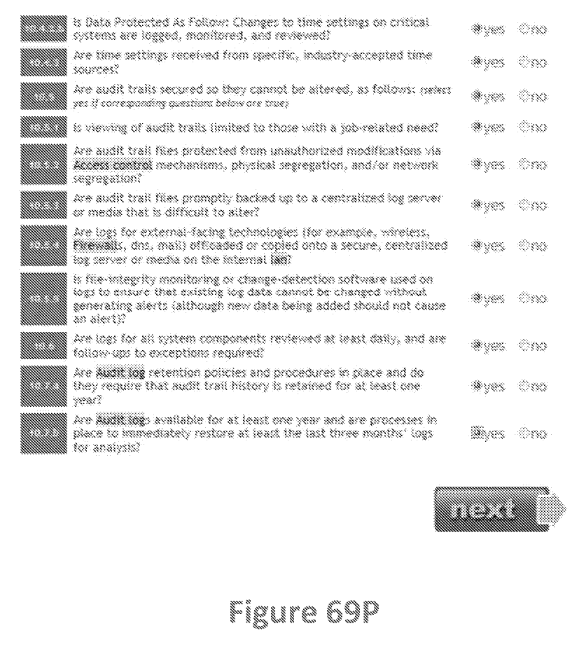

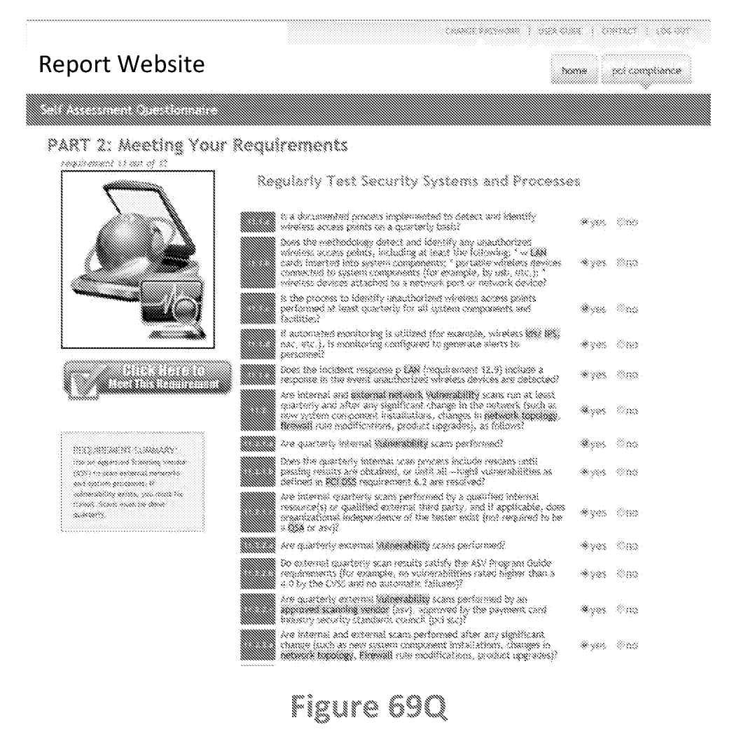

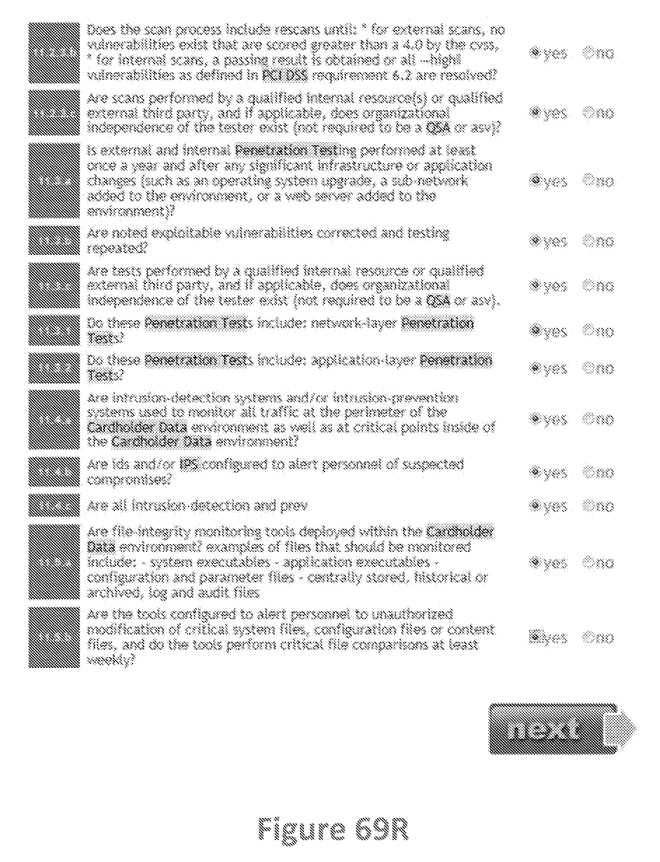

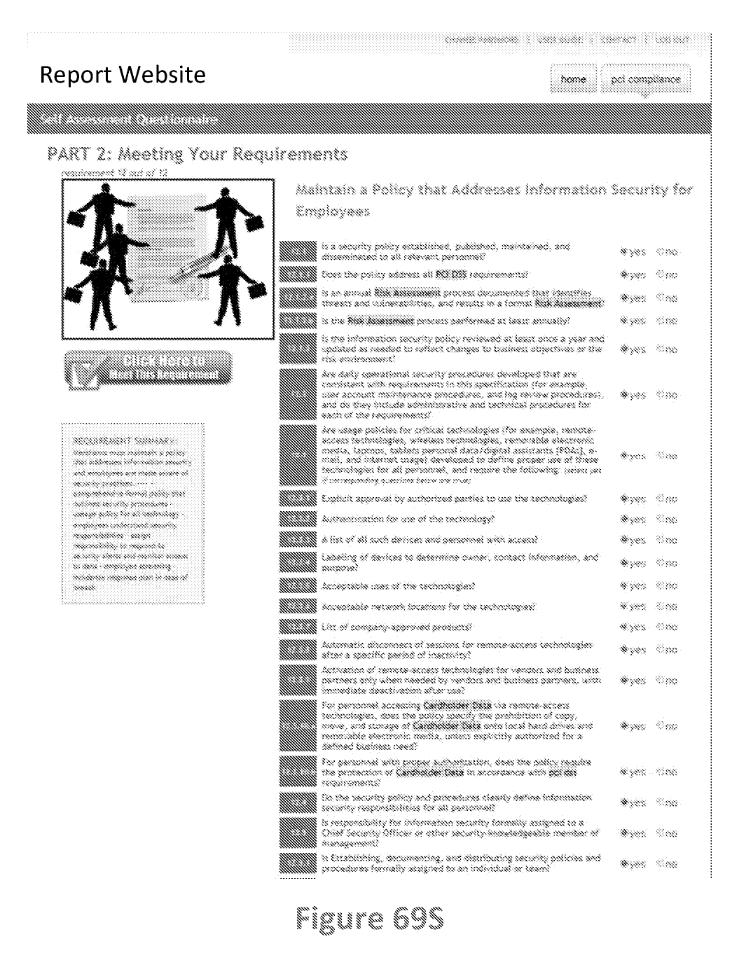

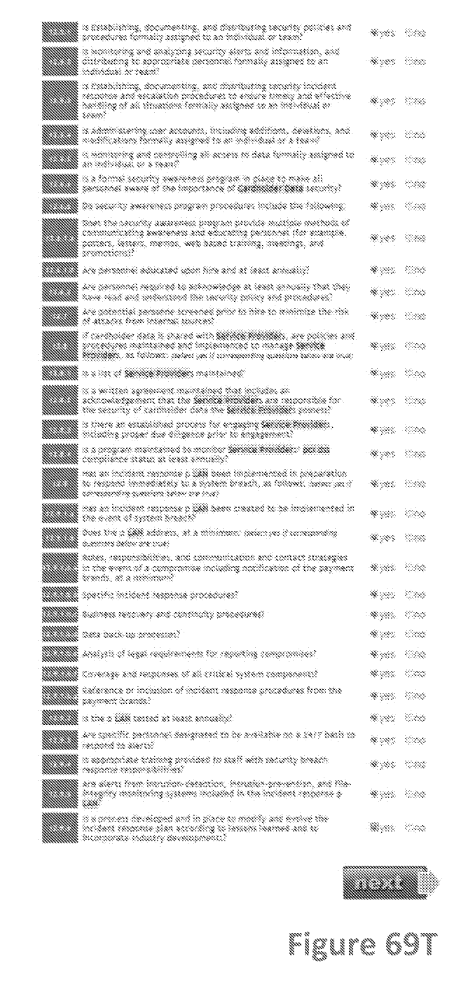

At step 624, the server transmits a processing card industry compliance questionnaire including a plurality of questions to the device. Reports server 101 transmits a PCI questionnaire 1630, shown in FIG. 69B, including a plurality of questions (shown in box 1630 through 1710.). Details regarding FIG. 69B are described below.

At step 626, one or more responses to the plurality of questions are received by the server. Reports server 101 receives or more responses, from network 104, to the plurality of questions shown in PCI questionnaire 2700, shown in FIG. 69B.

At step 628, the one or more responses are verified by the server. Reports server 101 verifies the one or more responses.

At step 630, the one or more responses are processed by the server in order to determine whether or not the merchant complies with a processing card industry compliance requirement. Reports server 101 processes the responses in order to determine whether or not the merchant complies with a PCI requirement.

At step 632, a processing card industry compliance certificate is provided by the server to the device in response to determining that the merchant complies with the processing card industry compliance requirement. Reports server 101 provides a PCI certificate to merchant device 103, via network 104, in response to determining that the merchant employing merchant device 103 complies with the PCI requirement.

In an embodiment, merchant device 103 may be a mobile device accessing the PCI questionnaire via mobile application 105. In another embodiment, merchant device 103 may be accessing the PCI questionnaire using website 102.

In FIG. 66, 1556 links merchant device 103 to a system (e.g., reports server 101, or another server) that verifies whether merchant device 103 passes a network security scan. The network security scan is performed periodically to ensure that the merchant complies with the processing card industry compliance requirement. For example, the time period may be every 90 days, etc.

In an embodiment, reports server 101 determines that a merchant does not comply with the PCI requirement. Should the merchant no longer comply with the PCI requirement, reports server 101 sends an alert to the merchant on merchant device 103 to alert the merchant that his/her merchant account no longer complies with the PCI requirement, in response to making the determination.

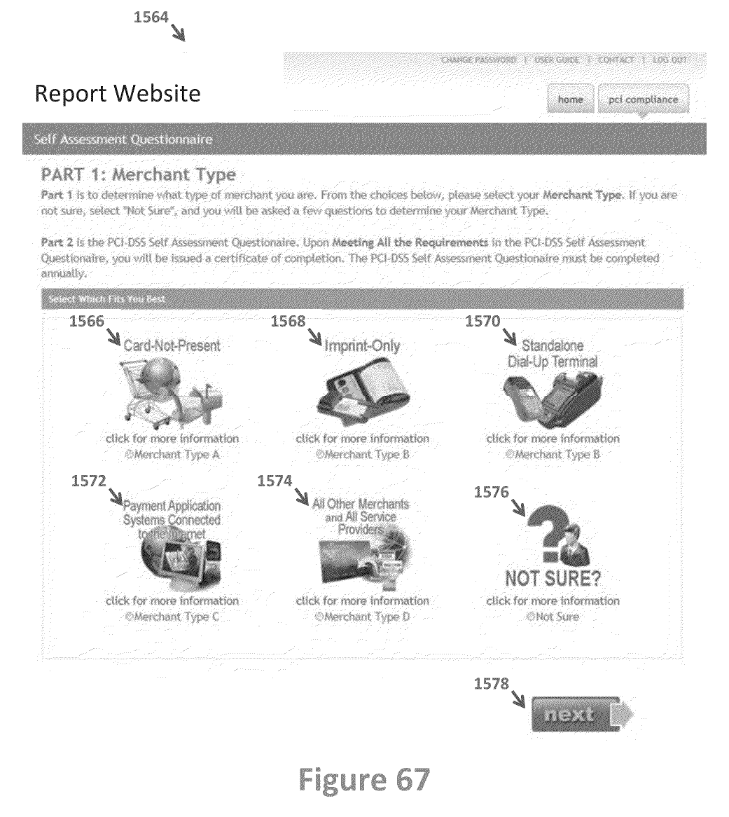

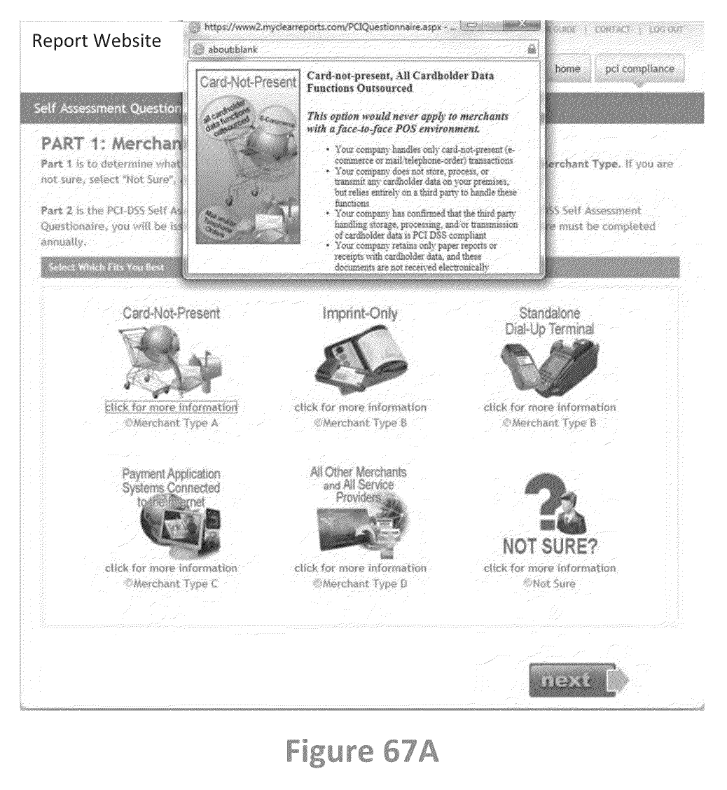

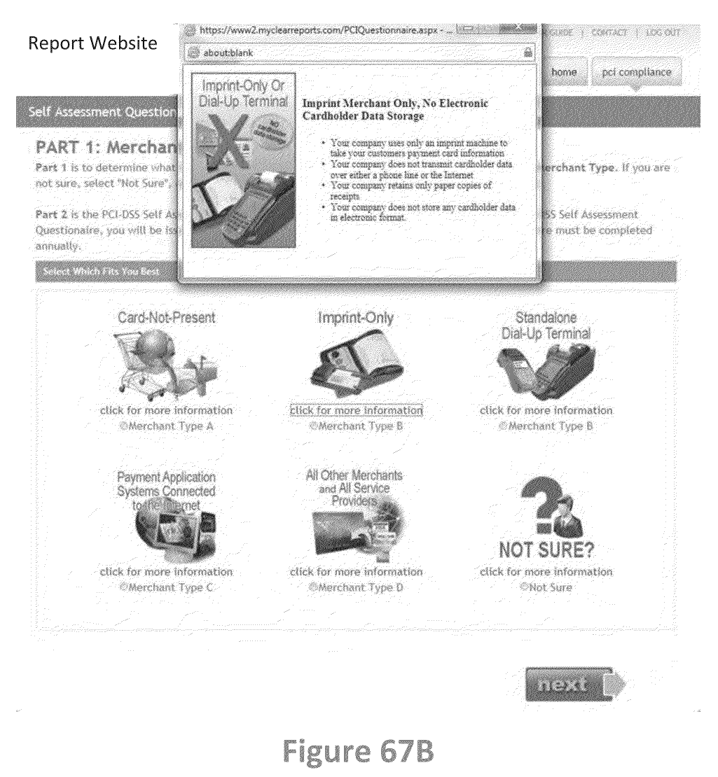

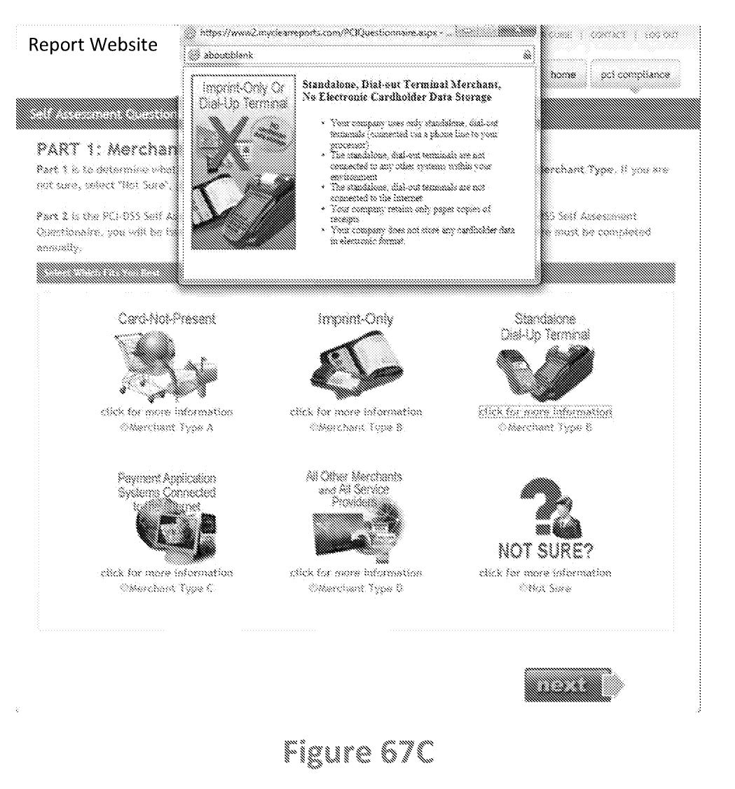

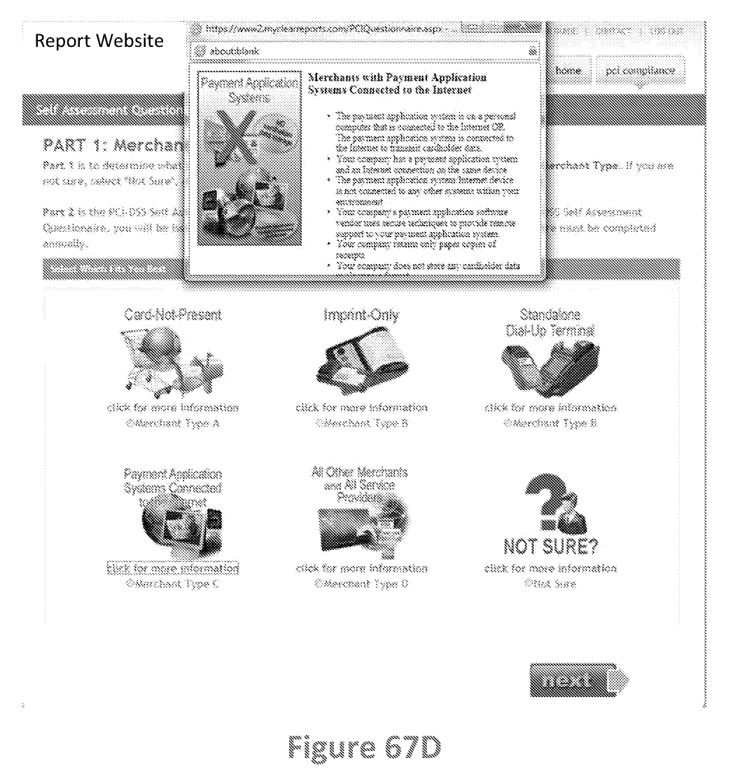

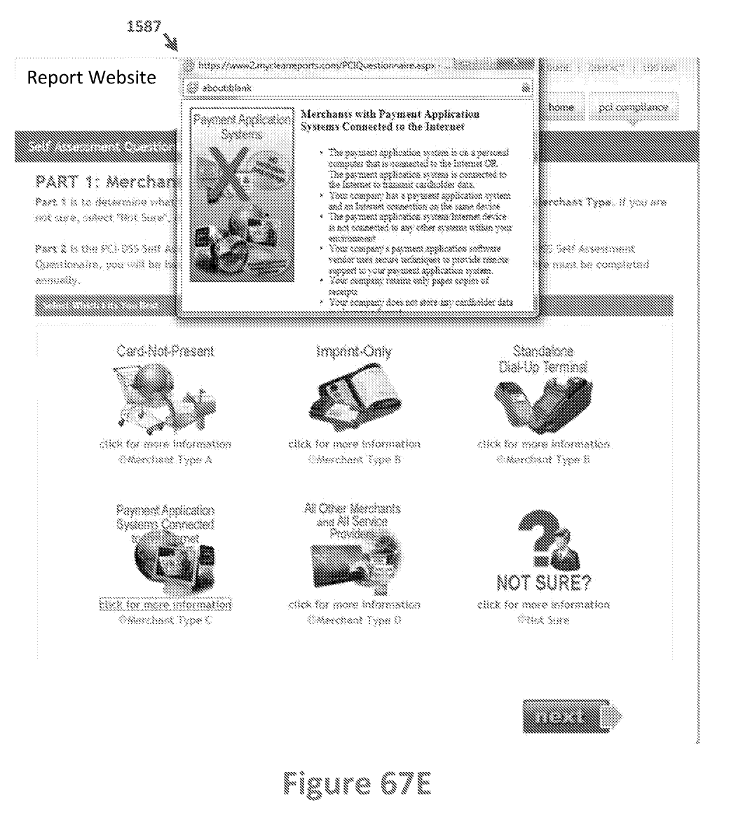

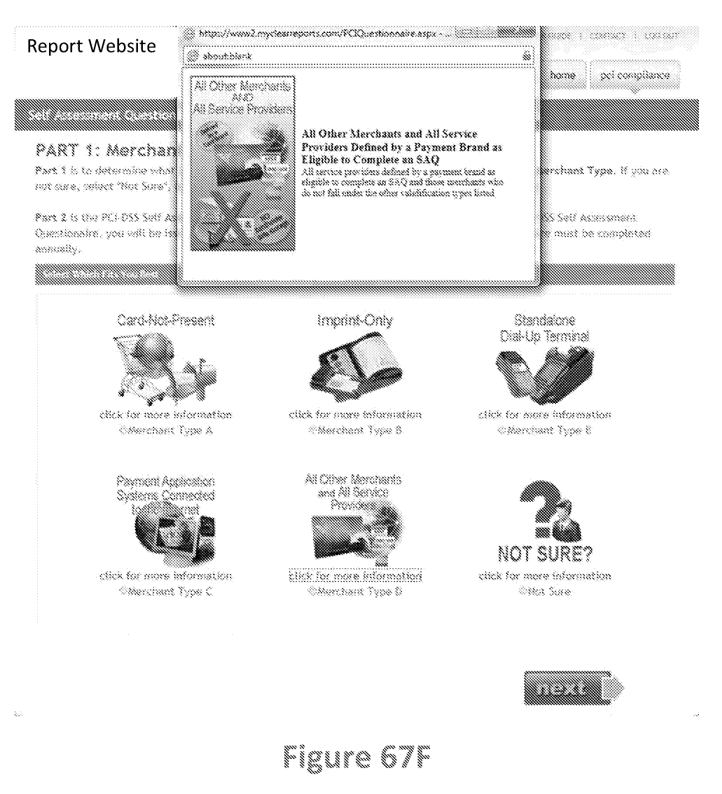

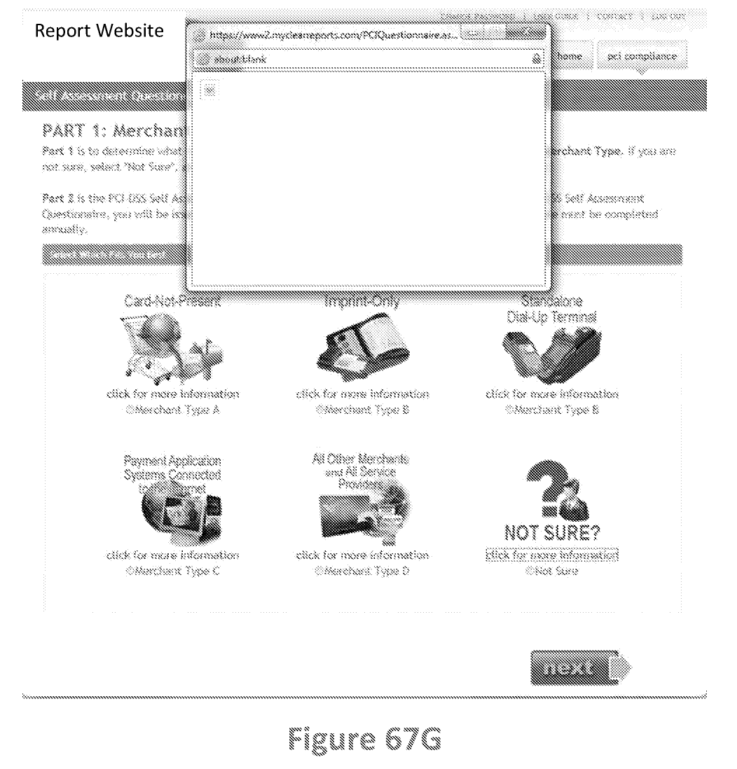

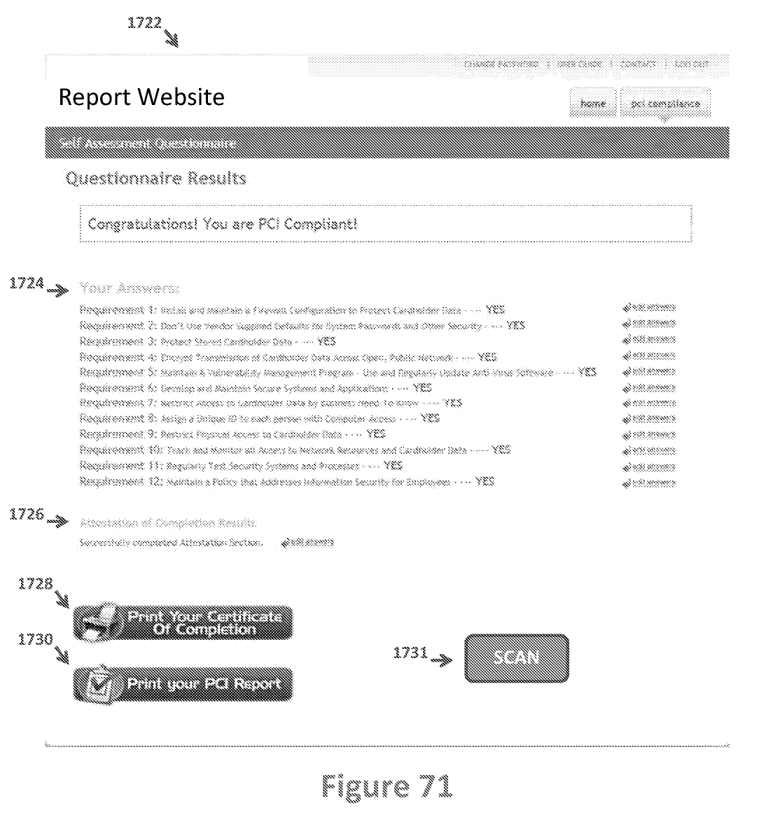

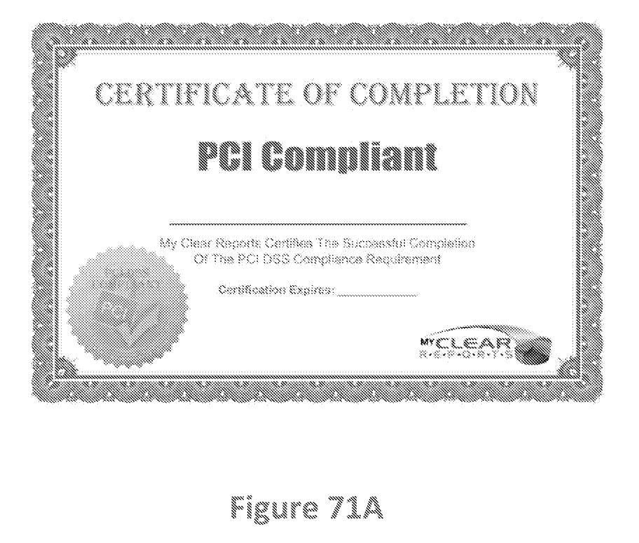

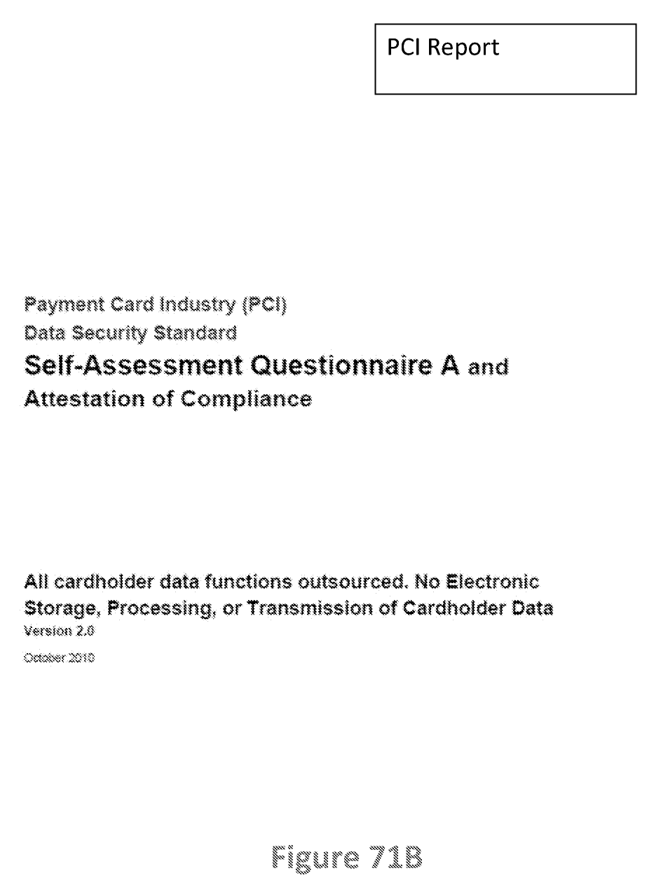

FIG. 67 depicts PCI compliance information, screen 1564, according to an embodiment. In part 1, merchant type is determined. In part 2, shown in FIG. 69B, a self-assessment questionnaire is provided and requirements that must be met for PCI compliance are determined. FIG. 71 depicts PCI compliance questionnaire results. In the depicted embodiment of FIG. 67 the merchant is determined to be PCI compliant and a certificate of completion is provided.

FIG. 67 depicts details regarding the PCI compliance information 1564, according to an embodiment. In part 1, merchant type associated with the merchant is determined. In the depicted embodiment, the merchant type may include a “card-not-present” type; an “imprint-only” type; a “standalone dial-up terminal” type; a “payment application systems connection to the Internet” type; or “all other merchants and all service providers.” In an embodiment, a merchant may select a “not sure” radio button, in case the merchant is not sure of his/her merchant type. In part 2, a self assessment questionnaire is provided. Additional questions may also be provided.

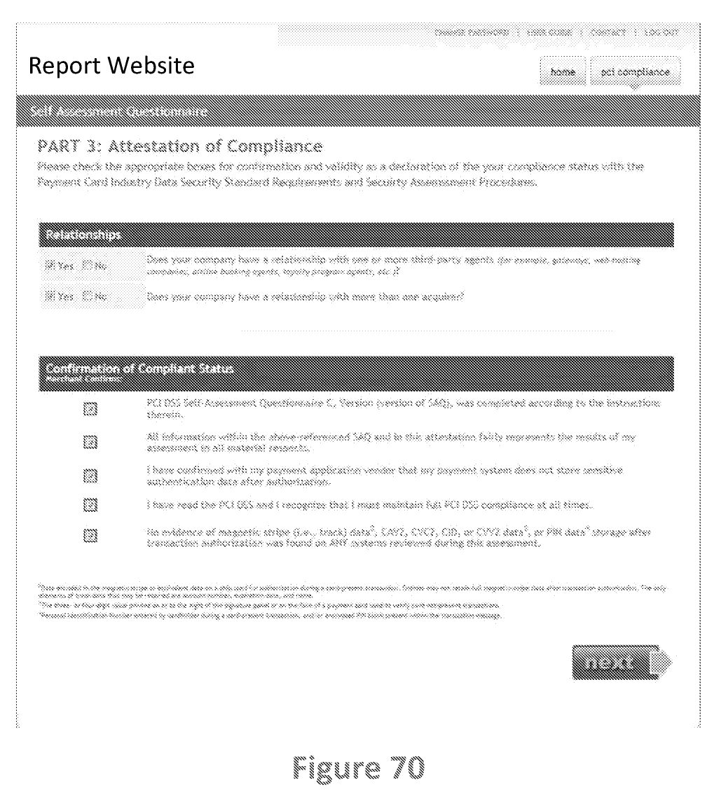

FIG. 70 depicts a PCI attestation compliance questions screen 1714, according to an embodiment.

FIG. 71 depicts a PCI questionnaire results screen 1722, according to an embodiment. The merchant's answers are displayed on screen 1724 and can be edited before completing the PCI review. PCI compliance status is display at 1726. Once completed, the PCI certificate can be printed by clicking box 1728 and PCI self-assessment form can be printed by clicking box 1730. Clicking on Box 1731 allows the merchant to run quarterly scans. FIG. 71A depicts the PCI certificate and FIG. 71B depicts the PCI Self-Assessment Questionnaire document.

### Prepaid Debit Card

Merchants can request a prepaid debit card that acts as a corporate card and can directly access all reporting and analytics associated with the account. Merchant may restrict standard industry code/merchant category code (SIC/MCC) codes with this card reducing employees from using the card for not business related expenses.

A prepaid debit card for business owners that acts as a corporate card may be provided. The prepaid card is a virtual bank account that tracks business payments and sales activity. Merchants may restrict employee spending while using the card to manage all their business finances. Merchants may set up automatic balance alerts and know when money has been deposited. This provides instant access to funds. The prepaid card provides all the benefits of a debit card without the need of a bank account. With the prepaid card, a merchant can manage expenses, pay bills, access cash at automatic teller machines (ATMs), easily add funds, manage his/her account online, etc.

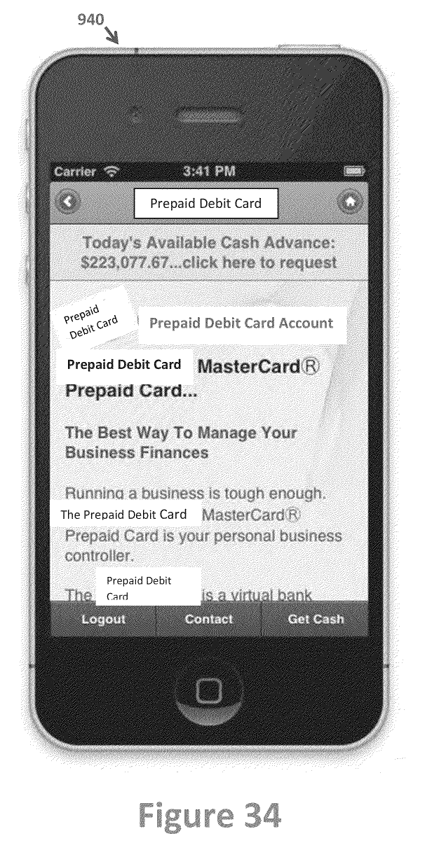

FIG. 34 depicts a prepaid card account information screen 940, in accordance with an embodiment. Prepaid card account information screen 940 describes some of the features of a prepaid card.

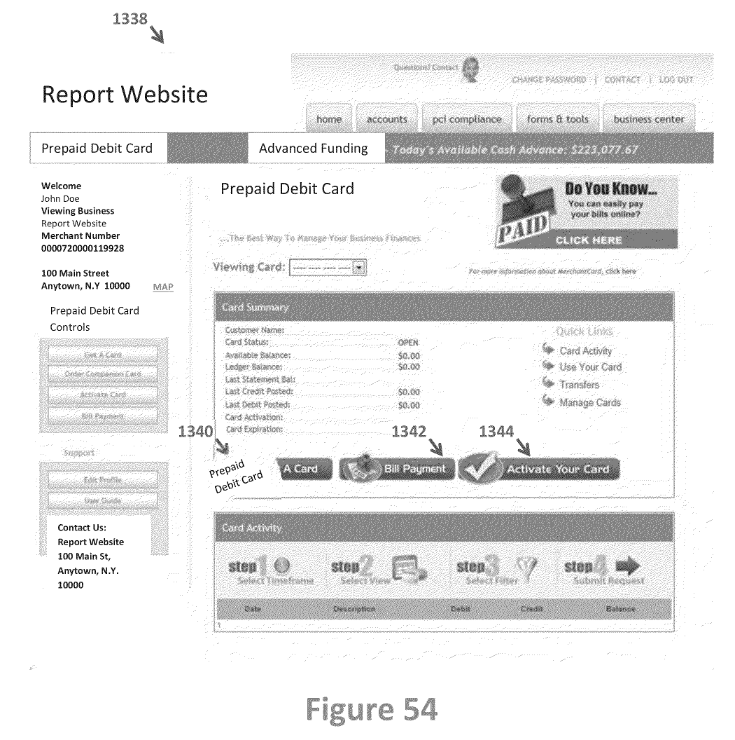

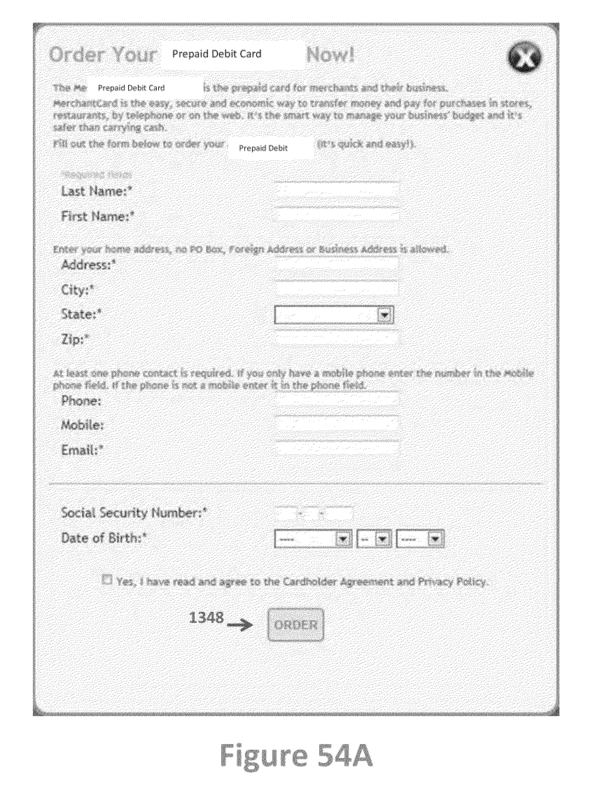

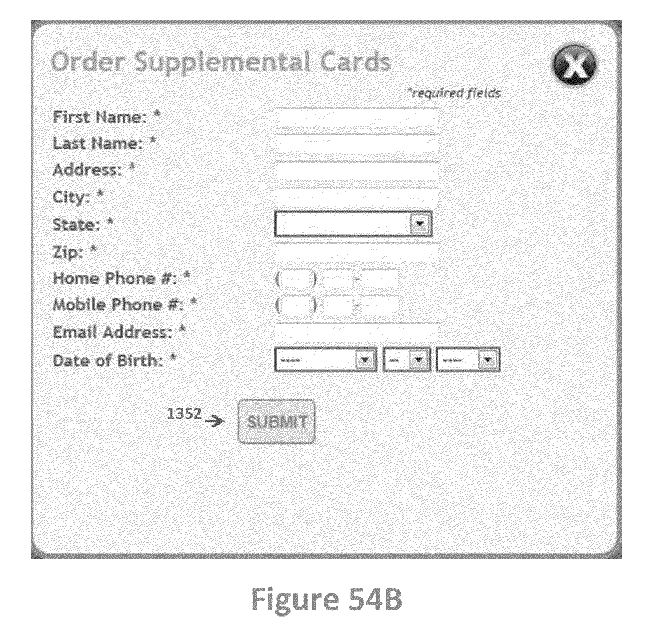

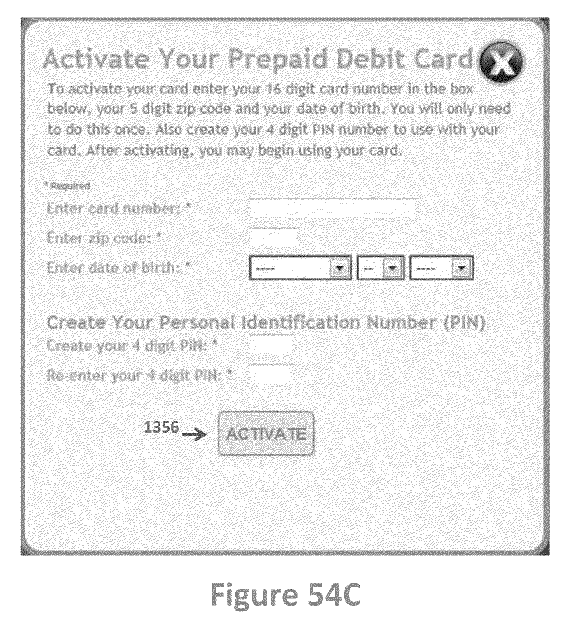

On the report website shown in FIG. 54 a prepaid card account information screen 1338 is depicted, in accordance with an embodiment. Prepaid card account information screen 1338 describes some of the features of a prepaid card.

FIG. 6C is a flowchart depicting a method of creating a prepaid card account, in accordance with an embodiment. In the illustrative embodiment, merchant device 103 is a mobile device such as a cell phone. At step 642, a first request for credit card sales account information is received by a server from a merchant employing a mobile device. Reports server 101 receives a first request for credit card sales account information from a merchant employing merchant device 103. The first request may be sent by merchant device 103 from network 104.

At step 644, the server requests credit card sales account information from a financial service provider. The financial service provider is different than an entity hosting the server. Reports server 101 requests the credit card sales account information from financial service provider database 108, via network 104. The financial service provider database 108 is different than an entity that hosts reports server 101. In an embodiment, the credit card sales account information may include available funds, a batch of credit card sales, chargebacks, deposits or cash advance.

In response, financial service provider database 108 provides the requested credit card sales account information to reports server 101.

At step 646, the server receives the credit card sales account information from the financial service provider. Reports server 101 receives the credit card sales account information from financial service provider database 108. In an embodiment, reports server 101 may receive the credit card sales account information from service provider database 108 in a raw data form. As such, service provider database 108 stores the credit card sales account information in a format compatible with reports server 101 and reports server 101 may receive the credit card sales account information in a raw data form so that reports server 101 may convert the credit card sales account information prior to providing it to the merchant employing the mobile device.

At step 648, the credit card sales account information is provided to the mobile device from the server. Reports server 101 provides the filtered custom credit card sales account information to merchant device 103, via network 104. The filtered custom credit card sales account information is provided to merchant device 103 in a format that is displayable to merchant device 103.

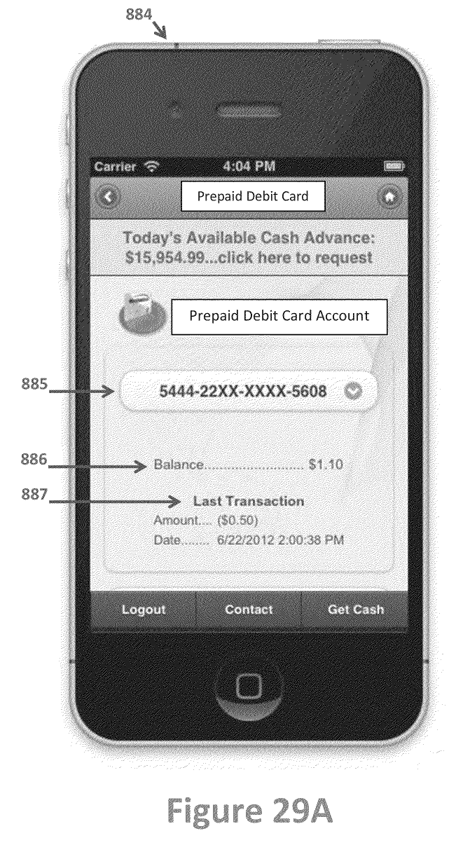

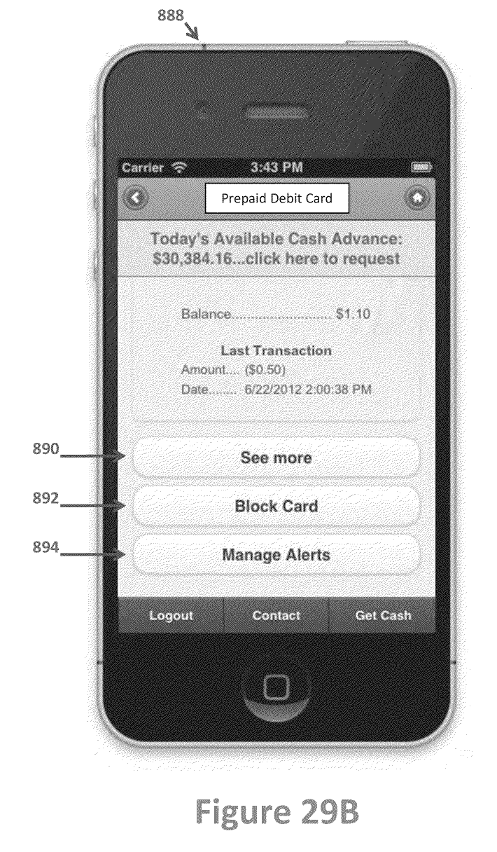

At step 650, a second request to provide a prepaid card account loaded with available funds based on the credit card sales account information is received by the server from the merchant employing the mobile device. Reports server 101 receives a second request to provide a prepaid account, as depicted in a prepaid account screen 884 in FIG. 29A, from merchant device 103. Details regarding the prepaid account are described below.

Suppose that the merchant is accessing the report website. In this embodiment, a second request to provide a prepaid card account loaded with available funds based on the credit card sales account information is received by the server from the merchant employing the device. Reports server 101 receives a second request to provide a prepaid account, as depicted in a prepaid account screen 1338 in FIG. 54, from merchant device 103. Clicking box 1340 allows the merchant to order a prepaid debit card. Clicking box 1342 allows the merchant to utilize bill payment. Clicking box 1344 allows the merchant to activate their prepaid debit card.

In an embodiment, ordering a prepaid debit card may only be done using the report website. By clicking box 1340, shown in FIG. 54, the merchant can order a primary card or multiple supplementary cards. FIG. 54A depicts the order form for the primary prepaid debit card and FIG. 54B depicts the order form for the supplement prepaid debit cards.

Clicking box 1344 shown in FIG. 54 allows the merchant to activate their prepaid debit card. FIG. 54C depicts the prepaid debit card activation screen.

For example, suppose that Tammy has a certain amount of available funds in her business' merchant account based on the credit card sales in the merchant account. Tammy may request to load some or all of the available funds onto the prepaid card account.

At step 652, the prepaid card account is created by the server by loading the prepaid card account with an amount of funds that are available. Reports server 101 loads prepaid card account, depicted in prepaid account screen 884 in FIG. 29A and screen 888 in FIG. 29B, with an amount of funds that are available. For example, an amount of funds that is loaded onto the prepaid card account is the same as the amount of available funds (e.g., in Tammy's merchant account).

In an embodiment, where the merchant is accessing the report website, the prepaid card account is created by the server by loading the prepaid card account with an amount of funds that are available. Reports server 101 loads prepaid card account, depicted in prepaid account screen 1338 in FIG. 54, with an amount of funds in an amount of the available funds. For example, an amount of funds that is loaded onto the prepaid card account is the same as the amount of available funds (e.g., in Tammy's merchant account).

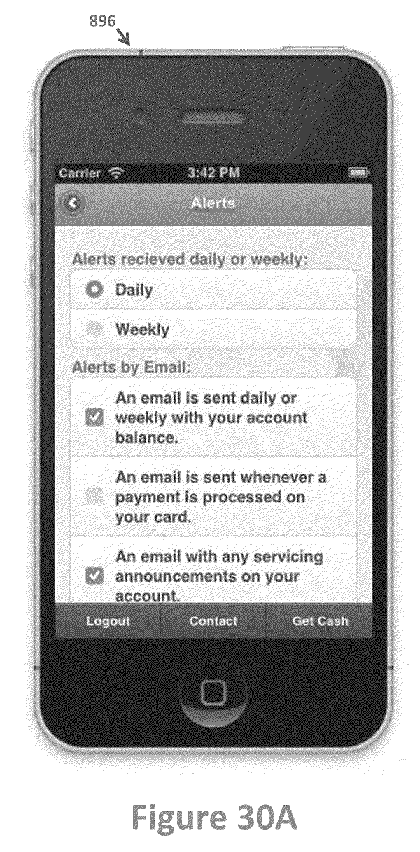

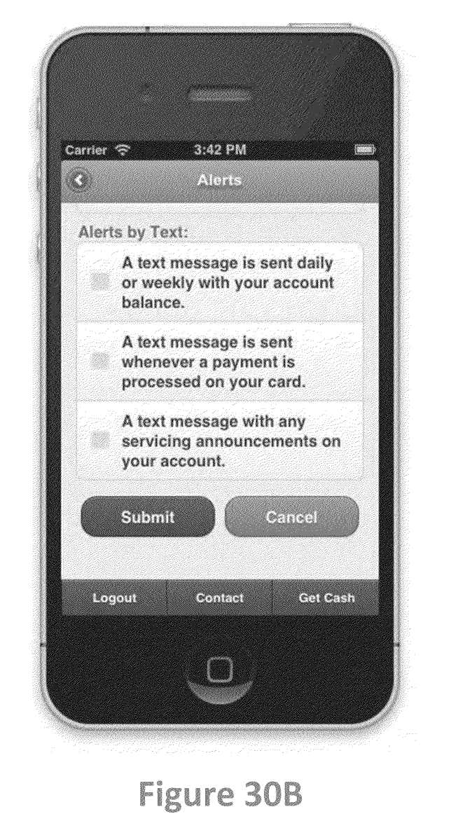

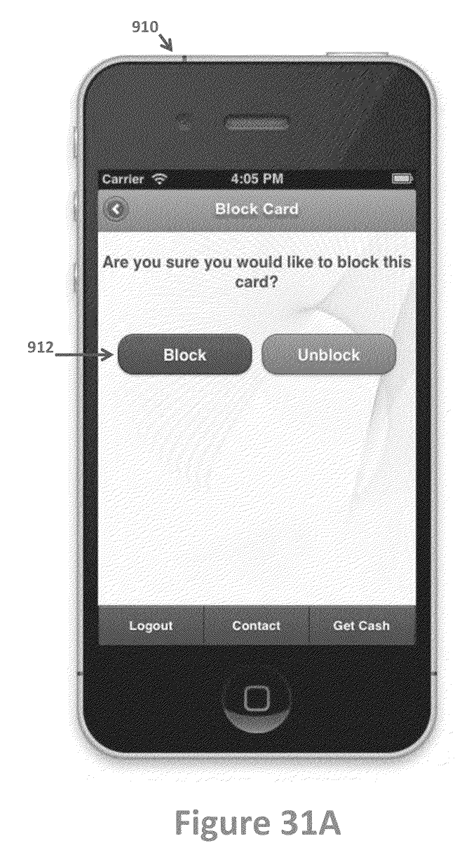

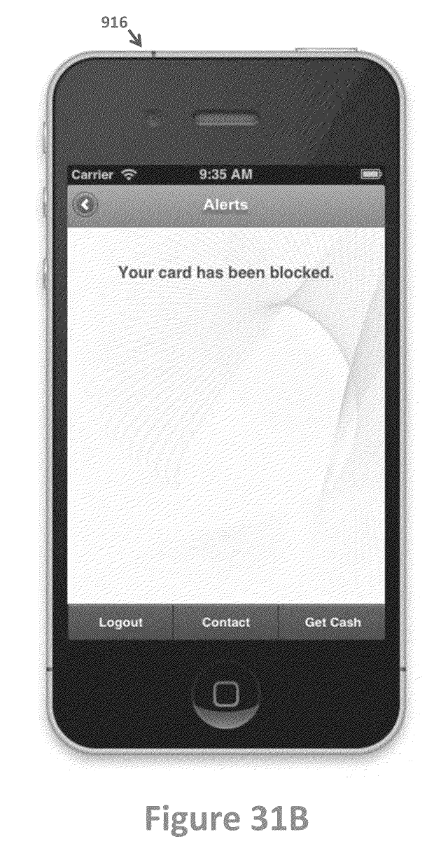

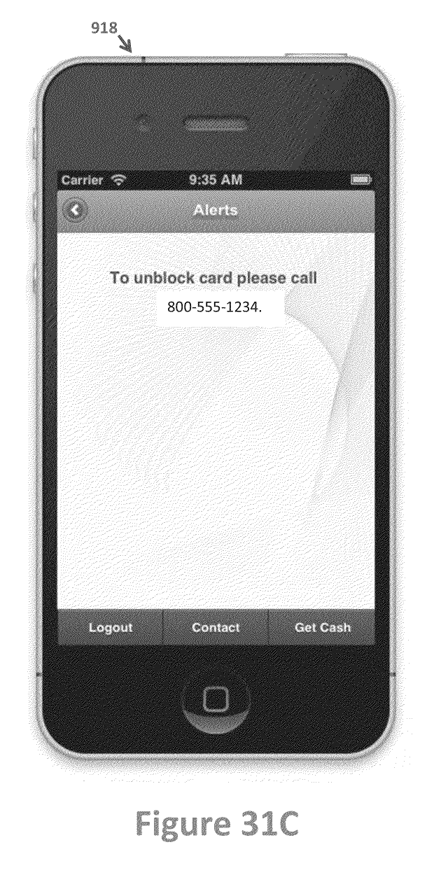

Returning to FIG. 17, upon selection of box 732, the prepaid card account is provided. FIG. 29A depicts a prepaid card account screen 884, in accordance with an embodiment. Box 885 provides a number of a particular prepaid card account. Upon selection of the particular prepaid card account (or by default) a balance 886 and details regarding a last transaction 887 is shown. The prepaid card account information of another prepaid card account may be provided by selection of the prepaid card account. Additional options to see more information, to block a card and to manage alerts may be provided. Upon selection of box 890, the see more option, the screen depicted in FIG. 29B is provided. Upon selection of box 892, the block card option, the screen depicted in FIG. 31A is provided. Upon selection of box 894, the manage alerts option, the screens depicted in FIGS. 30A and 30B are provided.

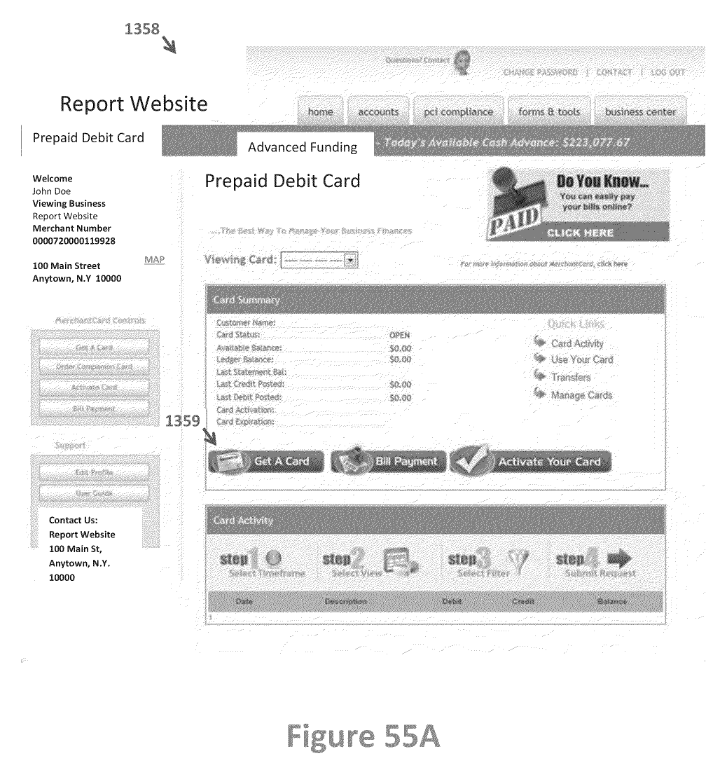

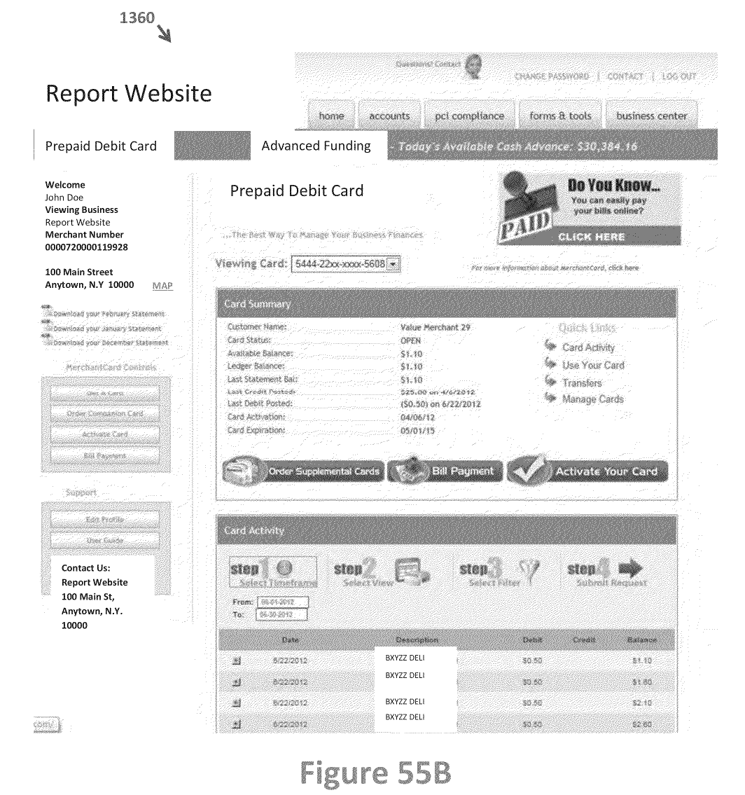

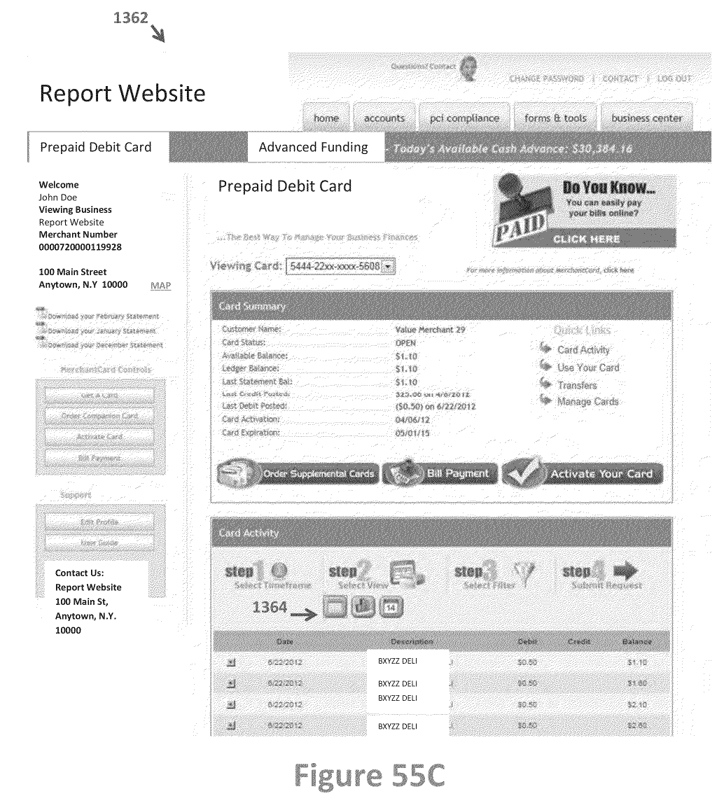

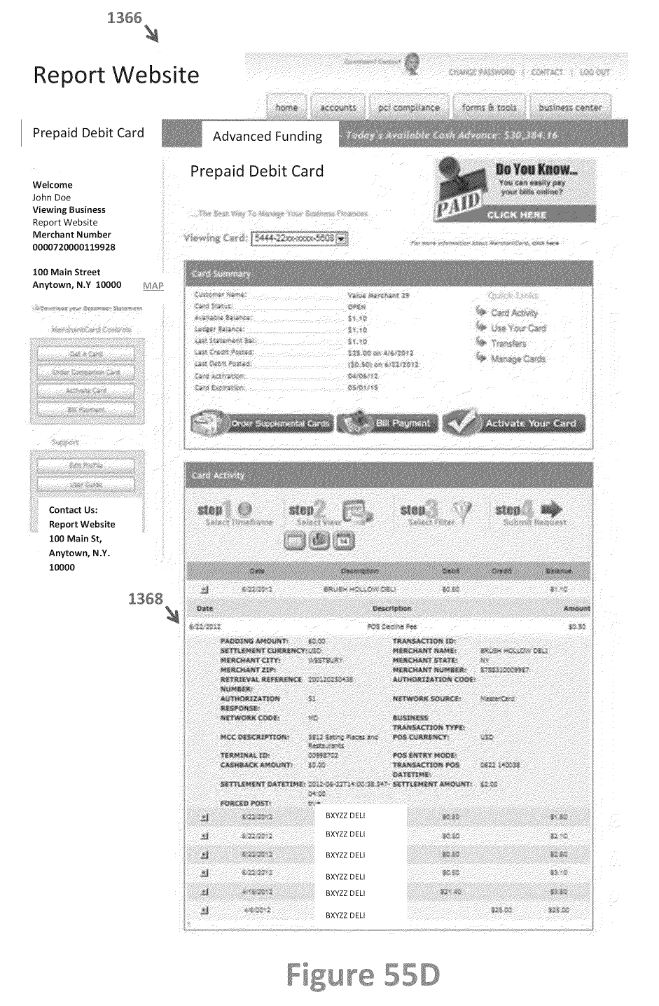

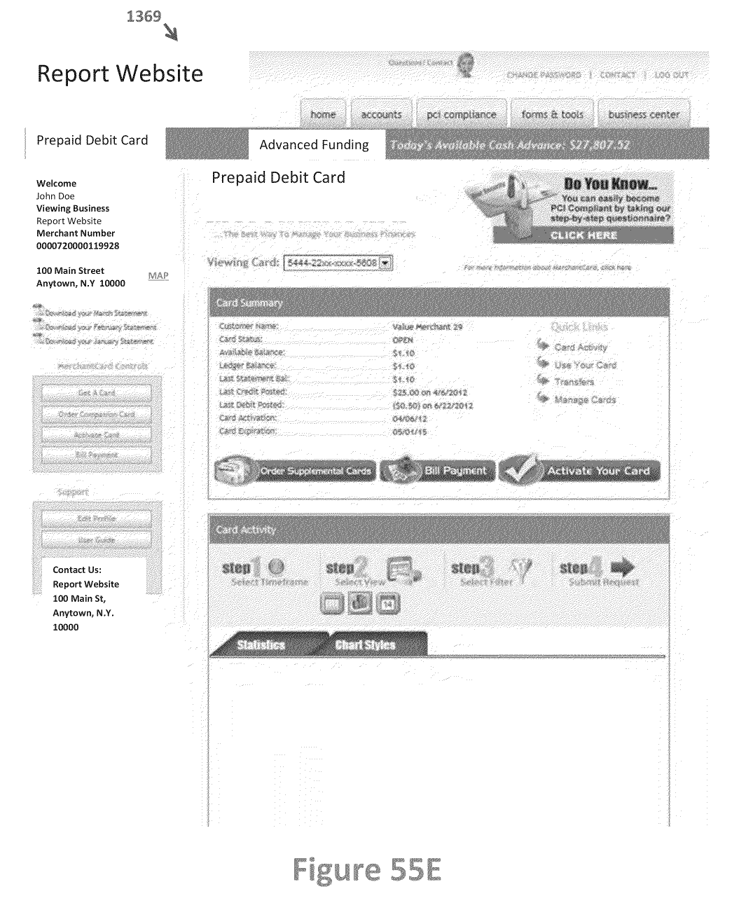

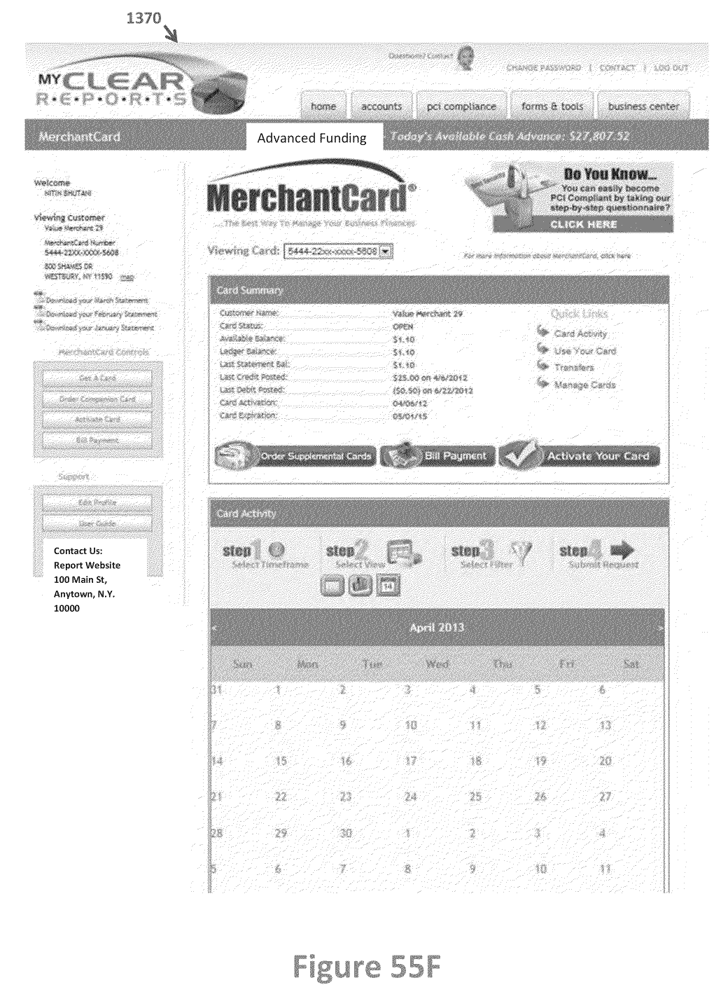

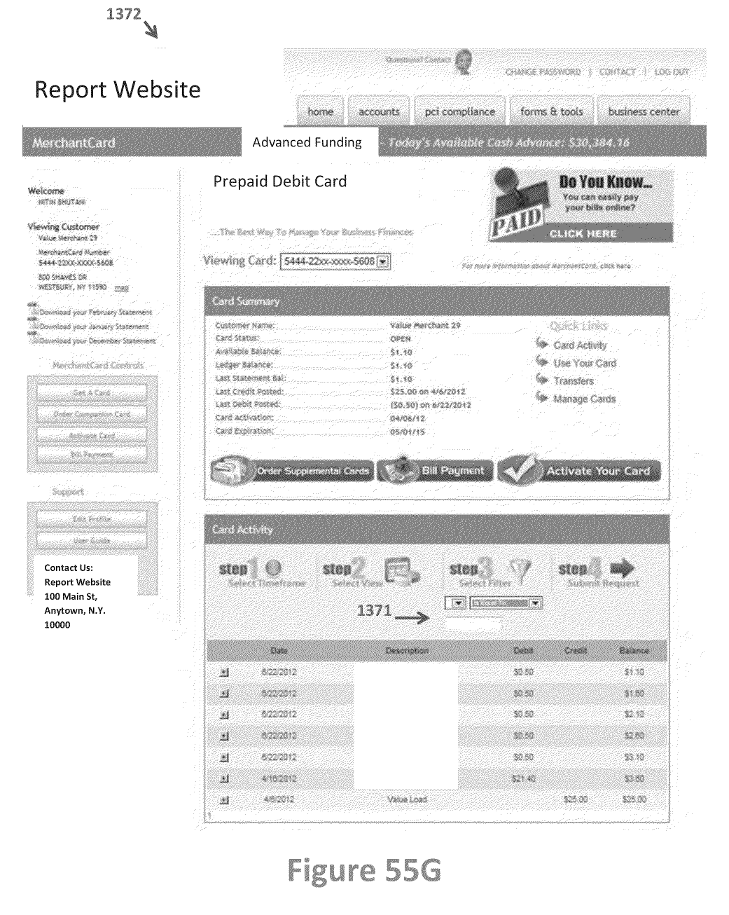

For the reports website, FIG. 55A depicts a prepaid card account screen 1358, in accordance with an embodiment. Box 1359 provides a number of a particular prepaid card account. Upon selection of the particular prepaid card account (or by default) a balance and details regarding a last transaction is shown. The prepaid card account information of another prepaid card account may be provided by selection of the prepaid card account.

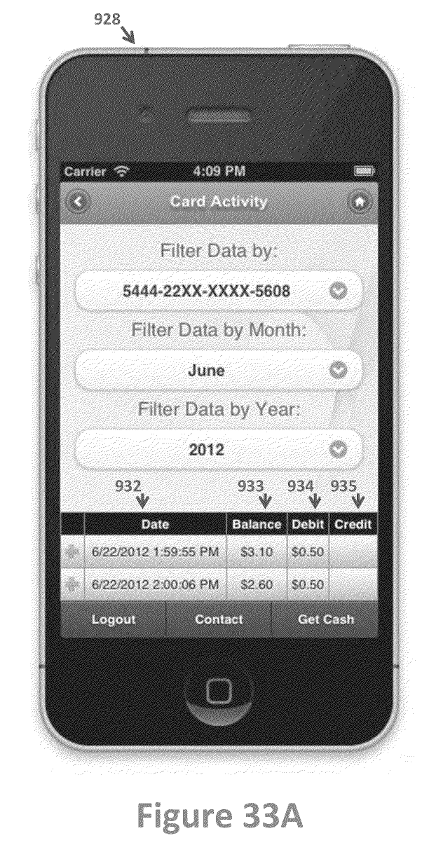

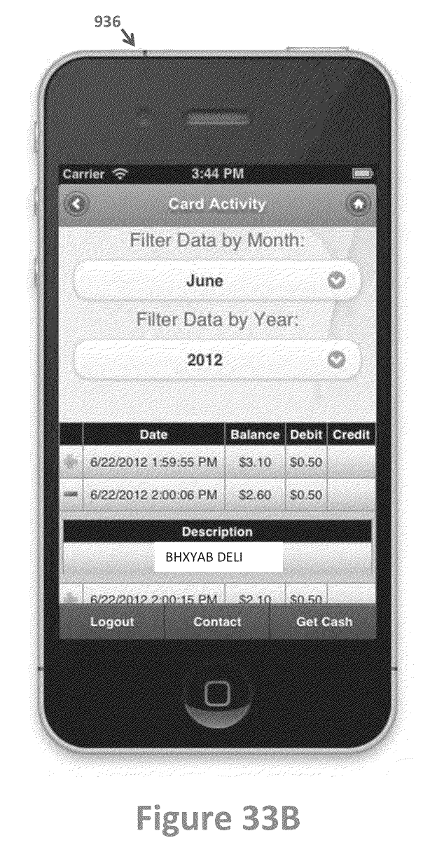

In an embodiment, the prepaid card account may be initially loaded with an amount of funds that is available in a merchant account, or some of the funds available in a merchant account. Suppose that Tammy selects to load $3.10 onto the prepaid card account. A prepaid card associated with the prepaid card account has $3.10 of available funds loaded onto it. When Tammy (or her employees, or any other designated party) uses the prepaid card to purchase items, the prepaid card account keeps track of the transactions (as shown in FIGS. 33A and 33B). Tammy is provided with balance shown in FIG. 29B, screen 888 (in this embodiment, the balance remaining is $1.10).

In an embodiment on the report website, FIGS. 55B and 55C keep track of the transactions. Tammy is provided with balance, shown in FIG. 55A (in this embodiment, the balance remaining is $1.10).

Returning to FIG. 6C, at step 654, transactional information associated with the prepaid card account is maintained by the server. Reports server 101 maintains transaction information associated with the prepaid card account. Details regarding the maintenance of transaction information are described below with respect to FIGS. 33A and 33B.

FIGS. 33A and 33B depict card activity screens 928 and 936 respectively, in accordance with an embodiment. Card activity screens 928 and 936 provide information associated with the prepaid card account. For example, card activity screens 928 and 936 may depict debit transaction dates and balance of the prepaid card. Card activity screens 928 and 936 may be provided in tabular form listing the date of the transaction, as shown in column 932, the amount of debit, as shown in column 934, the amount of credit (e.g., any purchase amount returned or credited back onto the prepaid card account), as shown in column 935 and the balance, as shown in column 933. Additional information regarding the prepaid card account may also be provided.

FIGS. 55B and 55C depicts a card activity screen 1362 and 1366, in accordance with an embodiment. Card activity screen 1362 and 1366 provide information associated with the prepaid card account. FIG. 55D depicts filtering for card activity information at 1370.

Returning to FIG. 6C, at step 656, a transaction that is processed on the prepaid card account is detected by the server. Reports server 101 detects a transaction that is processed on the prepaid card account.

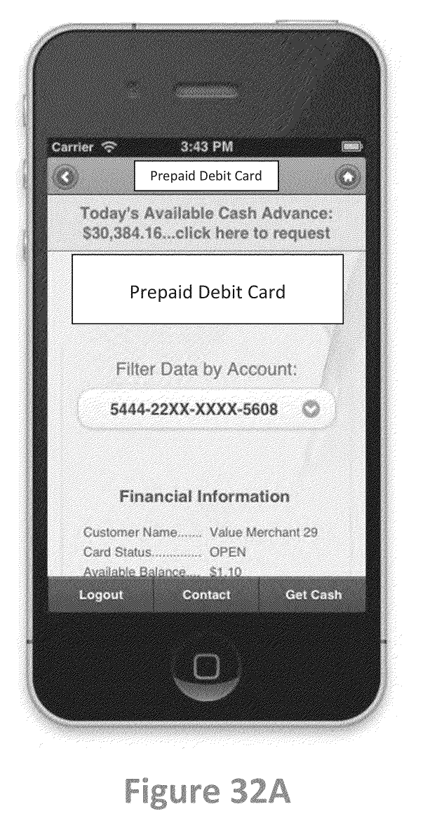

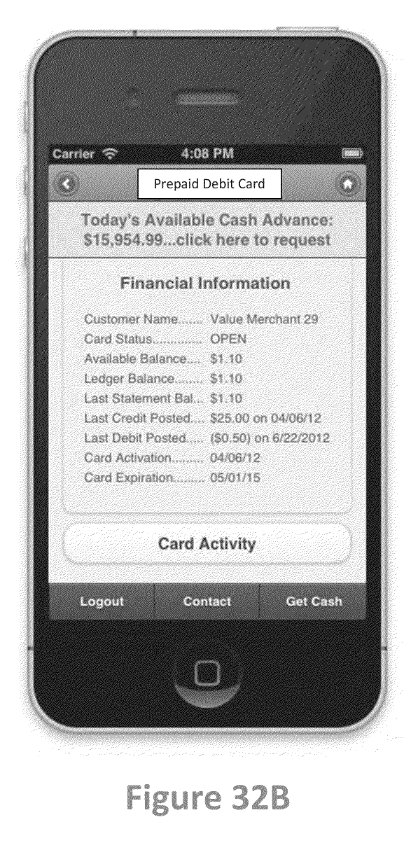

For example, suppose that Tammy starts out with a balance of $3.10. On Jun. 22, 2012, Tammy makes several purchases on her prepaid account each totaling $0.50. For the first $0.50 transaction that is processed on the prepaid card account, the transaction is detected by reports server 101. Similarly, for every other transaction that is processed on the prepaid card account, the transaction is detected by reports server 101. For every transaction Tammy makes, the details regarding the transaction (e.g., the transaction date and the debit amount) are maintained by reports server 101. The final balance after the transactions have been entered and/or completed is shown in FIG. 32B as $1.10.

At step 658, an alert to the mobile device is provided by the server in response to the detecting. Reports server 101 provides an alert to user device 103 in response to the detecting performed in step 656.

FIGS. 30A and 30B depict alerts screens associated with a prepaid card account, in accordance with an embodiment. The merchant may select one or more alerts from alerts screen 896, shown in FIG. 30A. The merchant may wish to receive daily or weekly alerts associated with his/her merchant account by email and/or by text. Some exemplary alerting options are shown in alerts screen 896.

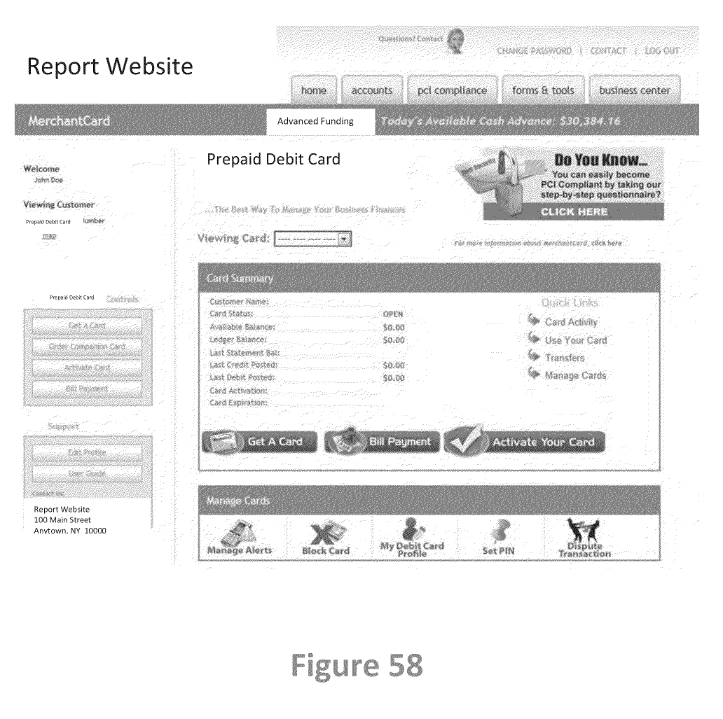

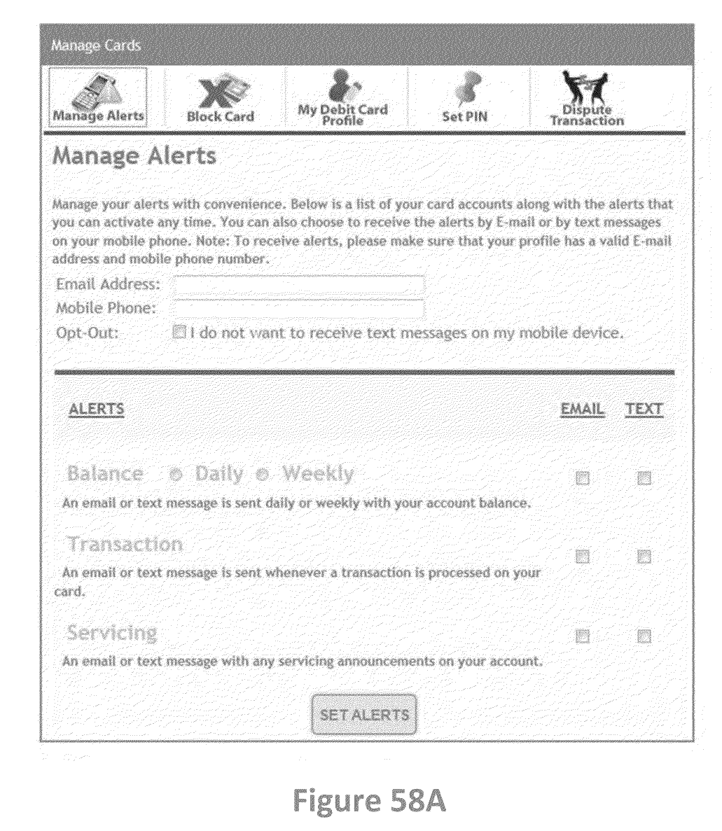

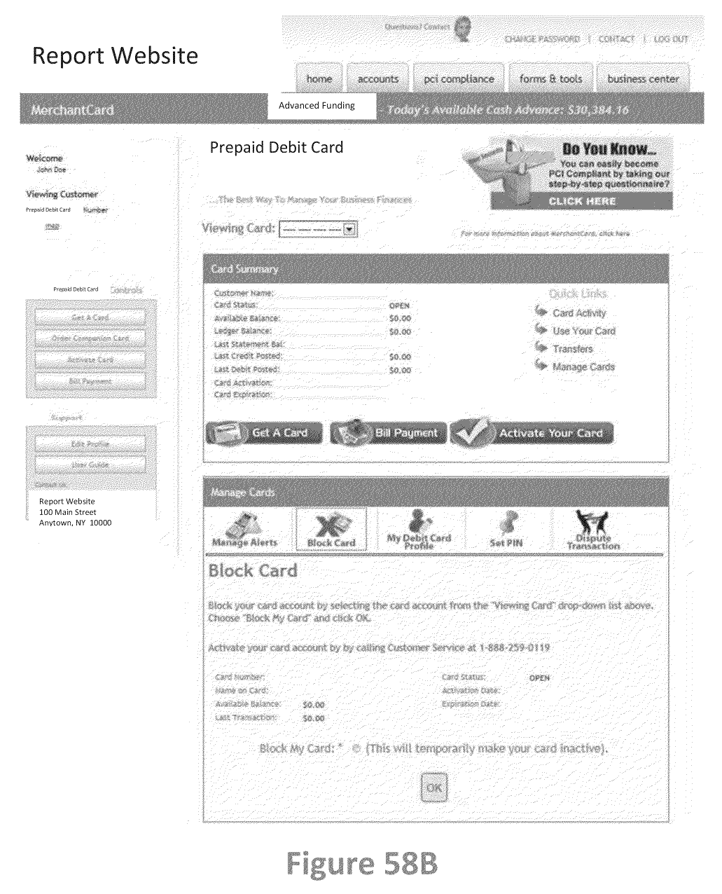

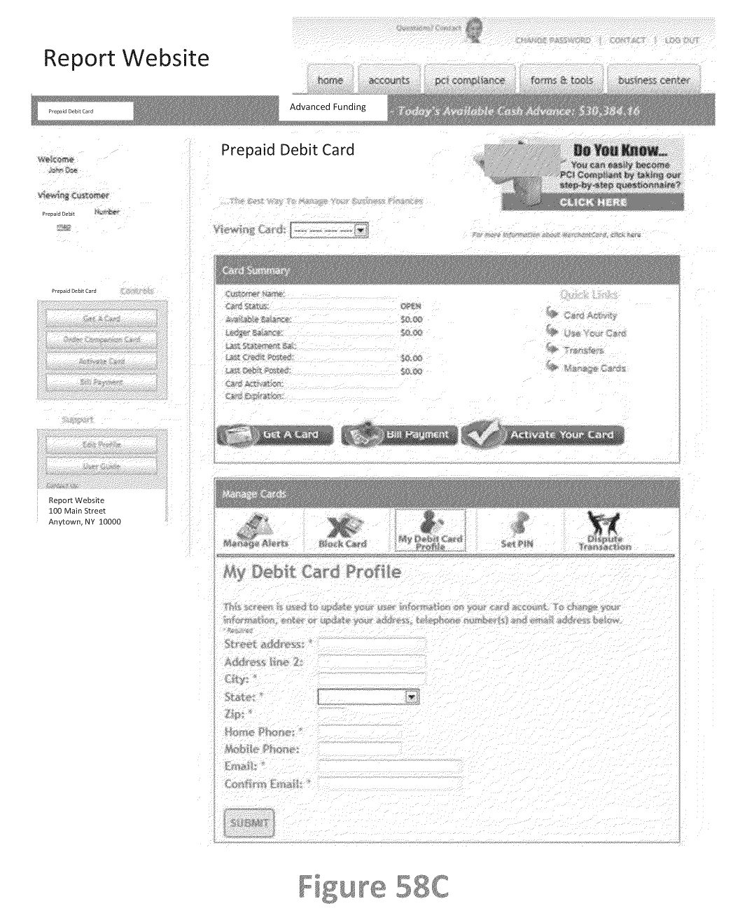

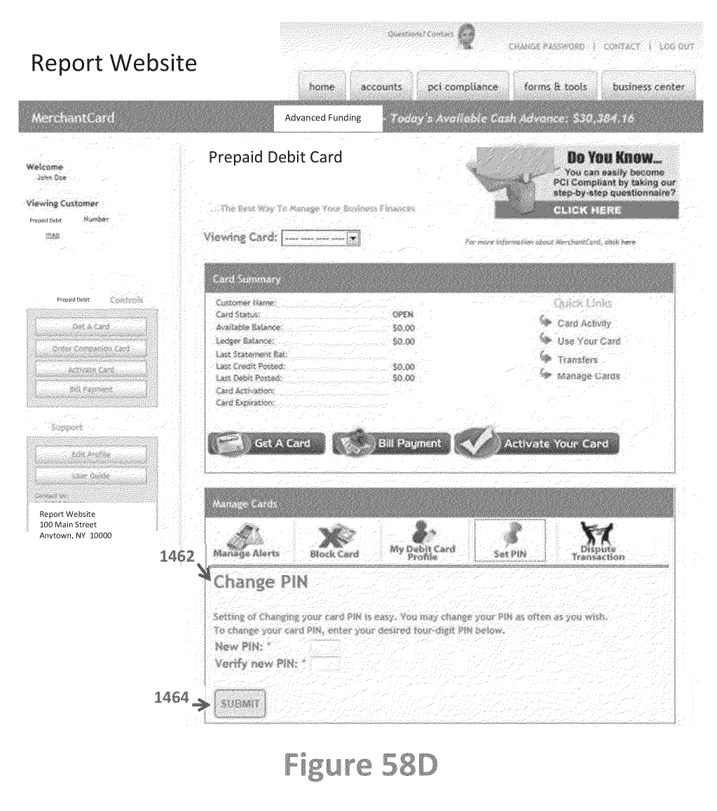

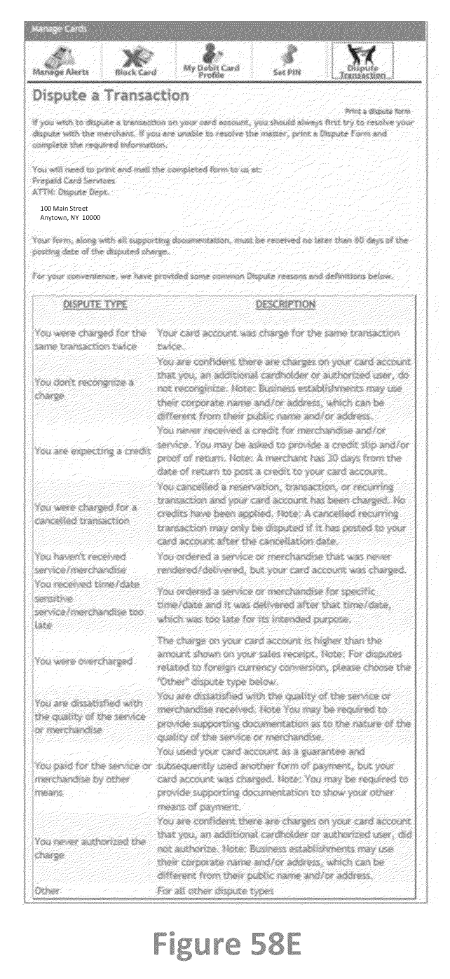

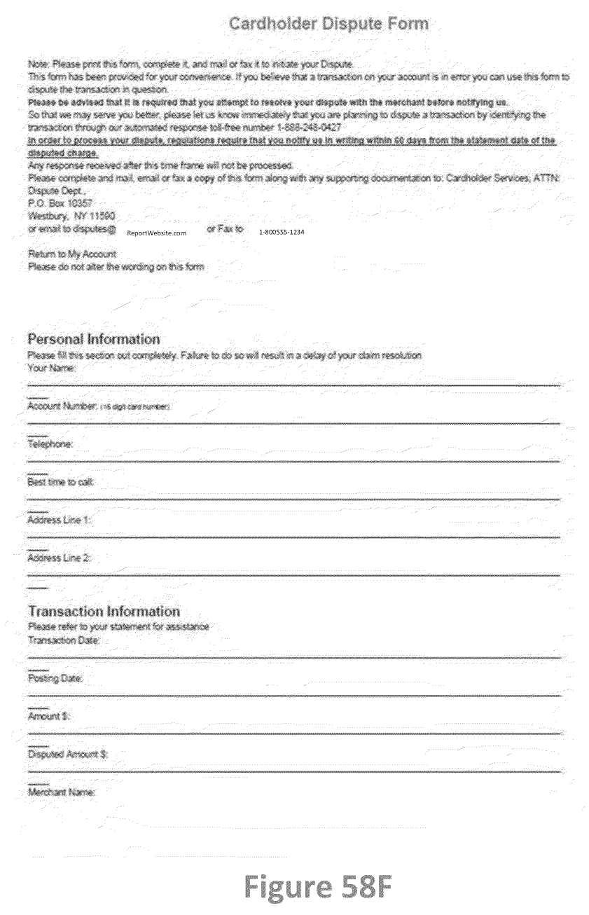

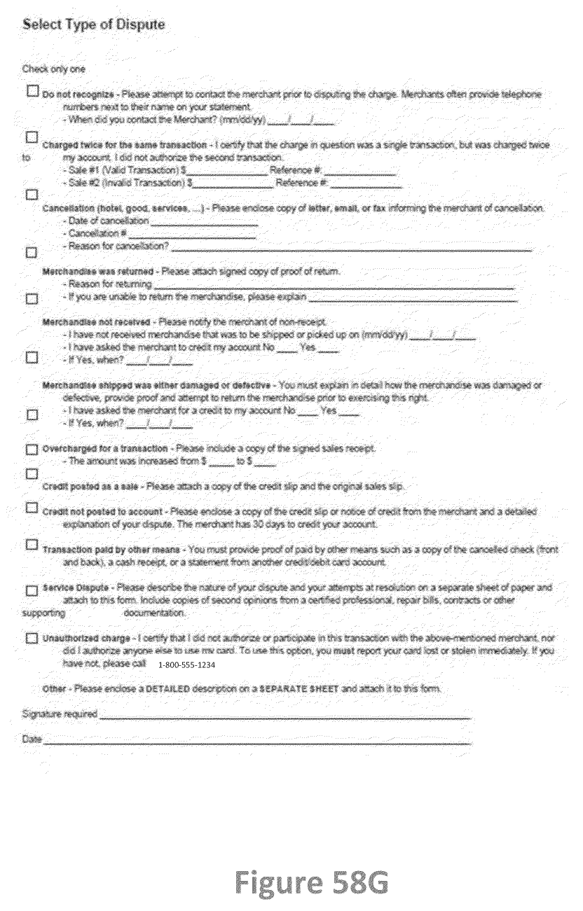

FIG. 58A depicts a web application's prepaid debit card account manage cards screen displaying manage alerts, in accordance with an embodiment. The merchant may select one or more alerts from the alerts screen. The merchant may wish to receive daily or weekly alerts associated with his/her merchant account by email and/or by text. Some exemplary alerting options are shown in the alerts screen in FIG. 58A.

In an embodiment, upon detecting a transaction, reports server provides a text message, email alert, etc. to the merchant alerting the merchant that the transaction as taken place. The merchant may choose to receive alerts whenever any transaction takes place, whenever a transaction exceeds a minimum or maximum amount set by the merchant, transaction details that occur on a daily, weekly, monthly basis, etc. The merchant may configure the alert settings in alerts screen 896, shown in FIG. 30A.

In an embodiment, prior to the receiving, by reports server 101 from the merchant employing the merchant device 103, the first request, server 101 performs authentication of merchant device 103. Authentication may be performed by using a known authentication process.

Although the merchant is provided with the prepaid card account details, the merchant may still access the merchant account. In an embodiment, reports server 101 may receive a request to sort the credit card account sales based on a certain criteria from merchant device 103. For example, the merchant employing merchant device 103 may request to sort the credit card sales account information by month. Reports server 101 sorts the credit card sales account information based on the certain criteria. Reports server 101 then generates sorted credit card sales account information based on the sorting. Reports server 101 then provides the sorted credit card sales account information a format that can be properly displayed by merchant device 103. For example, if merchant device 103 is a mobile device, the sorted credit card sales account information is provided in a format that is displayable within a display screen of merchant device 103.

In the embodiment of FIG. 6C, the prepaid card account is loaded with funds based on the merchant account. In another embodiment, the prepaid card account may be loaded from another source of funding (e.g., a merchant's bank account, etc.). In yet another embodiment, the prepaid card account may be loaded from the available cash back. For example, Tammy may have access to a $15,853.42 of cash advance. Tammy can request some or the entire available cash advance to be loaded onto the prepaid card account so that she can access the cash advance on the prepaid card when she makes purchases.

FIG. 29A depicts a prepaid card account screen with financial information 884, in accordance with an embodiment. Box 885 allows filtering of data based on a particular account. An additional prepaid card account may be selected by box 885. Information such as the customer's name, card status, available balance, etc. depicted in FIG. 29A may also be provided.

FIG. 31A depicts a block card screen 910, in accordance with an embodiment. Upon selection of box 912, the prepaid card is blocked and a card block screen 916 depicted in FIG. 31B is provided. FIG. 31C depicts information provided in unblock alert screen 918 that may be used to unblock the prepaid card. For example, the merchant may be notified about how to unblock his prepaid card (e.g. to dial a phone number in order to unblock the prepaid card).

Suppose that reports server 101 receives a request to block the prepaid card account from merchant device 103, via network 104. Reports server 101 then blocks the prepaid card account.

Reports server 101 may never receive a request to unblock a prepaid debit card account. To unblock a prepaid debit card, the merchant calls customer service of the prepaid card issuer.

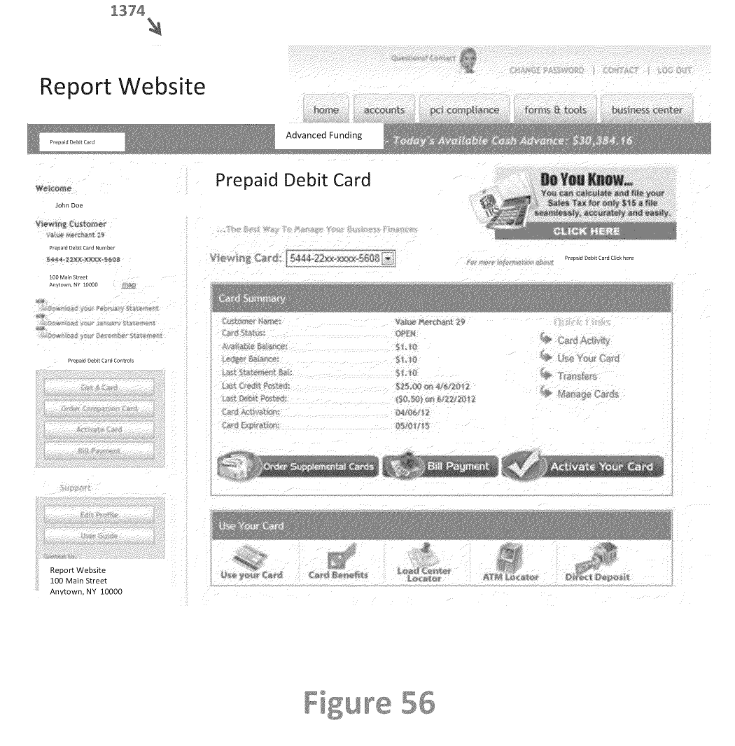

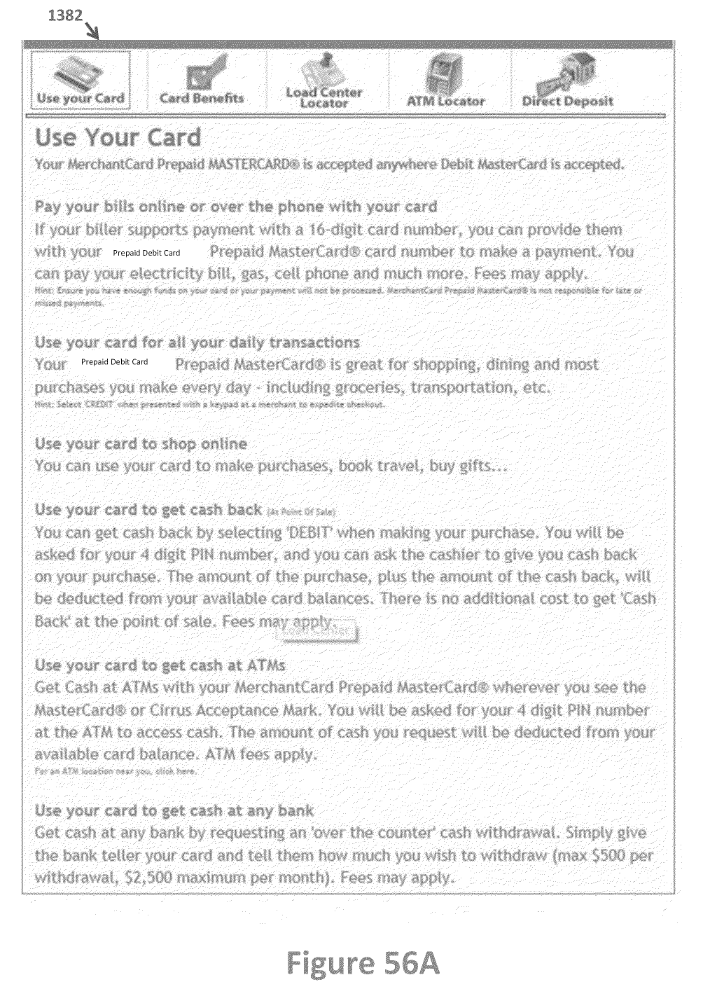

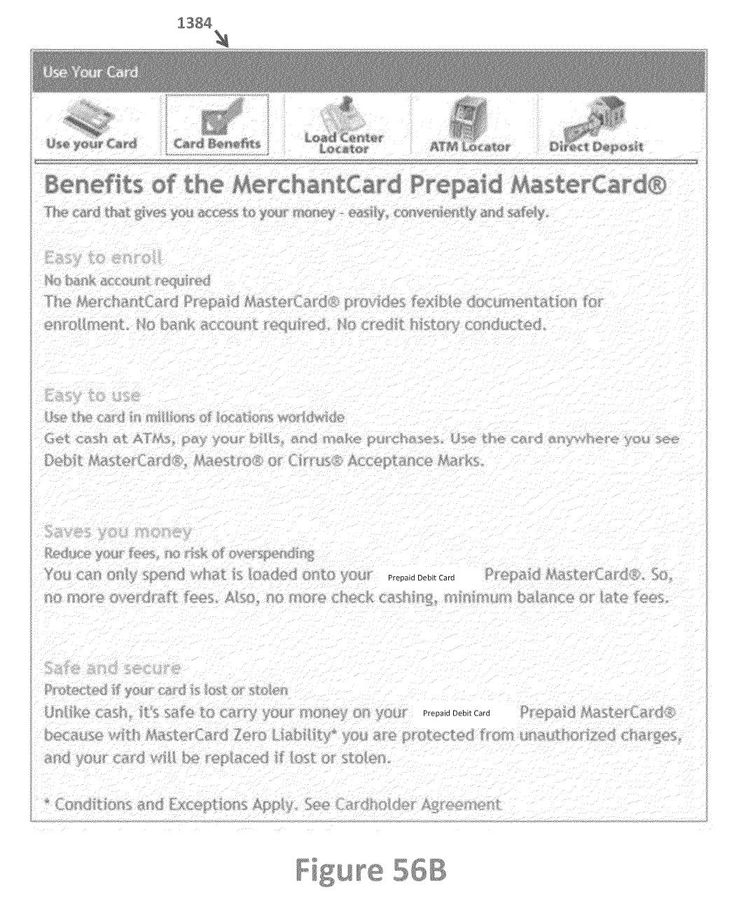

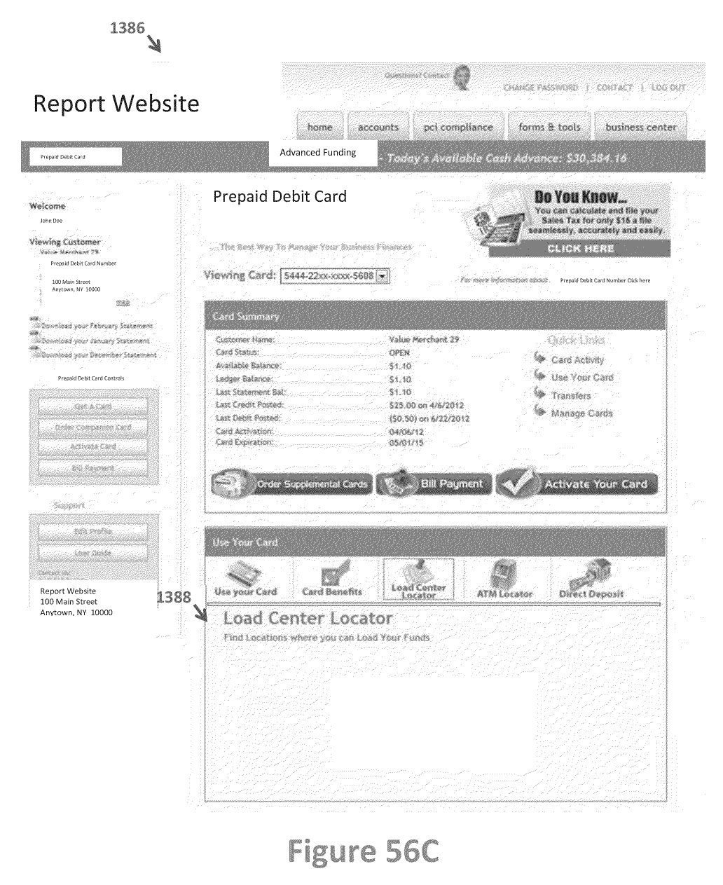

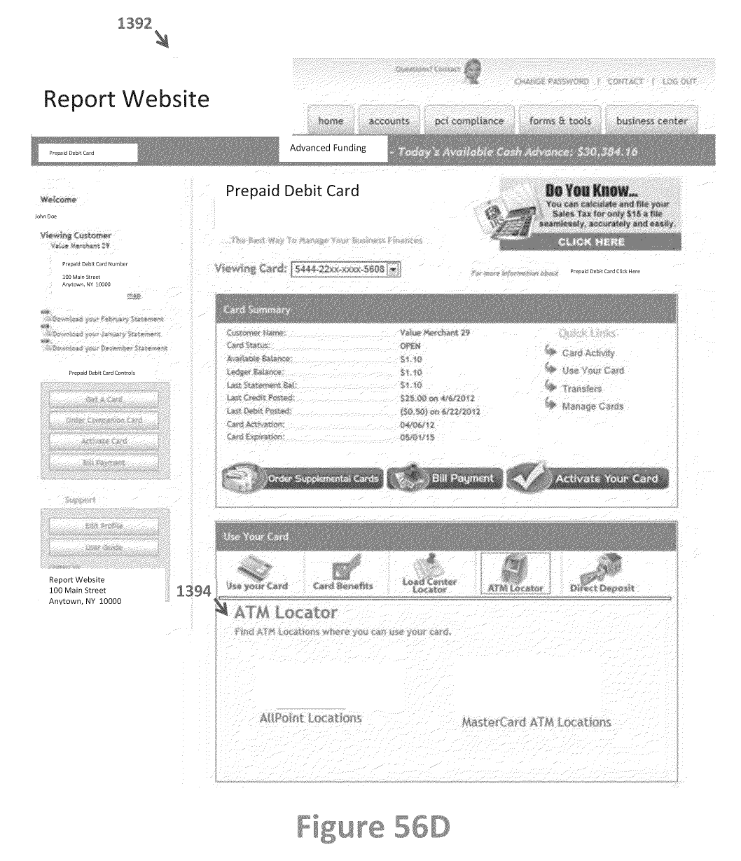

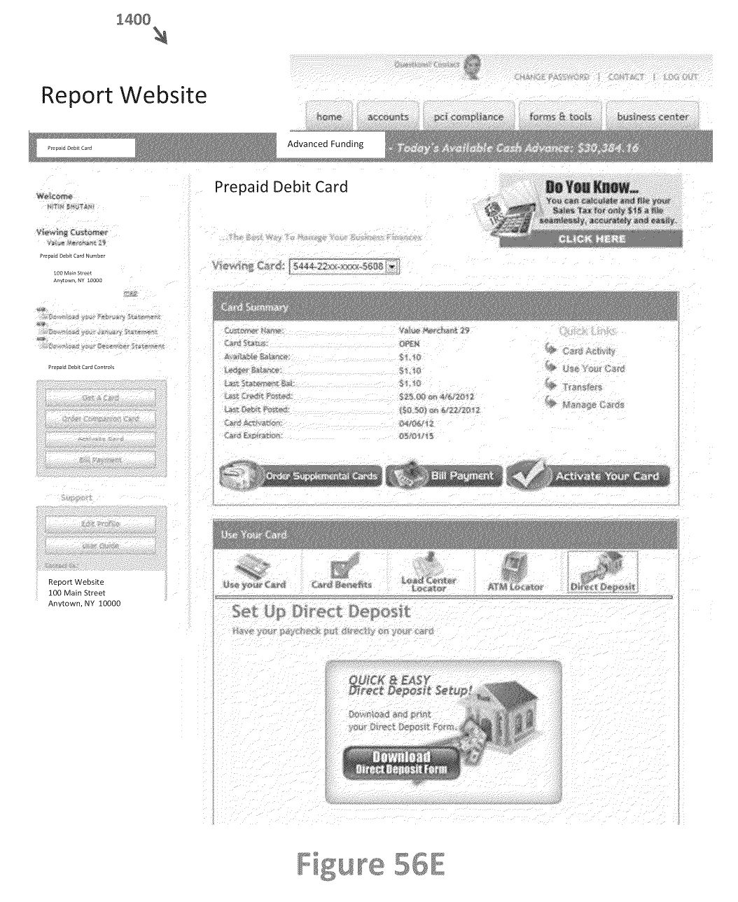

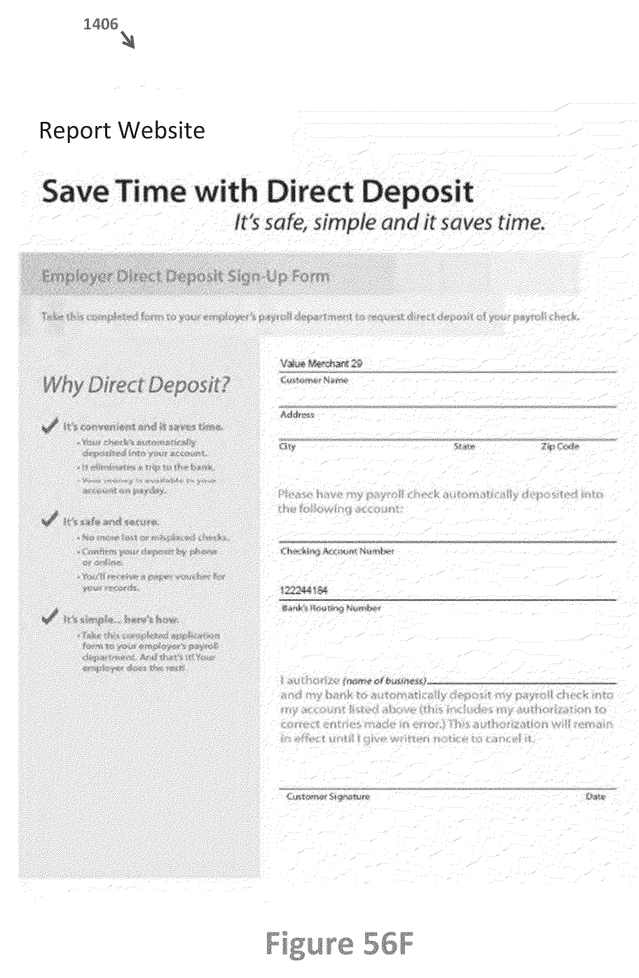

FIG. 56 on the report website depicts the use your card screen 1374, in accordance with an embodiment. FIG. 56A depicts information on how to use a prepaid debit card, on screen 1382. FIG. 56B depicts information on the benefits of the prepaid debit card, on screen 1384. FIG. 56C depicts information on finding a load center, on screen 1386. Details regarding a load center locator are shown in box 1388. FIG. 56D depicts the information on finding an ATM machine on screen 1392. FIG. 56E depicts a direct deposit screen 1400. FIG. 56F depicts a deposit form on screen 1406.

### Registering and Logging In

In an alternate embodiment, a merchant employing merchant device 103 may log in to their account either by going to a designated website (i.e., website 102) or through an ISO's, bank's or processor's website. The merchant registers by using his/her merchant identification number (MID#) along with setting up a few security questions. Once the merchant registers, he/she is taken directly to the web portal. The web portal provides detailed reports, analytics and account summaries. The merchant can also receive additional funding, pay bills online, become PCI certified, view trends and projections, or access additional products and services that are all designed by merchants for the benefit of merchants. FIG. 17 depicts a home screen 724, in accordance with an embodiment. On the report website, FIG. 37 depicts a home screen. The home screen provides information regarding the various features provided to the merchant. Merchants can view, sort, graph, filter, export, print and find data in a clear and concise manner. Each product/service has a summary and detail view for a number of data tables. Additionally, a number of useful reports and tools may be supplied. For example, merchants may download and print their own IRS form for accounting purposes. They can also pay bills, download statements, see future trends and use calculators to help with valuable cash flow projections.

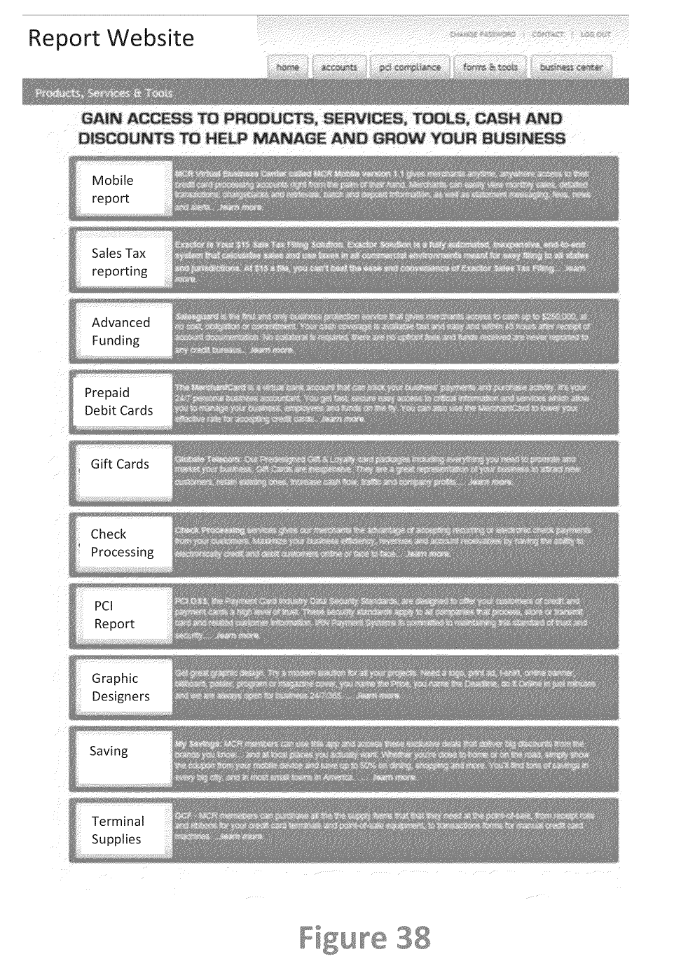

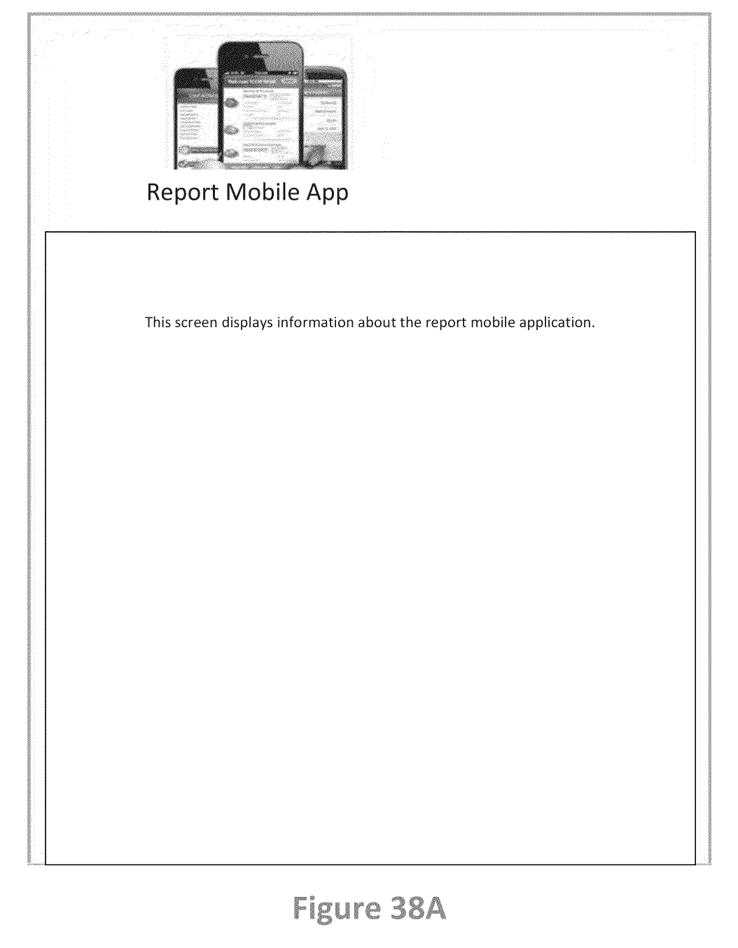

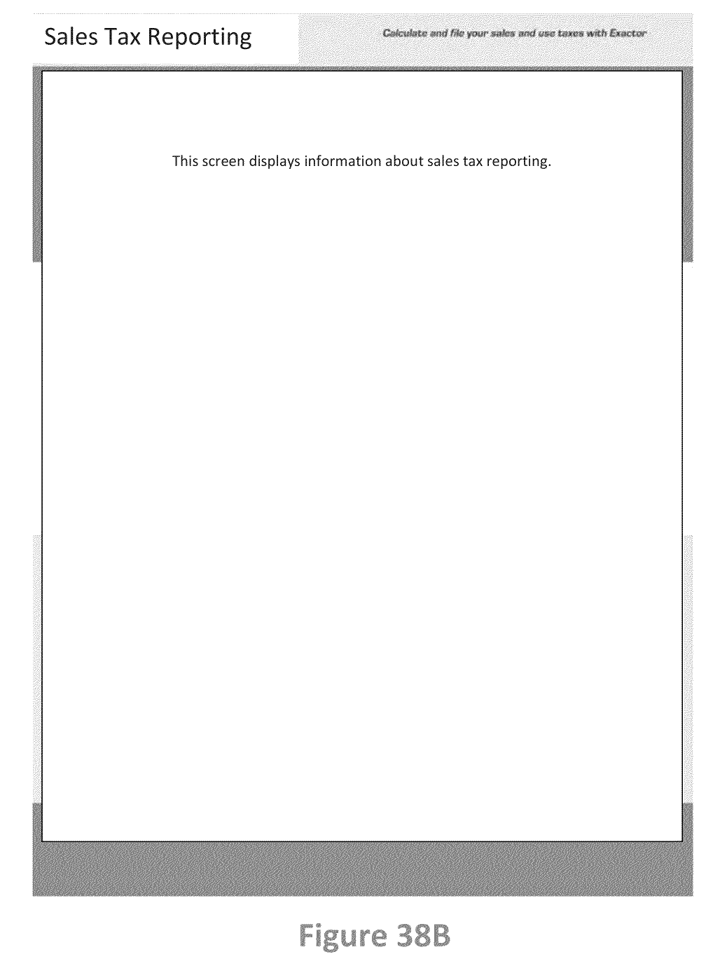

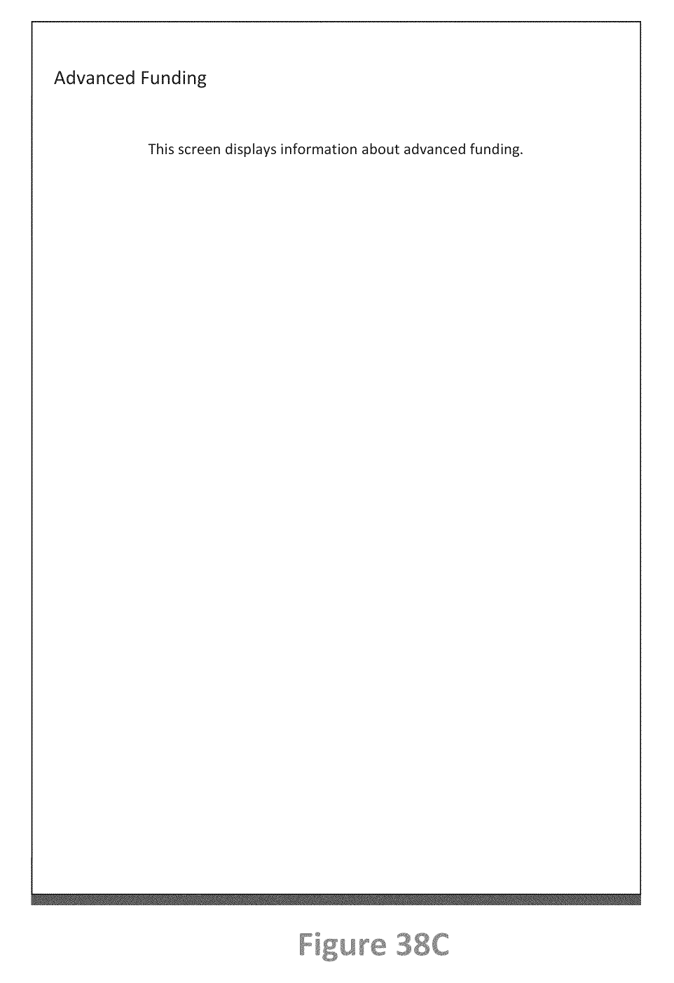

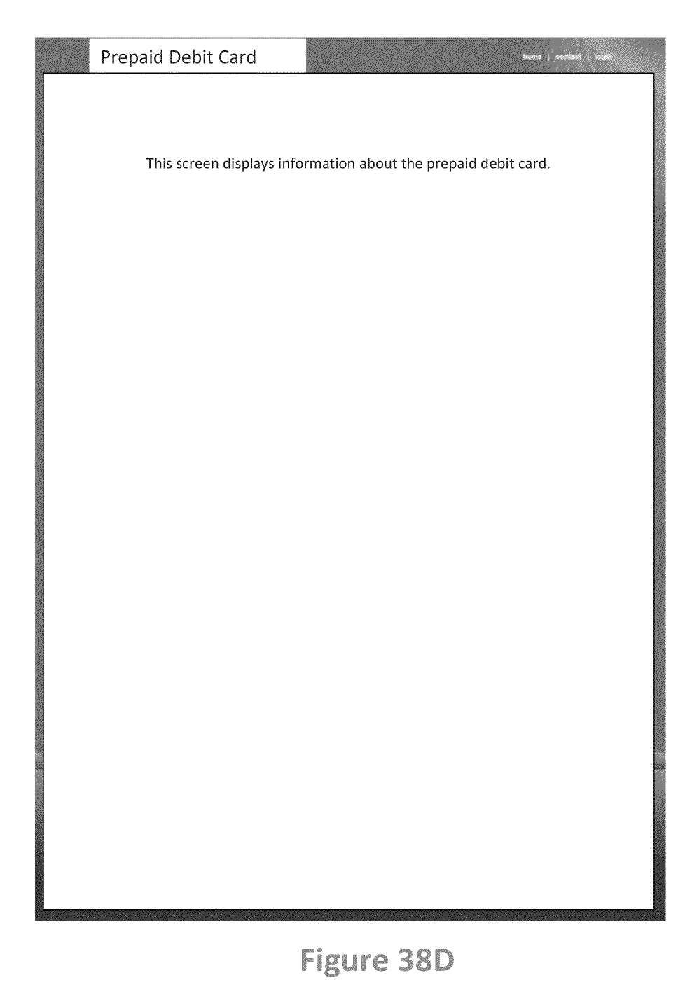

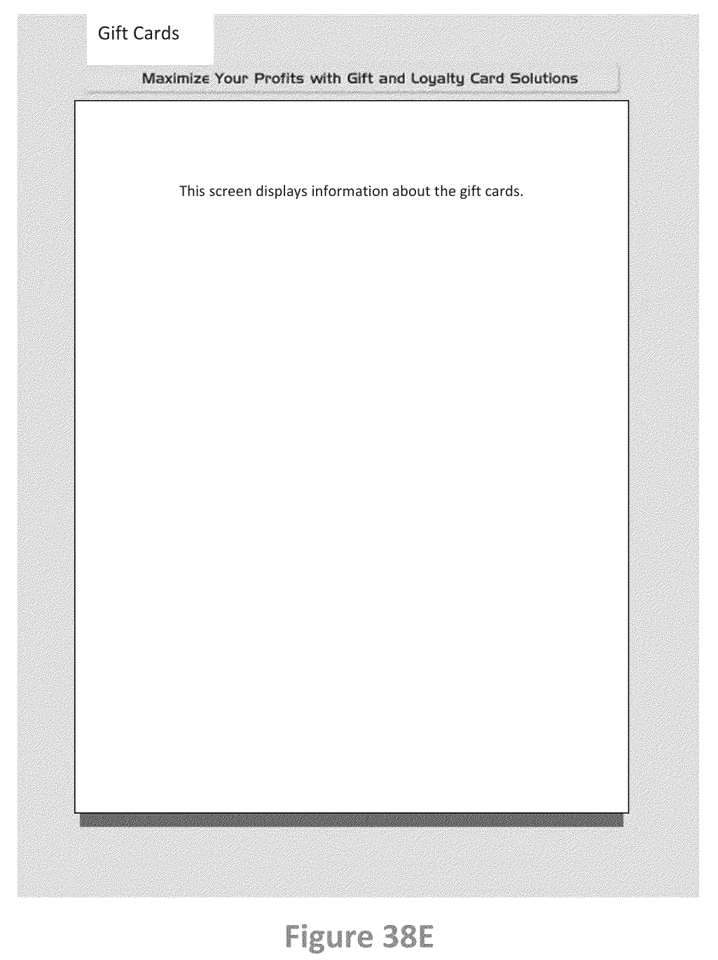

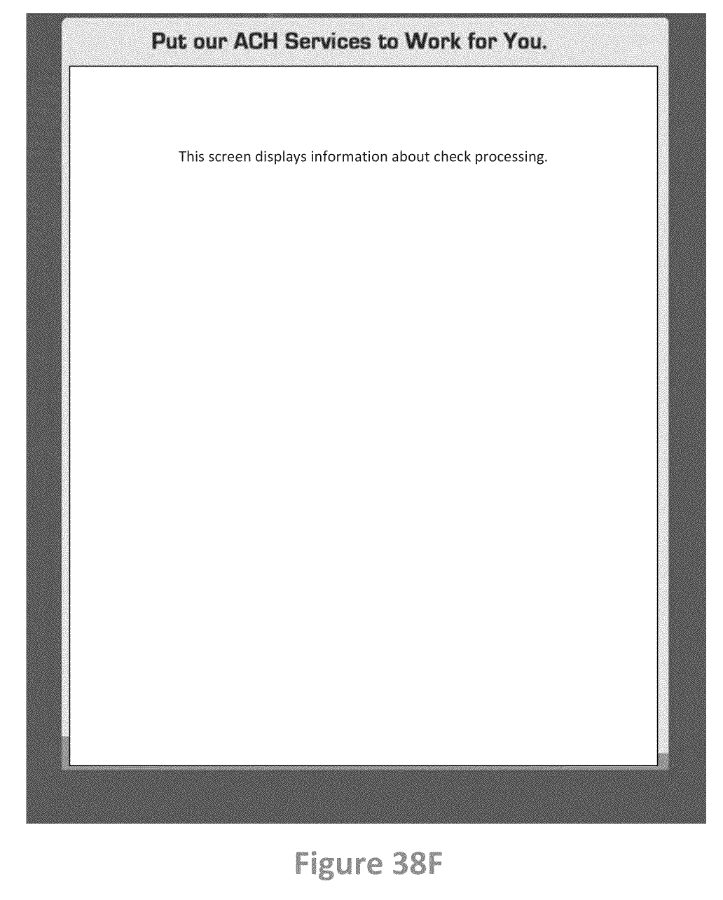

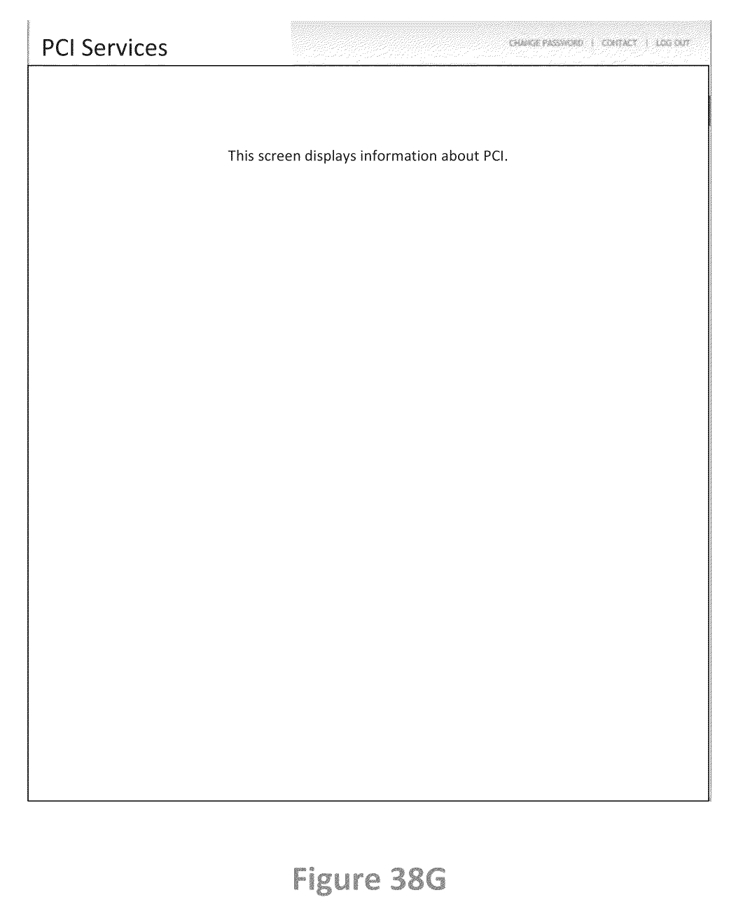

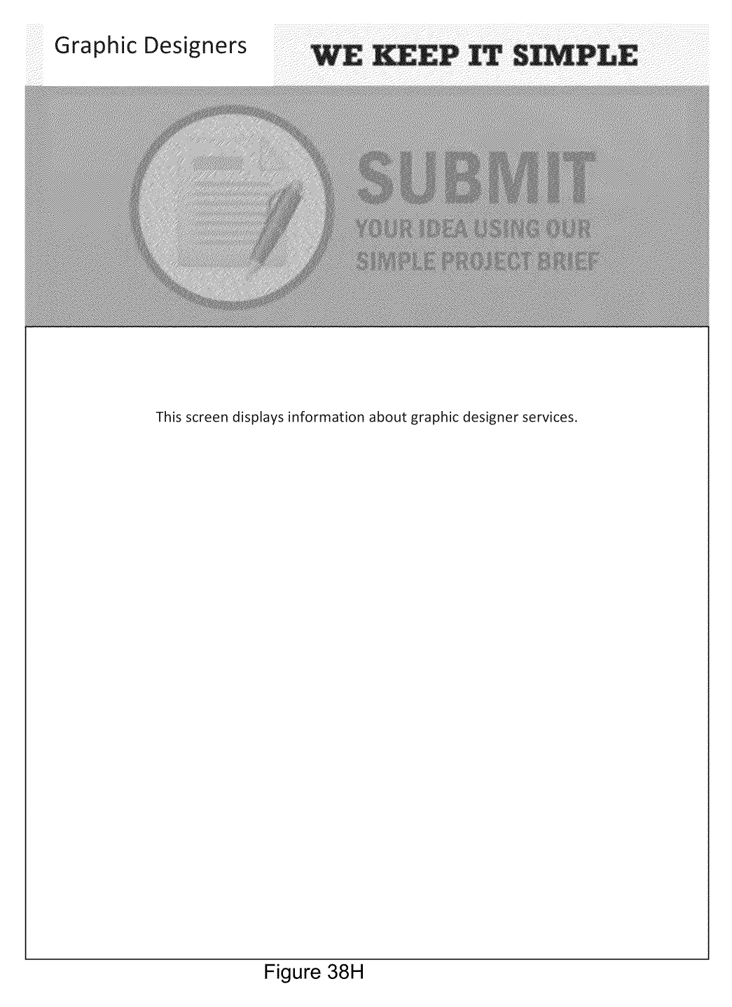

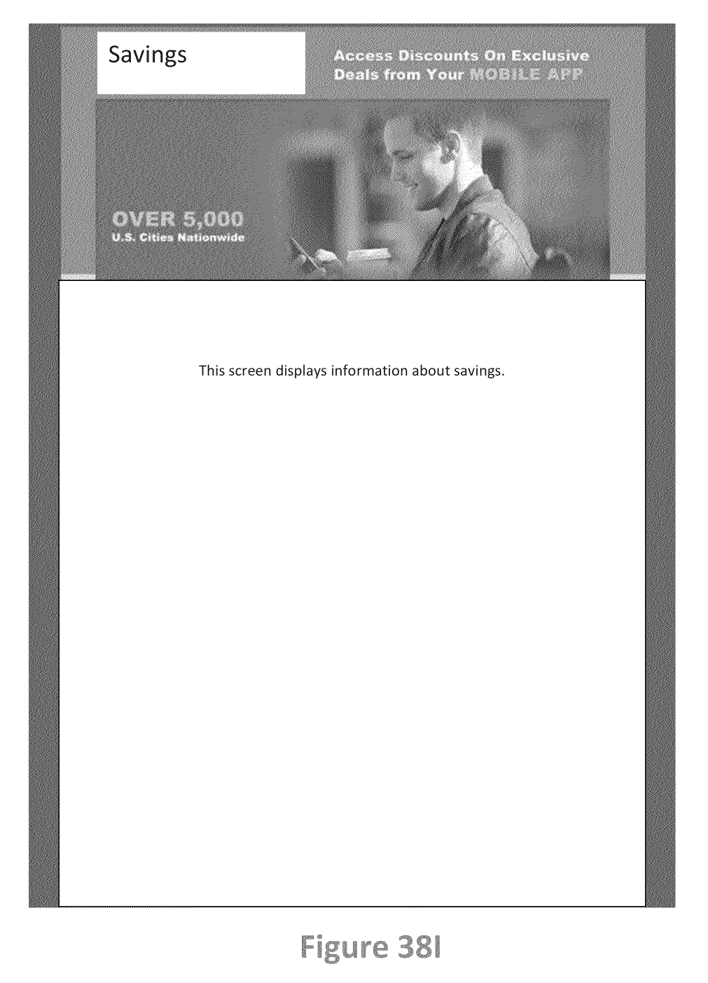

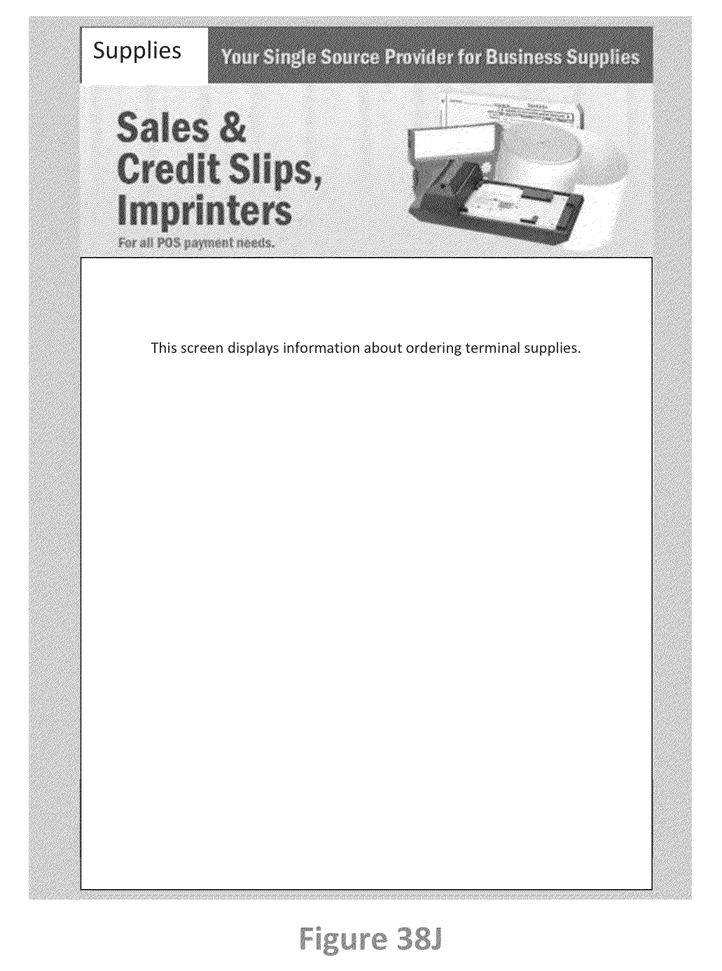

FIG. 38, on the report website, depicts a home screen listing all partners and their products. FIG. 38A through 38J depicts each partner's product information.

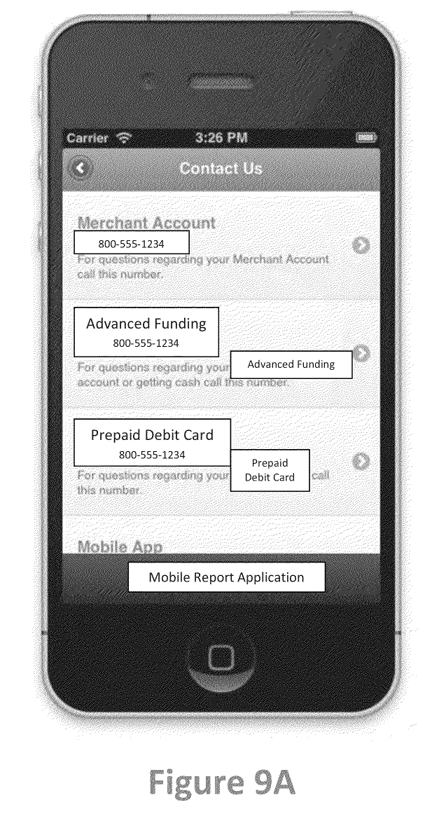

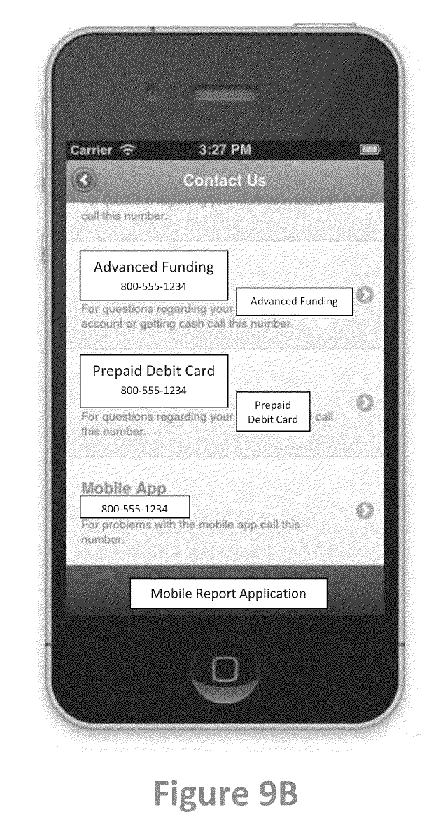

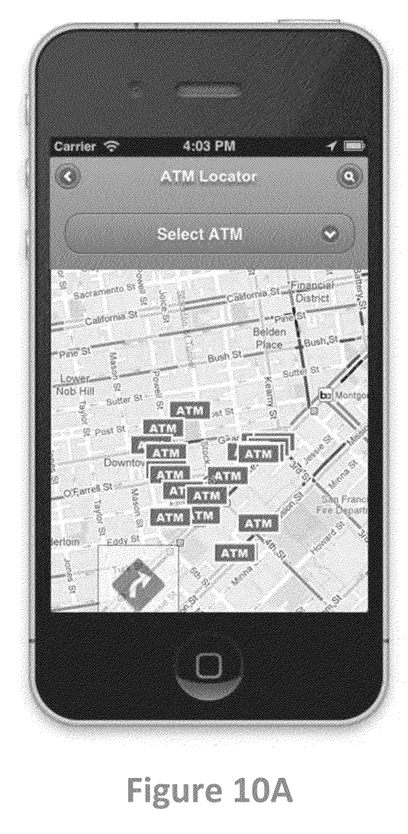

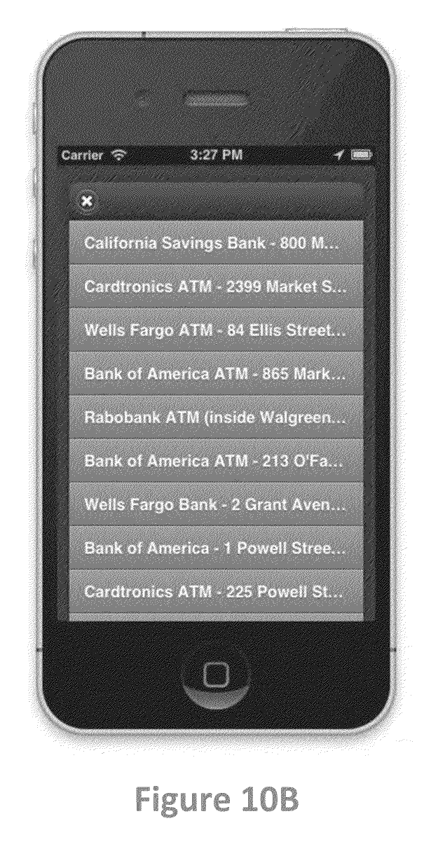

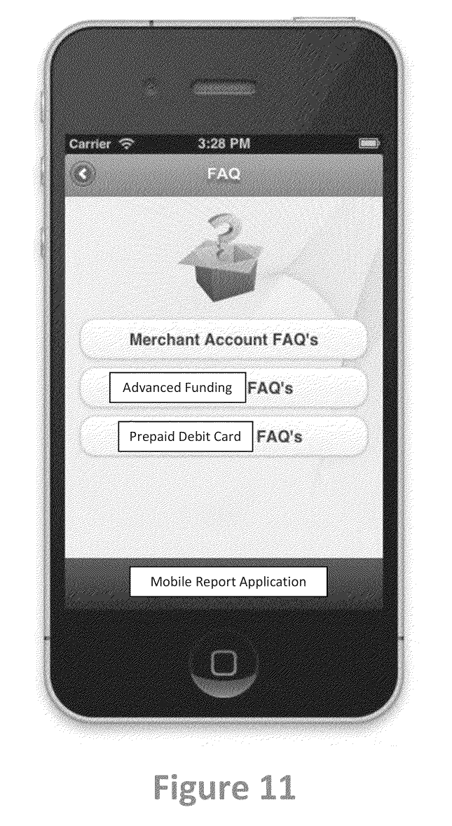

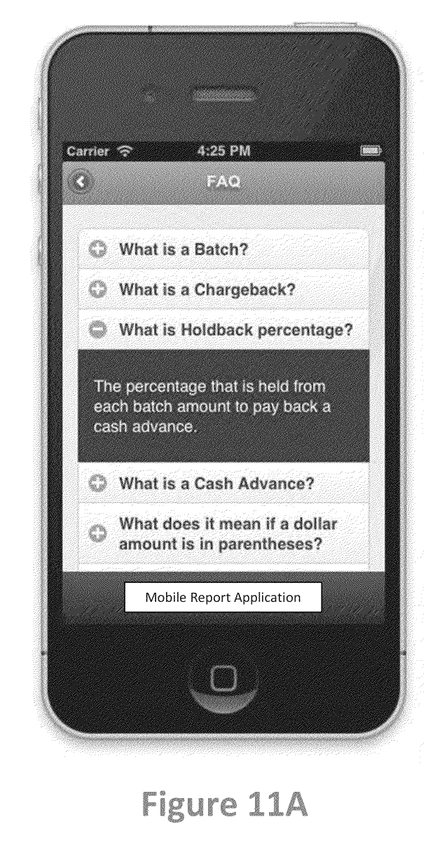

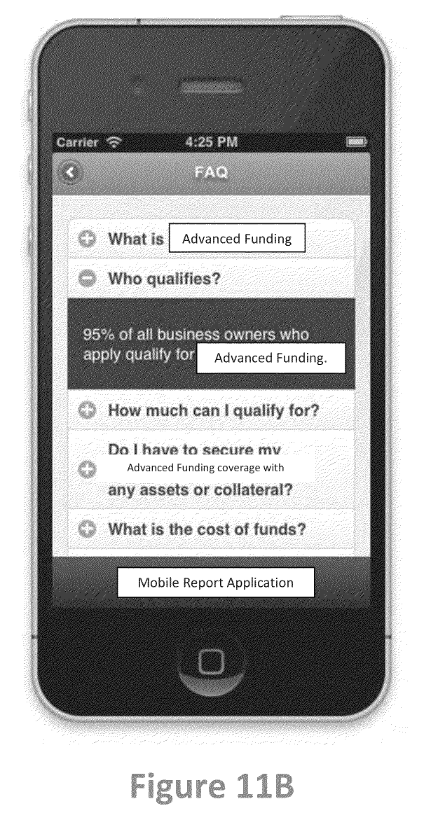

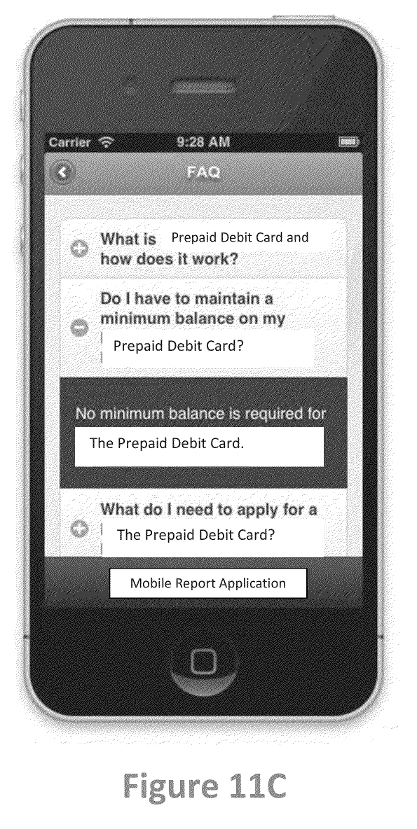

FIGS. 9A and 9B depict the contact information, in accordance with an embodiment. FIGS. 10A and 10B depict an ATM locator, in accordance with an embodiment. FIGS. 11 through 11C depict FAQ's for each product.

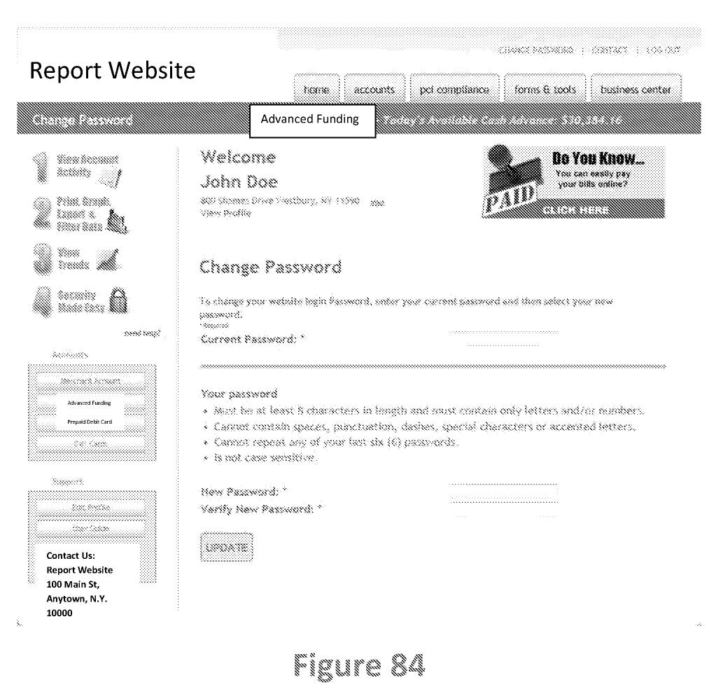

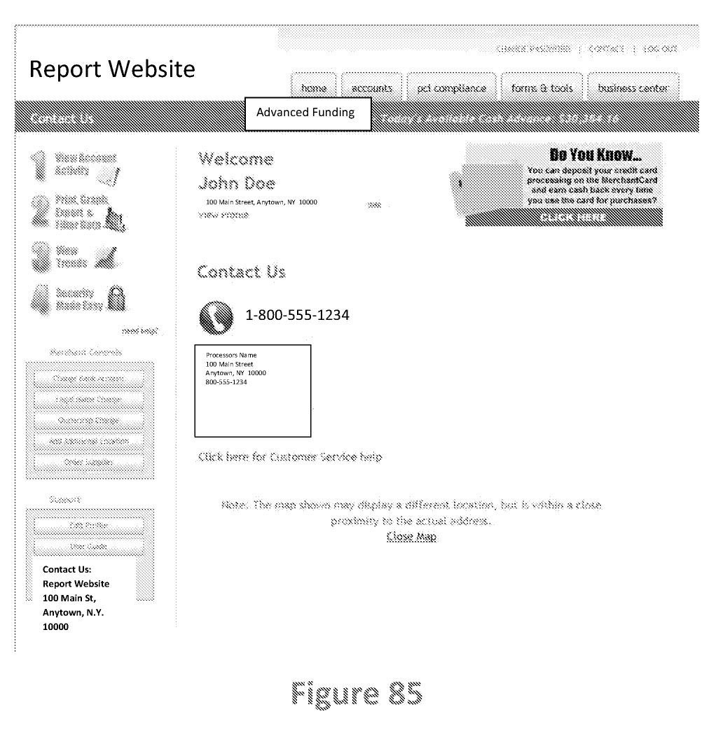

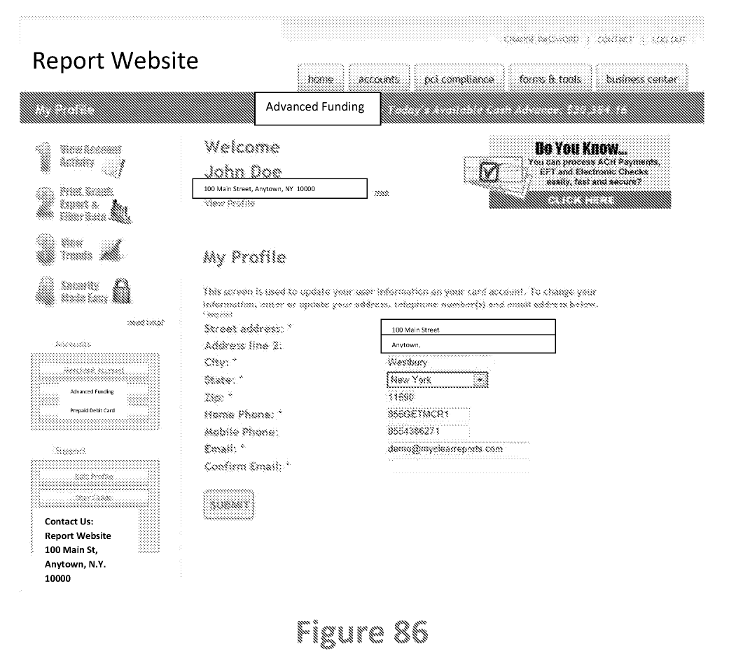

On the report website, FIG. 85 depicts the contact information, in accordance with an embodiment. FIG. 86 depicts the profile screen, in accordance with an embodiment. FIG. 84 depicts changing the merchant's login password, in accordance with an embodiment. The merchant may change the password by clicking on box 1856 to update the password.

The system and financial service providers work together to customize the portal for the financial service provider merchant. Products and services provided by the system may create income or revenue for the financial service provider. These products and services include the following.

### Gift and Loyalty Card Program

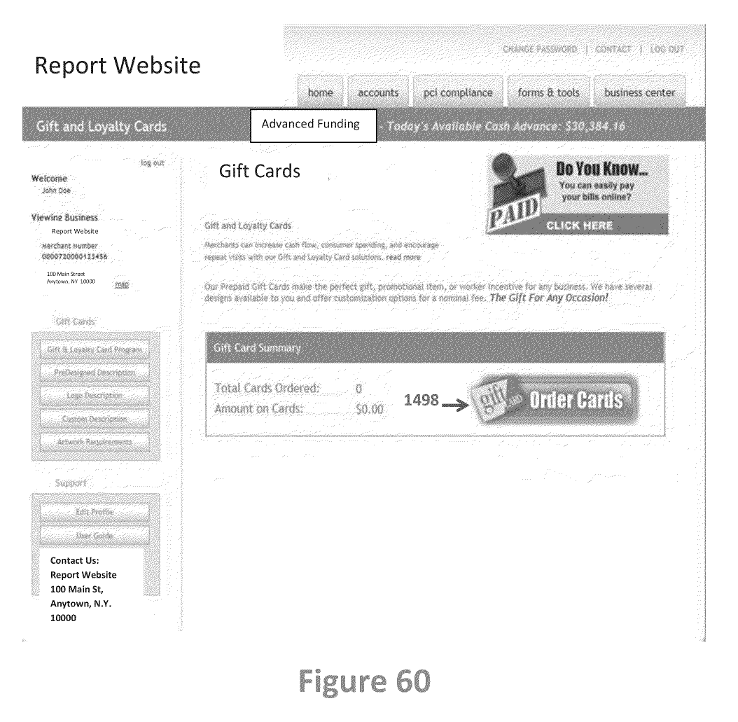

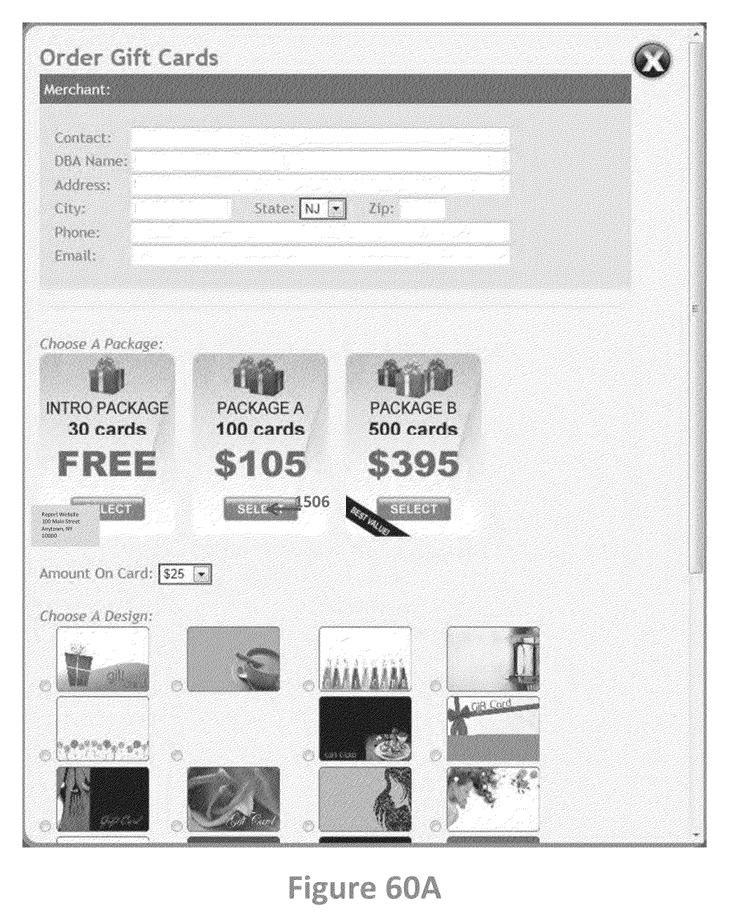

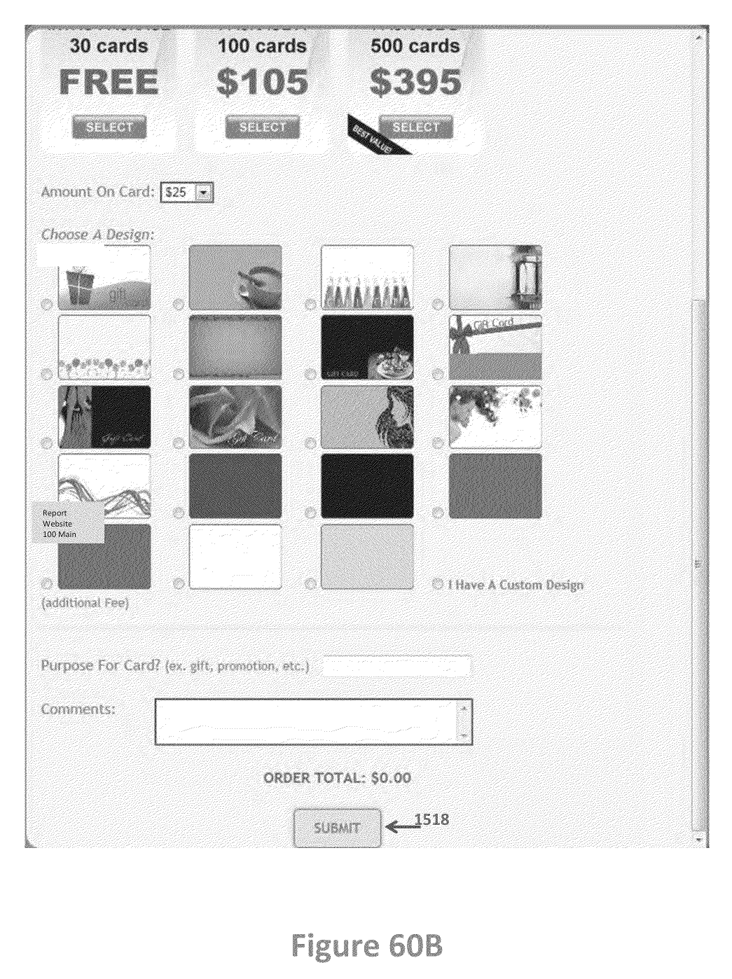

Merchants may acquire a gift and loyalty card program by ordering cards online and integrated detailed reporting as shown in FIG. 60. FIGS. 60A and 60B depict gift card order forms, in accordance with an embodiment.

### Check Processing Program

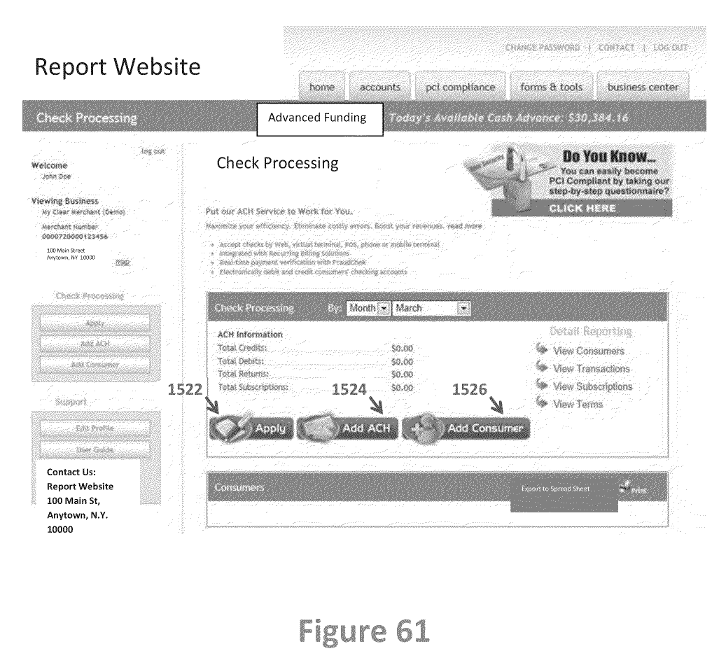

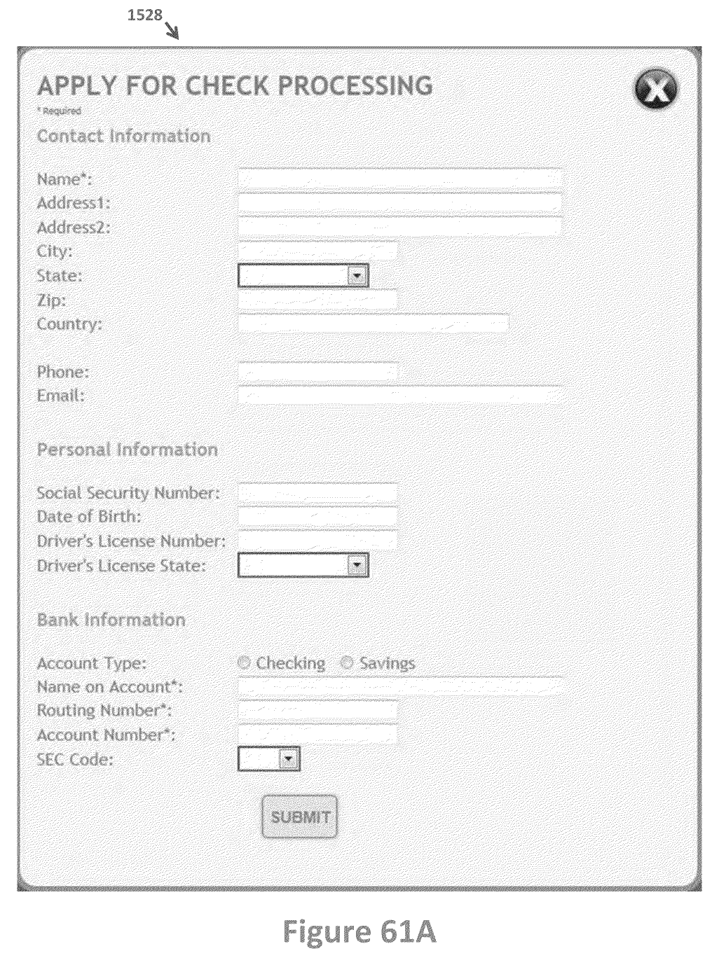

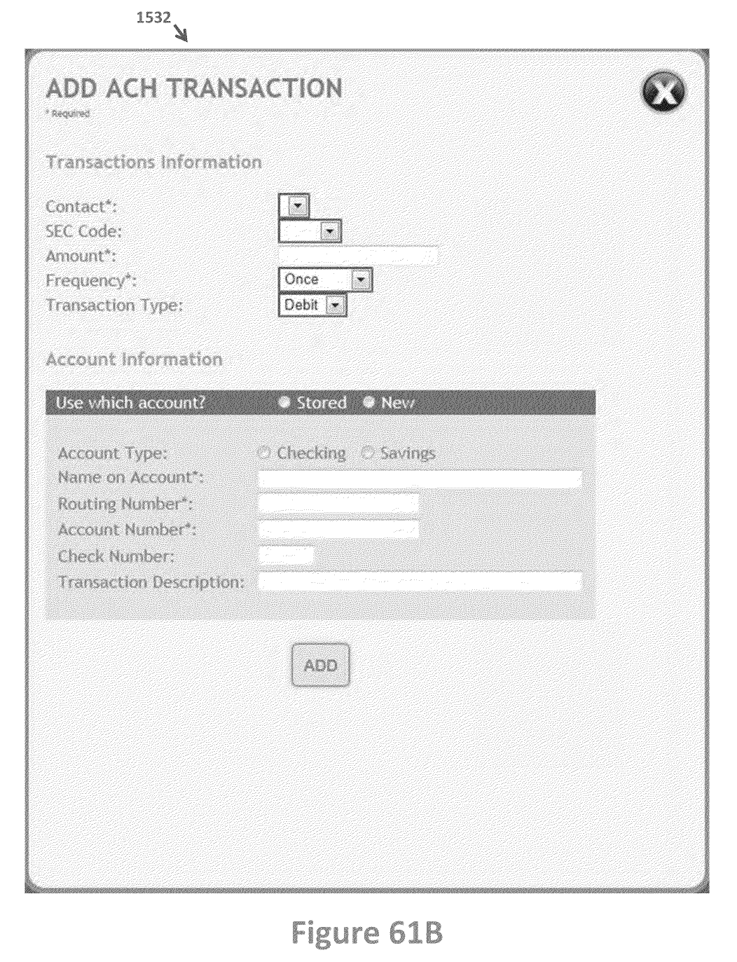

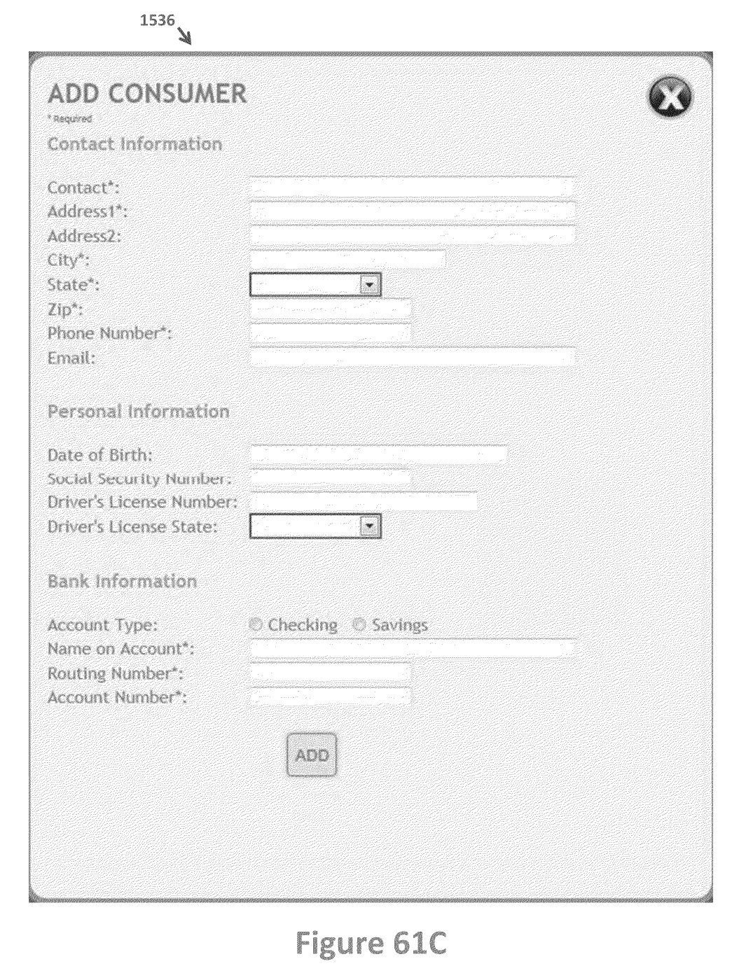

Merchants may acquire a check processing program by enrolling into the check processing services as shown in FIG. 61, in accordance with an embodiment. Clicking box 1522 allows the merchant to apply for the check processing program. FIG. 61A depicts a check processing application form screen 1528. Clicking box 1524 allows the merchant to add an ACH transaction. FIG. 61B depicts a check processing add ACH transaction form screen 1532. Clicking box 1526 allows the merchant to add a consumer. FIG. 61C depicts the check processing add a consumer form screen 1536.

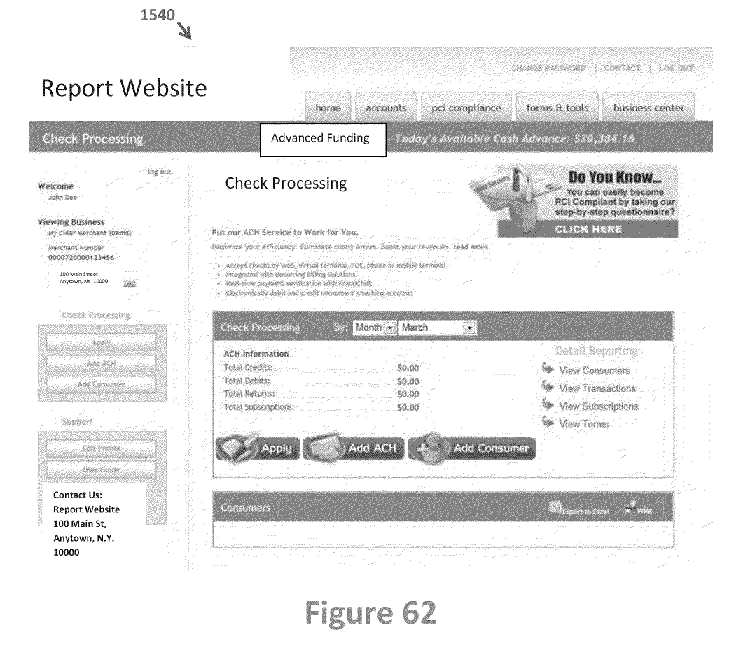

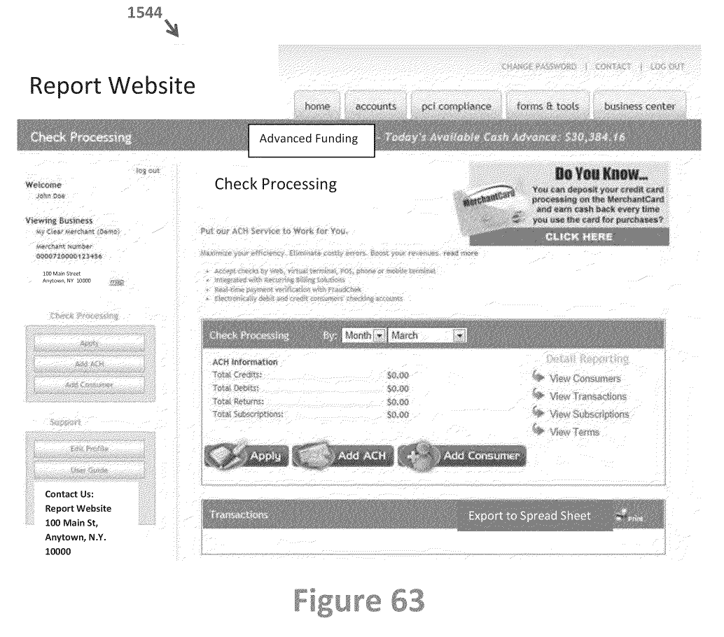

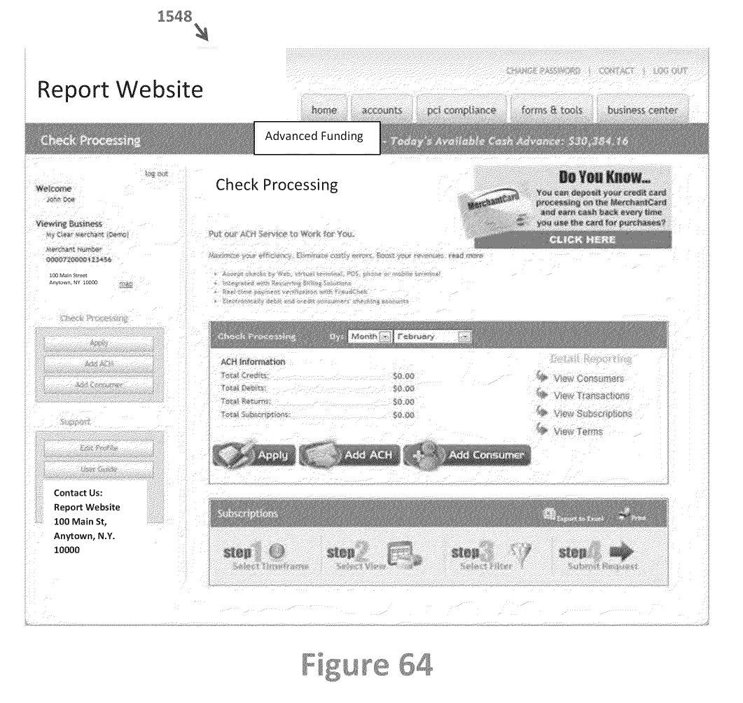

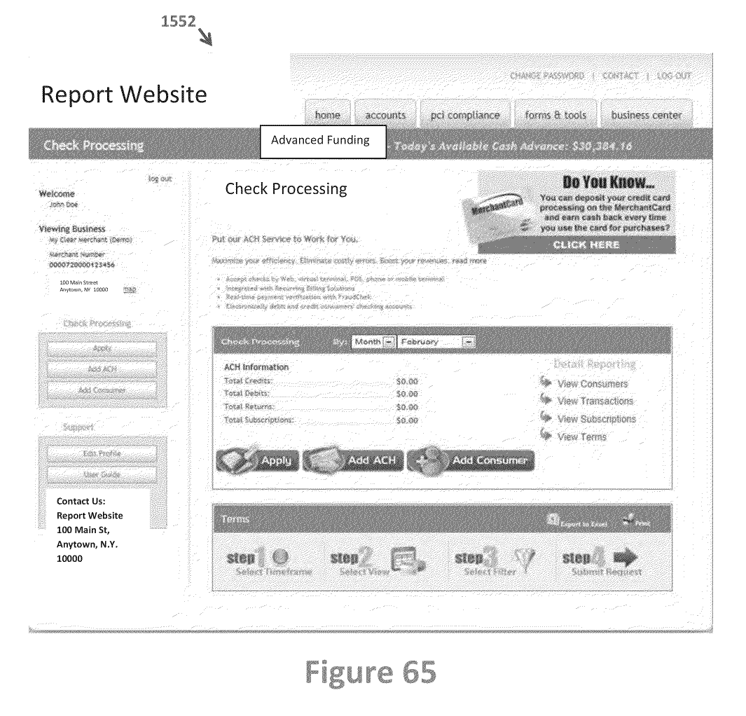

FIG. 62 depicts a view consumers screen 1540, in accordance with an embodiment. FIG. 63 depicts a view transactions, screen 1544, for check processing, in accordance with an embodiment. FIG. 64 depicts a view subscriptions, screen 1548, in accordance with an embodiment. FIG. 65 depicts a view terms for check processing, screen 1552, in accordance with an embodiment.

### IRS 1099K Program

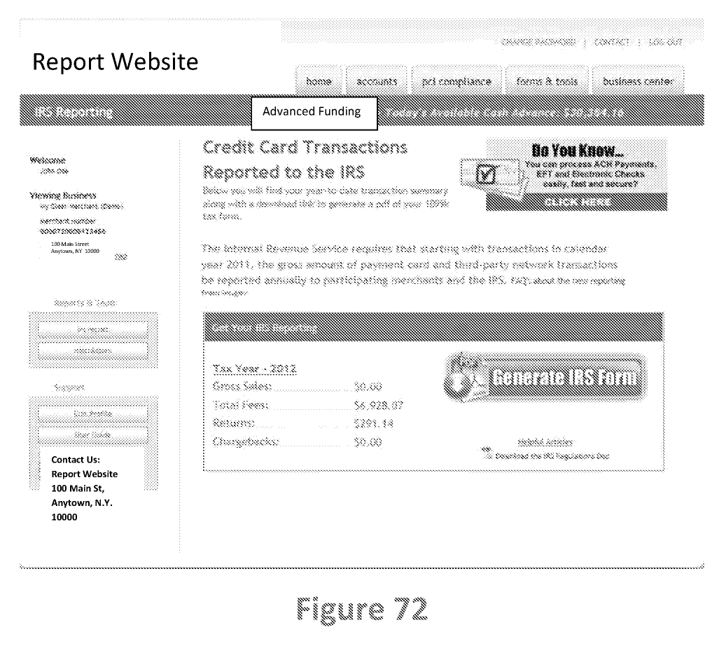

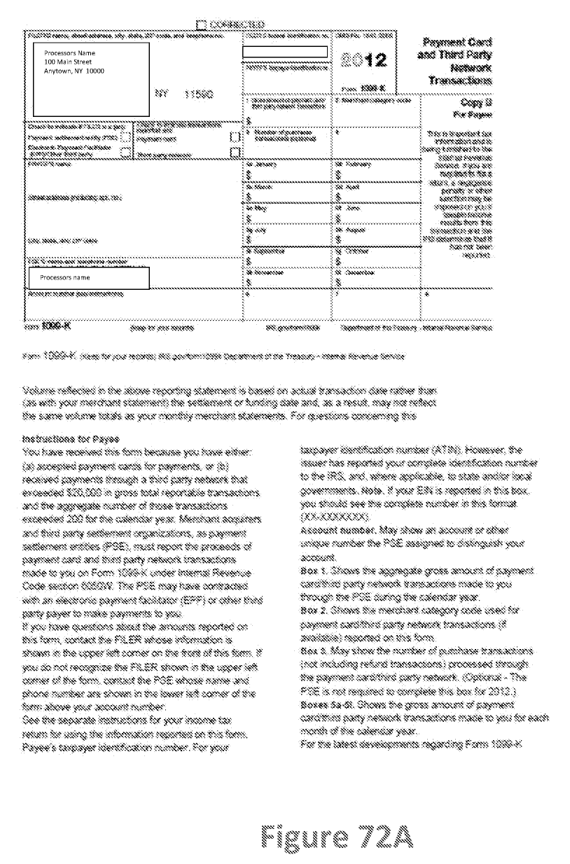

Merchants may receive their annual IRS 1099K form, as depicted in FIG. 72A. FIG. 72 depicts a reporting screen 1734, in accordance with an embodiment.

### Sales Tax Reporting Program

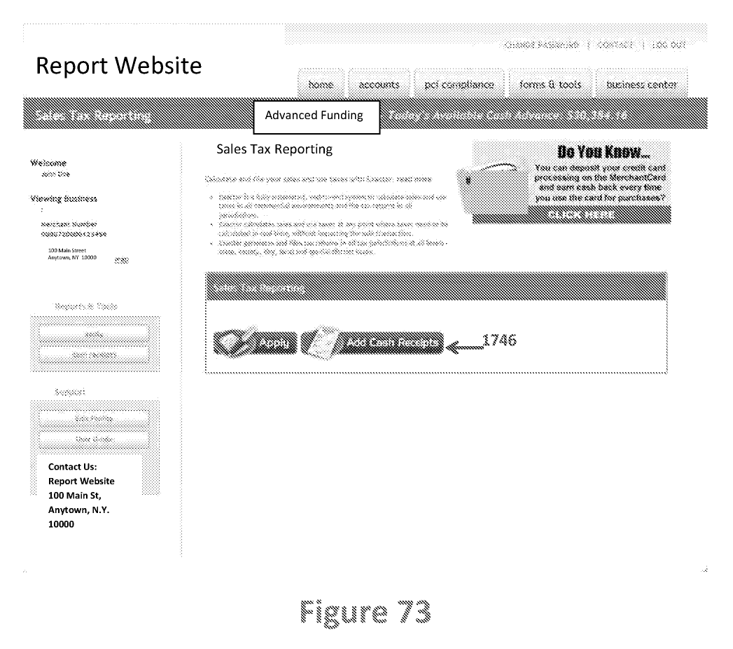

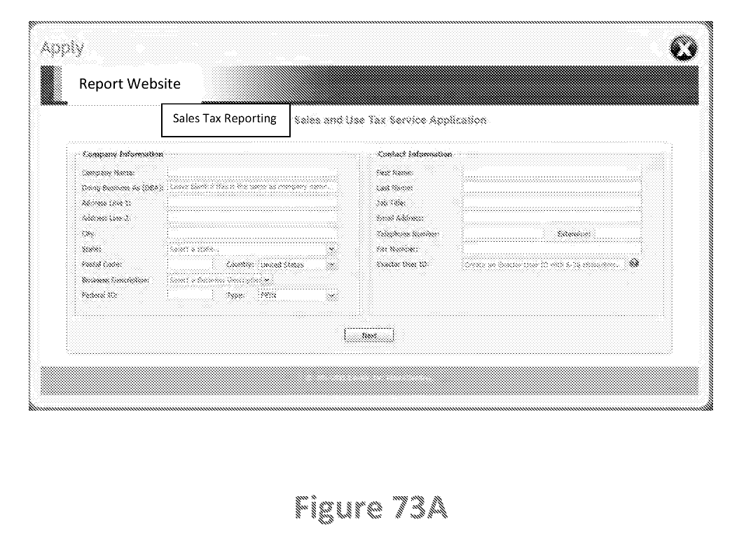

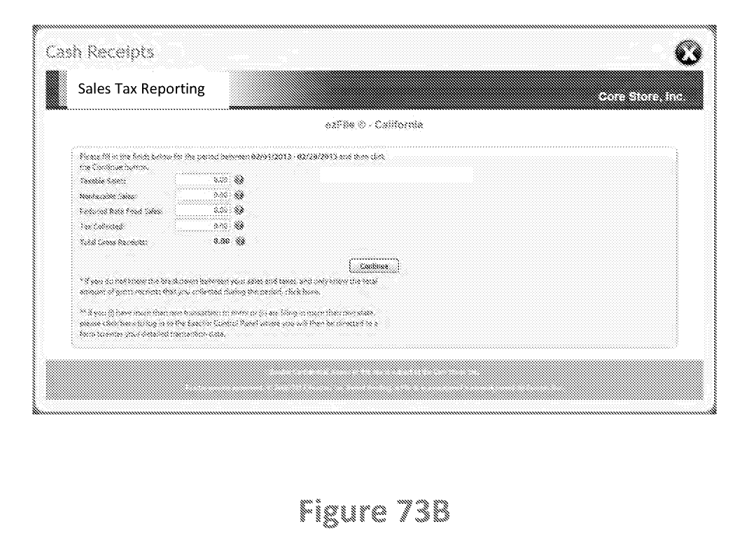

Merchants may file sales tax with a local jurisdiction by using the sales taxing reporting program depicted on screen 1742 in FIG. 73. FIG. 73A depicts an application for sales tax reporting shown in screen 1748, in accordance with an embodiment. FIG. 73B depicts the input form for cash receipts, in accordance with an embodiment.

### Graphic Designer Program

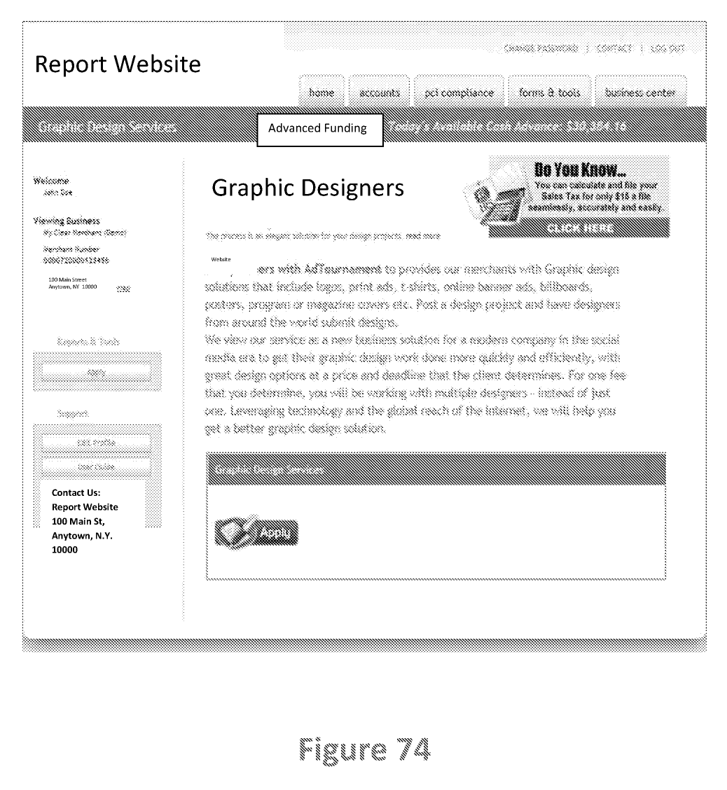

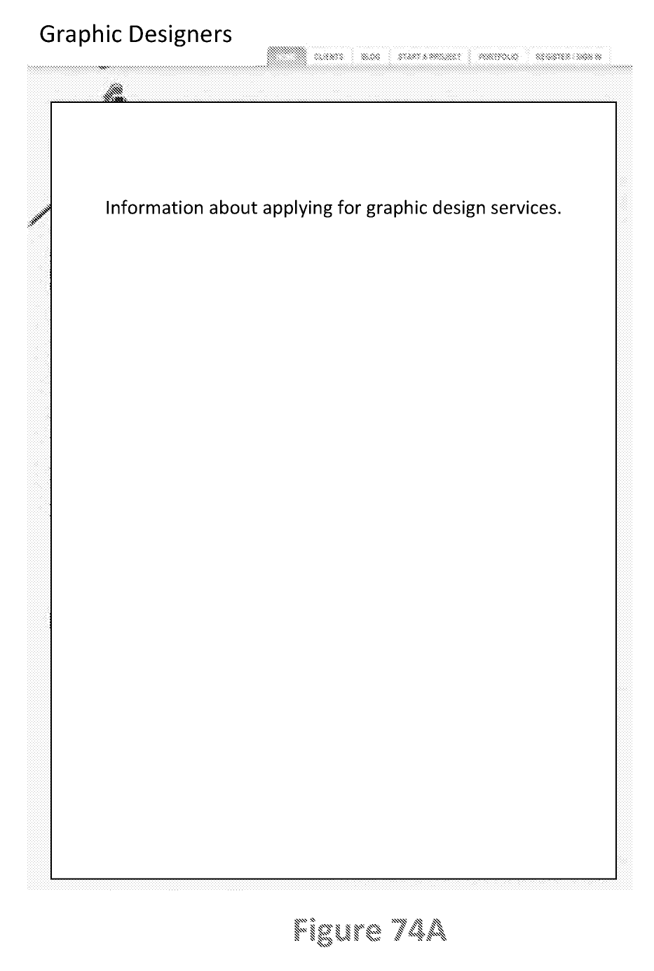

Merchants may acquire graphic design products by using the graphic designer program depicted on screen 1752 in FIG. 74. FIG. 74A depicts the application process for using graphic designer program shown in screen 1756, in accordance with an embodiment.

### Savings Program

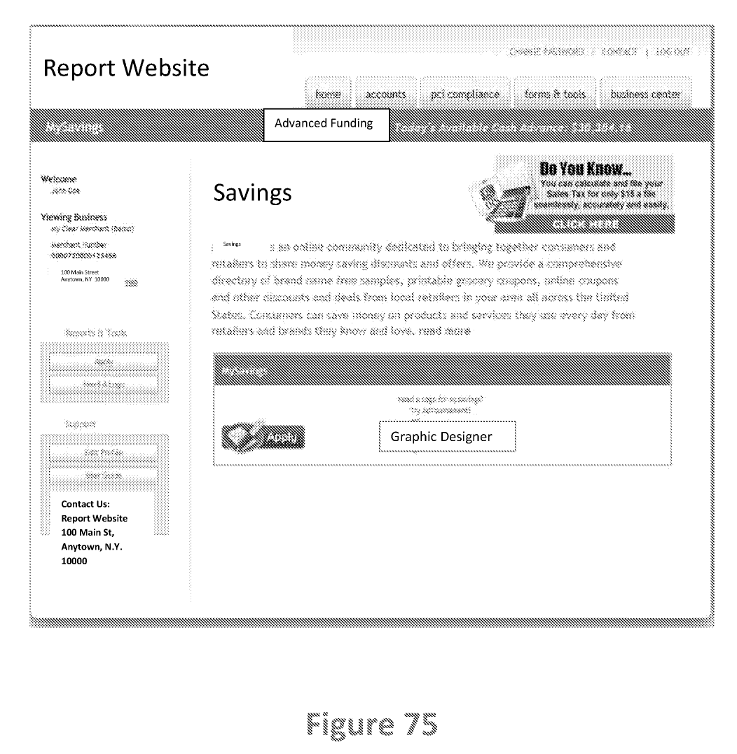

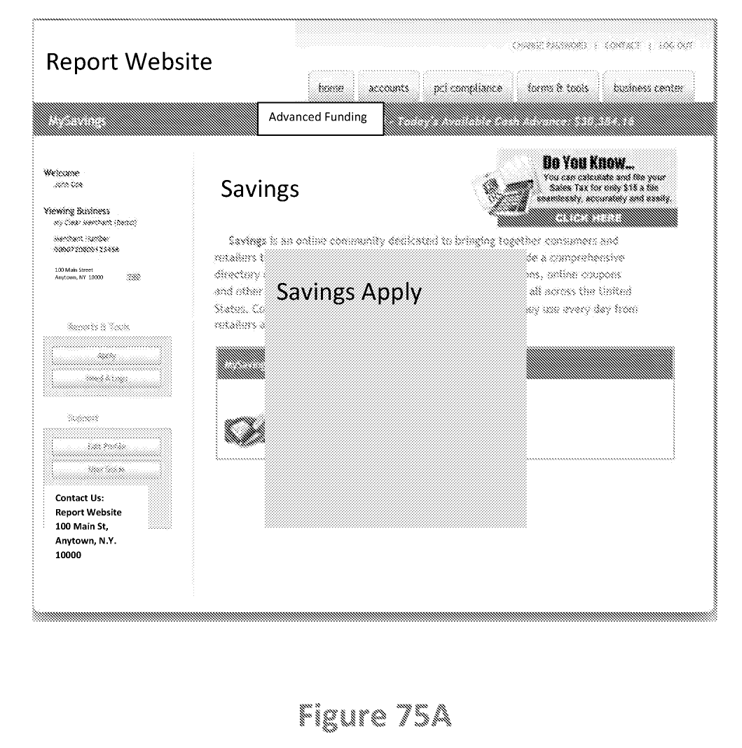

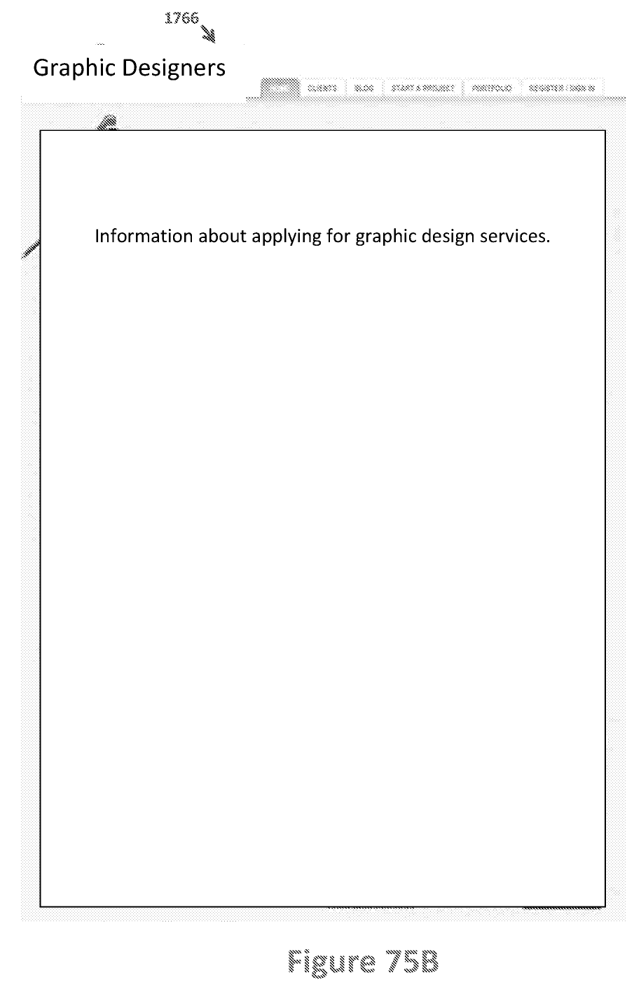

Merchants may acquire discounts and offer discounts by using the savings program depicted screen 1758 in FIG. 75. Clicking box 1760 displays the apply screen 1764 as depicted in FIG. 75A, in accordance with an embodiment. Clicking box 1762 displays the graphic designer apply program screen 1766 as depicted in FIG. 75B, in accordance with an embodiment.

### Calculators

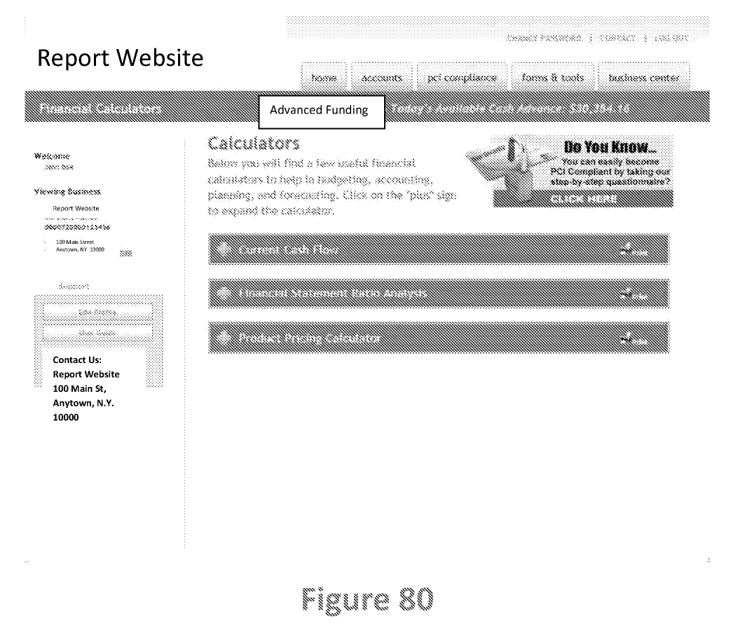

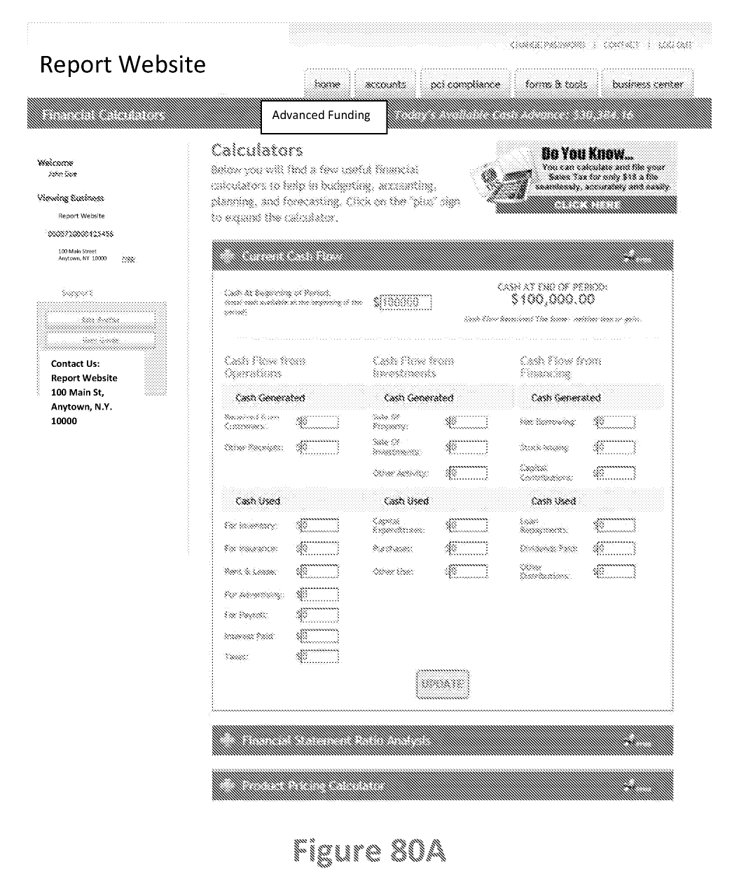

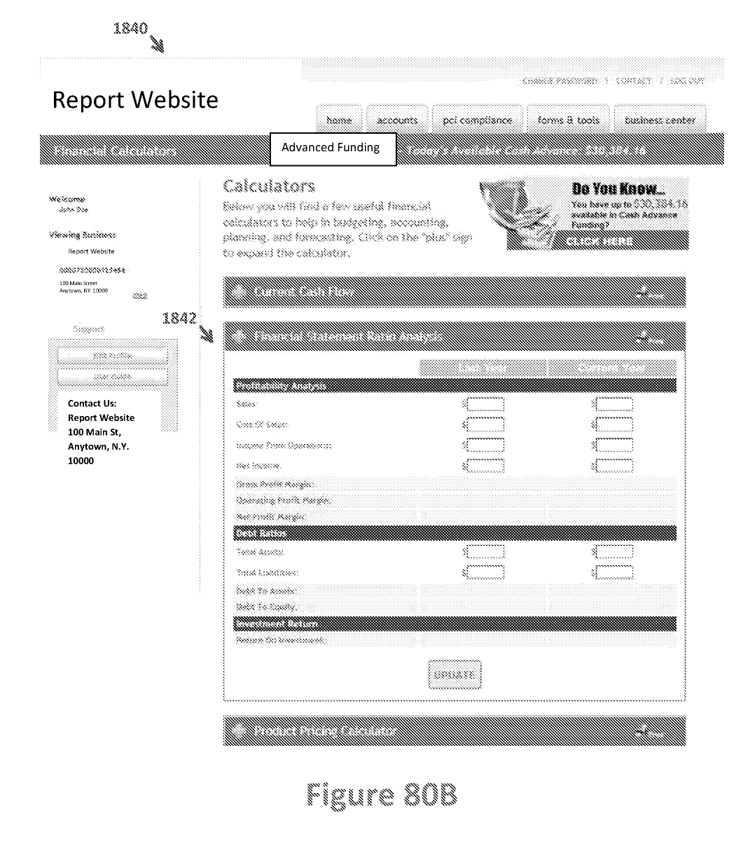

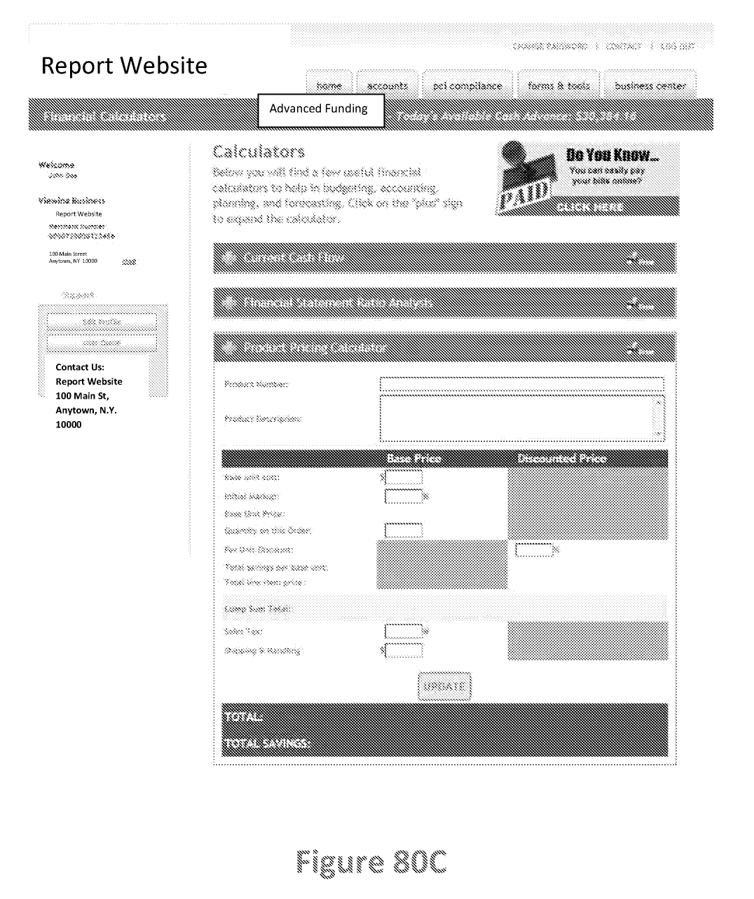

Merchants may use different financial calculators as provided by the calculator section as depicted screen 1828 in FIG. 80. FIG. 80A depicts a current cash flow calculator, shown in current cash flow box 1838 in screen 1836 in accordance with an embodiment. FIG. 80B depicts a financial statement ratio calculator, shown in financial statement ratio analysis box 1842 in screen 1840 in accordance with an embodiment. FIG. 80C depicts a product pricing calculator, shown in product pricing calculator box 1846 in screen 1844 in accordance with an embodiment.

### Discounts

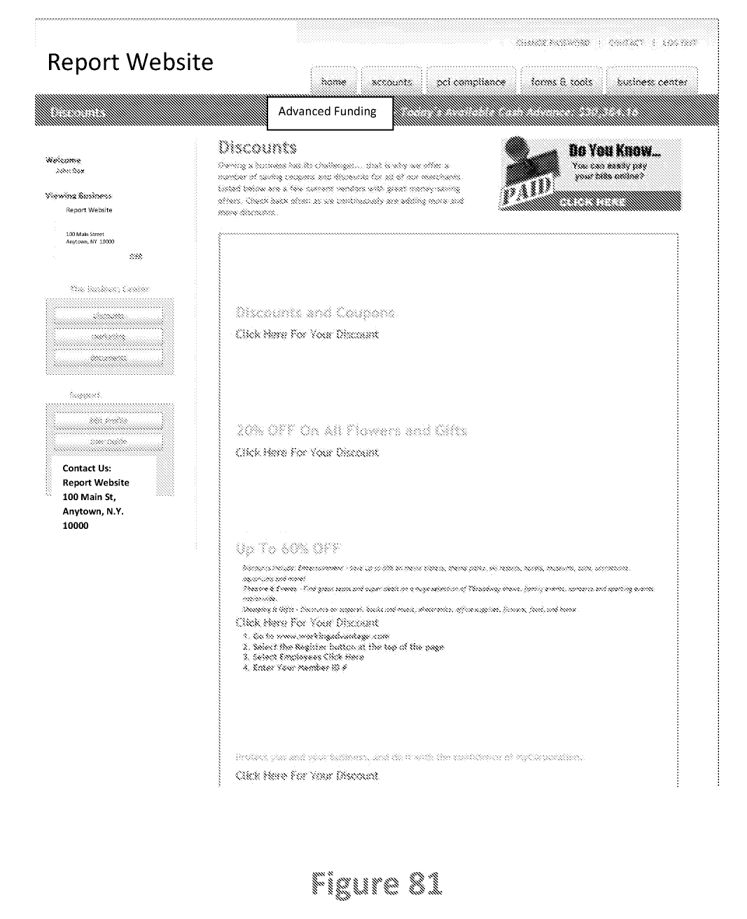

FIG. 81 depicts a discount screen 1848 of various vendors that merchants can utilize, in accordance with an embodiment.

### Marketing Tips

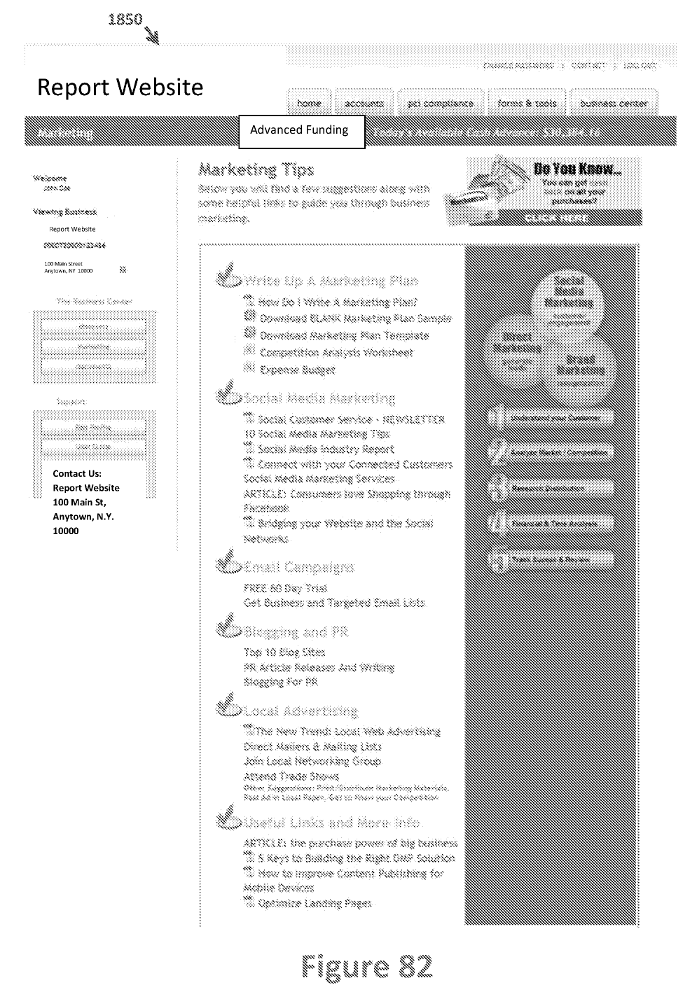

FIG. 82 depicts a marketing tips screen 1850 where merchants can access various hyperlinks and articles concerning marketing their products, in accordance with an embodiment.

### Documents

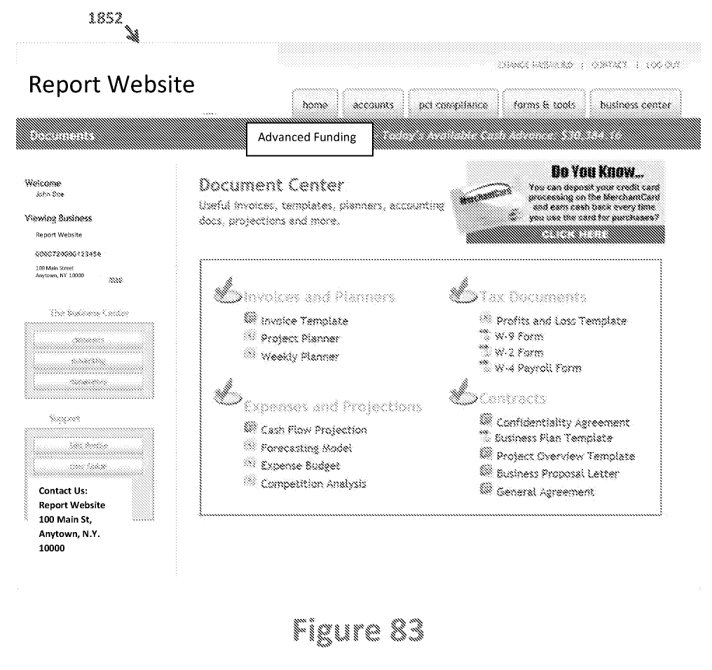

FIG. 83 depicts a document center screen 1852 that merchants can utilize, in accordance with an embodiment.

### Online Bill Payment

The merchant financing availability of advanced funds may be utilized to pays bills directly to desired vendors. The program within advanced funds is called bill pay.

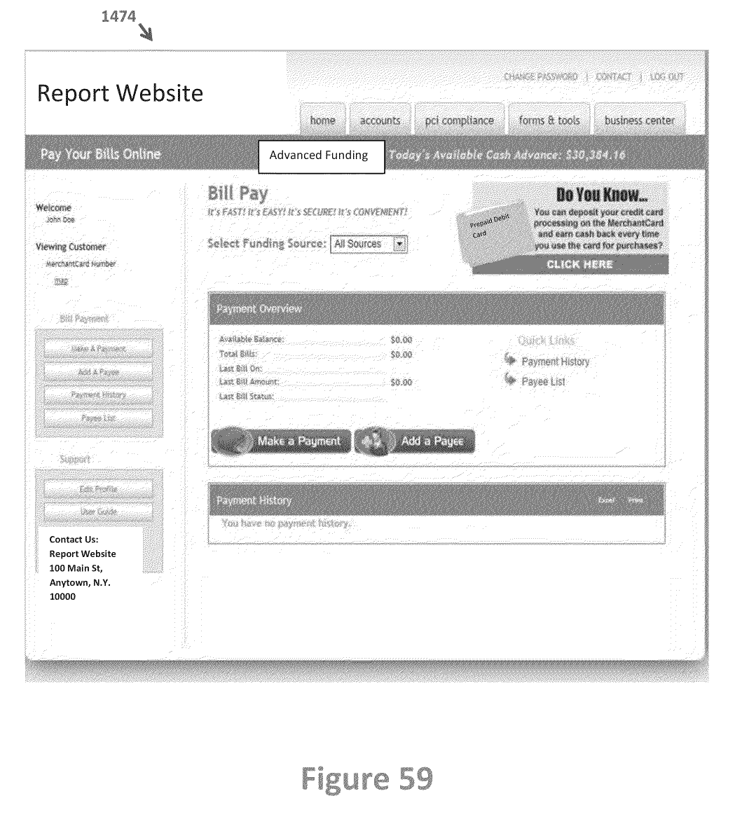

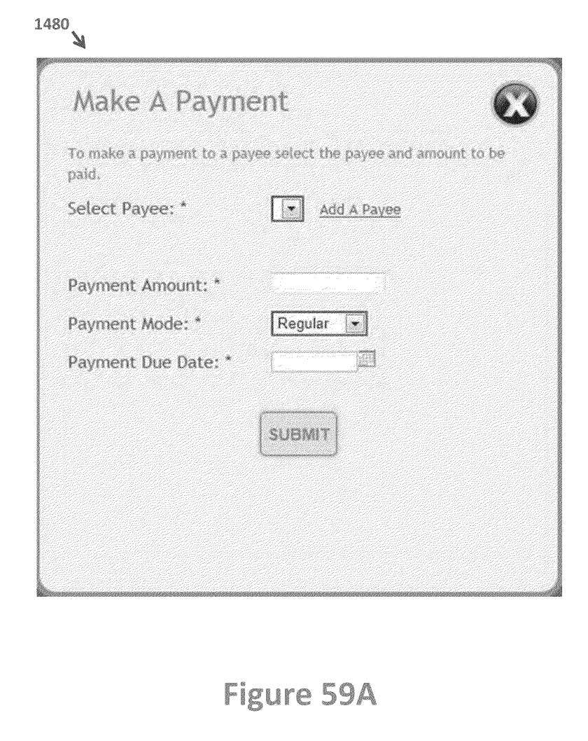

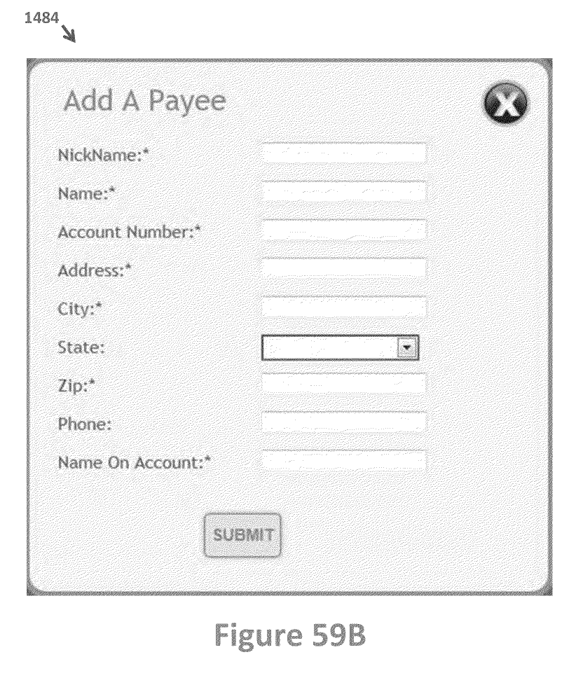

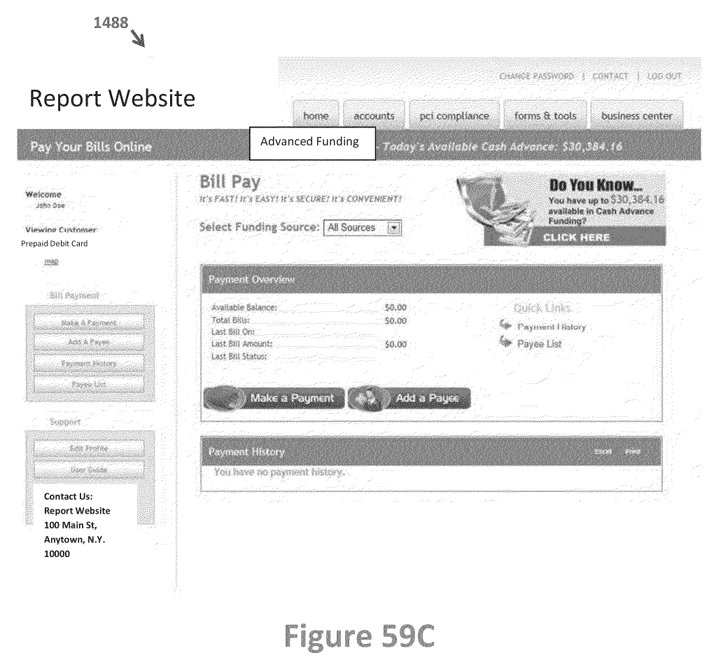

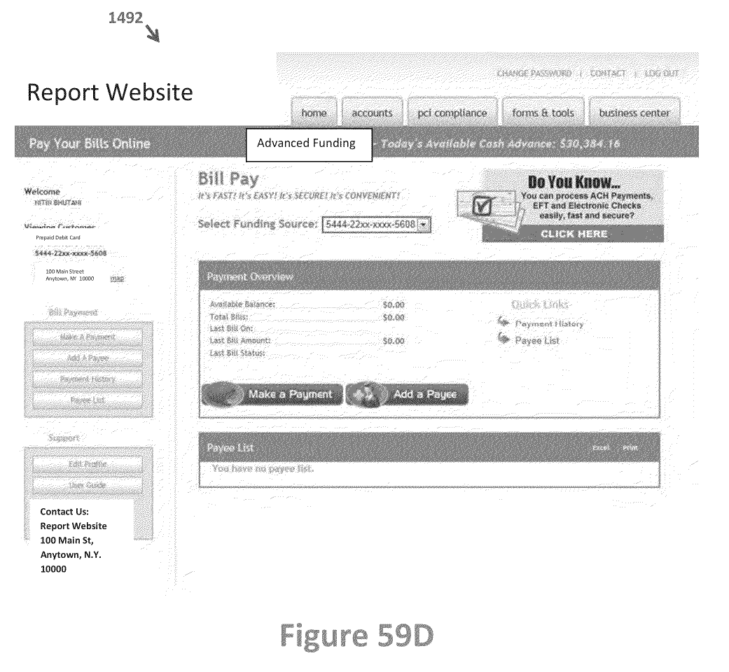

As described above, the advanced fund is a business protection service that gives merchants access to finances (e.g., up to $250,000 per month), at no cost, obligation or commitment. FIG. 59 depicts the bill pay screen 1474. FIG. 59A depicts a make a payment screen 1480 and FIG. 59B depicts an add a payee screen 1484.

FIG. 59C depicts a payment history screen 1488. FIG. 59D depicts a payee list in screen 1492, in accordance with an embodiment.

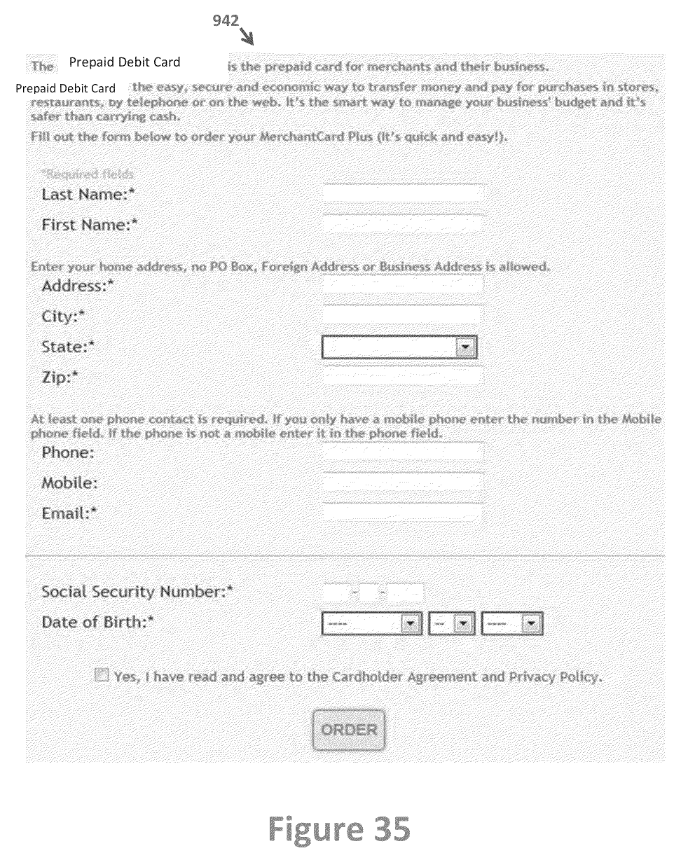

FIG. 35 depicts a request funding screen 942, according to an embodiment. By using advanced funds, a merchant may request funding upon completing the request funding form. On the report website, FIGS. 48A through 48C respectively depict request funding screens.

### Customer Relationship Management (CRM)

The following tools may be provided: an integrated lead tracking, sales and contact management, sales pipeline management and forecasting tool. The CRM program enables merchants to track their customers, service and business management as well as forecast future revenue and sales.

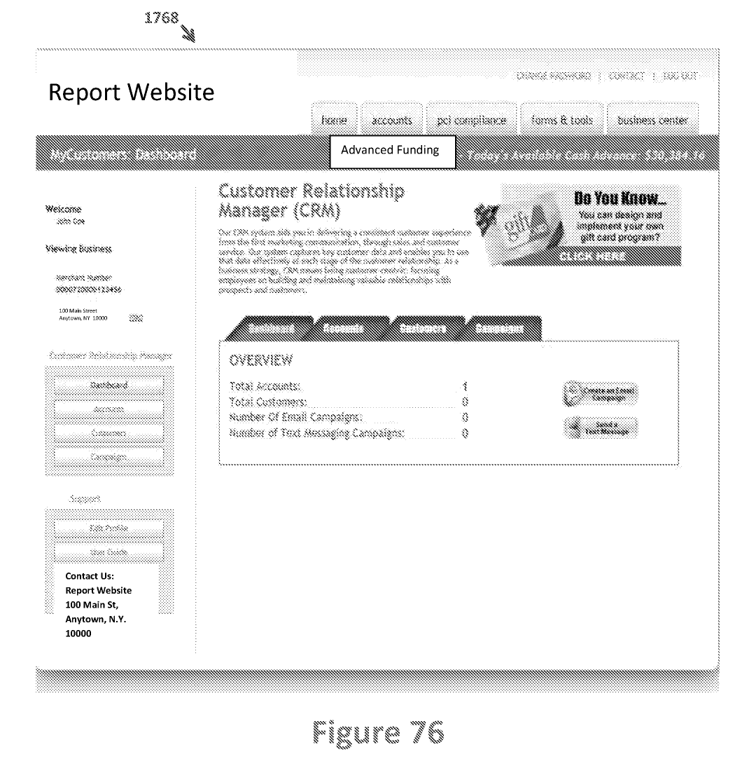

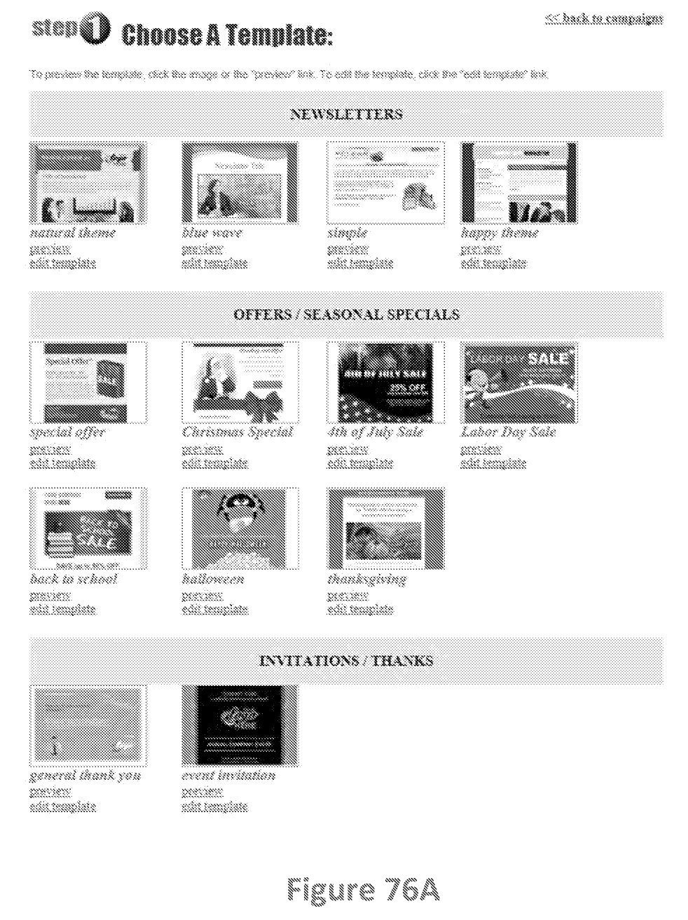

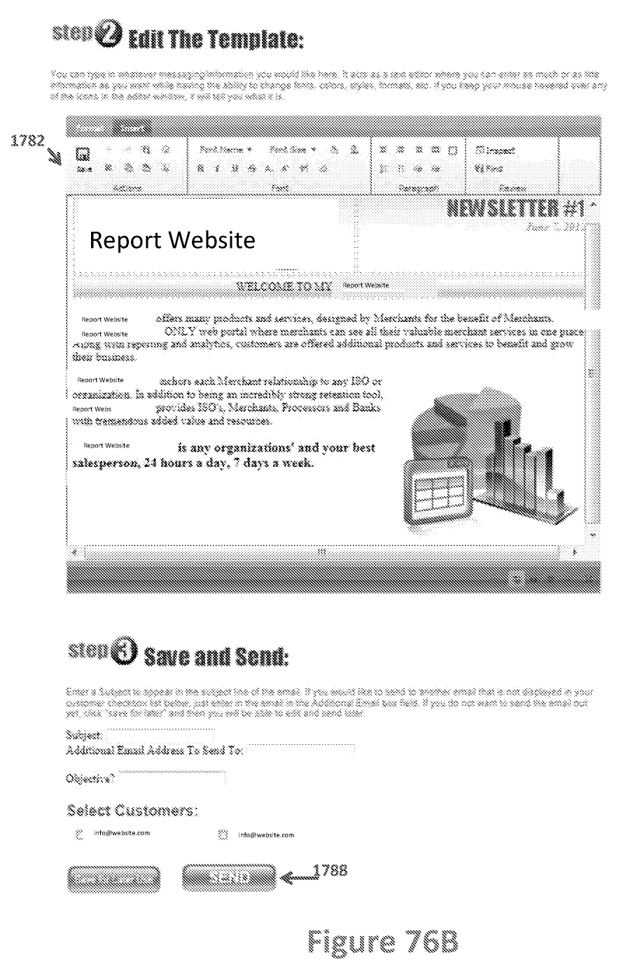

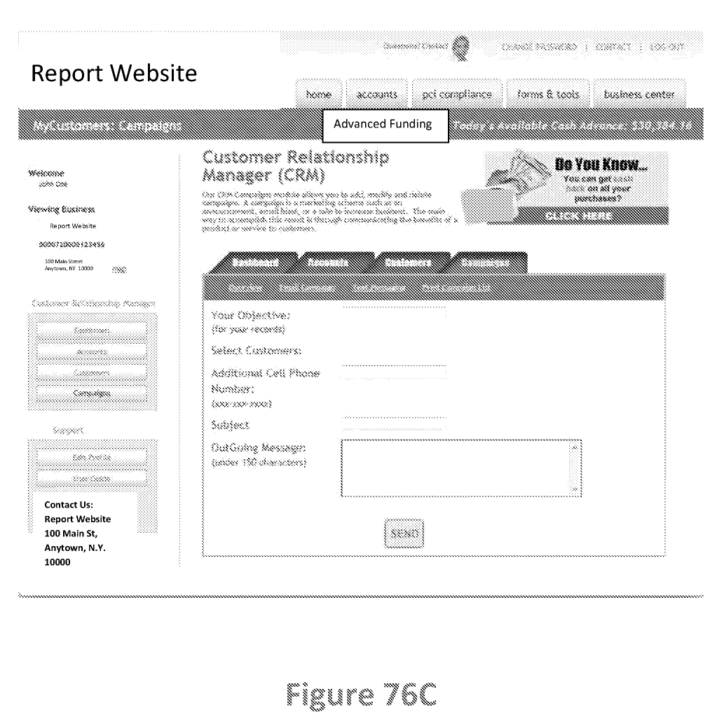

FIG. 76 depicts a customer relationship management screen 1768, according to an embodiment.

FIGS. 76A and 76B depict creating an email campaign, according to an embodiment. FIG. 76C depicts creating text messages for a merchant's customers, according to an embodiment.

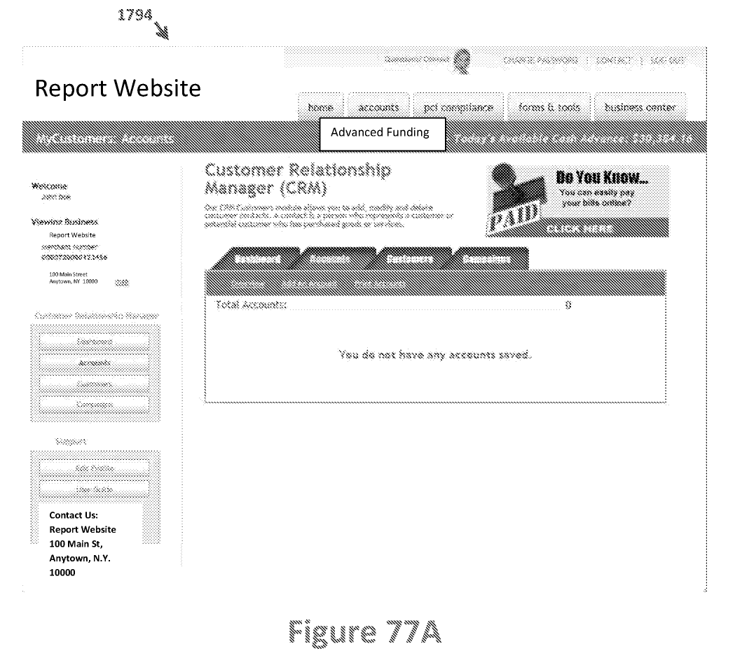

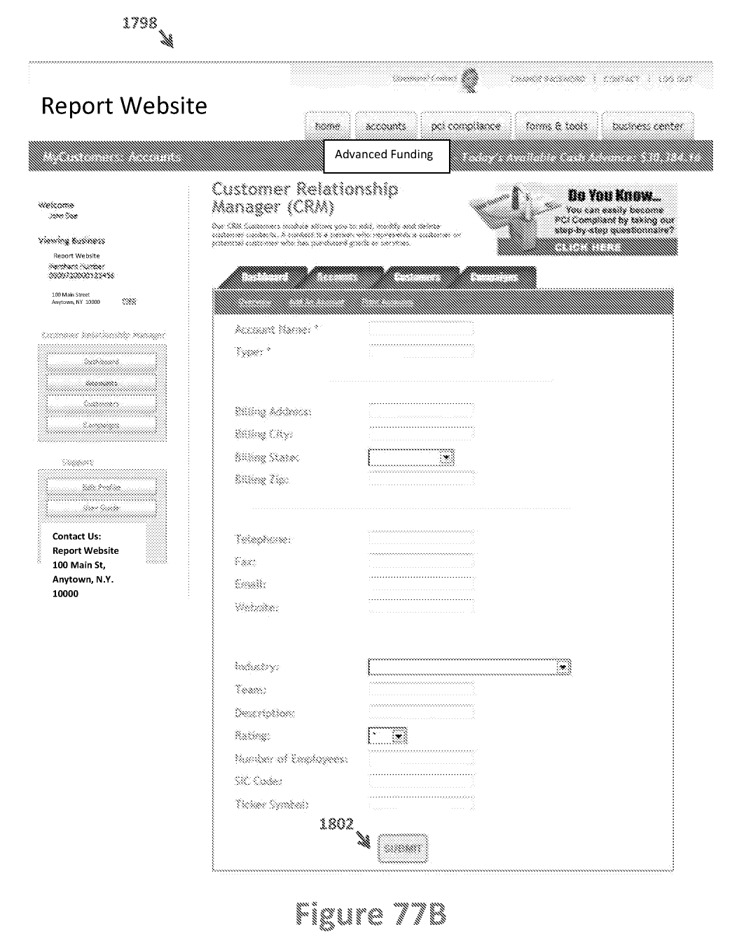

FIG. 77 depicts an accounts tab screen 1794, according to an embodiment. FIG. 77A depicts an add an account screen 1798, according to an embodiment.

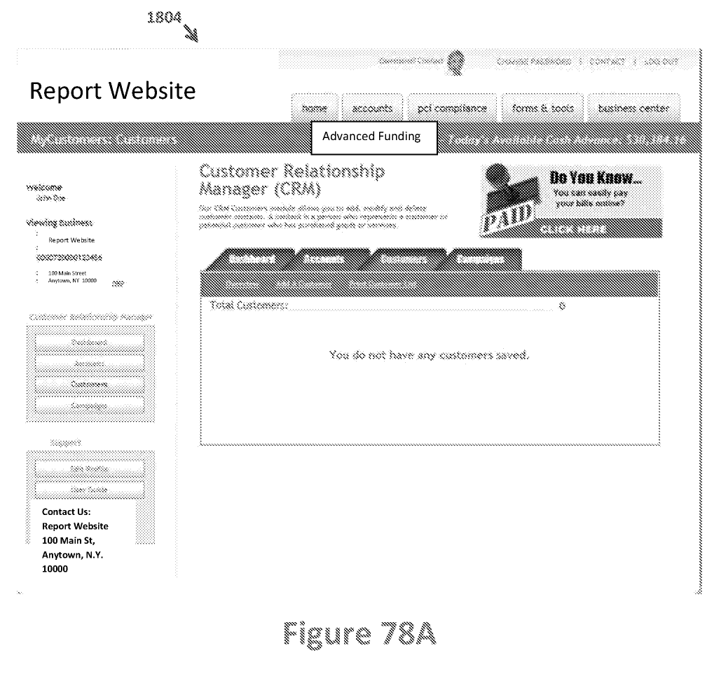

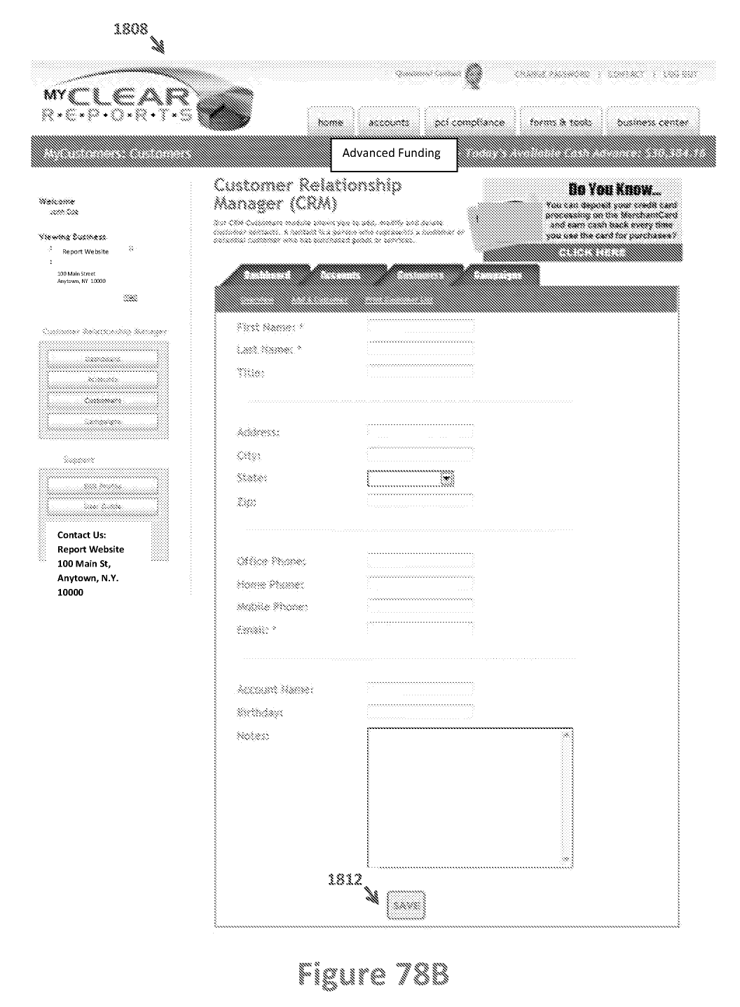

FIG. 78 depicts a customers tab screen 1804, according to an embodiment. FIG. 78A depicts an add a customer screen 1808, according to an embodiment.

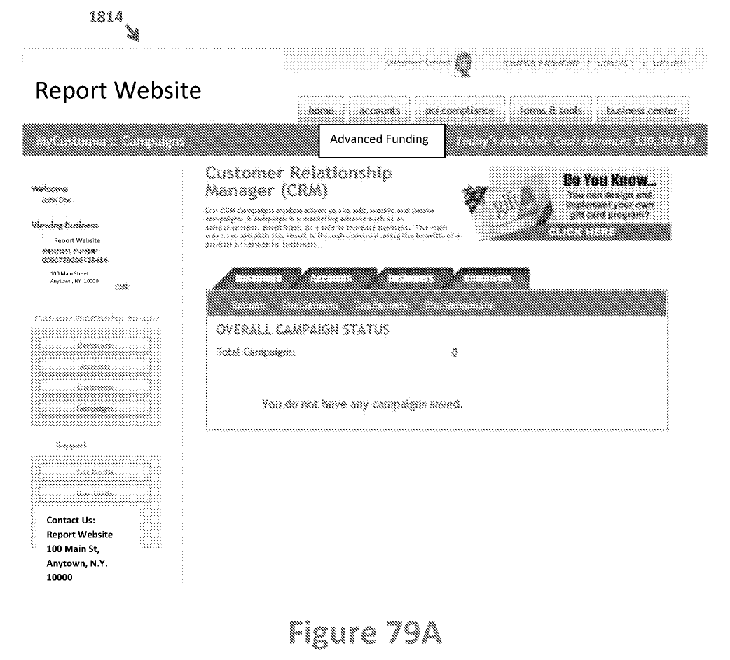

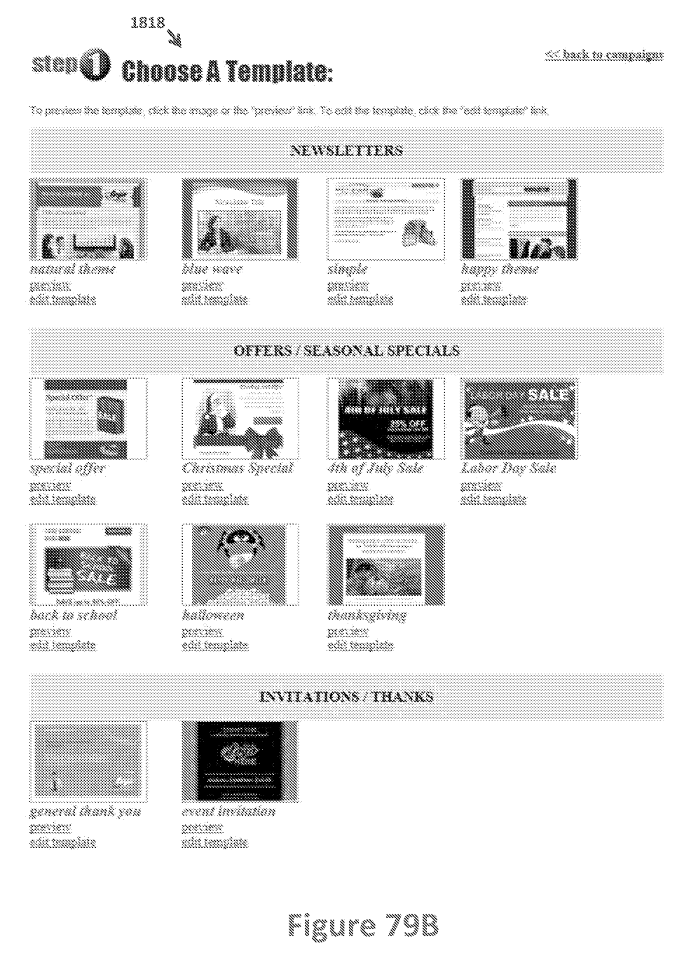

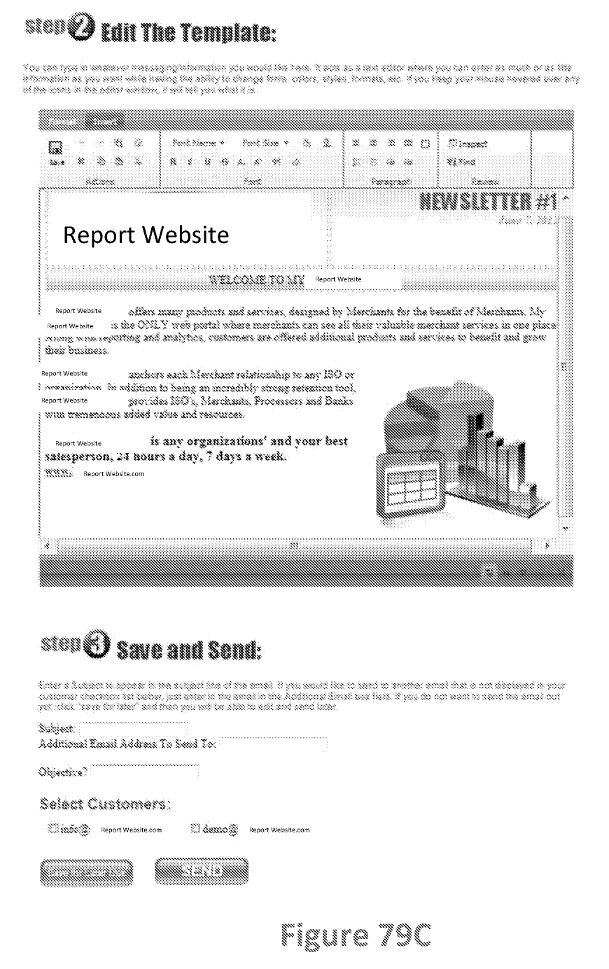

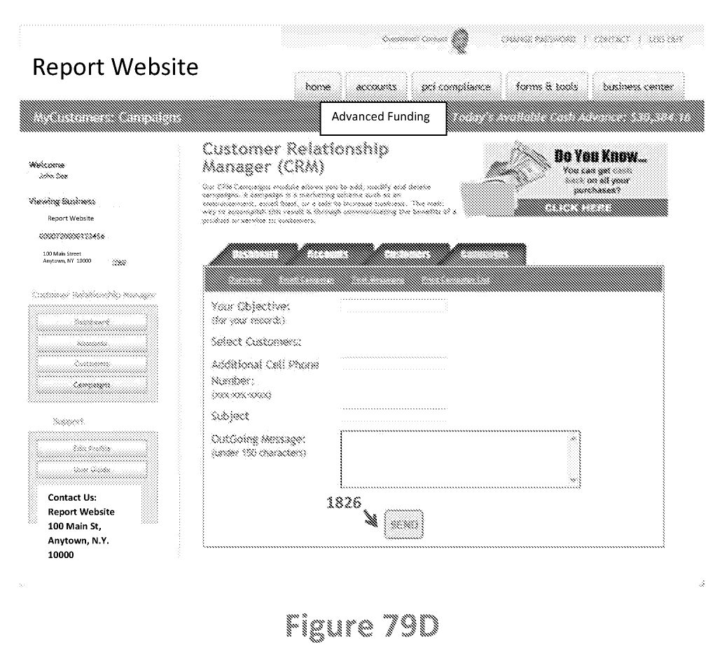

FIG. 79 depicts a campaigns tab screen 1814, according to an embodiment. FIGS. 79A and 79B depict add campaign screens 1818 and 1820 respectively, according to an embodiment. FIG. 79C depicts a creating text messages for merchant's customers screen 1824, according to an embodiment.

### Administration Reporting and Branding

Merchants, banks, processors and ISOs (i.e., financial service providers) can access analytics, customizable data views and have the ability to view future trends and projections and export data. FIG. 87A depicts an administration reporting screen of accounts screen 2000 displaying total accounts for the processor, bank or ISO, according to an embodiment.

FIG. 87B depicts an administration reporting of PCI compliant accounts screen 2004 displaying total PCI compliant accounts by merchant level for the processor, bank or ISO, according to an embodiment. FIGS. 87C and 87D depict detailed information about each merchant level.

FIG. 87E depicts an administration reporting screen 2014 of IRS Tax ID Number (TIN) matching screen 2014 displaying a percentage of merchant accounts whose tax ID number matches their legal name for the processor, bank or ISO, according to an embodiment. FIG. 87F depicts detail information about each merchant's TIN match, in screen 2018.

FIG. 87G depicts an administration reporting of merchant inquiries screen 2020 displaying a number of online chats, emails and phone calls received from merchants for the processor, bank or ISO, according to an embodiment.

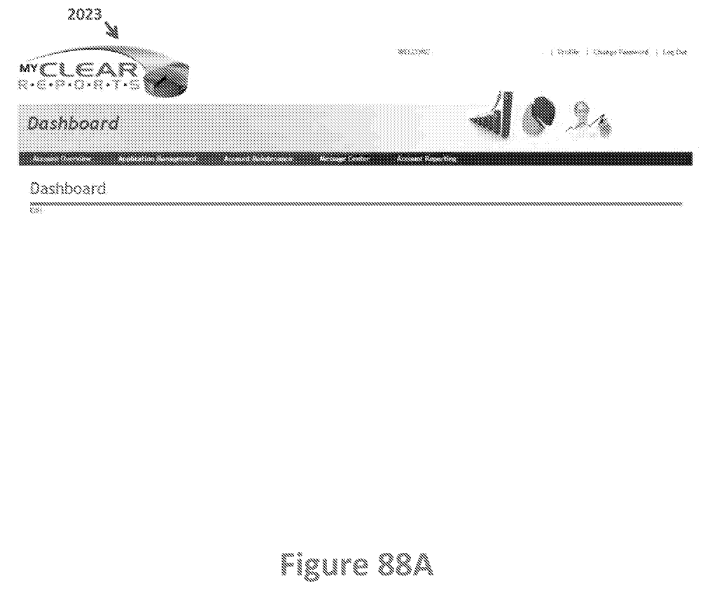

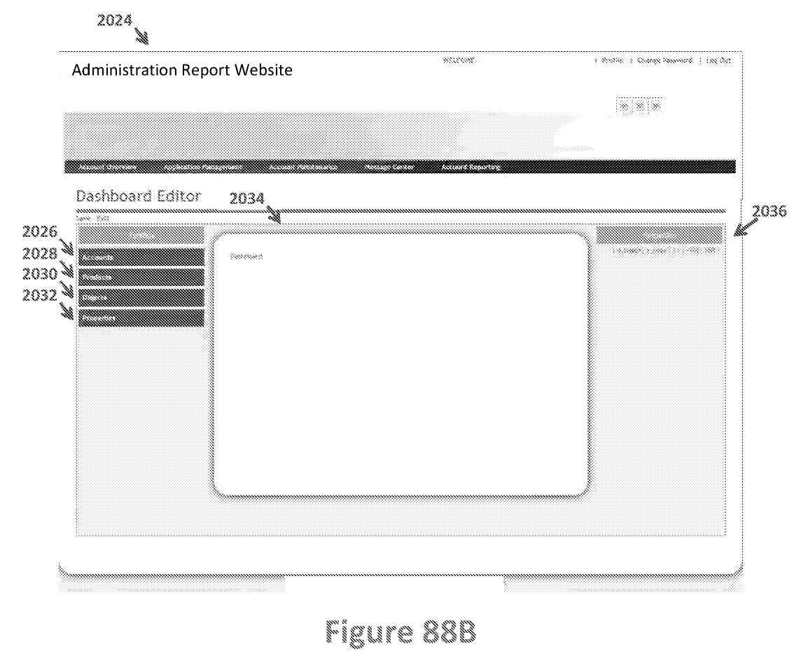

FIG. 88 depicts an administration reporting dashboard screen 2024 displaying dashboard graphs, indicators and/or charts for the processor, bank or ISO, according to an embodiment. The dashboard can be changed by selecting the graph, indicator or chart needed, using the menu choices in boxes 2026 through 2032. Individual properties for each graph, indicator or chart can be changed by using the property fields in box 2036.

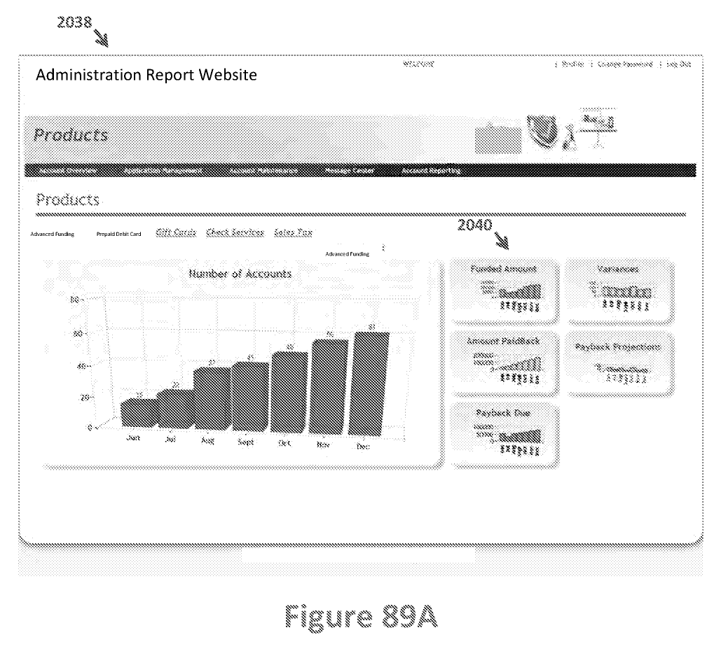

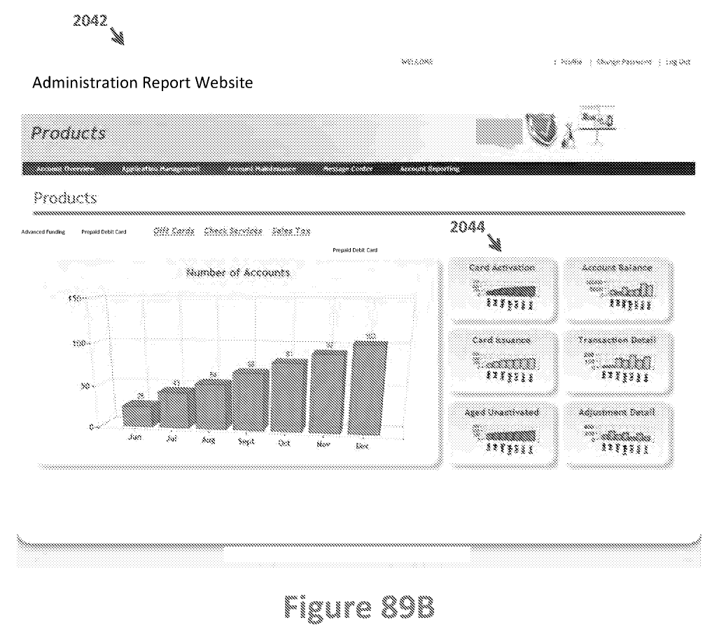

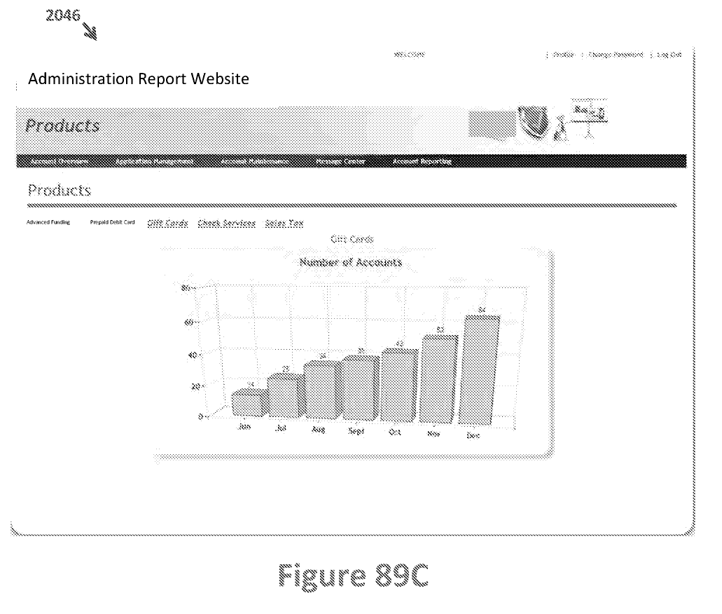

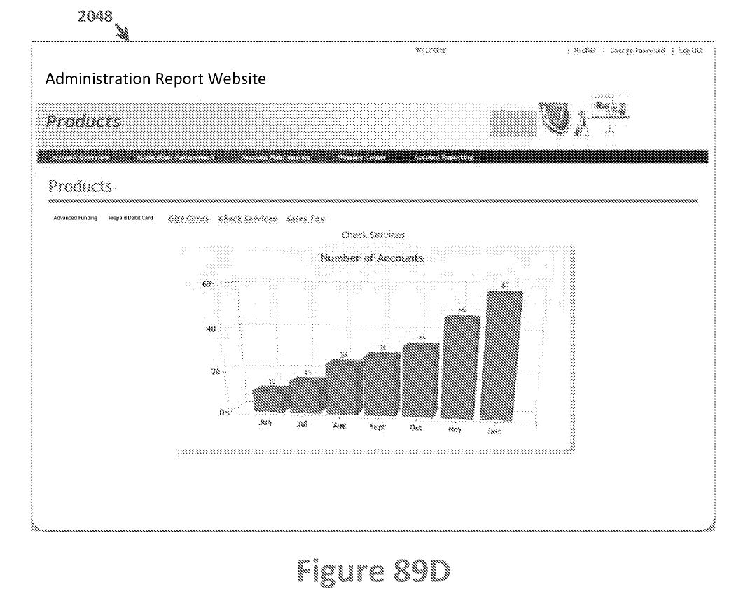

FIG. 89A depicts an administration reporting of products for advanced funding accounts screen 2038 for the processor, bank or ISO, according to an embodiment. Clicking any of the boxes at 2040 displays detail information about the advanced funding accounts.

FIG. 89B depicts an administration reporting of products for prepaid debit card accounts screen 2042 for the processor, bank or ISO, according to an embodiment. Clicking any of the boxes at 2044 displays detail information about the prepaid debit card accounts.

FIG. 89C depicts an administration reporting of products for gift card accounts screen 2046 for the processor, bank or ISO, according to an embodiment.

FIG. 89D depicts an administration reporting of products for check processing accounts screen 2048 for the processor, bank or ISO, according to an embodiment.

FIG. 89E depicts an administration reporting of products for sales tax reporting accounts screen 2050 for the processor, bank or ISO, according to an embodiment

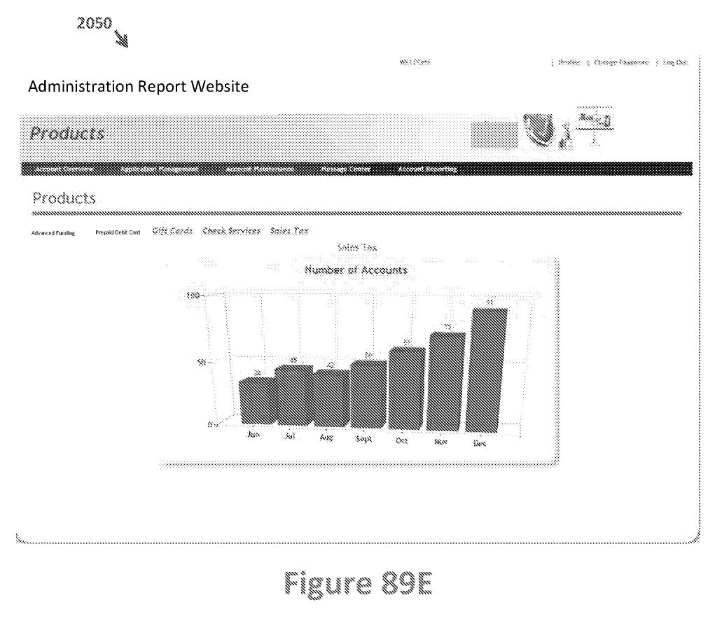

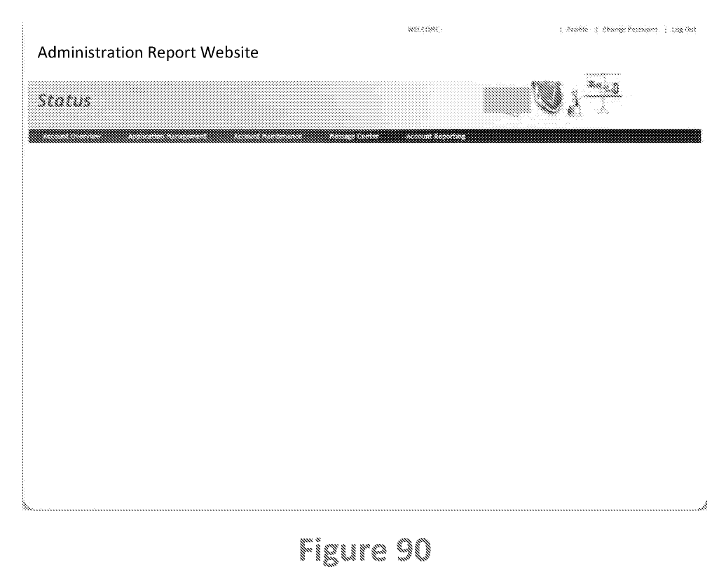

FIG. 90 depicts an administration reporting of account status screen 2052 for the processor, bank or ISO, according to an embodiment

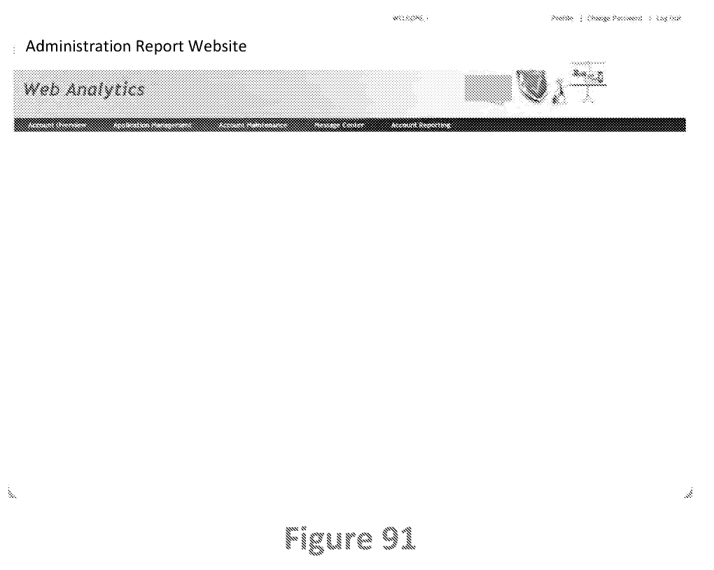

FIG. 91 depicts an administration reporting of web analytics screen 2054 for the processor, bank or ISO, according to an embodiment

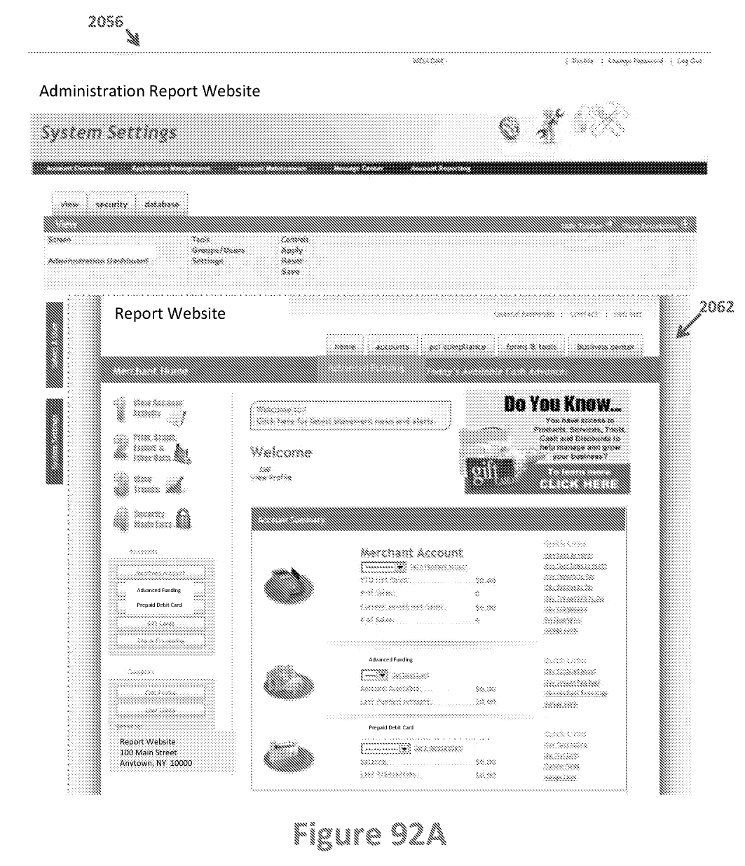

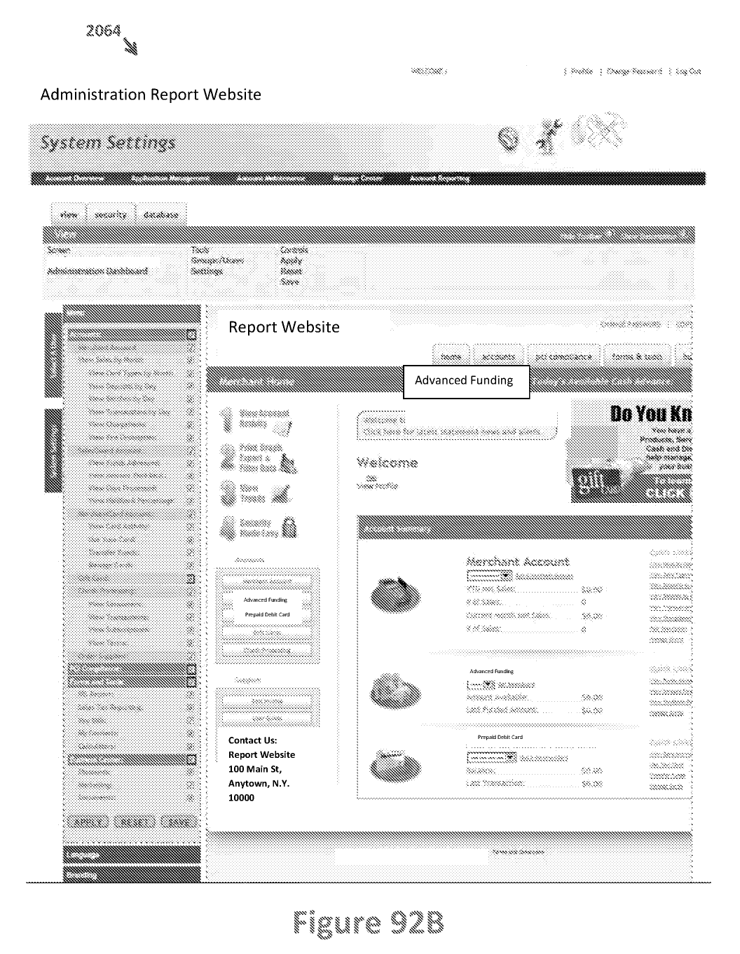

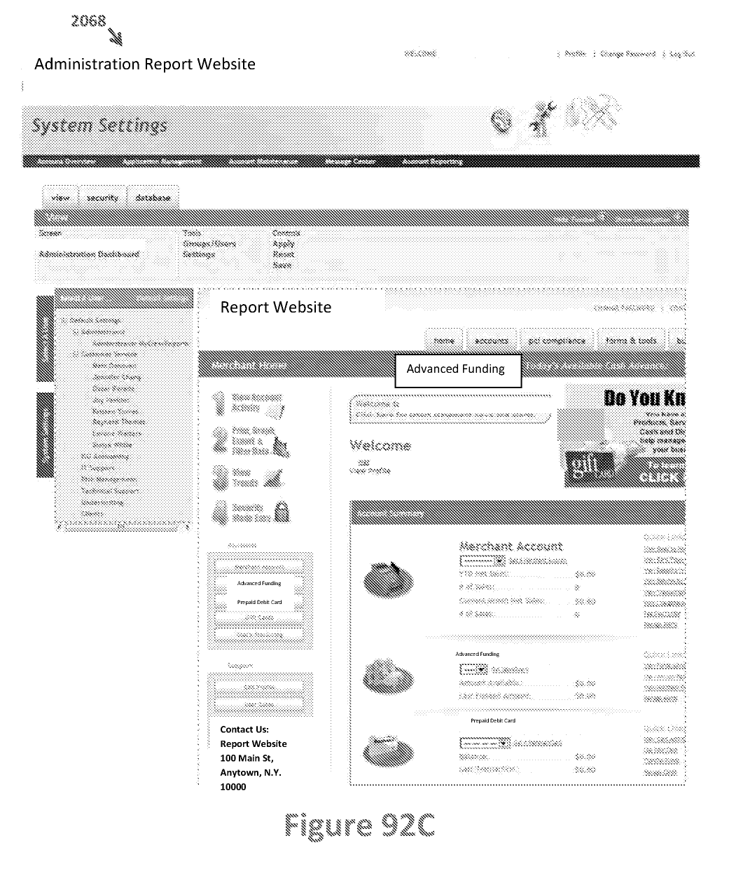

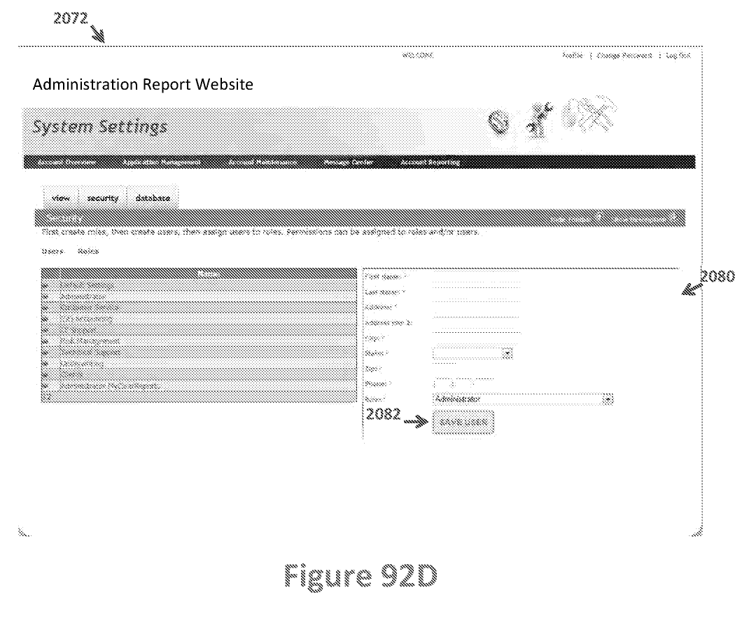

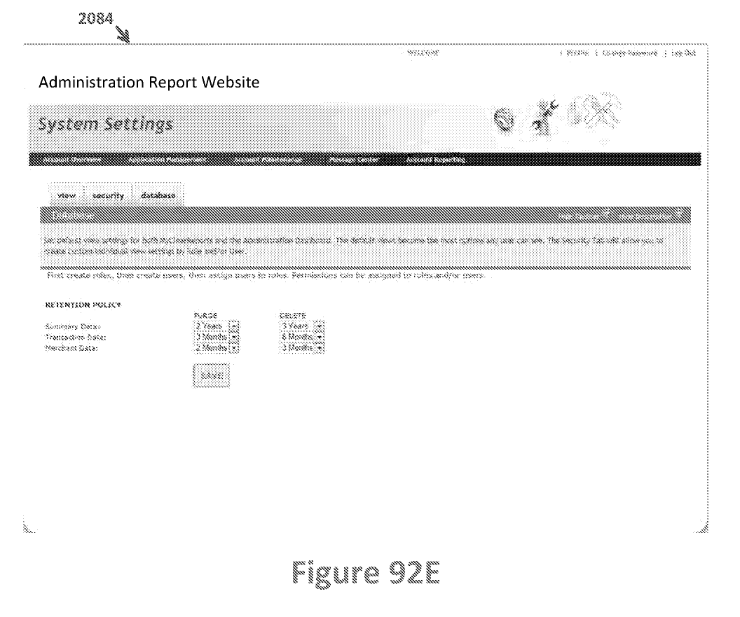

FIG. 92A depicts an administration reporting of system settings screen 2056 for the processor, bank or ISO, according to an embodiment. The processor, bank or ISO may customize the view and functionality of the report website for their merchants by selecting the menu options in box 2060. FIG. 92B depicts the ability of changing the applications view and function. It also provides the ability to brand the application by uploading the client's logo, name and contact information as shown in screen 2064. FIG. 92C depicts the ability to customize the application by roles or by users as shown in screen 2068.

Reports and other information can be white labeled or branded with the bank, processor or ISO's logo and contact information. Banks, financial service providers, etc. have complete control over what data is displayed. A financial service provider, etc. may choose to show as much or as little information as a financial service provider may want to show a merchant. FIG. 92B depicts a screen 2064 with a customized program with a customizable logo.

Suppose that a financial service provider wishes to place branded information (e.g., logo, etc.) on all credit card sales account information reports provided to merchants. The financial service provider may send a request to reports server 101, shown in FIG. 1, for providing branded information on reports that are provided to merchant device 103. The request may be submitted over network 104 by the financial service provider (not shown). Reports server 101 receives the request for providing branded information on reports to merchant device 103 from the financial service provider, over network 104. Reports server 101 inputs the branded information onto the reports. Reports server 101 generates branded reports. Reports server 101 then provides the branded reports to merchant device 103, over network 104. The branded reports include at least the branded information and the filtered custom credit card sales account information (described above with respect to FIG. 6A). When merchant device 103 accesses credit card sales account information, customizable logo 2064 in FIG. 92B is provided.

FIG. 92D depicts an administration reporting of the security tab of the system settings at screen 2072 for the processor, bank or ISO, according to an embodiment. The processor, bank or ISO can create roles (ex. administrator, customer service, etc.) and also add users and assign them to roles.

FIG. 92E depicts an administration reporting of the database tab of the system settings screen 2084 for the processor, bank or ISO, according to an embodiment. The processor, bank or ISO can set the retention schedule for their merchant data for merchant accounts, summary information and detail transactional data.

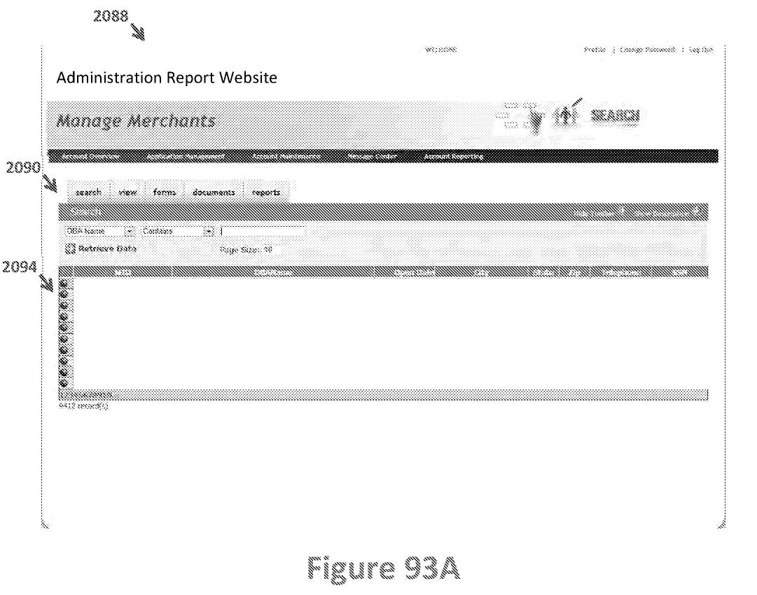

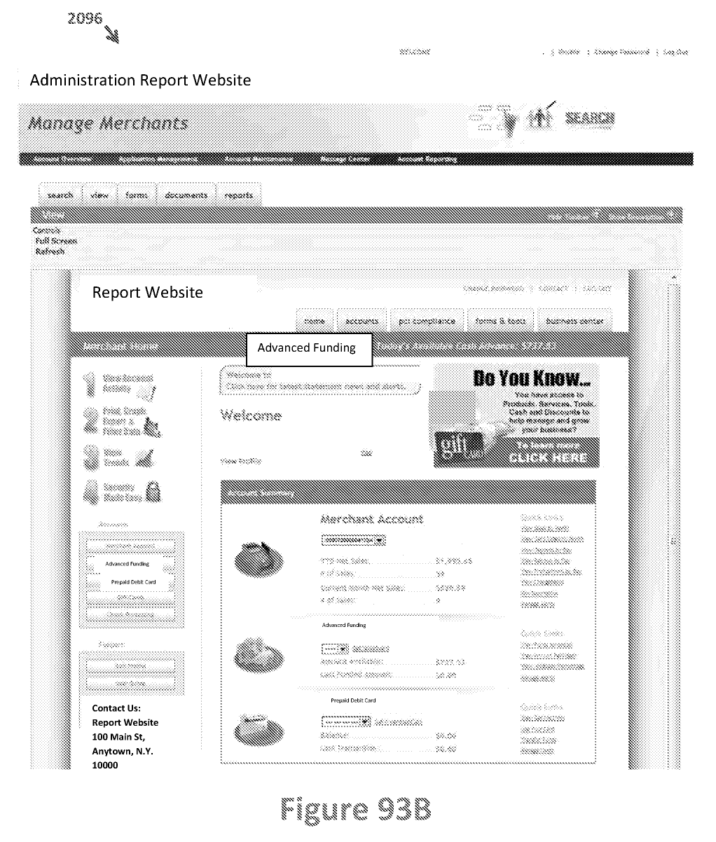

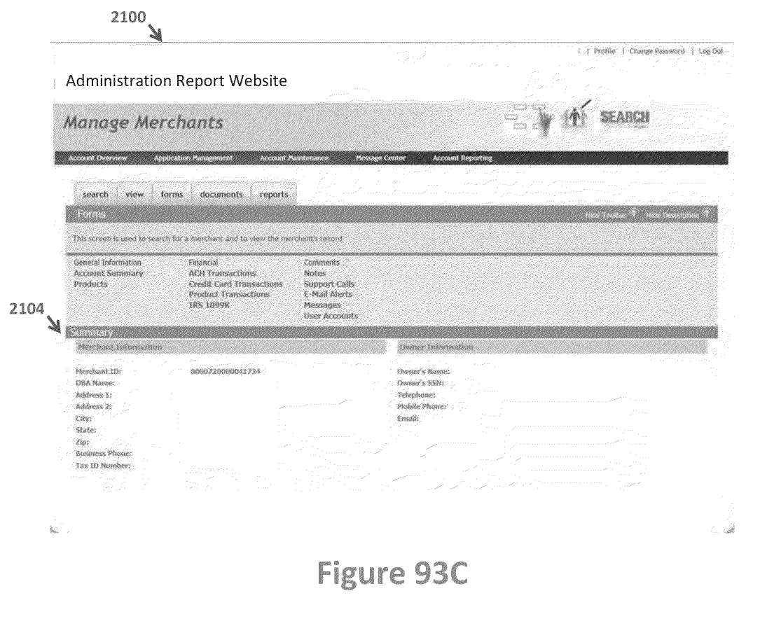

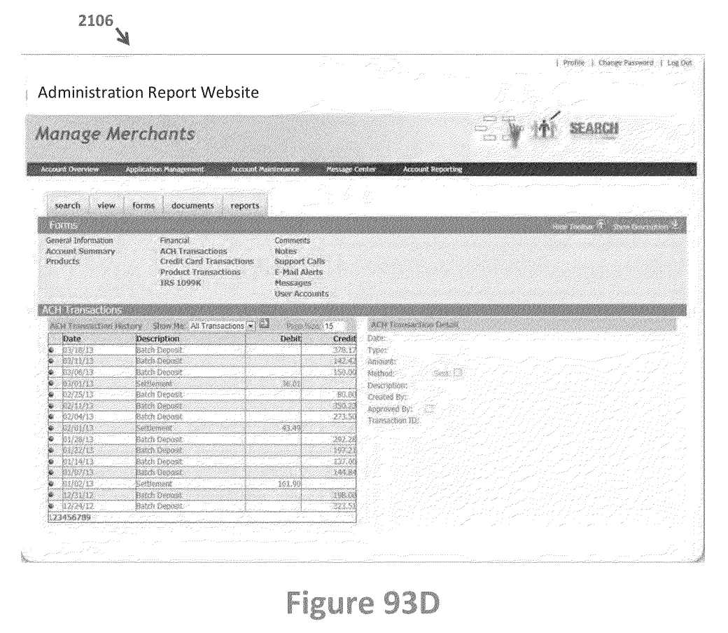

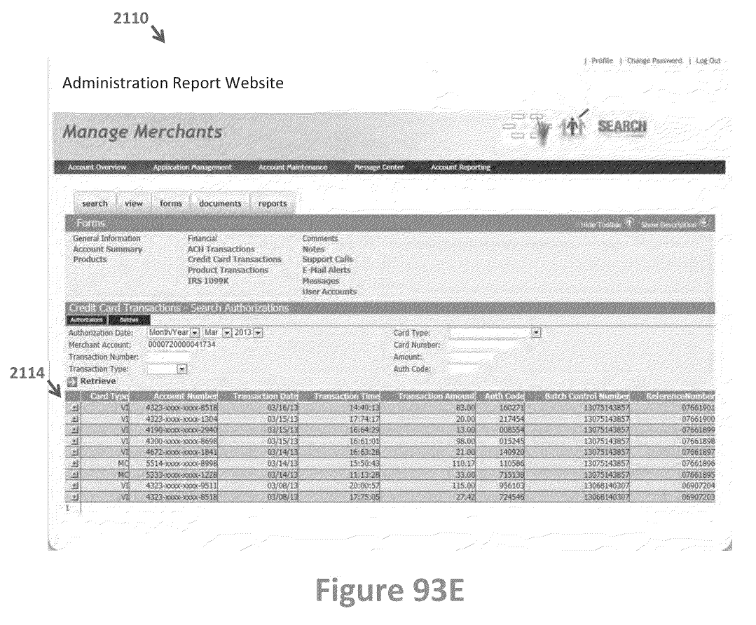

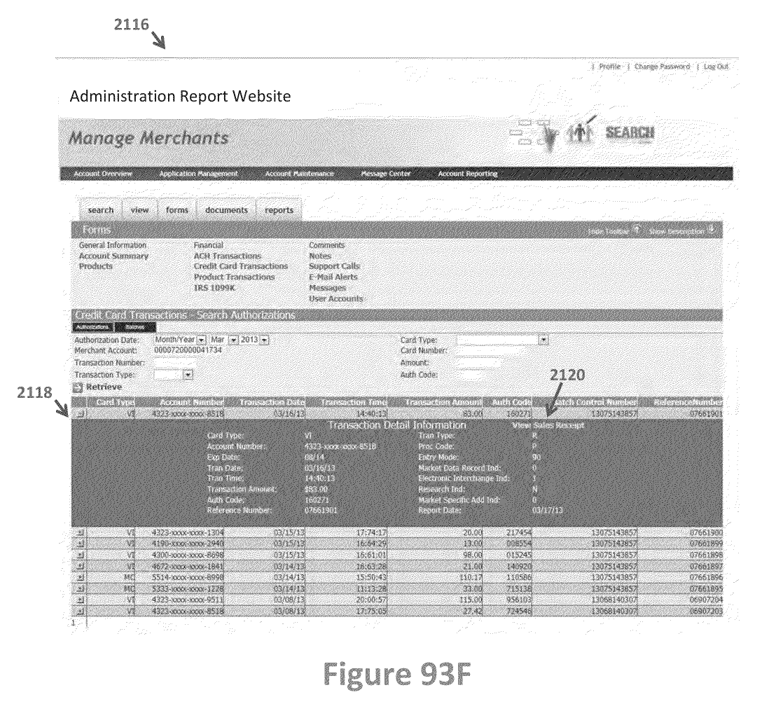

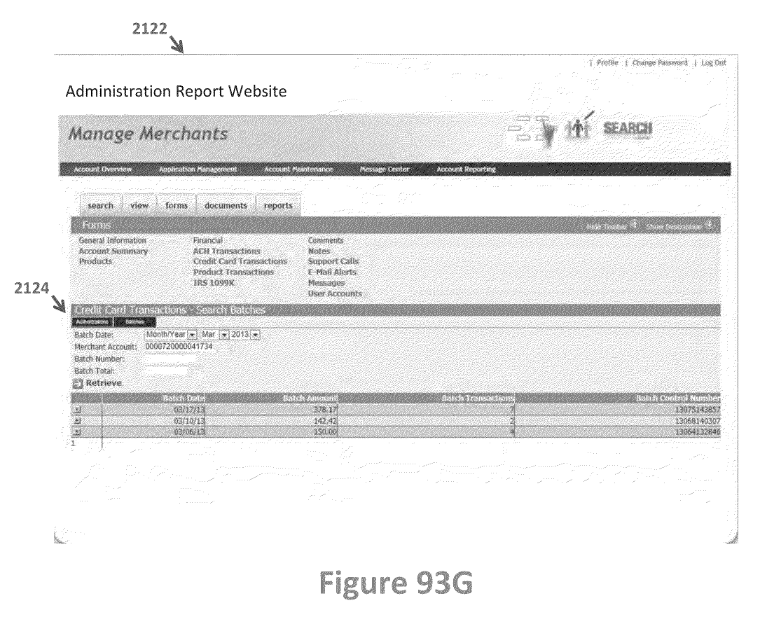

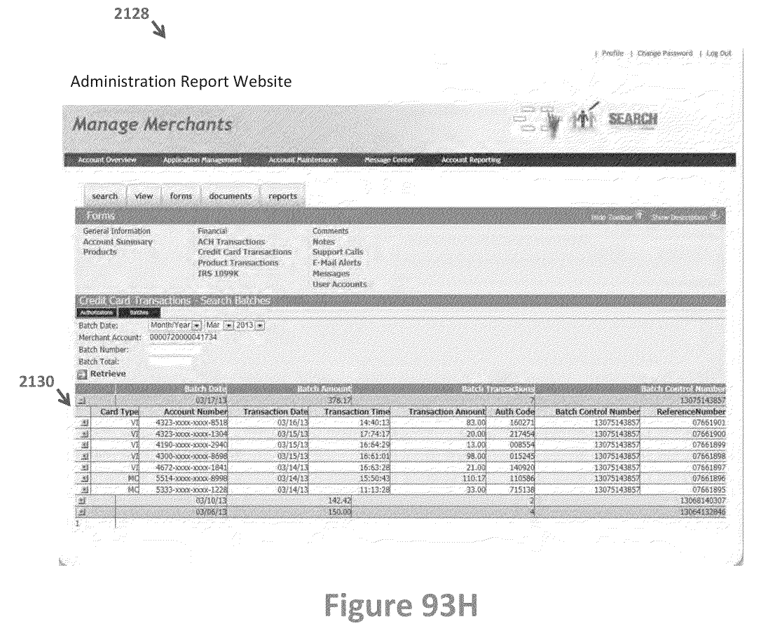

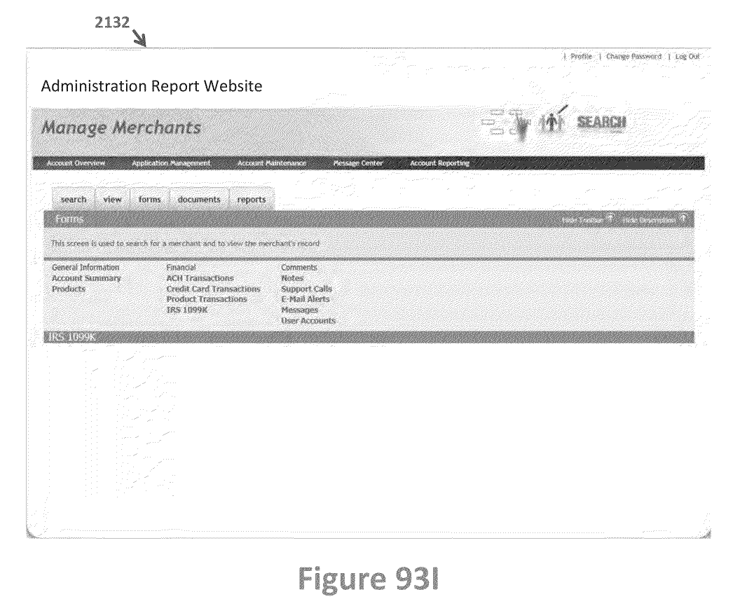

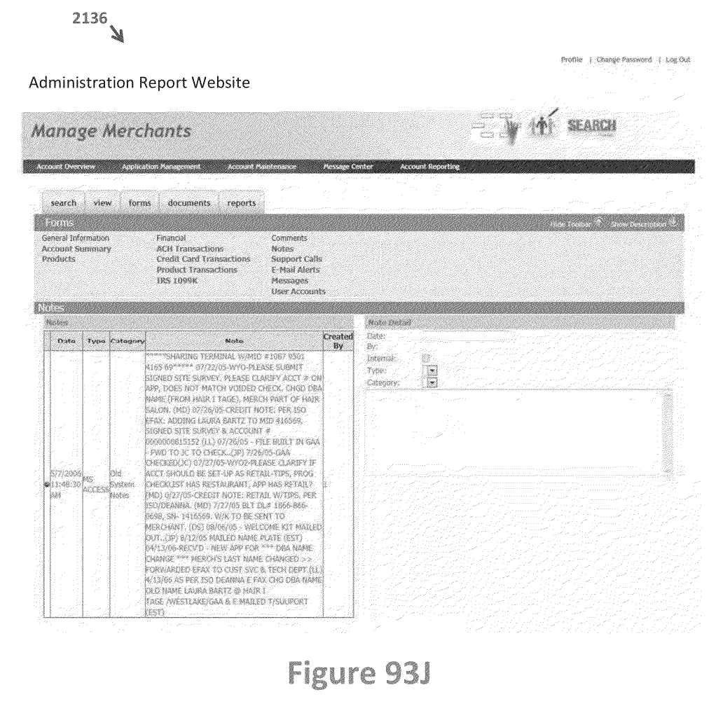

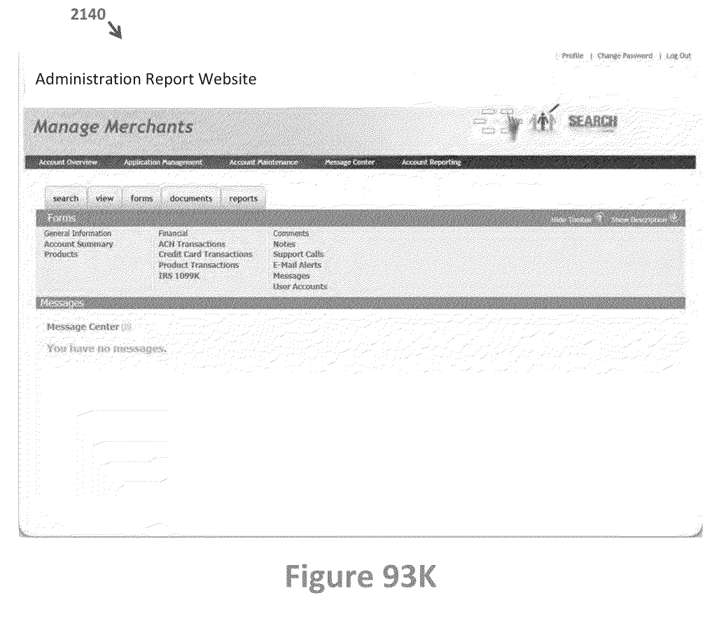

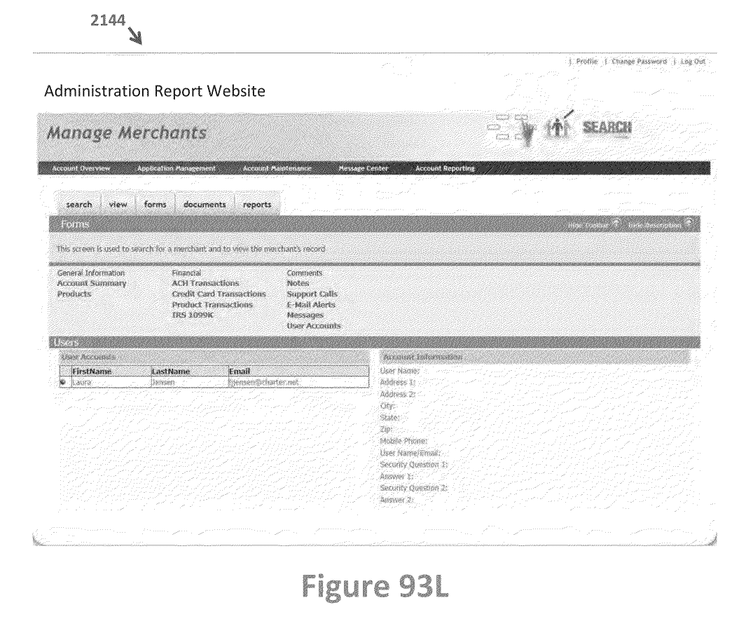

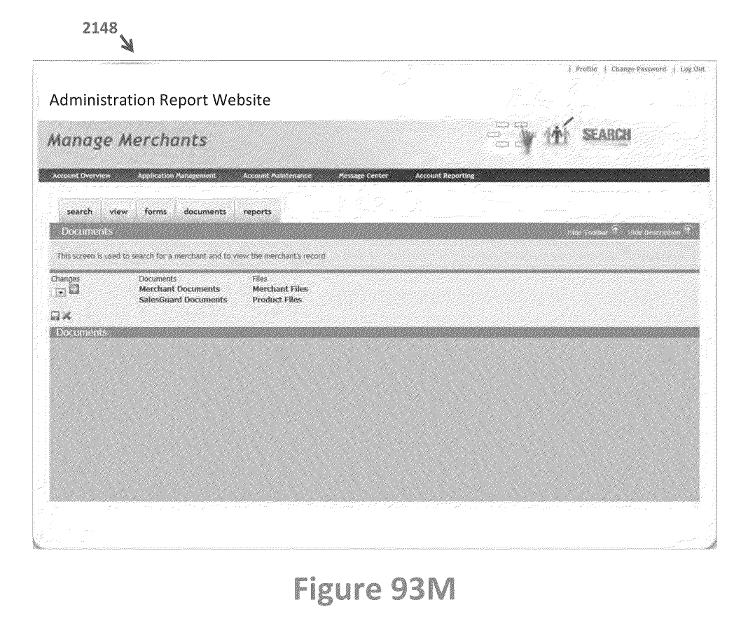

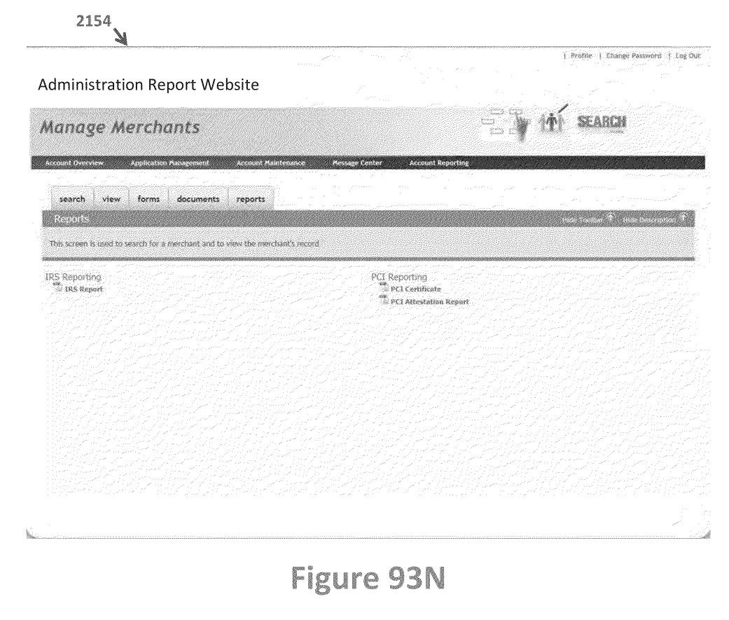

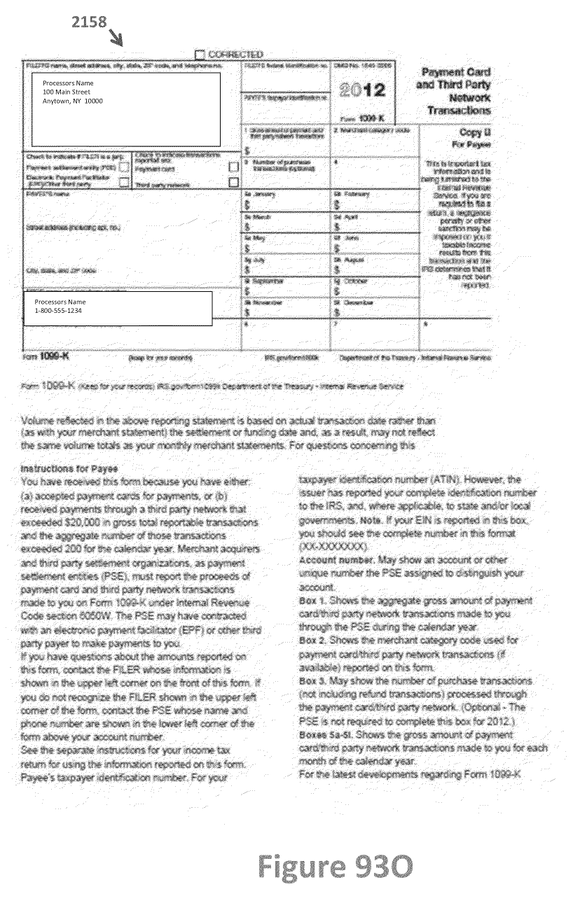

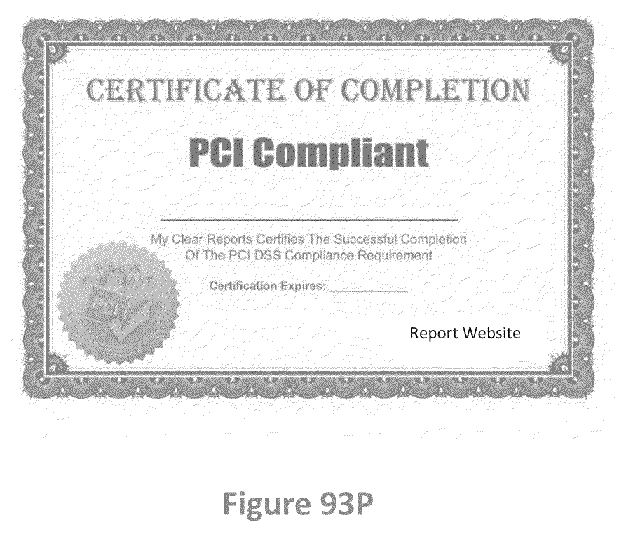

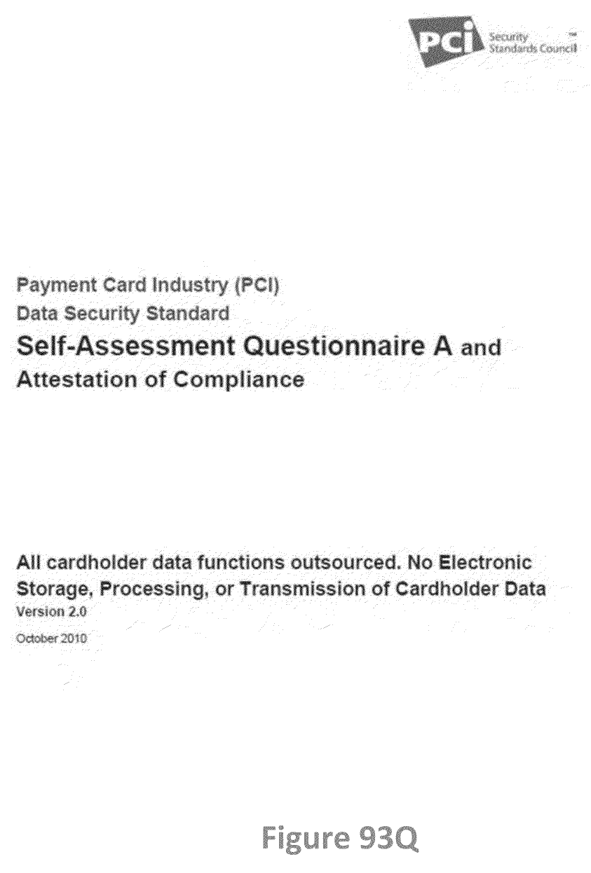

FIG. 93A depicts an administration reporting of managing merchants screen 2088 for the processor, bank or ISO, according to an embodiment. The processor, bank or ISO can search for any of their merchants using a search tab 2090. Clicking a merchant from the merchant search list 2094 retrieves that merchant's record.

FIG. 93B depicts an administration reporting of a view tab of a managing merchants screen 2096 for the processor, bank or ISO, according to an embodiment. The processor, bank or ISO can view exactly what the merchant sees on the report website.

FIG. 93C depicts an administration reporting of a forms tab of the managing merchants screen 2100 for the processor, bank or ISO, according to an embodiment. The processor, bank or ISO can view the merchant's summary record by selecting the link on a menu 2104. FIG. 93D depicts Automated Clearinghouse (ACH) transactions about the selected merchant in screen 2016. FIG. 93E depicts credit card authorization transactions about a selected merchant in screen 2110. Several filters and search parameters are provided in box 2114 to find a transaction. FIG. 93F depicts the ability to view detail information about a transaction by clicking the plus sign at 2118 shown in screen 2116. The sales receipt of the transaction can be printed by clicking the link at screen 2120.

FIG. 93G depicts credit card batch transactions for a selected merchant, shown in screen 2122, according to an embodiment. Several filters and search parameters are provided at 2124 to find a transaction. FIG. 93H depicts view detail information about a transaction by clicking the plus sign at 2130 shown in screen 2128.

The processor, bank or ISO can view a merchant's IRS 1099K form as depicted in screen 2132 in FIG. 93I, according to an embodiment. Merchant notes can be viewed and entered as depicted in screen 2136 in FIG. 93J, according to an embodiment. FIG. 93K depicts messages sent to and retrieved from a merchant in screen 2140, according to an embodiment. FIG. 93L depicts a merchant's user accounts in screen 2144, according to an embodiment.

FIG. 93M depicts an administration reporting of the documents tab of a managing merchant's screen 2148 for the processor, bank or ISO, according to an embodiment. The processor, bank or ISO can view any documents that may have been uploaded to the system.

FIG. 93N depicts an administration reporting of a reports tab of a managing merchants screen 2154 for the processor, bank or ISO, according to an embodiment. The processor, bank or ISO can view reports that a merchant has access to, like the PCI certificate as depicted in FIG. 93P and attestation form, as depicted in FIG. 93 Q. FIG. 93O depicts an IRS 1099K form, shown in screen 2158, that the processor, bank or ISO can print from the reports tab.

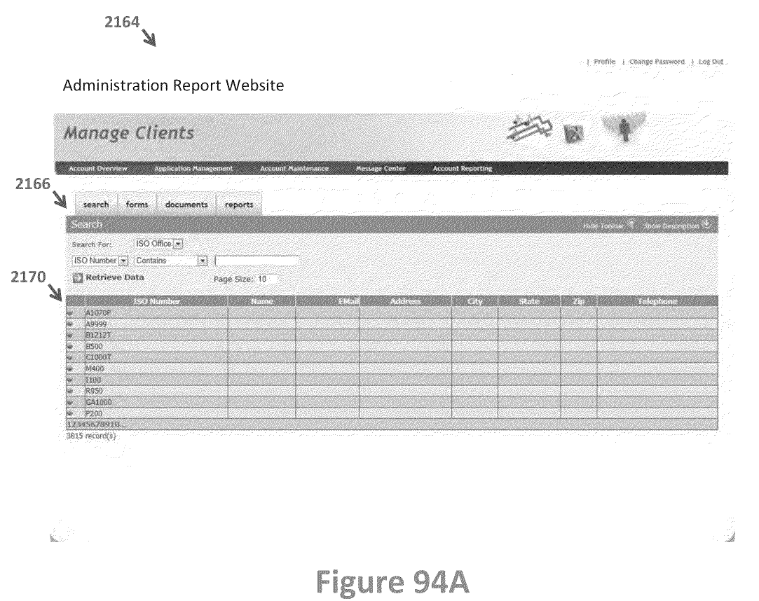

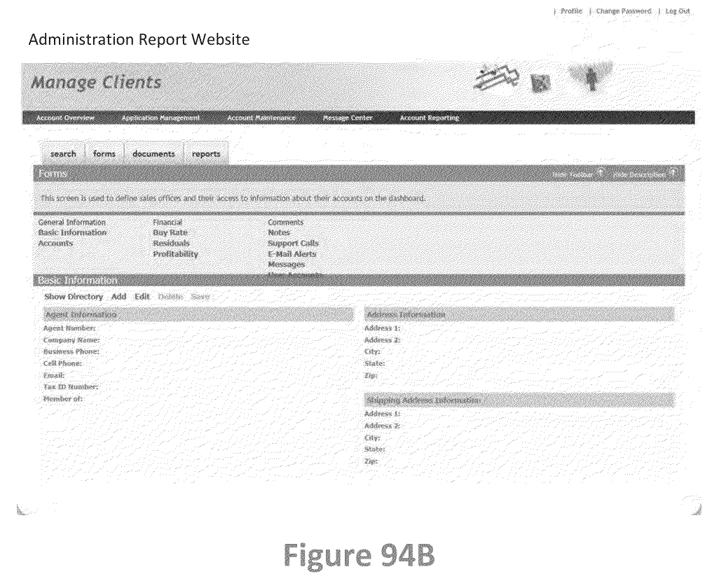

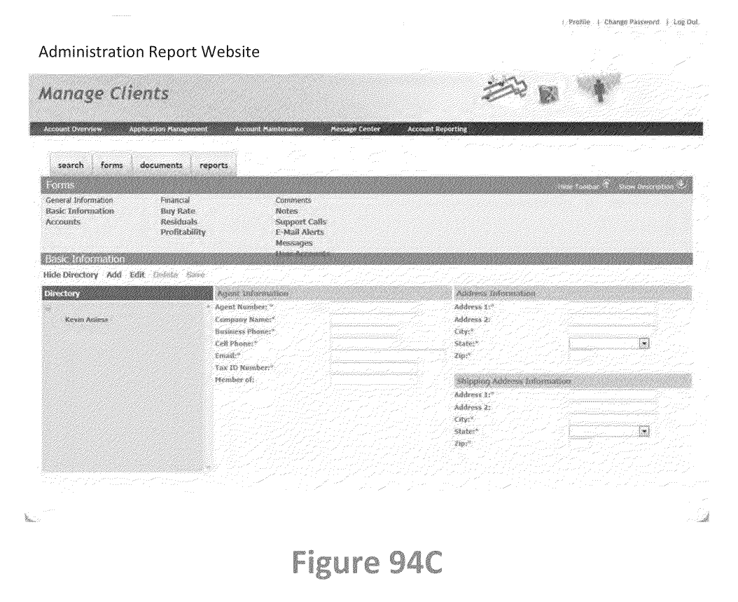

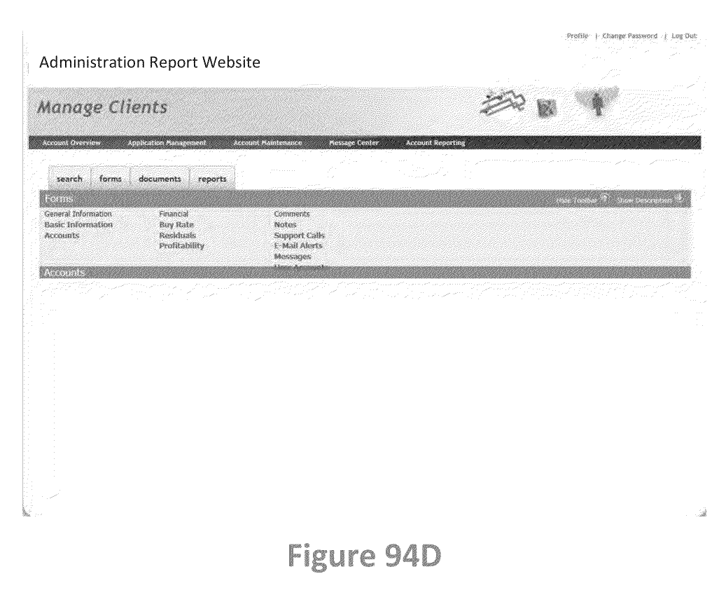

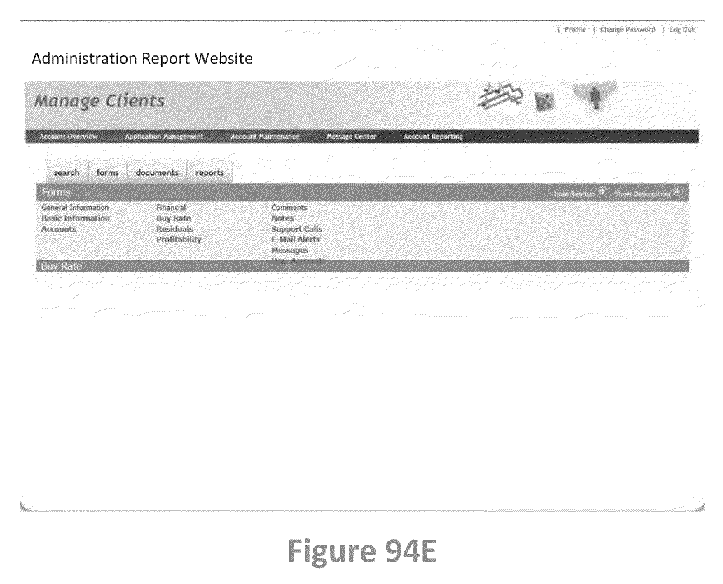

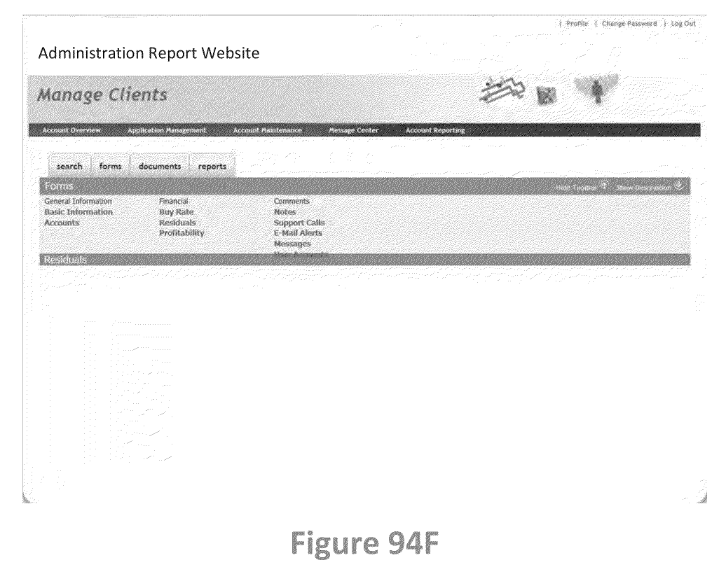

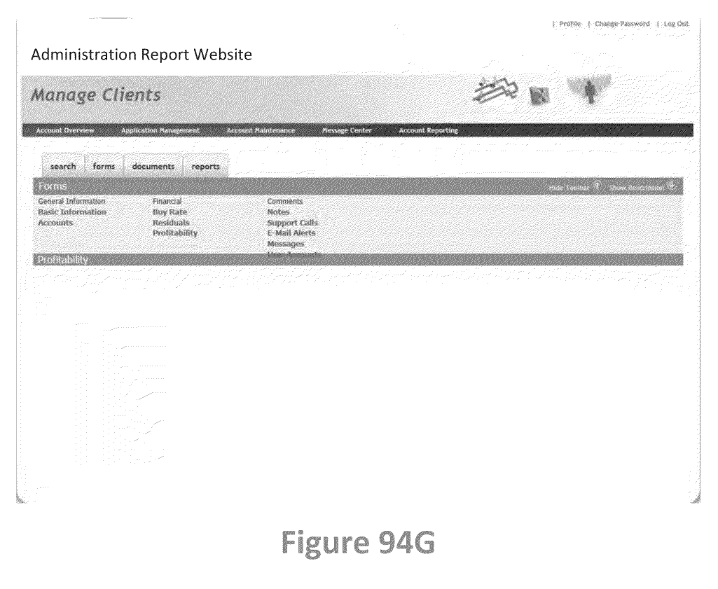

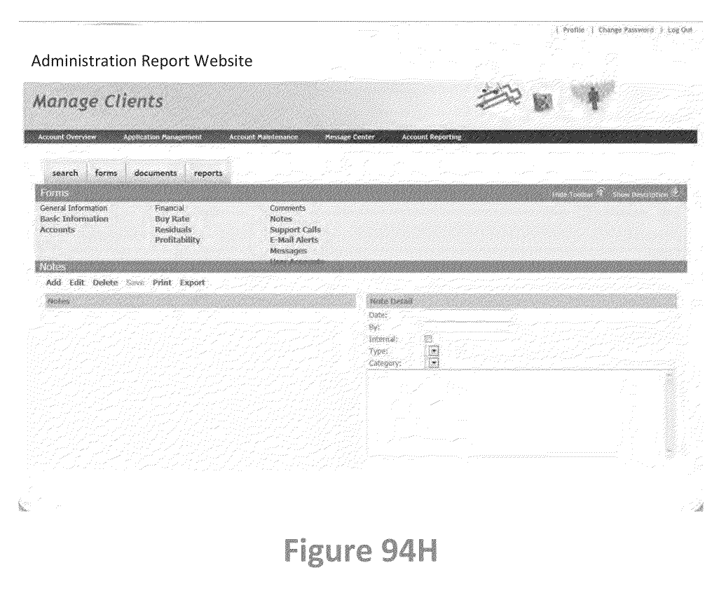

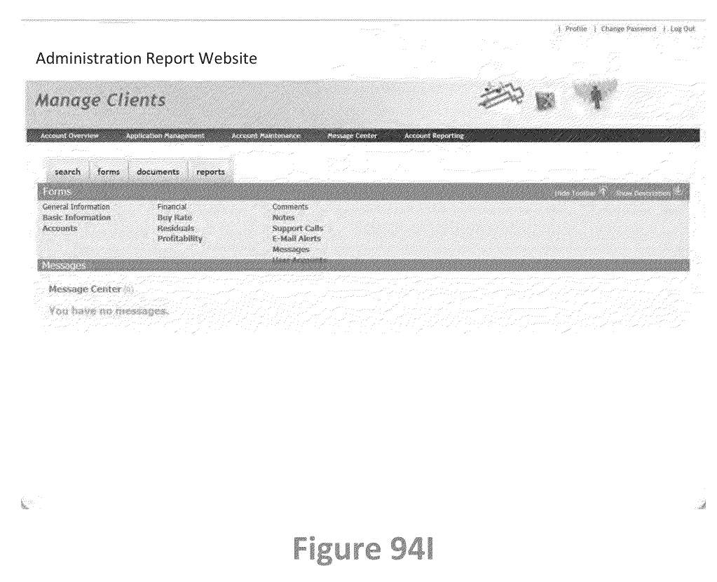

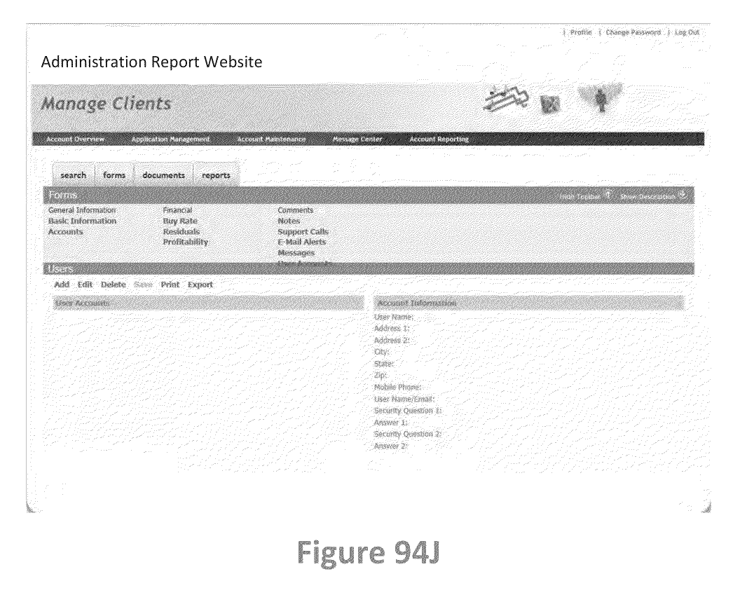

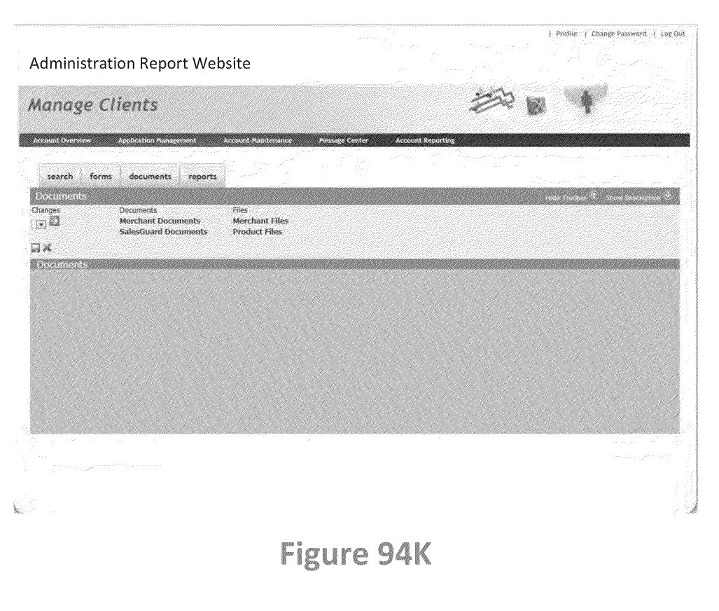

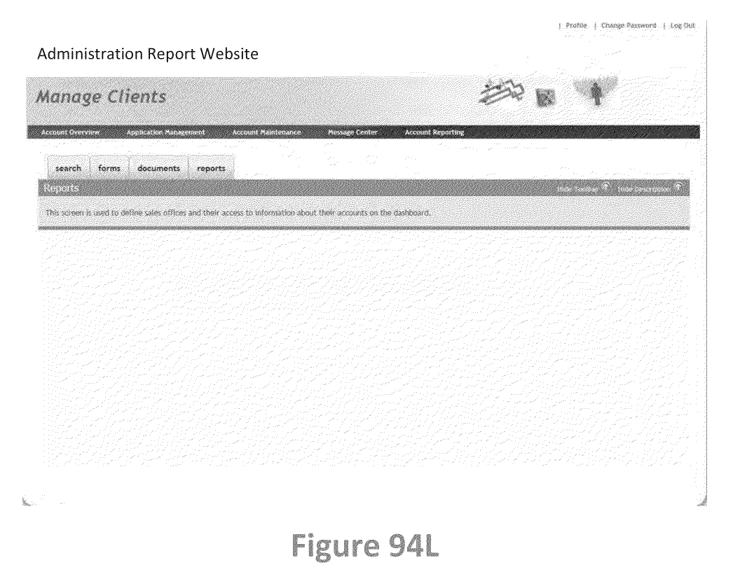

FIG. 94A depicts an administration reporting of managing clients screen 2164 for the processor, bank or ISO, according to an embodiment. The processor, bank or ISO can search for any of their clients using a search tab screen 2166. Clicking a client from the merchant search list screen 2170 retrieves that client's record.

FIG. 94B through 94M depicts an administration reporting of forms tabs of managing clients screens for the processor, bank or ISO, according to an embodiment. The processor, bank or ISO can view the client's summary record account information, documents and reports.

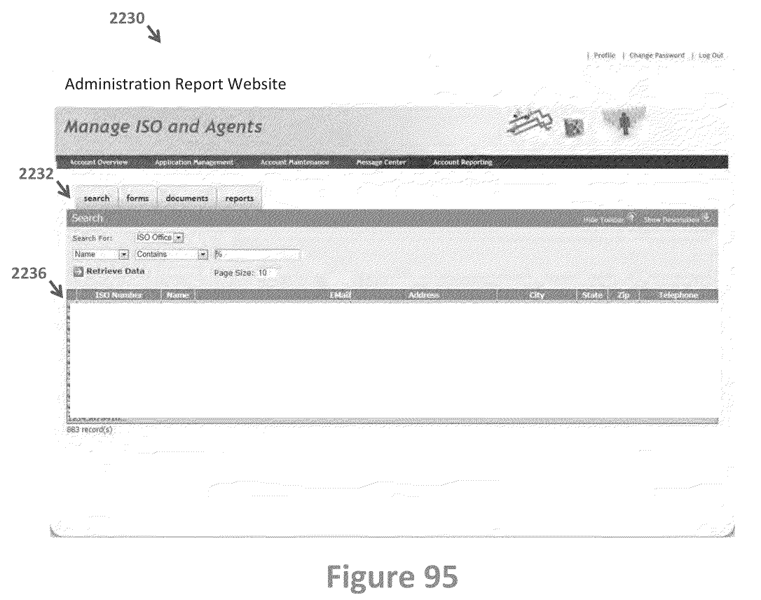

FIG. 95 depicts an administration reporting of managing ISOs and agents screen 2230 for the processor, bank or ISO, according to an embodiment. The processor, bank or ISO can search for any of their ISOs and agents using a search tab 2232. Clicking a client from a merchant search list screen 2236 retrieves that client's record.

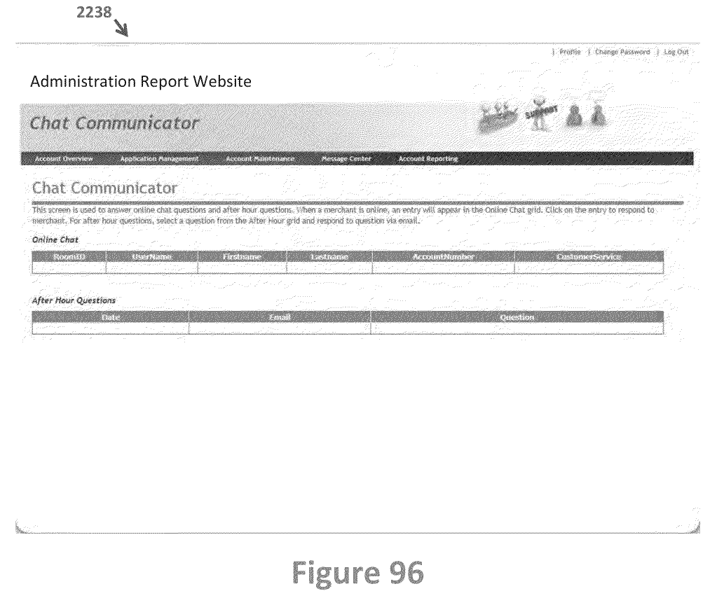

FIG. 96 depicts an administration reporting of chat communicator and after hour questions screen 2238 for the processor, bank or ISO, according to an embodiment. The processor, bank or ISO can assist their merchants by responding via live chat or by email to merchant questions.

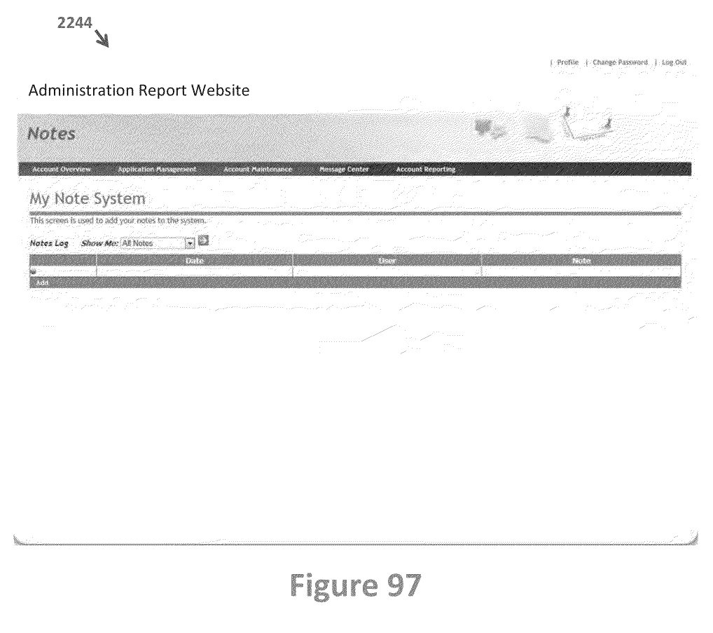

FIG. 97 depicts an administration reporting of notes screen 2244 for the processor, bank or ISO, according to an embodiment.

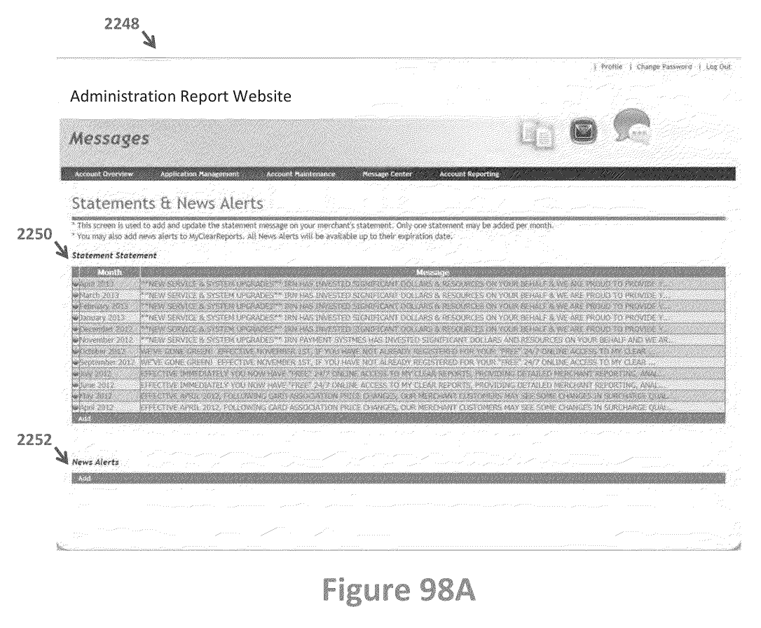

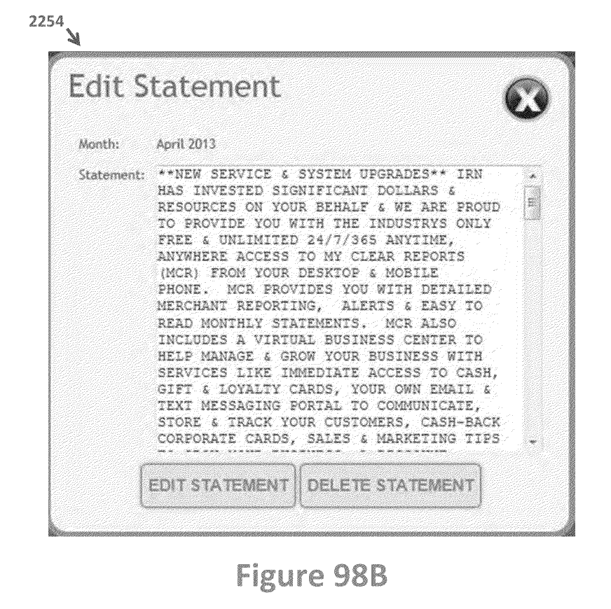

FIG. 98 depicts an administration reporting of messages and news alerts screen 2248 for the processor, bank or ISO, according to an embodiment. The processor, bank or ISO may add merchant statement messages at screen 2250 or post news alerts at screen 2252. FIG. 98B depicts an edit message screen 2254, according to an embodiment.

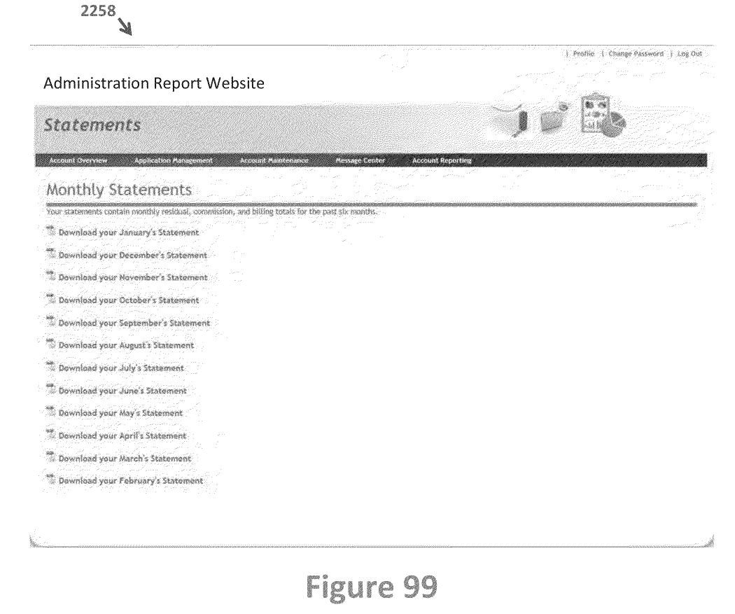

FIG. 99 depicts an administration reporting of invoice statements screen 2258 for the processor, bank or ISO, according to an embodiment.

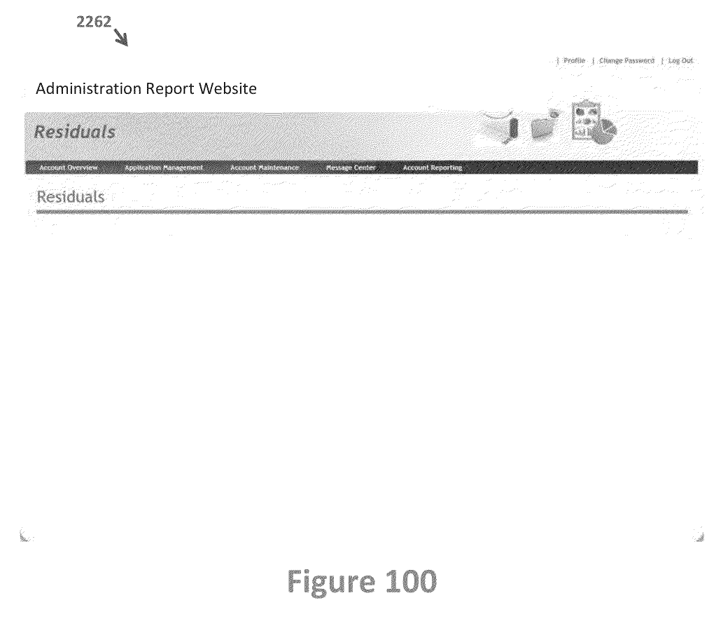

FIG. 100 depicts an administration reporting of residual report screen 2262 for the processor, bank or ISO, according to an embodiment.

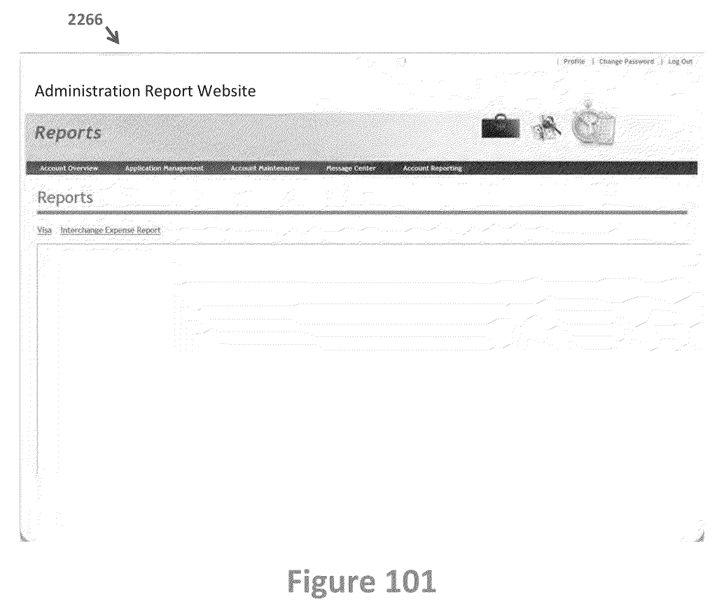

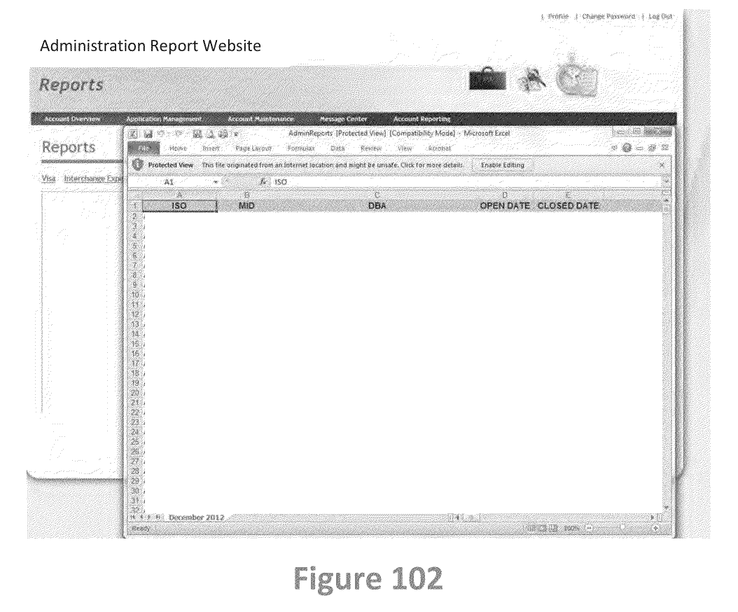

FIG. 101 depicts an administration reporting of payment industry report screen 2266 for the processor, bank or ISO, according to an embodiment. FIG. 102 depicts a payment card industry report.

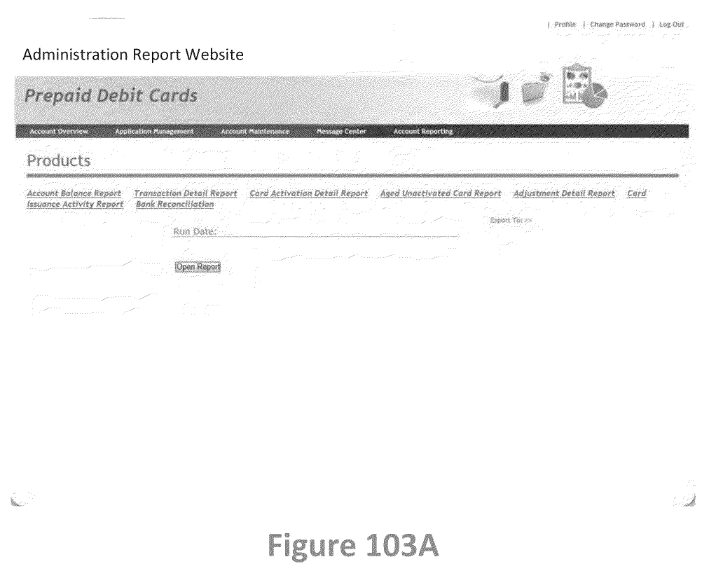

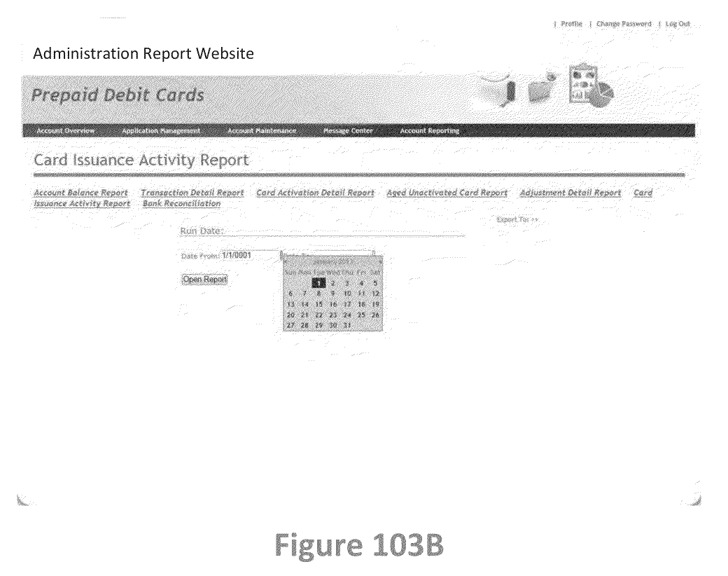

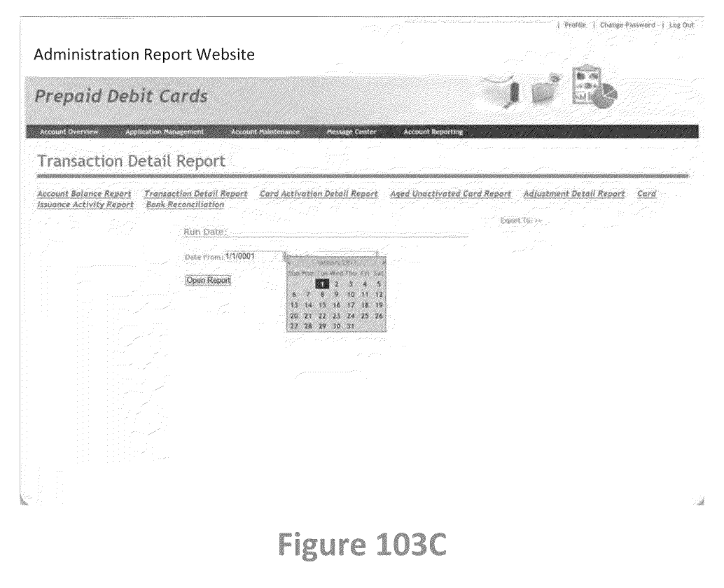

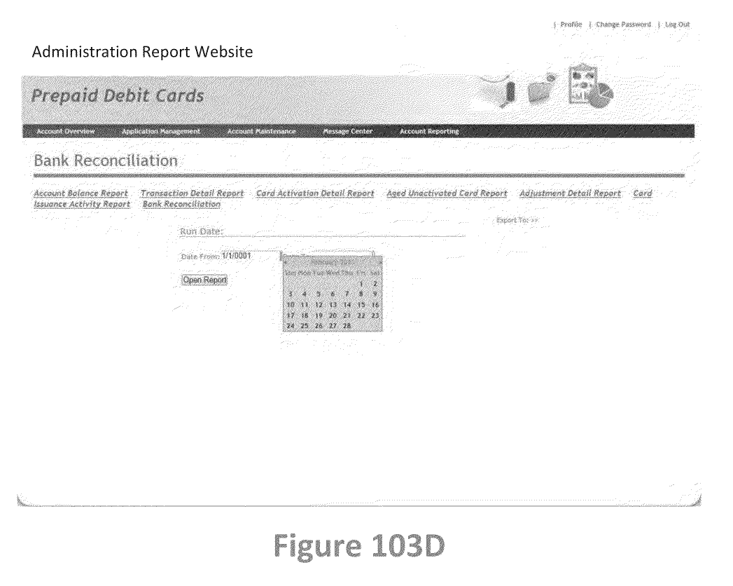

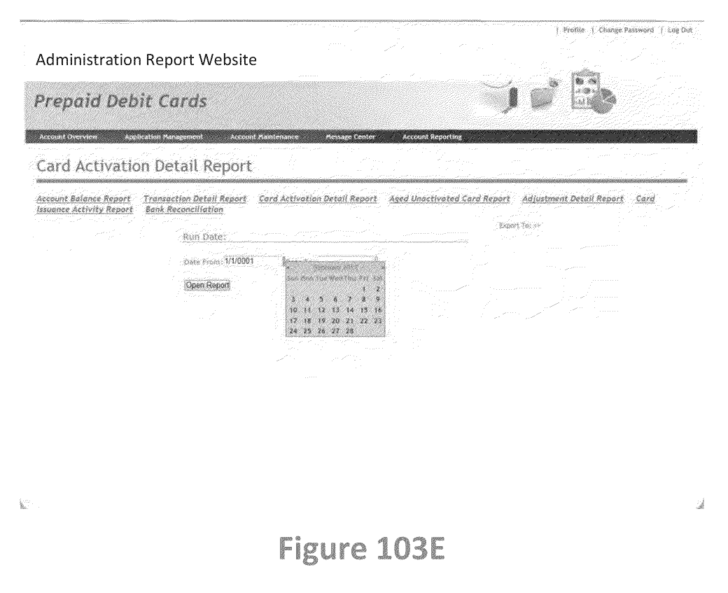

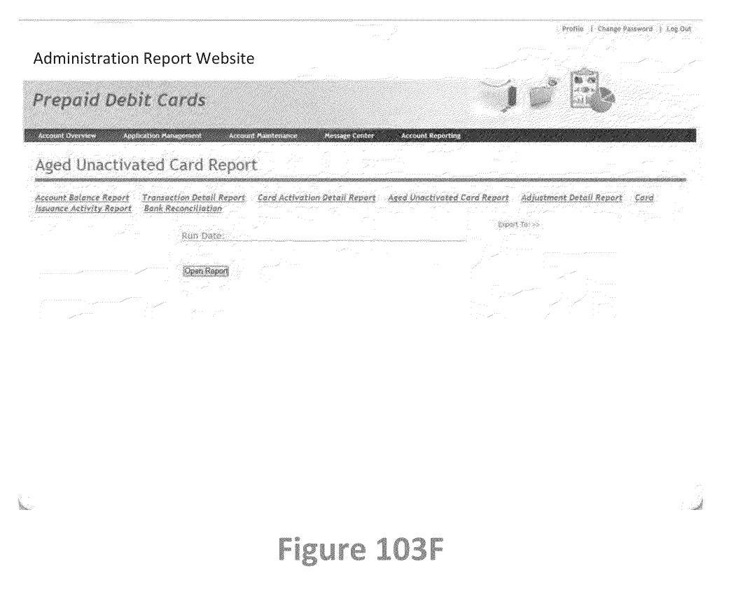

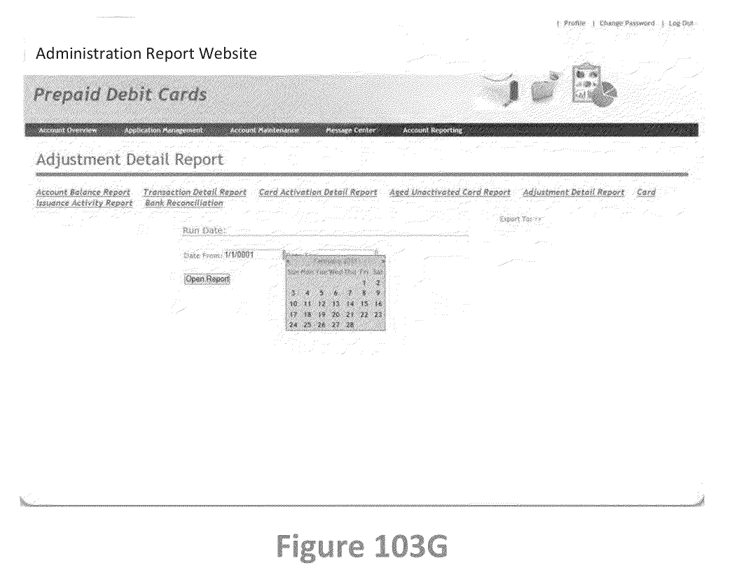

FIG. 103A through 103G depict an administration reporting of prepaid debit card report screen 2272 for the processor, bank or ISO, according to an embodiment.

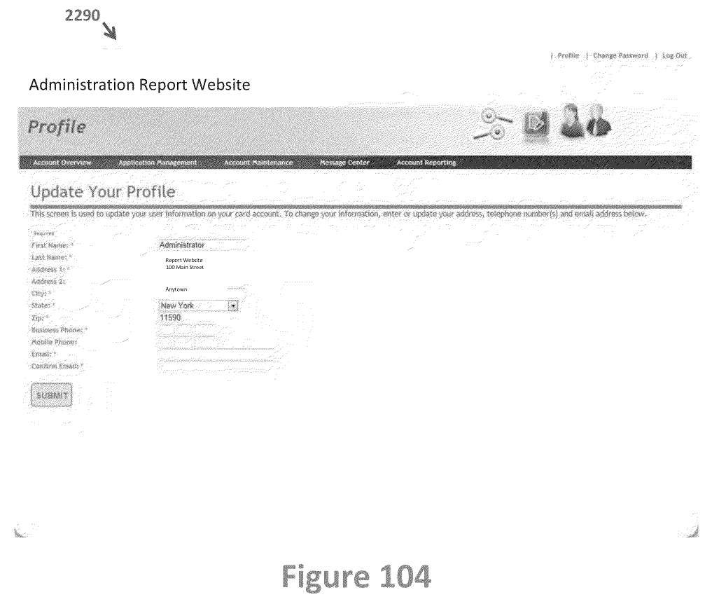

FIG. 104 depicts an administration reporting of profile screen 2290 for the processor, bank or ISO, according to an embodiment. The processor, bank or ISO can update their system profile.

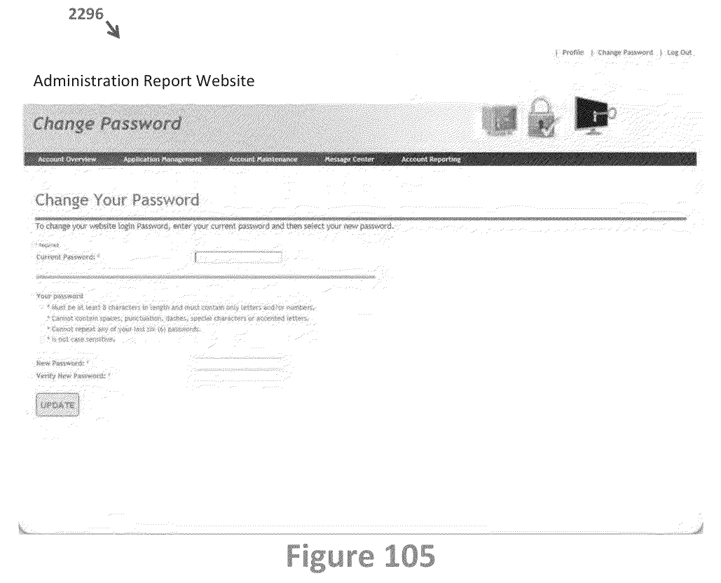

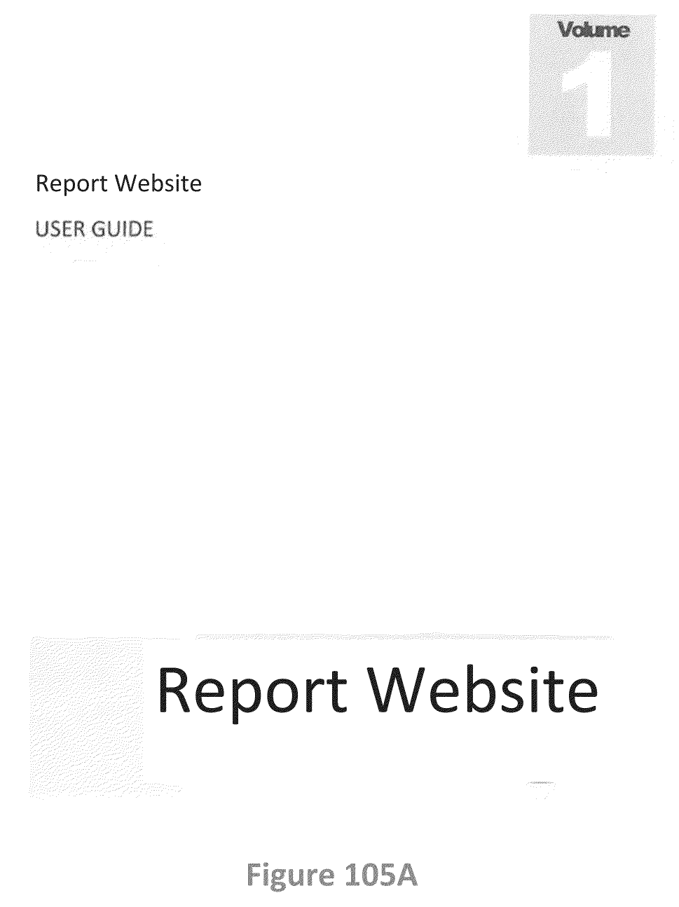

FIG. 105 depicts an administration reporting of password screen 2296 for the processor, bank or ISO, according to an embodiment. The processor, bank or ISO can change their login password.

### Customizable Products

Any and all of the available financial services or additional product or services offered are optional. The financial service provider chooses what products and services they want to offer to their merchants.

An administration panel offers a number of options for ISOs, banks, processors or any organization. They include:
Account and Commission Reporting
Set up privileges for administrators
View Merchant List
Post Messages or Notifications on Merchant Home Screen
Write Notes
Merchant Statistics
Contact/Address Book
Email Marketing
Add New Products

Security features for merchants, ISOs, banks and processors, financial service providers include:
SSL Certified
Server-Side scripted
Https site
Encrypted and truncated numbers
The data resides on the financial service providers or additional product or service providers end
System only displays the financial service provider or additional product or service companies' data for each merchant upon merchants request to view—the system may not store the data.
Secure Connection through web services

More products, more services and upgraded features to further benefit merchants and financial service providers may be included.

Some products described above that are provided include:
Advanced funds
Prepaid card
PCI
Gift and Loyalty Card Program
Online Bill Payment
CRM (customer relationship manager)
Business Resources
IRS Reporting & Reconciliation

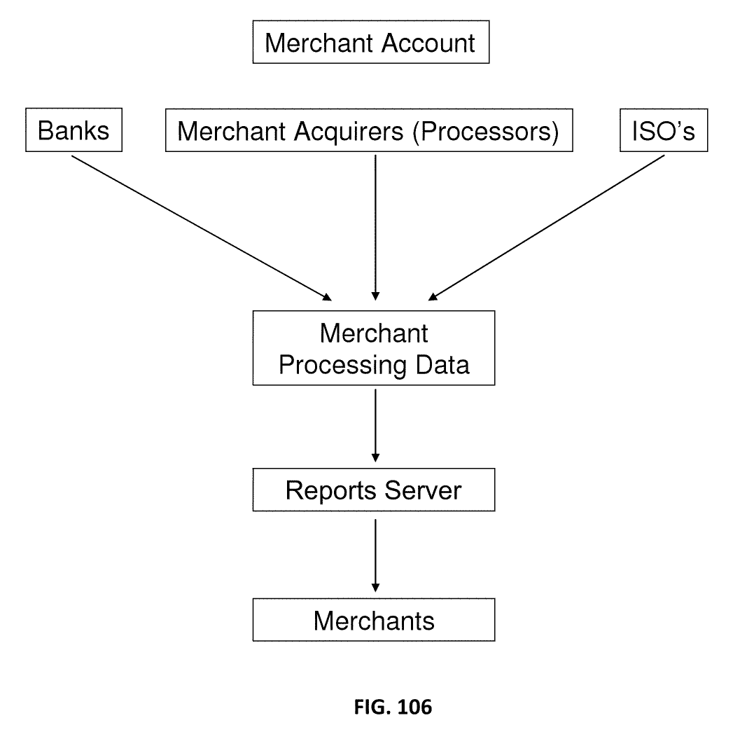

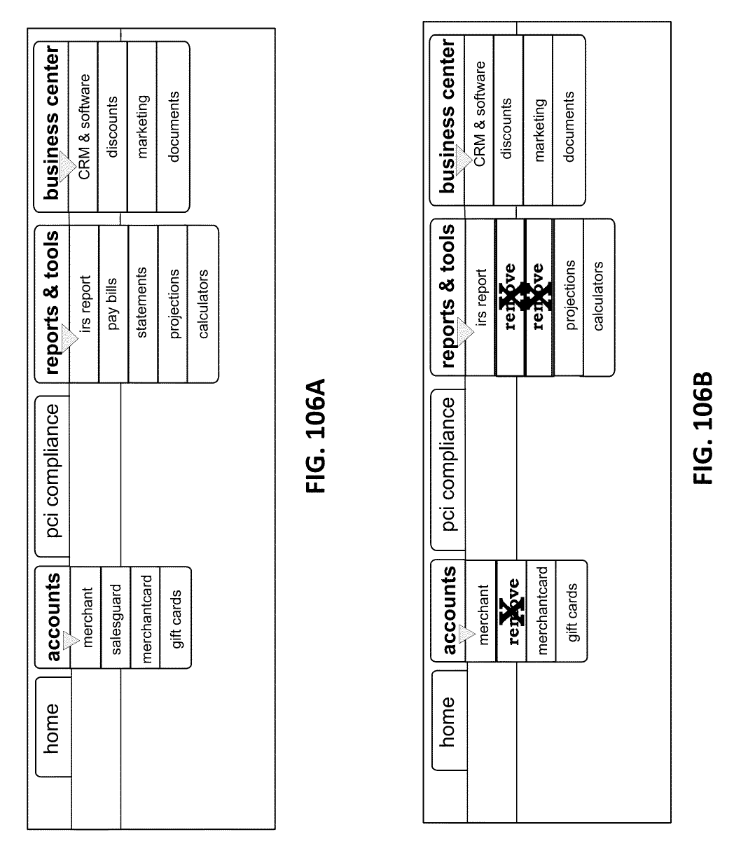

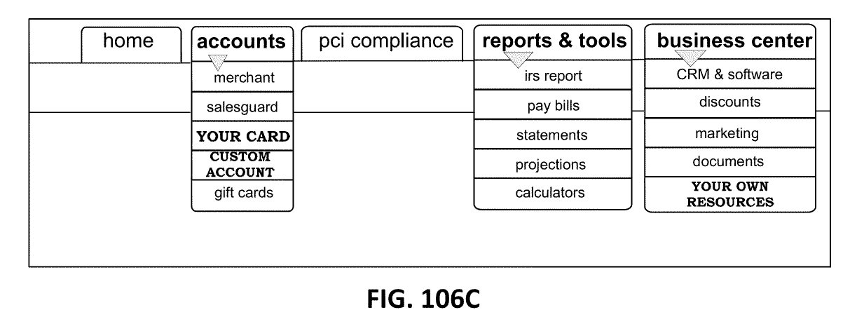

FIGS. 106A, 106B, and 106C depict customization options. As depicted by FIG. 106A, the products and services are menu driven meaning financial service provider users can choose which ones to offer to merchants.

The tabs depicted in FIGS. 106A, 106B, and 106C are fully customizable, so a financial service provider user can only show what he/she want to offer to merchants. As depicted by FIG. 105B, products/services can be removed. As depicted by FIG. 106C, user selectable products and services (e.g. “YOUR CARD,” “YOUR OWN RESOURCES,” etc.) can be added.

The following customization options and features are provided:

Security—“Your Data is your Data”

Display is provided of only the data a user chooses to display. The present systems are flexible, as much or as little information as the user wants is shown.

The following is a list of options offered. The list may be provided via an administration panel.
Account & Commission Reporting
Set up privileges for administrators
View Merchant List
Post Messages or Notifications on Merchant Home Screen
Write Notes
Merchant Statistics
Contact/Address Book
Email Marketing
Add New Products

FIG. 40 depicts a report screen 1086, in accordance with an embodiment. The report screen provides an account summary and a transaction activity. The merchant may choose to view a report of the credit card sales account information on a daily, monthly or yearly basis. For example, as depicted in FIG. 41A, the credit card sales account information for the month of March is shown.

FIG. 42A depicts another report screen 1116, in accordance with an embodiment. For example, credit card sales account information for March 2012 is shown.

FIG. 88 depicts a dashboard screen 2024, according to an embodiment. The dashboard screen displays ISOs, banks, processors or any organizations information. The information may be edited or changed.

FIG. 82 depicts a marketing tips screen 1850, according to an embodiment. The marketing tips screen is shown in response to selection of the business center tab on the top right portion of the webpage. A business center may encompass a multitude of important resources to help merchants run and grow their business. Merchants are provided with a free CRM (customer relationship management system), software download links, discounts, marketing tips and important documents and templates.

FIG. 106 depicts a flow diagram of merchant account data flow, according to an embodiment. Specifically, communication and data flow associated with a merchant account is shown. Information flows from the merchant banks, merchant acquirers (processors) and/or ISO's to merchant processing data to the system and finally to merchants.

In various embodiments, the method steps described herein, including the method steps described in FIGS. 6A, 6B, 6C and 106, may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIGS. 6A, 6B, 6C and 106. Certain steps of the methods described herein, including one or more of the steps of FIGS. 6A, 6B, 6C and 106, may be performed by a server or by another processor in a network-based cloud-computing system. Certain steps of the methods described herein, including one or more of the steps of FIGS. 6A, 6B, 6C and 106, may be performed by a client computer in a network-based cloud computing system. The steps of the methods described herein, including one or more of the steps of FIGS. 6A, 6B, 6C and 106, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIGS. 6A, 6B, 6C and 106, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

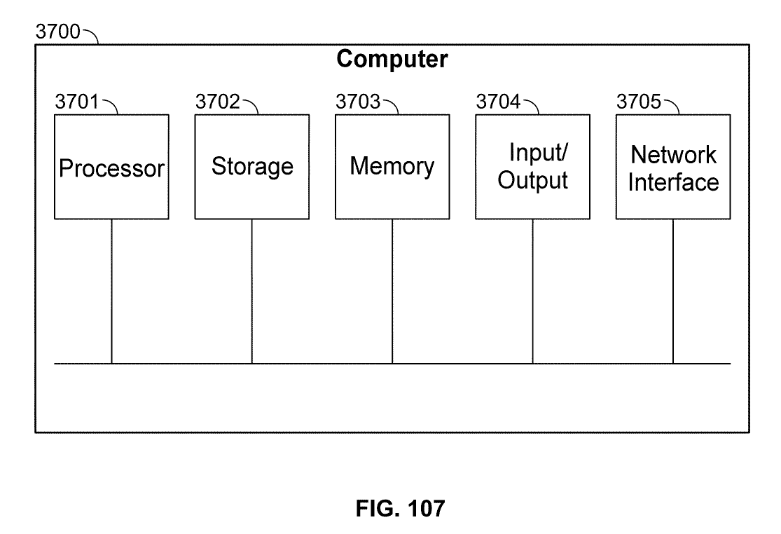

A high-level block diagram of an exemplary computer that may be used to implement systems, apparatus and methods described herein is illustrated in FIG. 107. Computer 3700 includes a processor 3701 operatively coupled to a data storage device 3702 and a memory 3703. Processor 3701 controls the overall operation of computer 3700 by executing computer program instructions that define such operations. The computer program instructions may be stored in data storage device 3702, or other computer readable medium, and loaded into memory 3703 when execution of the computer program instructions is desired. Thus, the method steps of FIGS. 6A, 6B, 6C and 106 can be defined by the computer program instructions stored in memory 3703 and/or data storage device 3702 and controlled by the processor 3701 executing the computer program instructions. For example, the computer program instructions can be implemented as computer executable code programmed by one skilled in the art to perform an algorithm defined by the method steps of FIGS. 6A, 6B, 6C and 106. Accordingly, by executing the computer program instructions, the processor 3701 executes an algorithm defined by the method steps of FIGS. 6A, 6B, 6C and 106. Computer 3700 also includes one or more network interfaces 3704 for communicating with other devices via a network. Computer 3700 also includes one or more input/output devices 3705 that enable user interaction with computer 3700 (e.g., display, keyboard, mouse, speakers, buttons, etc.).

Processor 3701 may include both general and special purpose microprocessors, and may be the sole processor or one of multiple processors of computer 3700. Processor 3701 may include one or more central processing units (CPUs), for example. Processor 3701, data storage device 3702, and/or memory 3703 may include, be supplemented by, or incorporated in, one or more application-specific integrated circuits (ASICs) and/or one or more field programmable gate lists (FPGAs).

Data storage device 3702 and memory 3703 each include a tangible non-transitory computer readable storage medium. Data storage device 3702, and memory 3703, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 3705 may include peripherals, such as a printer, scanner, display screen, etc. For example, input/output devices 3705 may include a display device such as a cathode ray tube (CRT) or liquid crystal display (LCD) monitor for displaying information to the user, a keyboard, and a pointing device such as a mouse or a trackball by which the user can provide input to computer 3700.

Any or all of the systems and apparatus discussed herein, including reports server 101, website 102, merchant device 103, mobile application 105, web services 106, financial service provider database 108, and financial service provider website 110, and components thereof, including web browser 201, display 202, memory 203, processor 205, processor 302, memory 303, application 316, merchant information tables 502, account summary tables 504, and account details tables 506, may be implemented using a computer such as computer 3700.

One skilled in the art will recognize that an implementation of an actual computer or computer system may have other structures and may contain other components as well, and that FIG. 107 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method comprising:
receiving, by a server from a merchant employing a mobile device, a request for custom credit card sales account information, wherein the request comprises an indication of a particular reporting type of the custom credit card sales account information;
requesting, by the server from a financial service provider, credit card sales account information, wherein the financial service provider is different than an entity hosting the server;
receiving, by the server from the financial service provider, the credit card sales account information;
filtering, by the server, the credit card sales account information based on the particular reporting type;
generating, by the server, a filtered custom credit card sales account based on the filtering; and
providing, by the server to the mobile device, the filtered custom credit card sales account information.

2. The method of claim 1, wherein the particular reporting type comprises a monthly reporting type.

3. The method of claim 1, further comprising:
receiving, by the server, a search request from the mobile device to search for a particular credit card sale;
performing a search, by the server, of the filtered custom credit card sales account information to identify the particular credit card sale; and
providing, by the server to the mobile device, the particular credit card sale in a format that can be properly displayed by the mobile device.

4. The method of claim 1, further comprising:
receiving, by the server from the mobile device, a request for cash advance, the request for cash advance based on a total number of sales indicated by the credit card sales account information;
requesting, by the server from at least one of the financial service provider, or another financial service provider, the cash advance;
receiving, by the server from the at least one of the financial service provider, or another financial service provider, payment based on the cash advance; and
providing, by the server to the mobile device, an indication of available funds based on the cash advance.

5. The method of claim 1, wherein the credit card sales account information comprises at least one of:
available funds;
batch of credit card sales;
chargebacks;
deposits;
fees; or
cash advance.

6. The method of claim 1, further comprising:
authenticating, by the server, the mobile device.

7. The method of claim 1, further comprising:
receiving, by the server from the financial service provider, a request for providing branded information on reports provided to the mobile device;
inputting the branded information on the reports;
generating branded reports; and
providing, by the server to the mobile device, the branded reports, wherein the branded reports comprise at least the branded information and the filtered custom credit card sales account information.

8. A method comprising:
receiving, by a server from a merchant employing a device, a request for a processing card industry compliance certificate;
authenticating, by the server, the device;
transmitting, by the server to the device, a processing card industry compliance questionnaire comprising a plurality of questions;
receiving, by the server, one or more responses to the plurality of questions;
verifying, by the server, the one or more responses;
processing, by the server, the one or more responses in order to determine whether or not the merchant complies with a processing card industry compliance requirement; and
providing, by the server, a processing card industry compliance certificate to the device in response to determining that the merchant complies with the processing card industry compliance requirement.

9. The method of claim 8, wherein the device is a mobile device.

10. The method of claim 8, wherein the verifying further comprises performing a network security scan by the server.

11. The method of claim 10, wherein the network security scan is performed periodically to ensure that the merchant complies with the processing card industry compliance requirement.

12. The method of claim 8, further comprising:
determining, by the server, that the merchant does not comply with the processing card industry compliance requirement; and
alerting the merchant in response to the determining.

13. The method of claim 8, wherein one of the plurality of questions comprises a question regarding a merchant type associated with the merchant.

14. A method comprising:
receiving, by a server from a merchant employing a mobile device, a first request for credit card sales account information;
requesting, by the server from a financial service provider, credit card sales account information, wherein the financial service provider is different than an entity hosting the server;
receiving, by the server from the financial service provider, the credit card sales account information;
providing, by the server to the mobile device, the credit card sales account information;
receiving, by the server, a second request from the merchant employing the mobile device to provide a prepaid card account loaded with available funds based on the credit card sales account information;
creating, by the server, the prepaid card account by loading the prepaid card account with an amount of funds in an amount of the available funds;
maintaining, by the server, transactional information associated with the prepaid card account;
detecting, by the server, a transaction that is processed on the prepaid card account; and
providing, by the server, an alert to the mobile device in response to the detecting.

15. The method of claim 14, further comprising:
receiving, by the server from the mobile device, a request to sort the credit card sales account information based on a certain criteria;
sorting, by the server, the credit card sales account information based on the certain criteria;
generating, by the server, sorted credit card sales account information based on the sorting; and
providing the sorted credit card sales account information in a format that can be properly displayed by the mobile device.

16. The method of claim 14, wherein the credit card sales account information comprises at least one of:
available funds;
batch of credit card sales;
chargebacks;
deposits;
fees; or
cash advance.

17. The method of claim 14, further comprising:
authenticating, by the server, the mobile device.

18. The method of claim 14, further comprising:
receiving, by the server from the financial service provider, a third request for providing branded information on reports provided to the mobile device;
inputting the branded information on the reports;
generating branded reports; and
providing, by the server to the mobile device, the branded reports, wherein the branded reports comprise at least the branded information and the credit card sales account information.

19. The method of claim 14, further comprising:
receiving, by the server, a third request to block the prepaid card account; and
blocking, by the server, the prepaid card account.

20. The method of claim 19, further comprising:
receiving, by the server, a fourth request to unblock the prepaid card account;
verifying, by the server, the fourth request;
notifying the merchant how to unblock via the customer service telephone number, by the server, the prepaid card account; and
providing, by the server, access to the prepaid card account in response to the notifying of how to unblock.
